(19) United States
(12) Patent Application Publication
(10) Pub. No.: US 2021/0108077 A1
(43) Pub. Date: Apr. 15, 2021

(54) POLYMER-BASED PORTION, ADHESIVE, FOLDABLE APPARATUS, AND METHODS OF MAKING

(71) Applicant: Corning Incorporated, Corning, NY (US)

(72) Inventors: Tara Marie Berleue, Hornell, NY (US); Charles Brandenburg, Wellsboro, PA (US); Justin Bernard Bult, Geneseo, NY (US); Matthew John Dejneka, Corning, NY (US); Sushmit Sunil Kumar Goyal, Painted Post, NY (US); Timothy Michael Gross, Corning, NY (US); Yungfeng Gu, Painted Post, NY (US); Yuhui Jin, Painted Post, NY (US); Jenny Kim, Horseheads, NY (US); Xinghua Li, Horseheads, NY (US); Jian Luo, Painted Post, NY (US); Kevin Robert McCarthy, Horseheads, NY (US); Weijun Niu, Painted Post, NY (US); Terri Lee Sines-Melock, Corning, NY (US); Michael Lesley Sorensen, Waverly, NY (US); Jonathan Earl Walter, Woodhull, NY (US); Arline Lee Weikel, Mansfield, PA (US); Lei Yuan, Painted Post, NY (US)

(21) Appl. No.: 17/068,272

(22) Filed: Oct. 12, 2020

Related U.S. Application Data
(60) Provisional application No. 62/914,727, filed on Oct. 14, 2019.
(60) Provisional application No. 62/914,769, filed on Oct. 14, 2019.
(60) Provisional application No. 62/950,688, filed on Dec. 19, 2019.
(60) Provisional application No. 62/958,117, filed on Jan. 7, 2020.
(60) Provisional application No. 63/041,369, filed on Jun. 19, 2020.
(60) Provisional application No. 63/067,398, filed on Aug. 19, 2020.

(51) Int. Cl. C08L 75/16; C08K 5/00; C08K 5/205; C08K 5/09; C08K 5/54; C08G 18/67; G02B 1/111

(52) U.S. Cl. CPC C08L 75/16; C08K 5/0025; C08K 5/205; C08K 5/09; G02F 1/133305; C08G 18/672; G02B 1/111; C08L 2312/08; C08L 2207/04; C08K 5/5406

(57) ABSTRACT

Polymer-based portions comprise an index of refraction ranging from about 1.49 to about 1.55. In some embodiments, the polymer-based portion comprises the product of curing 45-75 wt % of a difunctional urethane-acrylate oligomer with 25-55 wt % of a difunctional cross-linking agent and optionally a reactive diluent. In some embodiments, the polymer-based portion comprises the product of curing 75-100 wt % of a reactive diluent and optionally one or more a difunctional urethane-acrylate oligomer and/or a difunctional cross-linking agent. Adhesives comprise an index of refraction ranging from about 1.49 to about 1.55. In some embodiments, the adhesive comprises the product of heating 10-35 wt % of a silane-hydride-terminated siloxane and 65-90 wt % of a vinyl-terminated siloxane. In some embodiments, the adhesive comprises the product of irradiating a thiol-containing siloxane and a photo-initiator with at least one wavelength of light that the photo-initiator is sensitive to. Foldable apparatus can comprise the polymer-based portion and/or adhesive.

### RELATED APPLICATIONS

This application claims the benefit of priority under 35 U.S.C. § 119 of U.S. Provisional Application Ser. No. 62/914727 filed on Oct. 14, 2019, U.S. Provisional Application Ser. No. 62/914769 filed on Oct. 14, 2019, U.S. Provisional Application Ser. No. 62/950688 filed on Dec. 19, 2019, U.S. Provisional Application Ser. No. 62/958117 filed on Jan. 7, 2020, U.S. Provisional Application Ser. No. 63/041369 filed on Jun. 19, 2020 and U.S. Provisional Application Ser. No. 63/067398 filed on Aug. 19, 2020, the contents of each of which are relied upon and incorporated herein by reference in their entireties.

### FIELD

The present disclosure relates generally to foldable apparatus and methods of making and, more particularly, to foldable apparatus comprising a foldable substrate and methods of making.

### BACKGROUND

Foldable substrates are commonly used, for example, in display applications, for example, liquid crystal displays (LCDs), electrophoretic displays (EPD), organic light emitting diode displays (OLEDs), plasma display panels (PDPs), or the like.

It is known to use adhesives to attach portions of foldable displays and/or foldable protective covers. Also, it is known to use polymer-based portions in foldable displays and/or foldable protective covers.

There is a desire to develop foldable displays as well as foldable protective covers to mount on foldable displays. Foldable displays and foldable covers should have good impact and puncture resistance. At the same time, foldable displays and foldable covers should have small minimum bend radii (e.g., about 10 millimeters (mm) or less).

Some prior foldable displays have used polymer portions and/or adhesives. However, traditional adhesives can impair the transparency and/or low haze of a display if there is a refractive index mismatch, the adhesive becomes opaque after repeated use, or the portions attached by the adhesive delaminate. Further, polymer-based portions can impair the flexibility and/or impact resistance of the foldable display and/or foldable protective cover. Further, adhesives and/or polymer-based portions can impair the flexibility and bending performance of the foldable display and/or foldable protective cover if the bending strain exceeds the ultimate elongation of the adhesive and/or polymer-based portion.

Further, plastic displays and covers with small minimum bend radii tend to have poor impact and/or puncture resistance. Furthermore, conventional wisdom suggests that ultra-thin glass-based sheets (e.g., about 75 micrometers (μm or microns) or less thick) with small minimum bend radii tend to have poor impact and/or puncture resistance. Furthermore, thicker glass-based sheets (e.g., greater than 125 micrometers) with good impact and/or puncture resistance tend to have relatively large minimum bend radii (e.g., about 30 millimeters or more).

Consequently, there is a need to develop foldable substrates (e.g., glass-based substrates, ceramic-based substrates), adhesives, and polymer-based portions for foldable apparatus that have high transparency, low haze, low minimum bend radii, and good impact and puncture resistance.

### SUMMARY

There are set forth herein polymer-based portions, adhesives, foldable apparatus comprising a polymer-based portion and/or an adhesive, foldable apparatus comprising a shattered pane, foldable apparatus comprising a plurality of planes, and methods of making the same. The polymer-based portions of embodiments of the disclosure can provide several technical benefits. For example, the polymer-based portion can comprise a urethane acrylate material that is elastomeric. By providing an elastomeric polymer-based portion, the polymer-based portion can recover (e.g., fully recover) from folding-induced strains and/or impact-induced strains, which can decrease fatigue of the polymer-based portion from repeated folding, enable a low force to achieve a given parallel plate distance, and enable good impact and/or good puncture resistance. Further, the polymer-based portion can be cross-linked, for example, using a difunctional cross-linking agent, which can further increase the elastomeric character of the polymer-based portion. Also, the polymer-based portion can further comprise a block copolymer or silicone-based rubber, which can further increase the elastomeric character of the polymer-based portion. In some embodiments, the polymer-based portion can be made using a reactive diluent, which can decrease the glass transition temperature of the polymer-based portion. Providing a low glass transition temperature (e.g., about 0° C. or less, about −20° C. or less) can enable consistent mechanical properties of the polymer-based portion across a temperature range in which it is used (e.g., from about 0° C. to about 60° C., from about 10° C. to about 30° C.). Also, the polymer-based portion can withstand high strains (e.g., about 50% or more, from about 65% to about 110%), which can improve folding performance and durability. Providing a silane-coupling agent can increase adhesion of the polymer-based portion to substrates (e.g., glass-based substrates, polymer-based substrates) and/or adhesives. Additionally, the polymer-based portion can comprise high transmittance (e.g., about 90% or more) and low haze (e.g., about 0.2% or less).

The adhesives of embodiments of the disclosures can provide several technical benefits. The adhesive can comprise a silicone-based polymer with a low glass-transition temperature (e.g., about −60° C. or less). Providing a low glass transition temperature (e.g., about −60° C. or less) can enable consistent mechanical properties of the polymer-based portion across a temperature range in which it is used (e.g., from about −20° C. to about 60° C., from about 10° C. to about 30° C.). The adhesive can withstand high strains (e.g., about 75% or more), comprise a low storage modulus (e.g., from about 0.2 kiloPascals to about 2 kiloPascals), and/or comprise a low Young's modulus (e.g., elastic modulus about 75 MegaPascals or less). Providing an adhesive with a low storage modulus and/or low Young's modulus can improve folding performance of a foldable apparatus, for example, by decoupling the stresses of different components in the foldable apparatus. Providing a low modulus (e.g., storage, Young's) and high strain adhesive can improve folding performance and durability. The adhesive can be formed by curing a substantially solvent-free composition. Providing a composition that is substantially solvent-free can increase its curing rate, which can decrease processing time. Providing a composition that is substantially solvent-free can reduce (e.g. decrease, eliminate) the use of rheology modifiers and increase composition homogeneity, which can increase the optical transparency (e.g., transmittance) of the resulting adhesive. Providing a silane-coupling agent can increase adhesion of the polymer-based portion to substrates (e.g., glass-based substrates, polymer-based substrates), polymer-based portions, and/or adhesives.

Foldable apparatus can exhibit good optical performance, for example, low optical distortions across the thickness of the foldable apparatus. Providing a foldable apparatus comprising a shattered pane and/or a plurality of panes with a low difference (e.g., about 0.008 or less) between a refractive index at a major surface of the foldable apparatus and a central location of the foldable apparatus can minimize optical distortions from the plurality of shattered pieces comprising the shattered pane and/or the plurality of panes. Also, providing a foldable apparatus comprising a shattered pane and/or a plurality of panes with a low difference (e.g., about 0.008 or less) between a refractive index at a major surface of the foldable apparatus and a central location of the foldable apparatus can minimize optical distortions between an adjacent pair of shattered pieces of the plurality of shattered pieces and/or the plurality of panes and a first material positioned therebetween, if provided.

Providing a smooth surface of the foldable apparatus can reduce optical distortions and provide a perceived continuous surface for a user of the foldable apparatus. Likewise, providing a second material disposed over substantially an entire second major surface of a foldable substrate can reduce optical distortions. In some embodiments, the first material can substantially match (e.g., a magnitude of a difference of about 0.1 or less) a refractive index of a shattered piece and/or a pane, which can minimize the visibility of the shattered pane and/or plurality of panes to a user. In some embodiments, providing the first material between a pair of shattered pieces and/or a pair of panes can produce an anti-glare and/or anti-reflective property in the foldable apparatus that can improve visibility of an electronic device that the foldable apparatus may be disposed over. In some embodiments, providing a first material comprising a different (e.g., a magnitude of a difference of about 0.02 or more) refractive index than a refractive index of a shattered piece and/or a pane can produce an angle-dependent visibility (e.g., haze, color shift) through the foldable apparatus. For example, visibility may be at a maxima (e.g., maximum) when viewed at a direction normal to the surface (e.g., first major surface) of the foldable apparatus, and that visibility may decrease (e.g., increasing haze) as an angle relative to a direction normal to the surface is increased.

Providing a foldable apparatus comprising a central portion comprising a central thickness that is less than a first thickness of the first portion and/or second portion can enable small effective minimum bend radii (e.g., about 10 millimeters or less) based on the reduced thickness in the central portion. As indicated by surprising results of the Pen Drop Test presented in FIG. 16, foldable substrates comprising a thickness of about 50 μm or less can provide good pen drop performance while thicknesses in a range from about 50 μm to about 80 μm provide poor pen drop performance. Furthermore, providing the central portion with the central thickness that is less than the first thickness can reduce stress concentrations at the outer edges of the shattered pieces and/or the panes during folding that may otherwise occur with larger thicknesses at the first portion and the second portion. Furthermore, the thickness of the first portion and the second portion may be increased to enhance puncture resistance that may be more difficult to achieve with reduced thicknesses that are similar and/or the same thickness as the shattered pane, the plurality of panes, and/or the central portion. Additionally, the foldable substrate may comprise a glass-based substrate to enhance puncture resistance and/or impact resistance. Further, the foldable apparatus comprising the glass-based substrate may be chemically strengthened to further enhance impact resistance and/or puncture resistance of the foldable apparatus. Also, the plurality of panes and/or plurality of shattered pieces may comprise a plurality of glass-based panes that can optionally be chemically strengthened, which can enhance impact resistance and/or puncture resistance of the foldable apparatus.

A foldable apparatus according to embodiments of the disclosure can comprise the adhesive and/or the polymer-based portion. For example, the foldable apparatus can provide small effective minimum bend radii while simultaneously providing good impact and puncture resistance. By providing a shattered pane with a plurality of shattered pieces attached together by a first material having an elastic modulus that is less than an elastic modulus of a shattered piece of the plurality of shattered pieces, a foldable apparatus can enable good flexibility and folding performance (e.g., achieve an effective bend radius of about 10 millimeters or less). By providing a plurality of panes attached together by a first material having an elastic modulus that is less than an elastic modulus of a pane of the plurality of panes, a foldable apparatus can enable good flexibility and folding performance (e.g., achieve an effective bend radius of about 10 millimeters or less). The foldable apparatus can comprise glass-based and/or ceramic-based materials comprising one or more compressive stress regions, which can further provide increased impact resistance and/or increased puncture resistance while simultaneously facilitating good folding performance.

Also, by providing a shattered pane with a plurality of shattered pieces and/or a plurality of panes attached together by a first material, a smooth (e.g., regular, planar) surface (e.g., first major surface) can be enabled, for example, when the shattered pane and/or plurality of panes was generated from a substrate deposed on a backer when it was shattered. Providing a smooth surface of the foldable apparatus can reduce optical distortions and provide a perceived continuous surface for a user of the foldable apparatus. Likewise, providing a second material disposed over substantially an entire second major surface of a foldable substrate can reduce optical distortions. In some embodiments, the first material can substantially match (e.g., a magnitude of a difference of about 0.1 or less) a refractive index of a shattered piece, which can minimize the visibility of the shattered pane to a user.

In some embodiments, providing the first material between a pair of shattered pieces and produce an anti-glare and/or anti-reflective property in the foldable apparatus that can improve visibility of an electronic device that the foldable apparatus may be disposed over. In some embodiments, providing a first material comprising a different (e.g., a magnitude of a difference of about 0.02 or more) refractive index than a refractive index of a shattered piece can produce an angle-dependent visibility (e.g., haze, color shift) through the foldable apparatus. In further embodiments, providing the different refractive indices can be useful as a privacy screen. For example, visibility may be at a maxima (e.g., maximum) when viewed at a direction normal to the surface (e.g., first major surface) of the foldable apparatus, and that visibility may decrease (e.g., increasing haze) as an angle relative to a direction normal to the surface is increased.

Providing a central portion with a shattered pane and/or a plurality of panes with the first material can help further reduce the effective minimum bend radius compared to a monolithic pane entirely fabricated from a glass-based material or a ceramic-based material. Also, providing the plurality of shattered pieces of the shattered pane and/or a plurality of panes can provide good scratch resistance, good impact resistance, and/or good puncture resistance to the foldable apparatus, which may be difficult to achieve if fabricating the foldable substrate entirely of the first material. The foldable apparatus can comprise glass-based and/or ceramic-based materials comprising one or more compressive stress regions, which can further provide increased impact resistance and/or puncture resistance while simultaneously facilitating good bending performance.

By providing a shattered pane with a plurality of shattered pieces and/or plurality of panes attached together by a first material having an elastic modulus that is less than an elastic modulus of a shattered piece of the plurality of shattered pieces and/or a pane of the plurality of panes, a foldable substrate can enable good folding performance (e.g., achieve an effective bend radius of about 10 millimeters or less) as well as limiting the extent of potential damages to the foldable apparatus. For example, the damage resistance of the foldable apparatus may increase because damage to the foldable apparatus may be limited to a shattered piece and/or pane impacted rather than the entire foldable substrate. Additionally, the first material between pairs of shattered pieces and/or pairs of panes can improve the ability of the foldable apparatus to absorb impacts without failure. Furthermore, providing a central portion with a shattered pane with the first material can help further reduce the effective minimum bend radius compared to an unshattered pane entirely fabricated from a glass-based or ceramic-based material. Also, providing the plurality of shattered pieces of the shattered pane can provide good scratch resistance, good impact resistance, and/or good puncture resistance to the foldable apparatus, which may be difficult to achieve if fabricating the shattered pane entirely of the first material.

Minimizing a total mass of first material (e.g., about 10% or less of a total weight of the plurality of shattered pieces) can further improve scratch resistance, impact resistance, and/or puncture resistance of the foldable apparatus. The foldable apparatus can comprise glass-based and/or ceramic-based materials comprising one or more compressive stress regions, which can further provide increased impact resistance and/or puncture resistance while simultaneously facilitating good bending performance.

Providing a second material comprising a higher modulus than the first material can reduce bend-induced stresses on the foldable substrate, for example, by shifting a neutral axis of the substrate closer to the second material than a mid-plane of the substrate. Further, providing a second material disposed over substantially an entire second major surface of a foldable substrate can present a contact surface with consistent properties across its length and/or width for coupling components to (e.g., substrates, coatings, release liners, display devices). In some embodiments, a first portion and a second portion can be positioned opposite a first major surface of the substrate. Providing a first portion and a second portion with the second material positioned therebetween can provide good bending performance as well as minimize a region of the foldable apparatus with a lower impact resistance (e.g., the portion including the second material compared to the portions comprising the first portion or the second portion).

Further, the net mechanical properties of the foldable apparatus can be adjusted by changing the relationship between the elastic modulus of the first material relative to the elastic modulus of a piece of the shattered pieces and/or a pane of the plurality of panes. Providing a first material and/or a second material with a glass transition temperature outside of an operating range (e.g., outside of an operating range from about −20° C. to about)60° of a foldable apparatus can enable the foldable apparatus to have consistent properties across the operating range. Similarly, by providing a first material and/or a second material comprising a storage modulus that changes by a multiple of 100 or less when changing a temperature of the corresponding material from 100° C. to about −20° C. there can be achieved consistent properties across a wide range of temperatures. As discussed above, the adhesives can comprise the first material.

Providing a foldable apparatus and/or a foldable substrate comprising a neutral stress configuration when the foldable apparatus and/or a foldable substrate is in a bent configuration, the force to bend the foldable apparatus to a predetermined parallel plate distance can be decreased. Further, providing a neutral stress configuration when the foldable apparatus is in a bent state can reduce the maximum stress and/or maximum strain experienced by a polymer-based portion and/or an adhesive, if provided, during normal use conditions, which can, for example, enable increased durability and/or reduced fatigue of the foldable apparatus. In some embodiments, the neutral stress configuration can be generated by heating the foldable substrate and a sol-gel coating disposed on the foldable substrate to form the foldable substrate into a bent configuration (e.g., neutral stress configuration). Providing a width of the sol-gel coating from about 5% to about 30% or a longest dimension of the foldable substrate can minimize the amount of material and/or cost associated with making the foldable substrate and/or foldable apparatus.

Providing a neutral stress configuration when the foldable apparatus is in a bent configuration can decrease the force to fold the foldable apparatus to a predetermined parallel plate distance. Further, providing a neutral stress configuration when the foldable apparatus is in a bent state can reduce the maximum stress and/or the maximum strain experienced by the polymer-based portion during normal use conditions, which can, for example, enable increased durability and/or reduced fatigue of the foldable apparatus. In some embodiments, the polymer-based portion can comprise a low (e.g., substantially zero and/or negative) coefficient of thermal expansion, which can mitigate warp caused by volume changes during curing of the polymer-based portion. In some embodiments, the neutral stress configuration can be generated by providing a polymer-based portion that expands as a result of curing. In some embodiments, the neutral stress configuration can be generated by curing the polymer-based portion in a bent configuration.

Methods are disclosed that shift the neutral stress configuration of a foldable apparatus that, as used in its intended application, may experience large compressive and tensile stresses when folded to tight bend radii. These methods can reduce the incidence of fatigue failure in the foldable apparatus. In some embodiments, the neutral stress configuration can correspond to a bent (e.g., as-bent) configuration through the deposition and annealing of a sol-gel oxide coating, leading to a neutral stress state in the as-bent configuration and a beneficial stress state in a substantially non-bent configuration. Foldable apparatus of embodiments of the disclosure, for example, can be shaped in a desired as-bent configuration (e.g., neutral stress configuration) without the use of a mold and at lower temperatures than employed in thermal sagging processes. The methods also have flexibility in terms of developing the two-dimensional and three-dimensional as-bent configurations of the intended bendable glass articles by virtue of the ease in which the sol-gel coatings can be patterned on the glass substrate.

Some example embodiments of the disclosure are described below with the understanding that any of the features of the various embodiments may be used alone or in combination with one another.

Embodiment 1. A polymer-based portion comprises an index of refraction in a range from about 1.49 to about 1.55. The polymer-based portion comprises the product of curing a composition. The composition comprises 45-75 weight % (wt %) of a difunctional urethane-acrylate oligomer. The composition comprises 25-55 wt % of a difunctional cross-linking agent.

Embodiment 2. The polymer-based portion of embodiment 1, wherein the composition further comprises 25 wt % or less of a reactive diluent.

Embodiment 3. A polymer-based portion comprising an index of refraction in a range from about 1.49 to about 1.55. The polymer-based portion comprises the product of curing a composition. The composition comprises 0-25 weight % (wt %) of a difunctional urethane-acrylate oligomer. The composition comprises 0-5 wt % of a difunctional cross-linking agent. The composition comprises 75-100 wt % of a reactive diluent.

Embodiment 4. The polymer-based portion of any one of embodiments 2-3, wherein the reactive diluent comprises one or more of biphenylmethyl acrylate, nonyl phenol acrylate, or isooctyl acrylate.

Embodiment 5. The polymer-based portion of any one of embodiments 2-4, wherein the reactive diluent comprises a vinyl-terminated mono-acrylate monomer.

Embodiment 6. The polymer-based portion of any one of embodiments 1-5, wherein the difunctional cross-linking agent comprises a urethane diacrylate monomer.

Embodiment 7. The polymer-based portion of any one of embodiments 1-6, wherein the difunctional cross-linking agent comprises 2-[[(butylamino)carbonyl]oxy]ethyl acrylate.

Embodiment 8. The polymer-based portion of any one of embodiments 1-7, wherein the polymer-based portion comprises a glass transition temperature of about 0° C. or less.

Embodiment 9. The polymer-based portion of embodiment 8, wherein the glass transition temperature is in a range from about −60° C. to about −20° C.

Embodiment 10. The polymer-based portion of any one of embodiments 1-9, wherein the composition further comprises 0.1-3 wt % of a photo-initiator. Curing the composition comprises irradiating the composition with at least one wavelength of light that the photo-initiator is sensitive to.

Embodiment 11. The polymer-based portion of embodiment 10, wherein the photo-initiator comprises ethyl (2,4,6-trimethylbenzoyl) phenylphosphinate.

Embodiment 12. The polymer-based portion of any one of embodiments 1-9, wherein curing the composition comprises heating the composition at a temperature in a range from about 100° C. to about 200° C. for a time in a range from about 15 minutes to about 6 hours.

Embodiment 13. The polymer-based portion of any one of embodiments 1-12, wherein the composition further comprises 1-4.9 wt % of a silane coupling agent.

Embodiment 14. The polymer-based portion of embodiment 13, wherein the silane coupling agent comprises a mercapto-silane.

Embodiment 15. The polymer-based portion of embodiment 14, wherein the mercapto-silane comprises 3-mercaptopropyltrimethoxysilane.

Embodiment 16. The polymer-based portion of any one of embodiments 1-15, further comprising a thermoplastic elastomer.

Embodiment 17. The polymer-based portion of embodiment 16, wherein the elastomer comprises a styrene-ethylene-butylene-styrene block copolymer and/or a silicone-based rubber.

Embodiment 18. The polymer-based portion of any one of embodiments 1-17, wherein the polymer-based portion comprises an average transmittance of about 90% or more measured over optical wavelengths in a range from 400 nanometers to 760 nanometers.

Embodiment 19. The polymer-based portion of any one of embodiments 1-18, wherein the polymer-based portion comprises a haze of about 0.2% or less.

Embodiment 20. The polymer-based portion of any one of embodiments 1-19, wherein the polymer-based portion comprises an ultimate elongation of about 50% or more.

Embodiment 21. The polymer-based portion of embodiment 20, wherein the ultimate elongation is in a range from about 65% to about 110%.

Embodiment 22. The polymer-based portion of any one of embodiments 1-21, wherein the polymer-based portion comprises a tensile strength of about 1 MegaPascal or more.

Embodiment 23. The polymer-based portion of embodiment 22, wherein the tensile strength is in a range from about 1 MegaPascal to about 20 MegaPascals.

Embodiment 24. The polymer-based portion of any one of embodiments 1-23, wherein the polymer-based portion comprises an elastic modulus in a range from about 1 MegaPascal to about 100 MegaPascals.

Embodiment 25. The polymer-based portion of embodiment 24, wherein the elastic modulus is in a range from about 20 MegaPascals to about 50 MegaPascals.

Embodiment 26. The polymer-based portion of any one of embodiments 1-25, wherein a storage modulus of the polymer-based portion at 23° C. is in a range from about 0.3 MegaPascals to about 3 MegaPascals.

Embodiment 27. The polymer-based portion of any one of embodiments 1-26, wherein the polymer-based portion at 23° C. can fully recover after being extended to a strain of 40% at a strain rate of 10% strain per minute.

Embodiment 28. The polymer-based portion of any one of embodiments 1-27, wherein the polymer-based portion can withstand 2,000 bending cycles at a parallel plate distance of 3 millimeters.

Embodiment 29. An adhesive comprises an index of refraction in a range from about 1.49 to about 1.55. The adhesive comprises the product of heating a composition at a temperature in a range from about 100° C. to about 200° C. for a time in a range from about 15 minutes to about 6 hours. The composition comprises 10-35 weight % (wt %) of a silane-hydride-terminated siloxane. The composition comprises 65-90 wt % of a vinyl terminated siloxane.

Embodiment 30. The adhesive of embodiment 29, wherein the composition is substantially solvent-free.

Embodiment 31. The adhesive of any one of embodiments 29-30, wherein the silane-hydride-terminated siloxane comprises a copolymer comprising phenylmethylsiloxane.

Embodiment 32. The adhesive of any one of embodiments 29-31, wherein the vinyl-terminated siloxane comprises a copolymer comprising one or more of diphenyl siloxane and/or dimethyl siloxane.

Embodiment 33. The adhesive of any one of embodiments 29-32 further comprising a platinum-based catalyst.

Embodiment 34. The adhesive of any one of embodiments 29-33, wherein the adhesive comprises an average transmittance of about 95% or more measured over optical wavelengths in a range from 400 nanometers to 760 nanometers.

Embodiment 35. The adhesive of any one of embodiments 29-34, wherein the adhesive comprises a haze of about 1% or less.

Embodiment 36. The adhesive of any one of embodiments 29-35, wherein the adhesive comprises an ultimate elongation of about 75% or more.

Embodiment 37. The adhesive of any one of embodiments 29-36, wherein the adhesive comprises a tensile strength of about 3 MegaPascals or more.

Embodiment 38. The adhesive of any one of embodiments 29-37, wherein the adhesive comprises an elastic modulus in a range from about 25 MegaPascals to about 75 MegaPascals.

Embodiment 39. The adhesive of any one of embodiments 29-38, wherein the adhesive can withstand 2,000 bending cycles at a parallel plate distance of 3 millimeters.

Embodiment 40. An adhesive comprises an index of refraction in a range from about 1.49 to about 1.55. The adhesive is the product of curing a composition comprising a thiol-containing siloxane.

Embodiment 41. The adhesive of embodiment 40, wherein the composition is substantially solvent-free.

Embodiment 42. The adhesive of any one of embodiments 40-41, wherein the composition further comprises a photo-initiator.

Embodiment 43. The adhesive of embodiment 42, wherein the photo-initiator comprises dimethoxyphenyl acetophenone.

Embodiment 44. The adhesive of any one of embodiments 40-43, wherein the thiol-containing siloxane comprises a (mercaptopropyl)methylsiloxane.

Embodiment 45. The adhesive of any one of embodiments 40-44, wherein the composition further comprises a vinyl-terminated siloxane.

Embodiment 46. The adhesive of embodiment 45, wherein the vinyl-terminated siloxane comprises three or more vinyl-terminated functional groups.

Embodiment 47. The adhesive of any one of embodiments 45-46, wherein the composition comprises 10-35 weight % (wt %) of the thiol-containing siloxane. The composition comprises 65-90 wt % of the vinyl-terminated siloxane.

Embodiment 48. The adhesive of any one of embodiments 40-47, further comprising a silane coupling agent.

Embodiment 49. The adhesive of embodiment 48, wherein the silane coupling agent comprises vinyltrimethoxysilane.

Embodiment 50. The adhesive of any one of embodiments 40-49, wherein the adhesive comprises a glass transition temperature in a range from about −130° C. to about −60° C.

Embodiment 51. The adhesive of any one of embodiments 40-50, wherein a storage modulus of the adhesive at 23° C. is in a range from about 2 kiloPascals to about 20 kiloPascals.

Embodiment 52. The adhesive of any one of embodiments 40-51, wherein a loss modulus of the adhesive at 23° C. is in a range from about 0.2 kiloPascals to about 2 kiloPascals.

Embodiment 53. The adhesive of any one of embodiments 40-52, wherein the adhesive can withstand 2,000 bending cycles at a parallel plate distance of 3 millimeters.

Embodiment 54. The foldable apparatus comprises a shattered pane comprising a length extending in a direction of the foldable apparatus and a width extends in a direction perpendicular to the direction of the fold axis. The foldable apparatus comprises a plurality of shattered pieces. One or more of the plurality of shattered pieces comprises a maximum dimension that is less than the length and less than the width. The foldable apparatus comprises a first material positioned between a pair of shattered pieces of the plurality of shattered pieces. The first material comprises the adhesive of any one of embodiments 29-53. The first material comprises an elastic modulus that is less than an elastic modulus of a shattered piece of the plurality of shattered pieces.

Embodiment 55. The foldable apparatus of embodiment 54, wherein the shattered pane comprises an average transmittance of about 80% or more measured over optical wavelengths in a range from 400 nanometers to 760 nanometers.

Embodiment 56. The foldable apparatus of embodiment 55, wherein the average transmittance of the shattered pane is in a range from about 85% to about 95%.

Embodiment 57. The foldable apparatus of any one of embodiments 54-56, wherein the shattered pane comprises a haze of about 40% or less.

Embodiment 58. The foldable apparatus of embodiment 57, wherein the haze of the shattered pane is in a range from about 5% to about 35%.

Embodiment 59. A method of forming a polymer-based portion comprises creating a composition by combining 45-75 weight % (wt %) of a difunctional urethane-acrylate oligomer and 25-55 wt % of a difunctional cross-linking agent. The method comprises curing the composition to form the polymer-based portion. The polymer-based portion comprises an index of refraction in a range from about 1.49 to about 1.55.

Embodiment 60. The method of embodiment 59, wherein the difunctional cross-linking agent comprises a urethane diacrylate monomer.

Embodiment 61. The method of any one of embodiments 59-60, wherein the difunctional cross-linking agent comprises 2-[[(butylamino)carbonyl]oxy]ethyl acrylate.

Embodiment 62. The method of any one of embodiments 59-61, wherein the composition further comprises 25 wt % or less of a reactive diluent.

Embodiment 63. A method of forming a polymer-based portion comprising creating a composition by combining 45-75 weight % (wt %) of a difunctional urethane-acrylate oligomer and 25-55 wt % of a reactive diluent. The method comprises curing the composition to form the polymer-based portion. The polymer-based portion comprises an index of refraction in a range from about 1.49 to about 1.55.

Embodiment 64. The method of any one of embodiments 62-63, wherein the reactive diluent comprises one or more of biphenylmethyl acrylate, nonyl phenol acrylate, or isooctyl acrylate.

Embodiment 65. The method of any one of embodiments 62-64, wherein the reactive diluent comprises a comprises a vinyl-terminated mono-acrylate monomer.

Embodiment 66. The method of any one of embodiments 62-65, wherein the polymer-based portion comprises a glass transition temperature of about 0° C. or less.

Embodiment 67. The method of embodiment 66, wherein the glass transition temperature is in a range from about −60° C. to about −20° C.

Embodiment 68. The method of any one of embodiments 59-67, wherein creating the composition further comprises combining a 0.1-3 wt % of a photo-initiator. Curing the composition comprises irradiating the composition with at least one wavelength of light that the photo-initiator is sensitive to.

Embodiment 69. The method of embodiment 68, wherein the photo-initiator comprises ethyl (2,4,6-trimethylbenzoyl) phenylphosphinate.

Embodiment 70. The method of any one of embodiments 59-67, wherein curing the composition comprises heating a composition at a temperature in a range from about 100° C. to about 200° C. for a time in a range from about 15 minutes to about 6 hours.

Embodiment 71. The method of any one of embodiments 59-70, wherein the composition further comprises 1-4.9 wt % of a silane coupling agent.

Embodiment 72. The method of embodiment 71, wherein the silane coupling agent comprise a mercapto-silane.

Embodiment 73. The method of embodiment 72, wherein the mercapto-silane comprises 3-mercaptopropyltrimethoxysilane.

Embodiment 74. The method of any one of embodiments 59-73, wherein the creating composition further comprises including a thermoplastic elastomer.

Embodiment 75. The method of embodiment 74, wherein the elastomer comprises a styrene-ethylene-butylene-styrene block copolymer and/or a silicone-based rubber.

Embodiment 76. The method of any one of embodiments 59-75, wherein the polymer-based portion comprises an average transmittance of about 90% or more measured over optical wavelengths in a range from 400 nanometers to 760 nanometers.

Embodiment 77. The method of any one of embodiments 59-76, wherein the polymer-based portion comprises a haze of about 0.2% or less.

Embodiment 78. The method of any one of embodiments 59-77, wherein the polymer-based portion comprises an ultimate elongation of about 50% or more.

Embodiment 79. The method of embodiment 78, wherein the ultimate elongation is in a range from about 65% to about 110%.

Embodiment 80. The method of any one of embodiments 59-79, wherein the polymer-based portion comprises a tensile strength of about 1 MegaPascal or more.

Embodiment 81. The method of embodiment 80, wherein the tensile strength is in a range from about 1 MegaPascal to about 20 MegaPascals.

Embodiment 82. The method of any one of embodiments 59-81, wherein the polymer-based portion comprises an elastic modulus in a range from about 1 MegaPascal to about 100 MegaPascals.

Embodiment 83. The method of embodiment 82, wherein the elastic modulus is in a range from about 20 MegaPascals to about 50 MegaPascals.

Embodiment 84. The method of any one of embodiments 59-83, wherein a storage modulus of the polymer-based portion at 25° C. is in a range from about 0.3 MegaPascals to about 3 MegaPascals.

Embodiment 85. The method of any one of embodiments 59-84, wherein the polymer-based portion at 23° C. can fully recover after being extended to a strain of 40% at a strain rate of 10% strain per minute.

Embodiment 86. The method of any one of embodiments 59-85, wherein the polymer-based portion can withstand 2,000 bending cycles at a parallel plate distance of 3 millimeters.

Embodiment 87. A method of forming an adhesive comprising creating a composition by combining 10-35 weight % (wt %) of a silane-hydride-terminated siloxane and 65-90 wt % of a vinyl-terminated siloxane. The method comprises heating the composition at a temperature in a range from about 100° C. to about 200° C. for a time in a range from about 15 minutes to about 6 hours to form the adhesive. The adhesive comprises an index of refraction in a range from about 1.49 to about 1.55.

Embodiment 88. The method of embodiment 87, wherein the composition is substantially solvent-free.

Embodiment 89. The method of any one of embodiments 87-88, wherein the silane-hydride-terminated siloxane comprises a copolymer comprising phenylmethylsiloxane.

Embodiment 90. The method of any one of embodiments 87-89, wherein the vinyl-terminated siloxane comprises a copolymer comprising one or more of diphenyl siloxane and/or dimethyl siloxane.

Embodiment 91. The method of any one of embodiments 87-90, wherein the creating the composition further comprises including a platinum-based catalyst.

Embodiment 92. The method of any one of embodiments 87-91, wherein the adhesive comprises an average transmittance of about 95% or more measured over optical wavelengths in a range from 400 nanometers to 760 nanometers.

Embodiment 93. The method of any one of embodiments 87-92, wherein the adhesive comprises a haze of about 1% or less.

Embodiment 94. The method of any one of embodiments 87-93, wherein the adhesive comprises an ultimate elongation of about 75% or more.

Embodiment 95. The method of any one of embodiments 87-94, wherein the adhesive comprises a tensile strength of about 3 MegaPascals or more.

Embodiment 96. The method of any one of embodiments 87-95, wherein the adhesive comprises an elastic modulus in a range from about 25 MegaPascals to about 75 MegaPascals.

Embodiment 97. The method of any one of embodiments 87-96, wherein the adhesive can withstand 2,000 bending cycles at a parallel plate distance of 3 millimeters.

Embodiment 98. A method of forming an adhesive comprising creating a composition comprising a thiol-containing siloxane. The method comprises curing the composition to form the adhesive. The adhesive comprises an index of refraction in a range from about 1.49 to about 1.55.

Embodiment 99. The method of embodiment 98, wherein the composition is substantially solvent-free.

Embodiment 100. The method of any one of embodiments 98-99, wherein the composition further comprises a photo-initiator.

Embodiment 101. The method of embodiment 100, wherein the photo-initiator comprises dimethoxyphenyl acetophenone.

Embodiment 102. The method of any one of embodiments 98-101, wherein the thiol-containing siloxane comprises a (mercaptopropyl)methyl siloxane.

Embodiment 103. The method of any one of embodiments 98-102, wherein creating the composition comprises including a vinyl-terminated siloxane.

Embodiment 104. The method of embodiment 103, wherein the vinyl-terminated siloxane comprises three or more vinyl-terminated functional groups.

Embodiment 105. The method of any one of embodiments 98-104, wherein creating the composition comprises combining 10-35 weight % (wt %) of the silane-hydride-terminated siloxane and 65-90 wt % of the vinyl-terminated siloxane.

Embodiment 106. The method of any one of embodiments 98-105, wherein the composition further comprises a silane coupling agent.

Embodiment 107. The method of embodiment 106, wherein the silane coupling agent comprises vinyltrimethoxysilane.

Embodiment 108. The method of any one of embodiments 98-107, wherein the adhesive comprises a glass transition temperature in a range from about −130° C. to about −60° C.

Embodiment 109. The method of any one of embodiments 98-108, wherein a storage modulus of the adhesive at 23° C. is in a range from about 2 kiloPascals to about 20 kiloPascals.

Embodiment 110. The method of any one of embodiments 98-109, wherein a loss modulus of the adhesive at 23° C. is in a range from about 0.2 kiloPascals to about 2 kiloPascals.

Embodiment 111. The method of any one of embodiments 98-110, wherein the adhesive can withstand 2,000 bending cycles at a parallel plate distance of 3 millimeters.

Embodiment 112. The method of any one of embodiments 98-111, further comprising shattering a portion of a foldable substrate to form a shattered pane comprising a plurality of shattered pieces. The method further comprises flowing the composition of any one of embodiments 98-111 into a space between a pair of shattered pieces of the plurality of shattered pieces. The method further comprises curing the composition into the adhesive attaching the pair of shattered pieces together.

Embodiment 113. The method of embodiment 112, wherein the shattered pane comprises an average transmittance of about 80% or more measured over optical wavelengths in a range from about 400 nanometers to about 760 nanometers.

Embodiment 114. The method embodiment 113, wherein the average transmittance of the shattered pane is in a range from about 85% to about 95%.

Embodiment 115. The method of any one of embodiments 112-114, wherein the shattered pane comprises a haze of about 40% or less.

Embodiment 116. The method of embodiment 115, wherein the haze of the shattered pane is in a range from about 5% to about 35%.

Embodiment 117. A foldable apparatus comprises a foldable substrate comprising a first major surface and a second major surface opposite the first major surface. The foldable substrates comprises a substrate thickness from about 0.1 millimeters to about 5 millimeters defined between the first major surface and the second major surface. The foldable substrate comprises a central portion positioned between a first portion and a second portion. The foldable apparatus comprises a polymer-based layer disposed over the first major surface of the substrate. The foldable apparatus comprises a neutral stress configuration comprising when the foldable apparatus is in a bent configuration. The foldable substrate comprises a residual compressive stress at the first major surface of the substrate of about 500 MegaPascals or more when the foldable apparatus is in a substantially non-bent configuration.

Embodiment 118. The foldable apparatus of embodiment 117, wherein the neutral stress configuration comprises a bend angle from about 45 degrees to about 90 degrees when bent with a diameter of curvature from about 2 millimeters to about 20 millimeters.

Embodiment 119. The foldable apparatus of embodiment 118, wherein the neutral stress configuration comprises the bend angle of about 90 degrees with the diameter of curvature of about 4.75 millimeters.

Embodiment 120. The foldable apparatus of embodiment 118, wherein the neutral stress configuration comprises the bend angle of about 45 degrees with the diameter of curvature of about 3 millimeters.

Embodiment 121. The foldable apparatus of any one of embodiments 117-120, wherein the foldable substrate comprises a first compressive stress region extending to a first depth of compression from the first major surface. The first compressive stress region comprises a maximum compressive stress of about 800 MegaPascals or more.

Embodiment 122. The foldable apparatus of any one of embodiments 117-121, wherein the polymer-based layer comprises the polymer-based portion of any one of embodiments 1-28 and/or produced by the method of any one of embodiments 59-86.

Embodiment 123. The foldable apparatus of any one of embodiments 117-122, wherein the central portion of the foldable substrate further comprises a first central surface area recessed from the first major surface by a recess depth.

Embodiment 124. The foldable apparatus of any one of embodiments 117-122, wherein the central portion of the foldable substrate further comprises a central shattered region extending from the second major surface to a shattered depth ranging from about 0.01 micrometers to about 2 millimeters.

Embodiment 125. The foldable apparatus of embodiment 124, wherein the central shattered region comprising a plurality of micro-cracks having a longest dimension from 0.01 micrometers to 2 millimeters.

Embodiment 126. The foldable apparatus of embodiment 125, wherein the plurality of micro-cracks are oriented substantially normal to the second major surface of the foldable substrate.

Embodiment 127. The foldable apparatus of any one of embodiments 124-126, wherein the shattered depth as a percentage of the substrate thickness is from about 5% to about 50%.

Embodiment 128. The foldable apparatus of any one of embodiments 117-127, wherein the substrate thickness is from about 25 micrometers to about 2 millimeters.

Embodiment 129. The foldable apparatus of any one of embodiments 117-128, wherein the foldable apparatus comprises an oxide coating disposed over the second major surface of the foldable substrate.

Embodiment 130. The foldable apparatus of any one of embodiments 117-129, wherein the foldable apparatus withstands at least 25,000 bend cycles in a Clamshell Cyclic Fatigue Test with a 10 millimeter plate separation.

Embodiment 131. A foldable apparatus comprising a central portion positioned between a first portion and a second portion. The central portion comprises a shattered pane comprising a first major surface and a second major surface opposite the first major surface. A substrate thickness is defined between the first major surface and the second major surface. The central portion comprises a length extending in a direction of a fold axis of the foldable apparatus. The central portion comprises a width extending in a direction perpendicular to the direction of the fold axis. The central portion comprises a plurality of shattered pieces. One or more of the plurality of shattered pieces comprises a maximum dimension that is less than the length and less than the width. The first major surface of the central portion is defined by the plurality of shattered pieces, and the second major surface of the central portion is defined by the plurality of shattered pieces. The central portion comprises a first surface refractive index at the first major surface. The central portion comprises a second surface refractive index at the second major surface. The central portion comprises a central refractive index at a midpoint of the substrate thickness. An absolute difference between the first surface refractive index and the central refractive index is about 0.006 or less.

Embodiment 132. The foldable apparatus of embodiment 131, wherein an absolute difference between the second surface refractive index and the central refractive index is about 0.006 or less.

Embodiment 133. The foldable apparatus of embodiment 132, wherein the second surface refractive index is greater than the central refractive index.

Embodiment 134. The foldable apparatus of any one of embodiments 132-133, wherein the absolute difference between the second surface refractive index and the central refractive index is about 0.004 or less.

Embodiment 135. The foldable apparatus of any one of embodiments 131-134, wherein the first surface refractive index is greater than the central refractive index.

Embodiment 136. The foldable apparatus of any one of embodiments 131-135, wherein the absolute difference between the first surface refractive index and the central refractive index is about 0.004 or less.

Embodiment 137. The foldable apparatus of any one of embodiments 131-136, wherein the first surface refractive index is substantially equal to the second surface refractive index.

Embodiment 138. The foldable apparatus of any one of embodiments 131-137, wherein the shattered pane comprises a first compressive stress region extending to a first depth of compression from the first major surface comprising an average depth of compression of the plurality of shattered pieces. The shattered pane comprises a first depth of layer of one or more alkali metal ions associated with the first compressive stress region. The first depth of layer is in a range from about 35% to about 50% of the substrate thickness.

Embodiment 139. The foldable apparatus of embodiment 138, wherein the first compressive stress region comprises a first maximum compressive stress of about 500 MegaPascals or less.

Embodiment 140. The foldable apparatus of any one of embodiments 131-139, wherein the central portion further comprises a first material positioned between a pair of shattered pieces of the plurality of shattered pieces. The first material comprises an index of refraction. The first material comprises an elastic modulus that is less than an elastic modulus of a shattered piece of the plurality of shattered pieces.

Embodiment 141. The foldable apparatus of embodiment 140, wherein an absolute difference between the central refractive index of the shattered pane and the index of refraction of the first material is about 0.01 or less.

Embodiment 142. The foldable apparatus of any one of embodiments 140-141, wherein an absolute difference between the first surface refractive index of the shattered pane and the index of refraction of the first material is about 0.01 or less.

Embodiment 143. A foldable apparatus comprising a foldable substrate comprising a substrate thickness defined between a first major surface and a second major surface and a second portion opposite the first major surface. The foldable substrate comprises a first portion, a second portion, and a central portion attaching the first portion to the second portion. The central portion comprises a shattered pane comprising a length extending in a direction of a fold axis of the foldable apparatus. The central portion comprises a width extending in a direction perpendicular to the direction of the fold axis. The central portion comprises a plurality of shattered pieces. One or more of the plurality of shattered pieces comprises a maximum dimension that is less than the length and less than the width. The central portion comprises a first material positioned between a pair of shattered pieces of the plurality of shattered pieces. The first material comprises an index of refraction and an elastic modulus that is less than an elastic modulus of a shattered piece of the plurality of shattered pieces.

Embodiment 144. The foldable apparatus of any one of embodiments 140-143, further comprising a first plurality of cracks internal to the first portion. The first plurality of cracks is at least partially filled with the first material.

Embodiment 145. The foldable apparatus of any one of embodiments 140-144, further comprising a second plurality cracks internal to the second portion. The second plurality of cracks is at least partially filled with the first material.

Embodiment 146. The foldable apparatus of any one of embodiments 140-143, wherein the first portion comprises a second shattered pane comprising a second plurality of shattered pieces. One or more of the second plurality of shattered pieces comprises a maximum dimension that is less than the length and less than the width. The first material is positioned between a second pair of shattered pieces of the second plurality of shattered pieces.

Embodiment 147. The foldable apparatus of any one of embodiments 140-143 or embodiment 146 inclusive, wherein the second portion comprises a third shattered plane comprising a third plurality of shattered pieces. One or more of the third plurality of shattered pieces comprises a maximum dimension that is less than the length and less than the width. The first material is positioned between a third pair of shattered pieces of the third plurality of shattered pieces.

Embodiment 148. A foldable apparatus comprising a foldable substrate comprising a first portion, a second portion, a central portion attaching the first portion to the second portion, and a shattered pane. The shattered pane comprises a length extending in a direction of a fold axis of the foldable apparatus. The shattered pane comprises a width extending in a direction perpendicular to the direction of the fold axis. The shattered pane comprises a plurality of shattered pieces, one or more of the plurality of shattered pieces comprises a maximum dimension that is less than the length and less than the width. The shattered pane comprises a first material positioned between a pair of shattered pieces of the plurality of shattered pieces. The first material comprises an index of refraction. The first material comprises an elastic modulus that is less than an elastic modulus of a shattered piece of the plurality of shattered pieces. The first portion, the second portion, and the second portion comprise the shattered pane. A substrate thickness is defined between a first major surface and a second major surface opposite the first major surface.

Embodiment 149. The foldable apparatus of embodiment 143 or embodiment 148, wherein the foldable apparatus is chemically strengthened.

Embodiment 150. The foldable apparatus of any one of embodiments 140-149, wherein a total mass of the first material is about 10% or less of a total mass of the plurality of shattered pieces.

Embodiment 151. The foldable apparatus of any one of embodiments 140-150, wherein the elastic modulus of the first material at 23° C. is in a range from about 0.01 MegaPascals to about 18,000 MegaPascals.

Embodiment 152. The foldable apparatus of embodiment 151, wherein the elastic modulus of the first material at 23° C. is in a range from about 1 MegaPascal to about 500 MegaPascals.

Embodiment 153. The foldable apparatus of any one of embodiments 140-152, wherein the elastic modulus of the first material changes by a multiple of 100 or less when changing a temperature of the first material from about 100° C. to about −20° C.

Embodiment 154. The foldable apparatus of any one of embodiments 140-153, wherein the first material comprises a strain at yield of about 10% or more.

Embodiment 155. The foldable apparatus of any one of embodiments 140-154, wherein the first material comprises an average transmittance of about 80% or more measured over optical wavelengths in a range from 400 nanometers to 760 nanometers.

Embodiment 156. The foldable apparatus of any one of embodiments 140-155, wherein the first material comprises a polymer-based material.

Embodiment 157. The foldable apparatus of embodiment 156, wherein the first material comprises one or more of a silicone-based polymer, an acrylate-based polymer, an epoxy-based polymer, a thiol-containing polymer, a polyurethane, or a silicone elastomer.

Embodiment 158. The foldable apparatus of any one of embodiments 156-157, wherein the first material comprises the adhesive of any one of embodiments 29-39 or embodiments 40-54 and/or produced by the method of any one of embodiments 87-97 or embodiments 98-111.

Embodiment 159. The foldable apparatus of any one of embodiments 156-157, wherein the first material comprises a glass transition temperature of about 0° C. or less.

Embodiment 160. The foldable apparatus of embodiment 159, wherein the glass transition temperature of the first material is about −20° C. or less.

Embodiment 161. The foldable apparatus of any one of embodiments 156-157, wherein the first material comprises a glass transition temperature of about 60° C. or more.

Embodiment 162. The foldable apparatus of any one of embodiments 156-161, wherein the elastic modulus of the first material comprises a glassy plateau in a range from about 0.1 MegaPascals to about 18,000 MegaPascals.

Embodiment 163. The foldable apparatus of any one of embodiments 140-162, wherein the shattered pane comprises an average transmittance of about 85% or more measured over optical wavelengths in a range from 400 nanometers to 760 nanometers.

Embodiment 164. The foldable apparatus of any one of embodiments 140-163, wherein the first portion comprises a first surface area and a second surface area opposite the first surface area. The second portion comprises a third surface area and a fourth surface area opposite the third surface area. The central portion comprises a first central surface area and a second central surface area opposite the first central surface area. The first major surface comprises the first surface area and the third surface area. The second major surface comprises the second surface area, the fourth surface area, and the second central surface area. The second central surface area is positioned between the second surface area and the fourth surface area. A central thickness of the foldable substrate is defined between the first central surface area and the second central surface area. The central thickness is equal to or less than the substrate thickness.

Embodiment 165. The foldable apparatus of embodiment 164, further comprising a second material disposed over at least the first central surface area of the central portion.

Embodiment 166. The foldable apparatus of embodiment 165, wherein a thickness of the second material over the first central surface area of the foldable substrate is in a range from about 10 micrometers to about 250 micrometers.

Embodiment 167. The foldable apparatus of embodiment 166, wherein the thickness of the second material is in a range from about 20 micrometers to about 50 micrometers.

Embodiment 168. The foldable apparatus of any one of embodiments 165-167, wherein an elastic modulus of the second material at 23° C. is in a range from about 0.01 MegaPascals to about 5,000 MegaPascals.

Embodiment 169. The foldable apparatus of embodiment 165-168, wherein the elastic modulus of the second material at 23° C. is in a range from about 1 MegaPascal to about 500 MegaPascals.

Embodiment 170. The foldable apparatus of any one of embodiments 165-169, wherein the elastic modulus of the second material changes by a multiple of 100 or less when changing a temperature of the second material from about 100° C. to about −20° C.

Embodiment 171. The foldable apparatus of any one of embodiments 165-170, wherein the second material comprises an average transmittance of about 80% or more measured over optical wavelengths in a range from 400 nanometers to 760 nanometers.

Embodiment 172. The foldable apparatus of any one of embodiments 165-171, wherein the second material comprises a strain at yield of about 100% or more.

Embodiment 173. The foldable apparatus of any one of embodiments 170-172, wherein the second material comprises a polymer-based material.

Embodiment 174. The foldable apparatus of embodiment 173, wherein the second material comprises one or more of a silicone-based polymer, an acrylate-based polymer, an epoxy-based polymer, a polyimide-based material, a polyurethane, or an ethylene acid copolymer.

Embodiment 175. The foldable apparatus of any one of embodiments 173-174, wherein the second material comprises the polymer-based portion of any one of embodiments 1-28 and/or produced by the method of any one of embodiments 59-86.

Embodiment 176. The foldable apparatus of any one of embodiments 173-174, wherein the second material comprises a glass transition temperature of about 0° C. or less.

Embodiment 177. The foldable apparatus of embodiment 176, wherein the glass transition-temperature of the second material is about −20° C. or less.

Embodiment 178. The foldable apparatus of any one of embodiments 173-175, wherein the second material comprises a glass-transition temperature of about 60° C. or more.

Embodiment 179. The foldable apparatus of any one of embodiments 173-178, wherein the elastic modulus of the second material comprises a glassy plateau in a range from about 0.1 MegaPascals to about 10,000 MegaPascals.

Embodiment 180. The foldable apparatus of any one of embodiments 156-179, wherein the first major surface extends along a first plane. The foldable substrate comprises a recess defined between the first central surface area and the first plane. The second material fills the recess.

Embodiment 181. The foldable apparatus of any one of embodiments 156-180, wherein the second material is further disposed over at least a portion of the first surface area. The second material is further disposed over at least a portion of the third surface area.

Embodiment 182. The foldable apparatus of any one of embodiments 156-181, further comprising a first substrate comprising a sixth surface area and a seventh surface area opposite the sixth surface area, a first edge surface defined between the sixth surface area and the seventh surface area, and a first substrate thickness defined between the sixth surface area and the seventh surface area. The foldable apparatus further comprising a second substrate comprising an eighth surface area and a ninth surface area opposite the eighth surface area, a second edge surface defined between the eighth surface area and the ninth surface area, and a second substrate thickness defined between the eighth surface area and the ninth surface area. The second material is at least partially positioned between the first substrate and the second substrate. The seventh surface area faces the first surface area. The ninth surface area faces the third surface area.

Embodiment 183. The foldable apparatus of embodiment 182, wherein the first substrate thickness is in a range from about 10 micrometers to about 60 micrometers. The second substrate thickness is in a range from about 10 micrometers to about 60 micrometers.

Embodiment 184. The foldable apparatus of any one of embodiments 182-183, wherein the first substrate comprises a ceramic-based substrate.

Embodiment 185. The foldable apparatus of any one of embodiments 182-183, wherein the first substrate comprises a glass-based substrate.

Embodiment 186. The foldable apparatus of any one of embodiments 182-185, wherein an elastic modulus of the first substrate is greater than the elastic modulus of the second material. An elastic modulus of the second substrate is greater than the elastic modulus of the second material.

Embodiment 187. The foldable apparatus of any one of embodiments 182-186, further comprising a first adhesive portion attaching the first surface area to the seventh surface area. A second adhesive portion attaches the third surface area to the ninth surface area.

Embodiment 188. The foldable apparatus of embodiments 187, wherein the first adhesive portion comprises a thickness between the first surface area and the seventh surface area in a range from about 1 micrometer to about 30 micrometers. The second adhesive portion comprises a thickness between the third surface area and the ninth surface area in a range from about 1 micrometer to about 30 micrometers.

Embodiment 189. The foldable apparatus of any one of embodiments 182-188, wherein the second material contacts the first edge surface. The second material contacts the second edge surface.

Embodiment 190. The foldable apparatus of any one of embodiments 182-189, wherein the sixth surface area and the eighth surface area extend along a second plane. A recess is defined between the first central surface area and the second plane. The second material fills the recess.

Embodiment 191. The foldable apparatus of any one of embodiments 156-190, wherein a magnitude of a difference between an index of refraction of the shattered piece of the plurality of shattered pieces and an index of refraction of the second material is about 0.1 or less.

Embodiment 192. The foldable apparatus of embodiment 191, wherein the magnitude of the difference between the index of refraction of the shattered piece of the plurality of shattered pieces and the index of refraction of the second material is about 0.02 or less.

Embodiment 193. The foldable apparatus of any one of embodiments 156-192, wherein the first material comprises a composition that is the same as a composition of the second material.

Embodiment 194. The foldable apparatus of any one of embodiments 156-191, wherein a magnitude of a difference between an index of refraction of the shattered piece of the plurality of shattered pieces and an index of refraction of the first material is about 0.01 or more.

Embodiment 195. The foldable apparatus of embodiment 194, wherein the magnitude of the difference between the index of refraction of the shattered piece and the index of refraction of the first material is in a range from about 0.02 to about 0.1.

Embodiment 196. The foldable apparatus of any one of embodiments 156-195, wherein the foldable apparatus comprises a haze of about 10% or less measured at an angle of incidence normal to the second major surface in a region comprising the shattered pane using a CIE C illuminant.

Embodiment 197. The foldable apparatus of embodiment 196, wherein the haze of the foldable apparatus measured at the angle of incidence normal to the second major surface in the region using a CIE C illuminant is about 5% or less.

Embodiment 198. The foldable apparatus of any one of embodiments 196-197, wherein the haze is in a range from about 0.5% to about 3%.

Embodiment 199. The foldable apparatus of any one of embodiments 196-198, wherein a haze measured at an angle of incidence of 20° relative to a direction normal to the second major surface in the region is greater than the haze measured at the angle of incidence normal to the second major surface in the region by about 10% or more.

Embodiment 200. The foldable apparatus of embodiment 199, wherein the haze measured at the angle of incidence of 20° relative to a direction normal to the second major surface in the region is greater than the haze measured at the angle of incidence normal to the second major surface in the region by about 25% or more.

Embodiment 201. The foldable apparatus of any one of embodiments 164-200, further comprising an adhesive layer comprising a first contact surface and a second contact surface opposite the first contact surface. The first contact surface faces at least one of the first surface area or the third surface area.

Embodiment 202. The foldable apparatus of embodiment 201, further comprising a display device attached to one or more of the second contact surface or the second material.

Embodiment 203. The foldable apparatus of embodiment 201, further comprising a release liner attached to one or more of the second contact surface or the second material.

Embodiment 204. The foldable apparatus of any one of embodiments 164-203, wherein a density of the plurality of shattered pieces in the central portion is about 5 pieces per square centimeter (pc/cm²) or more measured over an area of the second central surface area in a range from about 1 cm² to about 5 cm².

Embodiment 205. The foldable apparatus of any one of embodiments 164-204, wherein the first material is substantially devoid of air pockets.

Embodiment 206. The foldable apparatus of any one of embodiments 164-205, wherein the central thickness is in a range from about 10 micrometers to about 220 micrometers.

Embodiment 207. The foldable apparatus of embodiment 206, wherein the central thickness is in a range from about 10 micrometers to about 60 micrometers.

Embodiment 208. The foldable apparatus of any one of embodiments 162-207, wherein the substrate thickness is in a range from about 40 micrometers to about 2 millimeters.

Embodiment 209. The foldable apparatus of any one of embodiments 162-208, wherein the central thickness is in a range from about 0.5% to about 13% of the substrate thickness.

Embodiment 210. The foldable apparatus of any one of embodiments 131-209, wherein the foldable substrate is chemically strengthened.

Embodiment 211. The foldable apparatus of any one of embodiments 121-210, wherein the foldable substrate of the foldable apparatus comprises an effective minimum bend radius in a range from about 1 millimeter to about 10 millimeters.

Embodiment 212. The foldable apparatus of embodiment 211, wherein the foldable substrate of the foldable apparatus achieves an effective bend radius of 10 millimeters.

Embodiment 213. The foldable apparatus of embodiment 212, wherein the foldable substrate of the foldable apparatus achieves an effective bend radius of 5 millimeters.

Embodiment 214. The foldable apparatus of any one of embodiments 121-213, wherein the foldable substrate comprises a foldable ceramic-based substrate.

Embodiment 215. The foldable apparatus of any one of embodiments 121-214, wherein the foldable substrate comprises a foldable glass-based substrate.

Embodiment 216. A consumer electronic product comprises a housing comprising a front surface, a back surface, and side surfaces. The consumer electronic product comprises electrical components at least partially within the housing. The electrical components comprise a controller, a memory, and a display. The display is at or adjacent to the front surface of the housing. The consumer electronic product comprises a cover substrate disposed over the display. At least one of a portion of the housing or the cover substrate comprises the foldable apparatus of any one of embodiments 121-215.

Embodiment 217. A foldable apparatus comprises a first portion comprising a first surface area and a second surface area opposite the first surface area, a first edge surface defined between the first surface area and the second surface area, and a first thickness defined between the first surface area and the second surface area. The foldable apparatus comprises a second portion comprising a third surface area and a fourth surface area opposite the third surface area, a second edge surface defined between the third surface area and the fourth surface area, and a second thickness defined between the third surface area and the fourth surface area. The foldable apparatus comprises a polymer-based portion of any one of embodiments 1-28 and/or produced by the method of any one of embodiments 59-86 positioned between the first edge surface and the second edge surface.

Embodiment 218. The foldable apparatus of embodiment 217, wherein a magnitude of a difference between an index of refraction of the first portion and an index of refraction of the polymer-based portion is about 0.05 or less.

Embodiment 219. The foldable apparatus of any one of embodiments 217-218, further comprises a ribbon. The ribbon comprises the first portion and the second portion. The ribbon comprises a central portion positioned between the first portion and the second portion in a direction of a length of the ribbon. The central portion comprises a central thickness defined between a first central surface area and a second central surface area opposite the first central surface area. The ribbon comprising a first major surface comprising the second surface area, the fourth surface area, and the second central surface area.

Embodiment 220. The foldable apparatus of any one of embodiments 217-218, further comprising a substrate comprising a first major surface, a second major surface opposite the first major surface, and a substrate thickness defined between the first major surface and the second major surface. The foldable apparatus comprises an adhesive layer comprising a first contact surface facing the first major surface of the substrate and a second contact surface opposite the first contact surface. The first surface area faces the second contact surface of the adhesive layer. The third surface area faces the second contact surface of the adhesive layer.

Embodiment 221. The foldable apparatus of embodiment 220, wherein the adhesive layer comprises the adhesive of any one of embodiments 29-39 or embodiments 40-54 and/or produced by the method of any one of embodiments 87-97 or embodiments 98-111.

Embodiment 222. The foldable apparatus of any one of embodiments 219-221, wherein the substrate comprises a shattered pane comprising a length extending in a direction of a fold axis of the foldable apparatus. The shattered pane comprises a width extending in a direction perpendicular to the direction of the fold axis. The shattered pane comprises a plurality of shattered pieces. One or more of the plurality of shattered pieces comprises a maximum dimension that is less than the length and less than the width. The shattered pane comprises a first material positioned between a pair of shattered pieces of the plurality of shattered pieces. The first material comprises an elastic modulus that is less than an elastic modulus of a shattered piece of the plurality of shattered pieces.

Embodiment 223. The foldable apparatus of embodiment 222, wherein the first material comprises the adhesive of any one of embodiments 29-39 or embodiments 40-54 and/or produced by the method of any one of embodiments 87-97 or embodiments 98-111.

Embodiment 224. A foldable apparatus comprises a first portion comprising a first surface area and a second surface area opposite the first surface area, a first edge surface defined between the first surface area and the second surface area, and a first thickness defined between the first surface area and the second surface area. The foldable substrate comprises a second portion comprising a third surface area and a fourth surface area opposite the third surface area, a second edge surface defined between the third surface area and the fourth surface area, and a second thickness defined between the third surface area and the fourth surface area. The foldable apparatus comprises a polymer-based portion positioned between the first edge surface and the second edge surface. The foldable apparatus comprises a substrate comprising a first major surface, a second major surface opposite the first major surface, and a substrate thickness defined between the first major surface and the second major surface. The foldable apparatus comprises an adhesive layer comprising a first contact surface facing the first major surface of the substrate and a second contact surface opposite the first contact surface. The first surface area faces the second contact surface of the adhesive layer. The third surface area faces the second contact surface of the adhesive layer. The adhesive layer comprises the adhesive of any one of embodiments 29-39 or embodiments 40-54 and/or produced by the method of any one of embodiments 87-97 or embodiments 98-111.

Embodiment 225. The foldable apparatus of embodiment 224, wherein the substrate comprises a shattered pane comprising a length extending in a direction of a fold axis of the foldable apparatus. The shattered pane comprises a width extending in a direction perpendicular to the direction of the fold axis. The shattered pane comprises a plurality of shattered pieces. One or more of the plurality of shattered pieces comprises a maximum dimension that is less than the length and less than the width. A first material is positioned between a pair of shattered pieces of the plurality of shattered pieces. The first material comprises an elastic modulus that is less than an elastic modulus of a shattered piece of the plurality of shattered pieces.

Embodiment 226. The foldable apparatus of embodiment 225, wherein the first material comprises the adhesive of any one of embodiments 29-39 or embodiments 40-54 and/or produced by the method of any one of embodiments 87-97 or embodiments 98-111.

Embodiment 227. A foldable apparatus comprising a foldable substrate comprising a first major surface extending along a first plane, a second major surface extending along a second plane that is parallel to the first plane, and a substrate thickness defined between the first plane and the second plane. The foldable substrate further comprises a first portion comprising a first surface area of the first major surface. The foldable substrate further comprises a second portion comprising a second surface area of the first major surface. The foldable substrate further comprises a central portion attaching the first portion of the foldable substrate to the second portion of the foldable substrate. The central portion comprises a first central surface area positioned between the first surface area of the first major surface and the second surface area of the first major surface. The central portion comprises a central thickness of the foldable substrate defined between the second plane and the first central surface area. The central thickness is less than the substrate thickness. The central portion comprises a plurality of panes that each comprise a length extending in a direction of a fold axis of the central portion and a width extending in a direction perpendicular to the fold axis. A pair of panes of the plurality of panes are connected together by a first material positioned between the pair of panes. The first material comprises an elastic modulus that is less than an elastic modulus of the foldable substrate.

Embodiment 228. The foldable apparatus of embodiment 227, further comprising a recess defined between the first central surface area of the central portion and the first plane. A second material fills the recess.

Embodiment 229. The foldable apparatus of embodiment 228, wherein the second material comprises the polymer-based portion of any one of embodiments 1-28 and/or produced by the method of any one of embodiments 59-86.

Embodiment 230. The foldable apparatus of any one of embodiments 227-229, wherein the elastic modulus of the first material is about 3 GigaPascals or less.

Embodiment 231. The foldable apparatus of any one of embodiments 227-230, wherein the first material comprises a polymer.

Embodiment 232. The foldable apparatus of embodiment 231, wherein the first material comprises the adhesive of any one of embodiments 29-39 or embodiments 40-54 and/or produced by the method of any one of embodiments 87-97 or embodiments 98-111.

Embodiment 233. The foldable apparatus of any one of embodiments 227-231, wherein the foldable substrate comprises an effective minimum bend radius in a range from about 1 millimeter to about 10 millimeters.

Embodiment 234. The foldable apparatus of embodiment 233, wherein the foldable substrate of the foldable apparatus achieves an effective bend radius of 10 millimeters.

Embodiment 235. The foldable apparatus of embodiment 233, wherein the foldable substrate of the foldable apparatus achieves an effective bend radius of 5 millimeters.

Embodiment 236. The foldable apparatus of any one of embodiments 233-235, wherein the width of each pane of the plurality of panes is in a range from about 1 micrometer to less than about 50 percent of the effective minimum bend radius.

Embodiment 237. The foldable apparatus of any one of embodiments 227-236, wherein the width of each pane of the plurality of panes is in a range from about 1 micrometer to about 200 micrometers.

Embodiment 238. The foldable apparatus of any one of embodiments 227-237, wherein the substrate thickness is in a range from about 80 micrometers to about 2 millimeters.

Embodiment 239. The foldable apparatus of any one of embodiments 227-238, wherein the central thickness is in a range from about 10 micrometers to about 125 micrometers.

Embodiment 240. The foldable apparatus of embodiment 239, wherein the range the central thickness is from about 10 micrometers to about 40 micrometers.

Embodiment 241. The foldable apparatus of any one of embodiments 227-240, wherein the central thickness is in a range from about 0.5% to about 13% of the substrate thickness.

Embodiment 242. The foldable apparatus of any one of embodiments 227-241, wherein an absolute value of a difference between an index of refraction of the foldable substrate and an index of refraction of the first material is about 0.1 or less.

Embodiment 243. The foldable apparatus of any one of embodiments 227-242, further comprising an adhesive comprising a first contact surface contacting the first surface area of the first major surface and the second surface area of the first major surface.

Embodiment 244. The foldable apparatus of any one of embodiments 227-243, further comprising a display device bonded to a second contact surface of the adhesive.

Embodiment 245. The foldable apparatus of any one of embodiments 227-243, further comprising a release liner bonded to a second contact surface of the adhesive.

Embodiment 246. The foldable apparatus of any one of embodiments 227-245, wherein the foldable substrate comprises a ceramic-based substrate, and the plurality of panes comprise a plurality of ceramic-based panes.

Embodiment 247. The foldable apparatus of any one of embodiments 227-245, wherein the foldable substrate comprises a glass-based substrate, and the plurality of panes comprise a plurality of glass-based panes.

Embodiment 248. The foldable apparatus of any one of embodiments 246-247, wherein the foldable substrate is chemically strengthened.

Embodiment 249. A consumer electronic product comprises a housing comprising a front surface, a back surface, and side surfaces. The consumer electronic product comprises electrical components at least partially within the housing. The electrical components comprise a controller, a memory, and a display. The display is at or adjacent to the front surface of the housing. The consumer electronic product comprises a cover substrate disposed over the display. At least one of a portion of the housing or the cover substrate comprises the foldable apparatus of any one of embodiments 227-248.

Embodiment 250. A method of making a foldable apparatus comprises disposing a sol-gel coating on a second major surface of a foldable substrate. The sol-gel coating comprises a silicon-containing constituent and a titanium-containing constituent. The foldable substrate comprises a substrate thickness from 0.1 millimeters to about 5 millimeters defined between a first major surface and the second major surface opposite the first major surface. The method comprises heating the sol-gel coating and the foldable substrate in air at an annealing temperature from about 500° C. to about 700° C. for an annealing duration from about 10 minutes to 180 minutes to form an oxide coating on the second major surface. The heating is conducted to define a neutral stress configuration of the foldable substrate and the oxide coating in a bent configuration. The method comprises etching the oxide coating from the foldable substrate. The method comprises folding the foldable substrate after the etching to form the foldable apparatus in a substantially non-bent configuration. The foldable substrate is characterized by about zero residual stress in the neutral stress configuration. The foldable apparatus is characterized by a residual compressive stress at the second major surface of at least about 500 MegaPascals and a residual tensile stress at the first major surface of at least about 500 MegaPascals in the substantially non-bent configuration.

Embodiment 251. The method of embodiment 250, wherein the neutral stress configuration comprises a bend angle from about 45 degrees to about 90 degrees when bent with a diameter of curvature from about 2 millimeters to about 20 millimeters.

Embodiment 252. The method of any one of embodiments 250-251, wherein the neutral stress configuration comprises the bend angle of about 90 degrees with the diameter of curvature of about 4.75 millimeters.

Embodiment 253. The method of any one of embodiments 250-251, wherein the neutral stress configuration comprises the bend angle of about 45 degrees with the diameter of curvature of about 3 millimeters.

Embodiment 254. The method of any one of embodiments 250-253, wherein the sol-gel coating comprises diphenylsilanediol, methyltriethoxysilane, tetraethoxysilane, hydroxyl poly(dimethylsiloxane), water, boron n-butoxide, tetrakistrimethylsilyltitanium, or n-propyl acetate.

Embodiment 255. The method of any one of embodiments 250-254, wherein the sol-gel coating disposed on the second major surface of the foldable substrate comprises a coating thickness from about 0.1 micrometers to about 10 micrometers.

Embodiment 256. The method of any one of embodiments 250-255, wherein the sol-gel coating comprises a width from about 5% to about 30% of a longest dimension of the foldable substrate.

Embodiment 257. The method of any one of embodiments 250-255, wherein the sol-gel coating comprises a width from about 1 millimeter to about 100 millimeters on the first major surface of the foldable substrate.

Embodiment 258. The method of any one of embodiments 250-257, wherein the method further comprises chemically strengthening the foldable substrate to form a compressive stress region extending to a depth of compression from the first major surface after the heating the sol-gel coating and the glass substrate. The compressive stress region comprises a maximum compressive stress of 800 MegaPascals or more.

Embodiment 259. The method of any one of embodiments 250-258, further comprises etching the first major surface of the foldable substrate to reveal a first central surface area and form a recess in a central portion of the foldable substrate after the heating the sol-gel coating and the glass substrate. The first central surface area of the central portion is recessed from the first major surface by a recess depth. The central portion and the recess are positioned between a first portion of the foldable substrate and a second portion of the foldable substrate.

Embodiment 260. The method of embodiment 259, wherein the etching the second major surface of the foldable substrate occurs before the etching the oxide coating.

Embodiment 261. The method of embodiment 250, wherein the etching the oxide coating is further conducted to etch a portion of the central portion at the second major surface.

Embodiment 262. The method of embodiment 258, further comprising disposing a polymer layer on the second major surface of the foldable substrate after the chemically strengthening the foldable substrate and the etching the oxide coating. The method further comprises folding the foldable substrate and the polymer layer after the disposing the polymer layer on the first major surface of the foldable substrate. The bending the foldable substrate and the polymer layer defines a central shattered region in the glass substrate. The central shattered region is defined from the second major surface to a shattered depth ranging from about 0.01 micrometers to about 2 millimeters.

Embodiment 263. The method of embodiment 262, wherein the central shattered region comprises a plurality of micro-cracks having a longest dimension from 0.01 micrometers to 2 millimeters.

Embodiment 264. The method of embodiment 263, wherein the plurality of micro-cracks are oriented substantially normal to the first major surface of the foldable substrate.

Embodiment 265. The method of any one of embodiments 262-264, wherein the chemically strengthening the foldable substrate further forms the compressive stress region extending to the depth of compression from the first major surface sufficient for frangibility of the foldable substrate.

Embodiment 266. The method of any one of embodiments 250-265, wherein the foldable apparatus is further characterized by no failures upon being subjected to at least 25,000 bend cycles in a Clamshell Cyclic Fatigue Test with a 10 mm plate separation.

Embodiment 267. The method of any one of embodiments 250-266, wherein the foldable substrate comprises a glass-based material.

Embodiment 268. A method of making a foldable apparatus from a foldable substrate, the method comprises shattering the foldable substrate into a shattered pane comprising a plurality of shattered pieces. The shattered pane comprises a first major surface and a second major surface opposite the first major surface. A substrate thickness is defined between the first major surface and the second major surface. The method comprises heating the shattered pane at a temperature from about 300° C. to about 400° C. for from about 10 minutes to about 168 hours. After the heating, the shattered pane comprises a first surface refractive index at the first major surface, a second surface refractive index at the second major surface, a central refractive index at a midpoint of the substrate thickness, and an absolute difference between the first surface refractive index and the central refractive index is about 0.006 or less.

Embodiment 269. A method of making a foldable apparatus from a foldable substrate, the method comprises shattering the foldable substrate into the shattered pane comprising a plurality of shattered pieces. The shattered pane comprises a first major surface and a second major surface opposite the first major surface. A substrate thickness is defined between the first major surface and the second major surface. The method comprises heating at least a portion of the shattered pane to a temperature of about 600° C. or more for from about 0.5 seconds to about 20 minutes. The heating comprises impinging at least the portion of the shattered pane with a laser beam. After the heating, the shattered pane comprises a first surface refractive index at the first major surface, a second surface refractive index at the second major surface, a central refractive index at a midpoint of the substrate thickness, and an absolute difference between the first surface refractive index and the central refractive index is about 0.006 or less.

Embodiment 270. The method of any one of embodiments 268-269, wherein, before the heating, the shattered pane comprises an existing first compressive stress region extending to an existing first depth of compression from the first major surface and an existing first depth of layer of one or more alkali metal ions associated with the existing first compressive stress region. After the heating, the shattered pane comprises a first compressive stress region extending to a first depth of compression from the first major surface and a first depth of layer of one or more alkali metal ions associated with the first compressive stress region. The first depth of layer is greater than the existing first depth of layer.

Embodiment 271. The method of embodiment 270, wherein the first depth of layer as a percentage of the substrate thickness is greater than the existing first depth of layer as a percentage of the substrate thickness by from about 5% or more.

Embodiment 272. The method of any one of embodiments 270-271, wherein the existing first compressive stress region comprises an existing first maximum compressive stress. The first compressive stress region comprises a first maximum compressive stress. The first maximum compressive stress is less than the existing first maximum compressive stress.

Embodiment 273. The method of embodiment 272, wherein the first maximum compressive stress is from about 20% to about 80% of the existing first maximum compressive stress.

Embodiment 274. The method of any one of embodiments 270-273, further comprising, before the heating, chemically strengthening the foldable substrate to form the existing first compressive stress region.

Embodiment 275. The method of any one of embodiments 268-274, further comprising, after the heating, flowing a first liquid into a space between a pair of shattered pieces of the plurality of shattered pieces. The method further comprises curing the first liquid into a first material attaching the pair of shattered pieces together. The first material comprises an elastic modulus that is less than an elastic modulus of a shattered piece of the plurality of shattered pieces.

Embodiment 276. A method of making a foldable apparatus from a foldable substrate, the method comprises heating a shattered pane at a temperature from about 300° C. to about 400° C. for from about 15 minutes to about 168 hours. After the heating, the shattered pane comprises a first surface refractive index at the first major surface, a second surface refractive index at a second major surface, a substrate thickness defined between the first major surface and the second major surface, a central refractive index at a midpoint of the substrate thickness, and an absolute difference between the first surface refractive index and the central refractive index is about 0.006 or less. After the heating, the method comprises flowing a first liquid into a space between a pair of shattered pieces of a plurality of shattered pieces of the shattered pane. The method comprises curing the first liquid into a first material attaching the pair of shattered pieces together. The first material comprises an elastic modulus that is less than an elastic modulus of a shattered piece of the plurality of shattered pieces.

Embodiment 277. The method of embodiment 268 or embodiment 276, wherein the heating comprises heating the shattered pane with an electric heater or a burner.

Embodiment 278. The method of embodiment 268, embodiment 276, or embodiment 277, wherein the heating comprises placing the shattered pane in an oven.

Embodiment 279. A method of making a foldable apparatus from a foldable substrate, the method comprises heating at least a portion of a shattered pane to a temperature of about 600° C. or more for from about 0.5 seconds to about 20 minutes. The heating comprises impinging at least the portion of the shattered pane with a laser beam. The shattered pane comprises a first major surface and a second major surface opposite the first major surface. The shattered pane comprises a substrate thickness defined between the first major surface and the second major surface. After the heating, the shattered pane comprises a first surface refractive index at the first major surface, a second surface refractive index at the second major surface, a central refractive index at a midpoint of the substrate thickness, and an absolute difference between the first surface refractive index and the central refractive index is about 0.006 or less. After the heating, the method comprises flowing a first liquid into a space between a pair of shattered pieces of the plurality of shattered pieces. The method comprises curing the first liquid into a first material attaching the pair of shattered pieces together. The first material comprises an elastic modulus that is less than an elastic modulus of a shattered piece of the plurality of shattered pieces.

Embodiment 280. The method of embodiment 269 or embodiment 279, wherein the laser beam comprises a wavelength in a range from about 1.5 micrometers to about 20 micrometers.

Embodiment 281. The method of embodiment 280, wherein the wavelength is in a range from about 9 micrometers to about 12 micrometers.

Embodiment 282. The method of any one of embodiments 275-281, wherein before the heating, the shattered pane comprises an existing first surface refractive index at the first major surface, an existing second surface refractive index at the second major surface, an existing central refractive index at the midpoint of the substrate thickness. The absolute difference between the first surface refractive index and the central refractive index is greater than an absolute difference between the existing first surface refractive index and the existing central refractive index by about 0.002 or more.

Embodiment 283. The method of embodiment 282, wherein the absolute difference between the first surface refractive index and the central refractive index is less than an absolute difference between the existing first surface refractive index and the existing central refractive index by about 0.004 or more.

Embodiment 284. The method of any one of embodiments 282-283, wherein the absolute difference between the second surface refractive index and the central refractive index is less than an absolute difference between the existing second surface refractive index and the existing central refractive index by about 0.002 or more.

Embodiment 285. The method of embodiment 284, wherein the absolute difference between the second surface refractive index and the central refractive index is less than an absolute difference between the existing second surface refractive index and the existing central refractive index by about 0.004 or more.

Embodiment 286. A method of making a foldable apparatus from a foldable substrate comprising a first portion, a second portion, and a central portion positioned between the first portion and the second portion, the method comprises shattering the central portion into a shattered pane comprising a plurality of shattered pieces. The method comprises flowing a first liquid into a space between a pair of shattered pieces of the plurality of shattered pieces. The method comprises curing the first liquid into a first material attaching the pair of shattered pieces together. The first material comprises an elastic modulus that is less than an elastic modulus of a shattered piece of the plurality of shattered pieces.

Embodiment 287. The method of embodiment 286, further comprising shattering the first portion into a second shattered pane comprising a second plurality of shattered pieces. The method further comprises shattering the second portion into a third shattered pane comprising a third plurality of shattered pieces. The shattering the first portion and shattering the second portion occurs before flowing the first liquid.

Embodiment 288. The method of embodiment 287, further comprising flowing the first liquid into a space between a second pair of shattered pieces of the second plurality of shattered pieces. The method further comprises flowing the first liquid into a space between a third pair of shattered pieces of the third plurality of shattered pieces. The method further comprises curing the first liquid into the first material attaching the second pair of shattered pieces together. The method further comprises curing the first liquid into the first material attaching the third pair of shattered pieces together.

Embodiment 289. A method of making a foldable apparatus from a substrate comprising a first portion, a second portion, and a central portion positioned between the first portion and the second portion, the method comprises shattering the substrate into a shattered pane comprising a plurality of shattered pieces. The method comprises flowing a first liquid into a space between a pair of shattered pieces of the plurality of shattered pieces. The method comprises curing the first liquid into a first material attaching the pair of shattered pieces together. The first material comprises an elastic modulus that is less than an elastic modulus of a shattered piece of the plurality of shattered pieces.

Embodiment 290. A method of making a foldable apparatus comprises shattering a central portion into a shattered pane comprising a plurality of shattered pieces. The method comprises flowing a first liquid into a space between a pair of shattered pieces of the plurality of shattered pieces. The method comprises curing the first liquid into a first material attaching the pair of shattered pieces together, the first material comprising a first elastic modulus. The method comprises forming a foldable substrate by attaching a first portion to the shattered pane and attaching a second portion to the shattered pane, wherein the shattered pane is positioned between the first portion and the second portion.

Embodiment 291. The method of embodiment 290, wherein forming the foldable substrate occurs prior to flowing the first liquid into the space between the pair of shattered pieces.

Embodiment 292. The method of any one of embodiments 275-291, wherein the first liquid comprises a viscosity in a range from about 100 milliPascal-seconds (mPa-s) to about 6,000 mPa-s.

Embodiment 293. The method of embodiment 292, wherein the viscosity of the first liquid is in a range from about 1,000 mPa-s to about 5,000 mPa-s.

Embodiment 294. The method of any one of embodiments 275-293, wherein a magnitude of a change in volume upon curing the first liquid into the first material is about 1% or less of the volume of the first liquid.

Embodiment 295. The method of any one of embodiments 275-294, wherein the elastic modulus of the first material at 23° C. is in a range from about 0.01 MegaPascals to about 18,000 MegaPascals.

Embodiment 296. The method of any one of embodiments 275-295, wherein the elastic modulus of the first material changes by a multiple of 100 or less when changing a temperature of the first material from about 100° C. to about −20° C.

Embodiment 297. The method of any one of embodiments 275-296, wherein the first material comprises one or more of a silicone-based polymer, an acrylate-based polymer, an epoxy-based polymer, a thiol-containing polymer, or a polyurethane.

Embodiment 298. The method of embodiment 297, wherein the first material comprises a silicone elastomer.

Embodiment 299. The method of embodiment 297, wherein the first material comprises the adhesive of any one of embodiments 29-39 or embodiments 40-54 and/or produced by the method of any one of embodiments 87-97 or embodiments 98-111.

Embodiment 300. The method of any one of embodiments 296-298, wherein a glass transition temperature of the first material is about −20° C. or less.

Embodiment 301. The method of any one of embodiments 296-298, wherein a glass transition temperature of the first material is about 60° C. or more.

Embodiment 302. The method of any one of embodiments 295-301, wherein the elastic modulus of the first material comprises a glassy plateau in a range from about 0.1 MegaPascals to about 18,000 MegaPascals.

Embodiment 303. The method of any one of embodiments 275-302, further comprising chemically strengthening the central portion before shattering the central portion.

Embodiment 304. The method of embodiment 303, wherein chemically strengthening the central portion creates a stored strain energy of the central portion of about 25 Joules per meter squared (J/m²) or more.

Embodiment 305. The method of any one of embodiments 275-304, wherein the central portion comprises a glass-based material.

Embodiment 306. The method of any one of embodiments 275-304, wherein the central portion comprises a ceramic-based material.

Embodiment 307. The method of any one of embodiments 275-306, wherein shattering the central portion comprises striking the central portion.

Embodiment 308. The method of any one of embodiments 275-307, wherein a total mass of the first material is about 10% or less of a total mass of the plurality of shattered pieces.

Embodiment 309. The method of any one of embodiments 275-307, further comprising disposing a backer layer over at least the central portion of the foldable substrate before shattering the central portion.

Embodiment 310. The method of embodiment 309, wherein the backer layer comprises a second material.

Embodiment 311. The method of embodiment 309, further comprising removing the backer layer after curing the first liquid into the first material. The method further comprises applying a second material to at least the central portion of the foldable substrate.

Embodiment 312. The method of any one of embodiments 275-308, further comprising applying a second material to at least the central portion of the foldable substrate after curing the first liquid.

Embodiment 313. The method of any one of embodiments 310-312, further comprising disposing a first substrate over the first portion and disposing a second substrate over the second portion before applying the second material.

Embodiment 314. The method of embodiment 313, wherein applying the second material comprises filling a region defined between a first edge surface of the first portion and a second edge surface of the second portion with the second material.

Embodiment 315. The method of any one of embodiments 313-314, wherein the first substrate comprises a ceramic-based substrate.

Embodiment 316. The method of any one of embodiments 313-314, wherein the first substrate comprises a glass-based substrate.

Embodiment 317. The method of any one of embodiments 315-316, wherein the first substrate is chemically strengthened. The second substrate is chemically strengthened.

Embodiment 318. The method of any one of embodiments 310-317, wherein the second material comprises a strain at yield of about 100% or more.

Embodiment 319. The method of any one of embodiments 310-318, wherein the second material comprises one or more of a silicone-based polymer, an acrylate-based polymer, an epoxy-based polymer, a polyimide-based material, a polyurethane, or an ethylene acid copolymer.

Embodiment 320. The method of any one of embodiments 310-319, wherein the second material comprises the polymer-based portion of any one of embodiments 1-28 and/or produced by the method of any one of embodiments 59-86.

Embodiment 321. The method of embodiment 319, wherein a glass transition temperature of the second material is about −20° C. or less.

Embodiment 322. The method of embodiment 319, wherein a glass transition temperature of the second material is about 60° C. or more.

Embodiment 323. The method of any one of embodiments 317-322, wherein an elastic modulus of the second material comprises a glassy plateau in a range from about 0.1 MegaPascals to about 10,000 MegaPascals.

Embodiment 324. The method of any one of embodiments 317-323, wherein the second material comprises an elastic modulus at 23° C. is in a range from about 0.01 MegaPascals to about 5,000 MegaPascals.

Embodiment 325. The method of embodiment 324, wherein the elastic modulus of the second material changes by a multiple of 100 or less when changing a temperature of the second material from about 100° C. to about −20° C.

Embodiment 326. The method of any one of embodiment 275-325, wherein the central portion comprises a second central surface area opposite a first central surface area. A density of the plurality of shattered pieces in the central portion is about 5 pieces per square centimeter (pc/cm²) or more measured over an area of the second central surface area in a range from about 1 cm² to about 5 cm².

Embodiment 327. The method of any one of embodiment 275-326, further comprising bending the shattered pane and flowing the first material when the shattered pane is bent.

Embodiment 328. The method of any one of embodiment 275-327, wherein the shattered pane comprises a length extending in a direction of a fold axis, a width extending in a direction perpendicular to the direction of the fold axis, and one or more of the plurality of shattered pieces comprise a maximum dimension that is less than the length and less than the width.

Embodiment 329. A method of making a foldable apparatus of comprises dividing a central portion of a foldable substrate into a plurality of panes. The foldable substrate comprises a substrate thickness defined between a first major surface extending along a first plane and a second major surface extending along a second plane that is parallel to the first plane. The foldable substrate is foldable about a fold axis. The central portion is positioned between a first portion and a second portion. A central thickness defined between a first central surface area of the central portion and the second plane. The plurality of panes each comprise a length extending in a direction of the fold axis and a width extending in a direction perpendicular to the fold axis. The method comprises flowing a first liquid into a space between the pair of panes. The method comprises curing the first liquid to form a first material connecting the pair of panes together. The first material comprises an elastic modulus that is less than an elastic modulus of the foldable substrate, and the central thickness is less than the substrate thickness.

Embodiment 330. The method of embodiment 329, further comprises bending the central portion about the fold axis to present a bent central portion. The flowing the first material into the space between the pair of panes is performed while the central portion is presented as the bent central portion.

Embodiment 331. The method of any one of embodiments 329-330, further comprises flowing a second liquid to fill a recess defined between the first central surface area of the central portion and the first plane. The method further comprises curing the second liquid to form a second material.

Embodiment 332. The method of any one of embodiments 329-331, further comprises applying a layer to the central portion prior to dividing the central portion into the plurality of panes.

Embodiment 333. The method of any one of embodiments 329-332, wherein dividing the central portion comprises forming holes through at least a portion of the central thickness.

Embodiment 334. The method of embodiment 333, wherein dividing the central portion further comprises separating the pair of panes along an aligned path of holes.

Embodiment 335. The method of any one of embodiments 329-334, further comprising dividing the central portion by forming a groove.

Embodiment 336. The method of embodiment 335, wherein dividing the central portion comprises separating the pair of panes along the groove.

### BRIEF DESCRIPTION OF THE DRAWINGS

The above and other features and advantages of embodiments of the present disclosure are better understood when the following detailed description is read with reference to the accompanying drawings, in which:

FIG. 1 is a schematic view of an example foldable apparatus in a flat configuration according to some embodiments, wherein a schematic view of the folded configuration may appear as shown in FIG. 11;

FIGS. 2-8 are cross-sectional views of foldable apparatus along line 2-2 of FIG. 1 according to some embodiments;

FIGS. 9-10 are cross-section views of foldable apparatus along line 2-2 of FIG. 1 according to some embodiments;

FIG. 11 is a schematic view of another example foldable apparatus in a folded configuration according to some embodiments, wherein a schematic view of the flat configuration may appear as shown in FIG. 1;

FIG. 12 is a schematic plan view of a shattered pane in accordance with embodiments of the disclosure;

FIG. 13-14 are cross-sectional views of the example foldable apparatus in the folded configuration along line 13-13 of FIG. 11 according to some embodiments;

FIG. 15 is a cross-sectional view of another example foldable apparatus in another foldable configuration along line 13-13 of FIG. 11 according to some embodiments;

FIG. 16 shows experimental results of the Pen Drop Test of glass-based substrates that shows the maximum principal stress on a major surface of the glass-based substrate as a function of a thickness of a glass-based substrate;

FIGS. 17-18 show cross-sectional views of example embodiments of foldable apparatus according to some embodiments;

FIG. 19 is a flow chart illustrating example methods of making a foldable apparatus in accordance with embodiments of the disclosure;

FIG. 20-24 schematically illustrate example methods of making a foldable apparatus in accordance with embodiments of the disclosure;

FIG. 25 schematic plan view of an example consumer electronic device according to some embodiments;

FIG. 26 is a schematic perspective view of the example consumer electronic device of FIG. 25;

FIG. 27 is a flow chart illustrating example methods making a foldable apparatus in accordance with embodiments of the disclosure;

FIGS. 28-42 schematically illustrate steps in methods of making a foldable apparatus;

FIGS. 43-44 are flow charts illustrating example methods of making a foldable apparatus in accordance with embodiments of the disclosure;

FIG. 45 schematically illustrates an example embodiment of dividing a central portion of a foldable substrate into a plurality of panes in a method of making a foldable apparatus according to some embodiments;

FIG. 46 schematically illustrates a top plan view along line 46-46 of FIG. 45 after dividing the central portion of the foldable substrate into the plurality of panes according to some embodiments;

FIG. 47 schematically illustrates a step in an example embodiment of dividing a central portion of a foldable substrate into a plurality of panes in a method of making a foldable apparatus according to some embodiments;

FIG. 48 schematically illustrates a step in an example embodiment of dividing a central portion of a foldable substrate into a plurality of panes in a method of making a foldable apparatus according to some embodiments;

FIG. 49 schematically illustrates a top plan view along line 49-49 of FIG. 48 according to some embodiments;

FIG. 50 schematically illustrates a step in an example embodiment of dividing a central portion of a foldable substrate into a plurality of panes in a method of making a foldable apparatus according to some embodiments;

FIGS. 51-52 schematically illustrates top plan views along line 51-51 of FIG. 50;

FIGS. 53-56 schematically illustrate steps in example embodiments of methods of making a foldable apparatus according to some embodiments;

FIG. 57-58 are schematic cross-sectional views of the foldable apparatus along line 57-57 of FIG. 56 according to some embodiments;

FIG. 59 is a schematic perspective view of a pen drop apparatus;

FIG. 60 schematically illustrates a foldable apparatus, resembling the test foldable apparatus of FIG. 13, in a neutral stress configuration;

FIG. 61 schematically illustrates the polymer-based portion when the foldable apparatus is in a flat configuration; and

FIG. 62 schematically illustrates the polymer-based portion when the foldable apparatus is in the neutral stress configuration.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, claims may encompass many different aspects of various embodiments and should not be construed as limited to the embodiments set forth herein.

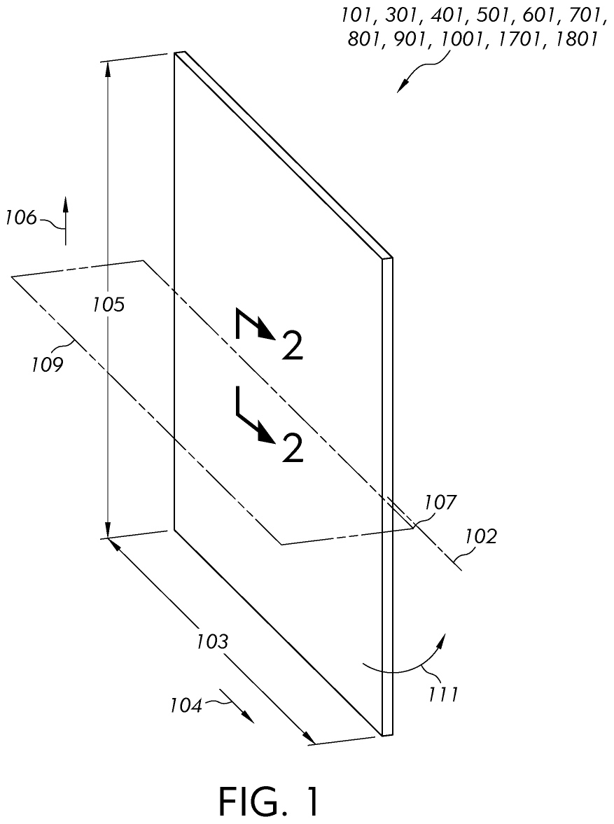

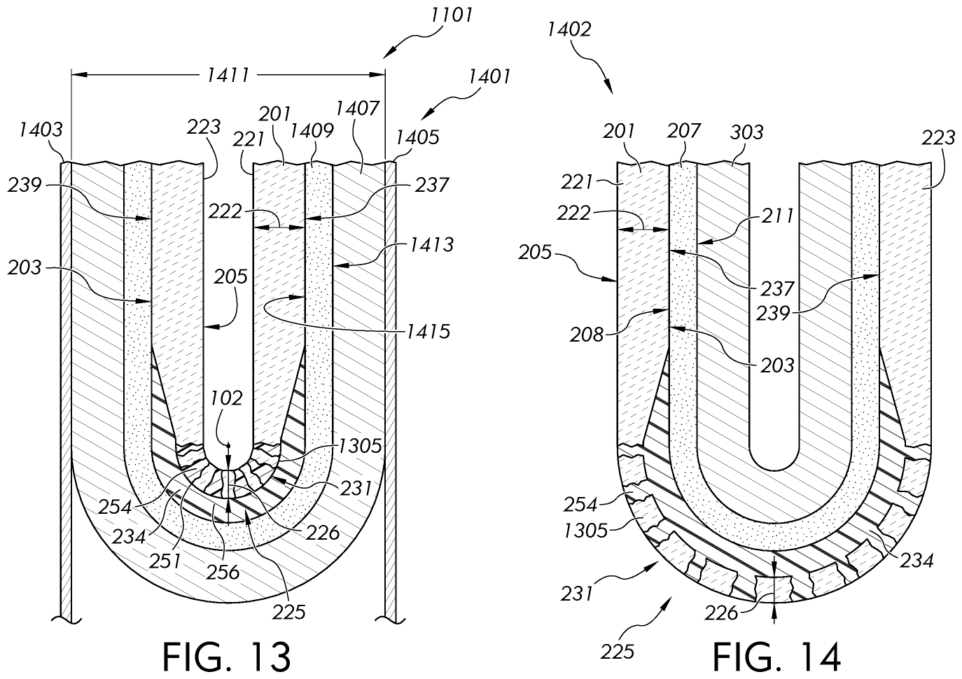

The polymer-based portions and/or adhesives of embodiments of the disclosure can be used, for example, in a foldable apparatus 101, 301, 401, 501, 601, 701, 801, 901, 1001, 1701, and 1801 (e.g., see FIGS. 1-10 and 17-18), a foldable apparatus 1402 and 1501 (e.g., see FIGS. 11, 14, and 15), or a foldable test apparatus 1101 illustrated in FIGS. 11 and 13. However, it is to be understood that the polymer-based portion and/or adhesive is not limited to such applications and can be used in other applications. Also, it is to be understood that the foldable apparatus 101, 301, 401, 501, 601, 701, 801, 901, 1001, 1402, 1501, 1701, and 1801 or the foldable test apparatus 1101 need not comprise the polymer-based portion and/or adhesive in some embodiments. Unless otherwise noted, a discussion of features of embodiments of one foldable apparatus can apply equally to corresponding features of any embodiment of the disclosure. For example, identical part numbers throughout the disclosure can indicate that, in some embodiments, the identified features are identical to one another and that the discussion of the identified feature of one embodiment, unless otherwise noted, can apply equally to the identified feature of any other embodiment of the disclosure.

Embodiments of the disclosure can comprise polymer-based portions. Throughout the disclosure, an index of refraction may be a function of a wavelength of light passing through a material. Throughout the disclosure, for light of a first wavelength, an index of refraction of a material is defined as the ratio between the speed of light in a vacuum and the speed of light in the corresponding material. Without wishing to be bound by theory, an index of refraction of a material can be determined using a ratio of a sine of a first angle to a sine of a second angle, where light of the first wavelength is incident from air on a surface of the material at the first angle and refracts at the surface of the material to propagate light within the material at a second angle. The first angle and the second angle are both measured relative to a normal of a surface of the material. As used herein, the refractive index is measured in accordance with ASTM E1967-19, where the first wavelength comprises 589 nm. In some embodiments, an index of refraction of the polymer-based portion may be about 1.4 or more, about 1.45 or more, about 1.49 or more, about 1.50 or more, about 1.53 or more, about 1.6 or less, about 1.55 or less, about 1.54 or less, or about 1.52 or less. In some embodiments, the index of refraction of the polymer-based portion can be in a range from about 1.4 to about 1.6, from about 1.45 to about 1.6, from about 1.45 to about 1.55, from about 1.49 to about 1.55, from about 1.50 to about 1.55, from about 1.53 to about 1.55, from about 1.49 to about 1.54, from about 1.49 to about 1.52, or any range or subrange therebetween.

As used herein, “optically transparent” or “optically clear” means an average transmittance of 70% or more in the wavelength range of 400 nm to 700 nm through a 1.0 mm thick piece of material. As used herein, an average transmittance of a material is measured by averaging over optical wavelengths in a range from 400 nm to 700 nm through a 1.0 mm thick piece of the material, which comprises measuring the transmittance of whole number wavelengths from about 400 nm to about 700 nm and averaging the measurements. Unless specified otherwise, “transmittance” of a material refers to the average transmittance of the material. In some embodiments, an “optically transparent material” or an “optically clear material” may have an average transmittance of 75% or more, 80% or more, 85% or more, or 90% or more, 92% or more, 94% or more, 96% or more in the wavelength range of 400 nm to 700 nm through a 1.0 mm thick piece of the material. In some embodiments, the polymer-based portion can be optically transparent. In further embodiments, the polymer-based portion can comprise an average transmittance measured over optical wavelengths in a range from 400 nm to 700 nm of about 90% or more, about 91% or more, about 92% or more, about 93% or more, 100% or less, about 96% or less, about 95% or less, or about 94% or less. In further embodiments, the polymer-based portion can comprise an average transmittance measured over optical wavelengths in a range from 400 nm to 700 nm in a range from about 90% to 100%, from about 90% to about 96%, from about 91% to about 96%, from about 91% to about 95%, from about 92% to about 95%, from about 92% to about 94%, from about 93% to about 94%, or any range or subrange therebetween.

The polymer-based portion can comprise a haze as a function of an angle of illumination relative to a direction normal to a surface of the polymer-based portion. As used herein, haze refers to transmission haze that is measured in accordance with ASTM E430. Haze can be measured using a haze meter supplied by BYK Gardner under the trademark HAZE-GUARD PLUS, using an aperture over the source port. The aperture has a diameter of 8 mm. A CIE C illuminant is used as the light source for illuminating the foldable apparatus. Unless indicated otherwise, haze is measured at about 10° relative to an angle of incidence normal to a surface of the polymer-based portion. In some embodiments, the haze at about 0° and/or 10° relative to an angle of incidence normal to the surface of the polymer-based portion measured through a 1.0 millimeter (mm) thick piece of the polymer-based portion can be about 1% or less, about 0.5% or less, about 0.2% or less, about 0.1% or less, or about 0.01% or more, or about 0.05% or more. In some embodiments, the haze at about 0° and/or 10° relative to an angle of incidence normal to the surface of the polymer-based portion measured through a 1.0 mm thick piece of the polymer-based portion can be in a range from 0% to about 1%, from 0% to 0.5%, from 0% to 0.2%, from about 0.01% to about 0.2%, from about 0.05% to about 0.2%, from about 0.05% to about 0.1%, or any range or subrange therebetween. In some embodiments, the haze at about 20° relative to an angle of incidence normal to the surface of the polymer-based portion can be within one or more of the ranges specified above for 0° and/or 10°. Providing a polymer-based portion comprising low haze can enable good visibility through the polymer-based portion.

The polymer-based portion can comprise a glass transition (Tg) temperature. As used herein, the glass transition temperature, a storage modulus at a range of temperatures, a storage modulus (e.g., at a glassy plateau), and a loss modulus (e.g., at a glass plateau) are measured using Dynamic Mechanical Analysis (DMA) with an instrument, for example, the DMA 850 from TA Instruments. The samples for the DMA analysis comprise a film secured by a tension clamp. As used herein, the storage modulus refers to the in-phase component of a response of the polymer-based material to the dynamic testing. Throughout the disclosure, the modulus of elasticity of a polymer-based material refers to the storage modulus of the polymer-based material because, without wishing to be bound by theory, the in-phase component of the response is attributed to the elastic portion of a viscoelastic material. As used herein, the loss modulus refers to the out-of-phase component of a response to the polymer-based material during the dynamic testing. Without wishing to be bound by theory, the loss modulus can correspond to the viscous component of a viscoelastic material. As used herein, the glass transition temperature corresponds to a maximum value of a tan delta, which is a ratio of the loss modulus to the storage modulus. In some embodiments, the glass transition temperature of the polymer-based portion can be about 40° C. or less, about 20° C. or less, about 0° C. or less, about −5° C. or less, about −15° C. or less, about −20° C. or less, or about −30° C. or less, about −40° C. or less, about −80° C. or more, about −60° C. or more, or about −50° C. or more. In further embodiments, the glass transition temperature of the polymer-based portion can be 0° C. or less. In some embodiments, the glass transition temperature of the polymer-based portion can in a range from about −80° C. to about 40° C., from about −80° C. to about 20° C., from about −80° C. to about 0° C., from about −60° C. to about 0° C., from about −60° C. to about −5° C., from about −60° C. to about −15° C., from about −60° C. to about −20° C., from about −50° C. to about −20° C., from about −50° C. to about −30° C., from about −50° C. to about −40° C., or any range or subrange therebetween. Providing a polymer-based portion with a glass transition temperature outside of an operating range (e.g., from about 0° C. to about 40° C., from about −20° C. to about 60° C.) can enable consistent properties across the operating range.

Throughout the disclosure, a storage modulus (i.e., modulus of elasticity) is measured for a polymeric material (e.g., polymer-based portion, adhesive) at 23° C. unless indicated otherwise. In some embodiments, the polymer-based portion can comprise a storage modulus of about 0.1 MegaPascals (MPa) or more, about 0.3 MPa or more, about 0.5 MPa or more, about 1 MPa or more, about 5 MPa or less, about 3 MPa or less, about 2 MPa or less, or about 1 MPa or less. In some embodiments, the polymer-based portion can comprise a storage modulus in a range from about 0.1 MPa to about 5 MPa, from about 0.3 MPa to about 5 MPa, from about 0.3 MPa to about 3 MPa, from about 0.3 MPa to about 2 MPa, from about 0.3 MPa to about 1 MPa, from about 0.5 MPa to about 1 MPa, from about 0.5 MPa to about 3 MPa, from about 1 MPa to about 3 MPa, or any range or subrange therebetween.

Throughout the disclosure, a loss modulus is measured for a material (e.g., polymer-based portion, adhesive) at 23° C. unless indicated otherwise. In some embodiments, the polymer-based portion can comprise a loss modulus of about 10 kiloPascals (kPa) or more, about 20 kPa or more, about 50 kPa or more, about 100 kPa or more, about 5 MPa or less, about 3 MPa or less, or about 1 MPa or less, or about 500 kPa or less. In some embodiments, the polymer-based portion can comprise a loss modulus in a range from about 10 kPa to about 5 MPa, from about 10 kPa to about 3 MPa, from about 20 kPa to about 3 MPa, from about 20 kPa to about 1 MPa, from about 50 kPa to about 1 MPa, from about 100 kPa to about 1 MPa, from about 100 kPa to about 500 kPa, or any range or subrange therebetween.

Throughout the disclosure, a tensile strength, ultimate elongation (e.g., strain at failure), and yield point of the polymer-based portion and elastomers is determined using ASTM D412A using a tensile testing machine, for example, an Instron 3400 or Instron 6800, at 23° C. and 50% relative humidity with a type I dogbone shaped sample. In some embodiments, a tensile strength of the polymer-based portion can be about 0.4 MPa or more, 0.5 MPa or more, about 1 MPa, about 2 MPa or more, about 5 MPa or more, about 20 MPa or less, about 15 MPa or less, about 10 MPa or less, or about 2.5 MPa or less. In some embodiments, a tensile strength of the polymer-based portion can be in a range from about 0.4 MPa to about 20 MPa, from about 0.5 MPa to about 20 MPa, from about 1 MPa to about 20 MPa, from about 1 MPa to about 15 MPa, from about 2 MPa to about 15 MPa, from about 5 MPa to about 15 MPa, from about 5 MPa to about 10 MPa, or any range or subrange therebetween. In some embodiments, a tensile strength of the polymer-based portion can be from about 0.4 MPa to about 20 MPa, 0.4 MPa to about 15 MPa, from about 0.5 MPa to about 15 MPa, from about 0.5 MPa to about 10 MPa, from about 0.5 MPa to about 2.5 MPa, or any range or subrange therebetween.

In some embodiments, an ultimate elongation of the polymer-based portion can be about 40% or more, about 50% or more, about 65% or more, about 80% or more, about 95% or more, about 150% or more, about 300% or less, about 200% or less, about 125% or less, about 110% or less, or about 80% or less. In some embodiments, an ultimate elongation of the polymer-based portion can be in a range from about 40% to about 300%, from about 50% to about 300%, from about 65% to about 300%, from about 80% to about 300%, from about 95% to about 300, from about 150% to about 300%, from about 150% to about 200%, or any range or subrange therebetween. In some embodiments, an ultimate elongation of the polymer-based portion can be in a range from about 40% to about 300%, from about 40% to about 200%, from about 50% to about 200%, from about 50% to about 125%, from about 65% to about 125%, from about 80% to about 125%, from about 95% to about 125%, from about 40% to about 80%, from about 50% to about 80%, from about 65% to about 80%, or any range or subrange therebetween.

Throughout the disclosure, an elastic modulus of the polymer-based portion and elastomers is measured using ISO 527-1:2019. In some embodiments, an elastic modulus of the polymer-based portion can be about 0.5 MPa or more, about 1 MPa or more, about 2 MPa or more, about 5 MPa or more, about 10 MPa or more, about 20 MPa or more, about 100 MPa or less, about 50 MPa or less, about 30 MPa or less, about 10 MPa or less, or about 5 MPa or less. In some embodiments, an elastic modulus of the polymer-based portion can be in a range from about 0.5 MPa to about 100 MPa, from about 1 MPa to about 100 MPa, from about 1 MPa to about 50 MPa, from about 2 MPa to about 50 MPa, from about 5 MPa to about 50 MPa, from about 10 MPa to about 50 MPa, from about 20 MPa to about 50 MPa, from about 20 MPa to about 30 MPa, or any range or subrange therebetween. In some embodiments, an elastic modulus of the polymer-based portion can be in a range from about 0.5 MPa to about 50 MPa, from about 0.5 MPa to about 30 MPa, from about 0.5 MPa to about 10 MPa, from about 1 MPa to about 10 MPa, from about 1 MPa to about 5 MPa, from about 2 MPa to about 5 MPa, or any range or subrange therebetween.

Throughout the disclosure, tension set of a sample is measured using ASTM D-412 as the strain at zero stress after the sample is stretched to a specified strain. In some embodiments, the polymer-based portion can comprise a tension set after being extended to a strain of 40% at a strain rate of 10% strain per minute at 23° C. In further embodiments, the tension set can be about 2% or less, about 1% or less, about 0.5% or less, or 0% or more. In further embodiments, the tension set can be in a range from 0% to about 2%, from 0% to about 1%, from 0% to about 0.5%, or any range or subrange therebetween. In further embodiments, the polymer-based portion can fully recover after being extended to a strain of 40% at a strain rate of 10% strain per minute at 23° C. In some embodiments, the polymer-based portion can fully recover after being extended to a strain of 40% at a strain rate of 10% strain per minute at 0° C. In some embodiments, the polymer-based portion can comprise a tension set after 200 cycles extending the polymer-based portion to a strain of 40% at a strain rate of 10% strain per minute at 23° C. In further embodiments, the tension set can be about 2% or less, about 1% or less, about 0.5% or less, or 0% or more. In further embodiments, the tension set can be in a range from 0% to about 2%, from 0% to about 1%, from 0% to about 0.5%, or any range or subrange therebetween.

The polymer-based portion described above can be formed as the product of curing a composition. Methods of forming the polymer-based portion described above will now be described.

Methods of forming the polymer-based portion can comprise creating a composition. The composition can comprise a difunctional urethane-acrylate oligomer. In some embodiments, the difunctional urethane-acrylate oligomer can comprise one or more of the following products in the Miramer product line available from Miwon: PU210, PU256, PU2050, PU2100, PU2300C, PU2560, PU320, PU340, PU3000, PU3200, PU340, PU5000, PU610, PU6510, PU9500, PU9800, PUA2516, SC2100, SC2404, SC2565, and/or SC9211. In some embodiments, the difunctional urethane-acrylate oligomer can comprise one or more of the following products in the Photomer product line available from IGM Resins: 6009, 6210, 6230, 6620, 6630, 6638, 6643, 6645, 6891, 6582, and/or 6581. In some embodiments, the difunctional urethane-acrylate oligomer can comprise the following products available from Arkema (Sartomer): PRO13944, PRO14213, CN8881, CN90004, CN9009, CN9030, CN9031, CN964, CN966J75, CN981, CN991, and/or CN 96. In some embodiments, the difunctional urethane-acrylate oligomer can comprise the following products from Dymax (Bomar): BR-374, BR-3042, BR-3641AA, BR-3641AJ, BR-3741AJ, BR-3747AE, BR-541S, BR-543, BR-543TF, BR-571, BR-582E8, BR-641E, BR-744BT, BR-744SD, and/or BR-771F. Exemplary embodiments of difunctional urethane-acrylate oligomers include Miramer SC9211 (Miwon), Photomer 6230 (IGM Resin), RX0057 (Allinex), and BR-543 (Dymax/Bomar).

In some embodiments, the composition can comprise a difunctional urethane-acrylate oligomer in a weight % (wt %) of about 45 wt % or more, about 47% or more, about 50 wt % or more, about 55 wt % or more, about 75 wt % or less, about 70 wt % or less, about 65 wt % or less, or about 60 wt % or less. In some embodiments, the composition can comprise a difunctional urethane-acrylate oligomer in a weight % (wt %) ranging from about 45 wt % to about 75 wt %, from about 45 wt % to about 70 wt %, from about 45 wt % to about 65 wt %, from about 47 wt % to about 65 wt %, from about 50 wt % to about 65 wt %, from about 50 wt % to about 60 wt %, from about 55 wt % to about 60 wt %, or any range or subrange therebetween.

In some embodiments, the composition can comprise a difunctional urethane-acrylate oligomer in a weight % (wt %) of 0 wt % or more, 1 wt % or more, about 5 wt % or more, about 10 wt % or more, about 25 wt % or less, about 20 wt % or less, or about 15 wt % or less. In some embodiments, the composition can comprise a difunctional urethane-acrylate oligomer in a weight % (wt %) ranging from 0 wt % to about 25 wt %, from 1 wt % to about 25 wt %, from about 1 wt % to about 20 wt %, from about 5 wt % to about 20 wt %, from about 10 wt % to about 20 wt %, from about 10 wt % to about 15 wt %, or any range or subrange therebetween. In some embodiments, the composition can be substantially free of comprise a difunctional urethane-acrylate oligomer.

In some embodiments, the composition can comprise a difunctional cross-linking agent. In some embodiments, the difunctional cross-linking agent can comprise a difunctional methacrylate monomer, for example, propylene-glycol dimethacrylate (e.g., SR-644 (Sartomer)). In some embodiments, the difunctional cross-linking agent can comprise a difunctional acrylate monomer. Exemplary embodiments of difunctional acrylate monomers include without limitation dipropylene-glycol diacrylate (DPGDA) (e.g., SR-508 (Sartomer), Photomer 4226 (IGM Resins)), 1,6-hexanediol diacrylate (e.g., Miramer M200 (Miwon)), bisphenol A diacrylate (e.g., Miramer M210 (Miwon)), bisphenol-A [4 EO] diacrylate (e.g., Photomer 4028 (IGM Resins)), tripropylene-glycol diacrylate (TPGDA) (e.g.,

Photomer 4061 (IGM Resins)), 3-methyl-1,5,-pentanediol diacrylate (MPDDA) (e.g., Photomer 4071 (IGM Resins)), neopentyl-glycol diacrylate (e.g., Photomer 4127 (IGM Resins)), Miramer HR 3700 (Miwon), and 1,6-hexanediol ethoxylate diacrylate (e.g., Photomer 4369 (IGM Resins)). In even further embodiments, the difunctional cross-linking agent can comprise dipropylene-glycol diacrylate and/or 2-[[(butylamino)carbonyl]oxy]ethyl acrylate (e.g., Photomer 4184 (IGM Resins)). In even further embodiments, the difunctional cross-linking agent comprising a difunctional acrylate monomer can comprise a urethane diacrylate monomer. An exemplary embodiment of a difunctional cross-linking agent comprises 2-[[(butylamino)carbonyl]oxy]ethyl acrylate (e.g., Photomer 4184 (IGM Resins)).

In some embodiments, the composition can comprise a difunctional cross-linking agent in a weight % (wt %) of about 25 wt % or more, about 30 wt % or more, about 35 wt % or more, about 40 wt % or more, about 55 wt % or less, about 50 wt % or less, or about 45 wt % or less. In some embodiments, the composition can comprise a difunctional cross-linking agent in a weight % (wt %) ranging from about 25 wt % to about 55 wt %, from about 30 wt % to about 55 wt %, from about 35 wt % to about 55 wt %, from about 35 wt % to about 50 wt %, from about 40 wt % to about 50 wt %, from about 40 wt % to about 45 wt % or any range or subrange therebetween.

In some embodiments, the composition can comprise a difunctional cross-linking agent in a weight % (wt %) of 0 wt % or more, about 0.1 wt % or more, about 0.2 wt % or more, about 1 wt % or less, or about 0.5 wt % or less. In some embodiments, the composition can comprise a difunctional cross-linking agent in a weight % (wt %) ranging from 0 wt % to about 1 wt %, from about 0.1 wt % to about 1 wt %, from about 0.1 wt % to about 0.5 wt %, from about 0.2 wt % to about 0.5 wt %, or any range or subrange therebetween. In some embodiments, the composition can be substantially free of a difunctional cross-linking agent.

In some embodiments, the composition can comprise a reactive diluent. As used herein, a reactive diluent is a monofunctional compound that can decrease the viscosity of composition and decrease a cross-linking density of the polymer-based portion. Without wishing to be bound by theory, decreasing the cross-linking density of the polymer-based portion can decrease the glass transition temperature of the polymer-based portion. In some embodiments, the reactive diluent can comprise a monofunctional acrylate. In further embodiments, the reactive diluent comprising a monofunctional acrylate include isobornyl acrylate (e.g., Miramer 1140 (Miwon), Photomer 4012 (IGM Resins)), biphenyl-methyl acrylate (e.g., Miramer 1192 (Miwon)), 2-propyl-heptyl acrylate, butyl acrylate, biphenyl methyl acrylate, nonyl phenol acrylates (e.g., Miramer 166 (Miwon)), ethoxy ethoxy ethyl acrylate (e.g., Miramer 170 (Miwon)), and/or isooctyl acrylate (e.g., Miramer 1084 (Miwon)). In further embodiments, the reactive diluent can comprise a vinyl-terminated mono-acrylate monomer. Exemplary embodiments of the reactive diluent include biphenylmethyl acrylate, nonyl phenol acrylate, and/or isooctyl acrylate.

In some embodiments, the composition can comprise a reactive diluent in combination with a difunctional urethane-acrylate oligomer and a difunctional cross-linking agent. In further embodiments, the composition can comprise the reactive diluent in a weight % (wt %) of 0 wt % or more, about 1 wt % or more, about 8 wt % or more, about 18 wt % or more, about 25 wt % or less, about 22 wt % or less, or about 20 wt % or less. In further embodiments, the composition can comprise the reactive diluent in a weight % (wt %) ranging from 0 wt % to about 25 wt %, from about 1 wt % to about 25 wt %, from about 5 wt % to about 25 wt %, from about 8 wt % to about 25 wt %, from about 8 wt % to about 22 wt %, from about 18 wt % about 22 wt %, from about 18 wt % to about 20 wt %, or any range or subrange therebetween. In some embodiments, the composition can be substantially free of a reactive diluent.

In some embodiments, the composition can comprise a reactive diluent, which can optionally be in combination with a difunctional urethane-acrylate oligomer and/or a difunctional cross-linking agent. In further embodiments, the composition can comprise the reactive diluent in a weight % (wt %) of 75 wt % or more, about 77 wt % or more, about 80 wt % or more, about 85 wt % or more, about 87 wt % or more, 100 wt % or less, about 99 wt % or less, about 95 wt % or less, or about 90 wt % or less. In further embodiments, the composition can comprise the reactive diluent ranging from about 75 wt % to 100 wt %, from about 77 wt % to 100 wt %, from 80 wt % to 100 wt %, from about 85 wt % to 100 wt %, from about 87 wt % to about 99 wt %, from about 87 wt % to about 95 wt %, from about 87 wt % to about 90 wt %, or any range or subrange therebetween. In further embodiments, the composition can comprise the reactive diluent ranging from about 75 wt % to 100 wt %, from about 75 wt % to about 99 wt %, from about 75 wt % to about 95 wt %, from about 75 wt % to about 90 wt %, from about 77 wt % to about 90 wt %, from about 80 wt % to about 90 wt %, from about 85 wt % to about 90 wt %, from about 87 wt % to about 90 wt %, or any range or subrange therebetween

In some embodiments, the composition can comprise a silane coupling agent. In further embodiments, the silane coupling agent can comprise a mercapto silane. In even further embodiments, silane coupling agent can comprise 3-mercaptopropyltrimethoxysilane (e.g., SIM6476.0 (Gelest)), 3-mercaptopropyltriethoxysilane (e.g., SIM6475. (Gelest)), 11-mercaptoundecyltrimethoxysilane (e.g., SIM6480.0 (Gelest)), (mercaptomethyl)methyldiethoxysilane (e.g., SIM6473.0 (Gelest)), and/or 3-mercaptopropylmethyldimethoxysilane (e.g., SIM6474.0 (Gelest)). An exemplary embodiment of the silane coupling agent comprises 3-mercaptopropyltrimethoxysilane. In some embodiments, the composition can comprise the silane coupling agent in a weight % (wt %) of about 0.1 wt % or more, about 0.2 wt % or more, about 0.5 wt % or more, about 5 wt % or less, about 2 wt % or less, or about 1 wt % or less. In some embodiments, the composition can comprise the silane coupling agent in a weight % (wt %) ranging from about 0.1 wt % to about 5 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween.

In some embodiments, the composition can comprise a photo-initiator. As used herein a photo-initiator is a compound sensitive to one or more wavelengths that upon absorbing light comprising the one or more wavelengths undergoes a reaction to produce one or more radicals or ionic species that can initiate a polymerization reaction. In further embodiments, the photo-initiator may be sensitive to one or more wavelengths of ultraviolet (UV) light. Example embodiments of photo-initiators sensitive to UV light include without limitation benzoin ethers, benzil ketals, dialkoxyacetophenones, hydroxyalkylphenones, aminoalkylphenones, acylphosphine oxides, thioxanthones, hydroxyalkylketones, and thoxanthanamines. In further embodiments, the photo-initiator may be sensitive to one or more wavelengths of visible light. Example embodiments of photo-initiators sensitive to visible light include without limitation 5,7-diiodo-3-butoxy-6-fluorone, bis (4-methoxybenzoyl) diethylgermanium, bis(2,4,6-trimethylbenzoyl)-phenylphosphineoxide, 3-methyl-4-aza-6-helicene, and thiocyanide borates. In further embodiments, the photo-initiator may be sensitive to a wavelength that the other components of the composition are substantially transparent at. As used herein, a compound (e.g., component of the composition) is substantially transparent at a predetermined wavelength if it comprises an average transmittance of 75% or more (e.g., 80% or more, 85% or more, or 90% or more, 92% or more, 94% or more, 96% or more) through a 1.0 mm thick piece of the compound at the predetermined wavelength. Providing a photo-initiator can enable controlled activation of curing of the composition. Providing a photo-initiator can enable uniform curing of the composition. In further embodiments, the photo-initiator may produce one or more radicals (e.g., free radicals). Example embodiments of photo-initiators producing one or more radicals include acetophenone, anisoin, anthraquinone, benzene, benzil, benzoin, benzoin ethyl ether, benzoin isobutyl ether, benzoin methyl ether, benzophenone, hydroxycyclohexyl phenyl ketone, 4-benzoylbiphernyl, camphorquinone, 2-chlorothioxanthen-9-one, bibezosuberenone, 2-,2-diethyoxyacetophenone, dimethylbenzil, ferrocene, ethylanthraquinone, hydroxyacetophenone, hydroxybenzophenone, thioxanthene-9-one, diphenyl(2,4,6-trimethylbenzoyl)phosphine oxide, and phophineoxide. Example embodiments of photo-initiators producing one or more ions include without limitation triarylsulfonium hexfluoroantimonate and bis(4-tert-butylphenyl)iodonium perfluoro-1-butanesulfonate. Commercially available photo-initiators include without limitation the Irgacure product line from Ciba Specialty Chemical. Exemplary embodiments of photo-initiators include acetophenone-based compounds, for example, dimethoxyphenyl acetophenone. In some embodiments, the composition can comprise the photo-initiator in a weight % (wt %) of about 0.1 wt % or more, about 0.2 wt % or more, about 0.5 wt % or more, about 3 wt % or less, about 2 wt % or less, or about 1 wt % or less. In some embodiments, the composition can comprise the silane coupling agent in a weight % (wt %) ranging from about 0.1 wt % to about 3 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween.

In some embodiments, the composition can comprise a catalyst. Without wishing to be bound by theory, a catalyst can increase a rate of the curing (e.g., polymerization, reaction), and the catalyst may avoid permanent chemical change as a result of the curing. In some embodiments, the catalyst can comprise one or more platinum group metals, for example, ruthenium, rhodium, palladium, osmium, iridium, and/or platinum. In some embodiments, the catalyst can comprise a platinum-based Karstedt' s catalyst solution. Exemplary embodiments of platinum-based catalysts include chloroplatinic acid, platinum-fumarate, colloidal platinum, metallic platinum, and/or platinum-nickel nanoparticles.

In some embodiments, the composition can comprise an elastomer. In some embodiments, the composition can comprise a thermoplastic elastomer, for example, a thermoplastic polyurethane, a thermoplastic polyamide, poly(dichlorophosphazene), a silicone-based rubber, and/or block copolymers. In some embodiments, the composition can comprise a block copolymer. Exemplary embodiments of block-copolymers include high-impact polystyrene, styrene-butadiene block copolymer, and styrene-ethylene-butylene-styrene block copolymer (e.g., Kraton G1650 (Kraton)). In some embodiments, the composition can comprise an elastomer in a weight % (wt %) of about 0.1 wt % or more, about 0.2 wt %, about 0.5 wt % or more, about 5 wt % or less, about 2 wt % or less, or about 1 wt % or less. In some embodiments, the composition can comprise the elastomer in a weight % (wt %) ranging from about 0.1 wt % to about 5 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween.

In some embodiments, the composition can be substantially solvent-free. In further embodiments, the composition can be solvent-free. In even further embodiments, the composition can be entirely solvent-free. As used herein, a composition is entirely solvent-free if it only contains components that participate in the curing reaction and/or are considered a photo-initiator, or a catalyst based on the above discussion. As used herein, a composition is solvent-free if it contains 99.5 wt % or more components that participate in the curing reaction and/or are considered a photo-initiator, or a catalyst based on the above discussion. As used herein a composition is substantially solvent-free if it contains 98 wt % or more components that participate in the curing reaction and/or are considered a photo-initiator, or a catalyst based on the above discussion. For example, water and octanol are considered solvents. Solvents can comprise one or more of a polar solvent (e.g., water, an alcohol, an acetate, acetone, formic acid, dimethylformamide, acetonitrile, dimethyl sulfoxone, nitromethane, propylene carbonate, poly(ether ether ketone)) or a non-polar solvent (e.g., pentane, 1,4-dioxane, chloroform, dichloromethane, diethyl ether, hexane, heptane, benzene, toluene, xylene). For example, a composition comprising up to 0.5 wt % solvent is considered to be both substantially solvent-free and solvent-free. Likewise, a composition containing no solvent is considered to be substantially solvent-free, solvent-free, and entirely solvent-free. Providing a composition that is substantially solvent-free (e.g., entirely solvent-free) can increase the curing rate of the composition, which can decrease processing time. Providing a composition that is substantially solvent-free (e.g., entirely solvent-free) can reduce (e.g. decrease, eliminate) the use of additives, for example, rheology modifiers, and increase composition homogeneity, which can improve the quality of the resulting polymer-based portion (e.g., increased transmittance, decreased haze, increased mechanical properties). In some embodiments, the composition can comprise the photo-initiator in a weight % (wt %) of about 0.1 wt % or more, about 0.2 wt % or more, about 0.5 wt % or more, about 3 wt % or less, about 2 wt % or less, or about 1 wt % or less. In some embodiments, the composition can comprise the silane coupling agent in a weight % (wt %) ranging from about 0.1 wt % to about 3 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween.

Methods of forming the polymer-based portion can comprise curing the composition to form the polymer-based portion. In some embodiments, curing the composition to form the polymer-based portion can comprise heating, ultraviolet (UV) irradiation, and/or waiting for a predetermined period of time. In some embodiments where the composition comprises a photo-initiator, curing can comprise irradiating the composition with at least one wavelength of light that the photo-initiator is sensitive to. In some embodiments, the irradiating can comprise impinging the composition with a light beam emitted from a light source. In further embodiments, the light source can be configured to emit a light beam comprising an ultra-violet (UV) wavelength or a visible wavelength. In even further embodiments, the wavelength of the light beam can be in a range from about 10 nm to about 400 nm, from about 100 nm to about 400 nm, from about 200 nm to about 400 nm, from about 10 nm to about 300 nm, from about 100 nm to about 300 nm, from about 200 nm to about 300 nm, from about 10 nm to about 200 nm, from about 100 nm to about 200 nm, or any range or subrange therebetween. In even further embodiments, an operating wavelength range of the light source may be over a range of optical wavelengths from about 315 nm to about 400 nm, from about 280 nm to about 315 nm, from about 100 nm to about 280 nm, or from 122 nm to about 200 nm. In even further embodiments, the wavelength of the light beam can be in a range from about 300 nm to about 1,000 nm, from about 350 nm to about 900 nm, from about 400 to about 800 nm, from about 500 nm to about 700 nm, or any range or subrange therebetween. In still further embodiments, the wavelength of the light beam can be about 365 nm, about 415 nm, or about 590 nm.

In some embodiments, curing can comprise heating the composition at a temperature for a time. As used herein, heating a composition “at a temperature” means that the composition is exposed to the temperature, for example, by being placed in an oven. In further embodiments, the temperature can be about 80° C. or more, about 100° C. or more, about 120° C. or more, about 140° C. or more, about 250° C. or less, about 200° C. or less, about 180° C. or less, or about 160° C. or less. In further embodiments, the temperature can be in a range from about 80° C. to about 250° C., from about 80° C. to about 200° C., from about 100° C. to about 200° C., from about 100° C. to about 180° C., from about 120° C. to about 180° C., from about 120° C. to about 160° C., from about 140° C. to about 160° C., or any range or subrange therebetween. In further embodiments, the time can be about 15 minutes or more, about 30 minutes or more, 1 hour or more about 12 hours or less, about 6 hours or less, about 3 hours or less, or about 2 hours or less. In further embodiments, the time can be in a range from about 15 minutes to about 12 hours, from about 15 minutes to about 6 hours, from about 15 minutes to about 3 hours, from about 30 minutes to about 3 hours, from about 1 hour to about 3 hours, from about 1 hour to about 2 hours, or any range or subrange therebetween.

In some embodiments, curing the composition to form the polymer-based material can result in a volume change of the polymer-based portion relative to a volume of the composition. In further embodiments, a magnitude of a difference of the volume the polymer-based portion relative to the volume of the composition as a percentage of the volume of the composition can be about 5% or less, about 2% or less, about 1% or less, about 0.5% or less, about 0.1% or less, about 0.01% or more, about 0.1% or more, about 0.5% or more, about 1% or more. In further embodiments, a magnitude of a difference of the volume the polymer-based portion relative to the volume of the composition as a percentage of the volume of the composition can be in a range from 0% to about 5%, from 0% to about 2%, from 0% to about 1%, from 0.01% to about 1%, from about 0.1% to about 1%, from about 0.5% to about 1%, from about 0.01% to about 5%, from about 0.01% to about 2%, from about 0.1% to about 2%, from about 0.5% to about 2%, or any range or subrange therebetween.

It is to be understood that any of the above ranges for the above-mentioned components can be combined in embodiments of the disclosure. Example ranges of some embodiments of the disclosure are presented in Table 1. R1 and R5 are the broadest of the ranges in Table 1 while R3-R4 and R8 are the narrowest ranges of the ranges in Table 1. R2 and R6-R7 represent intermediate ranges. R1-R4 comprise a difunctional cross-linking agent, R3 and R5-R8 comprise a reactive diluent, and R1-R2 can optionally include a reactive diluent. Again, it is to be understood that other ranges or subranges discussed above for these components can be used in combination with any of the ranges presented in Table 1.

TABLE 1
Composition ranges (wt %) of embodiments of polymer-based portions

| Range | R1 | R2 | R3 | R4 | R5 | R6 | R7 | R8 |
|---|---|---|---|---|---|---|---|---|
| Difunctional | 45-75 | 47-65 | 47-55 | 55-65 | 0-25 | 0 | 1-25 | 1-25 |
| Urethane-Acrylate | | | | | | | | |
| Oligomer | | | | | | | | |
| Difunctional | 25-55 | 25-45 | 25-45 | 35-45 | 0-1 | 0 | 0.1-1 | 0-1 |
| Cross-linking | | | | | | | | |
| Agent | | | | | | | | |
| Reactive Diluent | 0-25 | 0-20 | 17-25 | 0 | 75-100 | 87-100 | 75-100 | 77-99 |
| Photo-initiator | 0-3 | 0.1-3 | 0-3 | 0.1-3 | 0-3 | 0-3 | 0-3 | 0.1-3 |
| Silane Coupling | 0-5 | 1.5-3 | 0-5 | 0-5 | 0-5 | 0-5 | 0-5 | 1.5-3 |
| Agent | | | | | | | | |
| Elastomer | 0-5 | 0-5 | 0-5 | 0-5 | 0-5 | 0-5 | 0-5 | 0-5 |

Embodiments of the disclosure can comprise adhesives. In some embodiments, an index of refraction of the adhesive may be about 1.4 or more, about 1.45 or more, about 1.49 or more, about 1.50 or more, about 1.53 or more, about 1.6 or less, about 1.55 or less, about 1.54 or less, or about 1.52 or less. In some embodiments, the index of refraction of the adhesive can be in a range from about 1.4 to about 1.6, from about 1.45 to about 1.6, from about 1.45 to about 1.55, from about 1.49 to about 1.55, from about 1.50 to about 1.55, from about 1.53 to about 1.55, from about 1.49 to about 1.54, from about 1.49 to about 1.52, or any range or subrange therebetween.

In some embodiments, the adhesive can be optically transparent. In further embodiments, the adhesive can comprise an average transmittance (i.e., measured over optical wavelengths in a range from 400 nm to 700 nm by measuring the transmittance of whole number wavelengths from about 400 nm to about 700 nm and averaging the measurements) of about 90% or more, about 94% or more, about 95% or more, about 96% or more, 100% or less, about 99% or less, about 98% or less, or about 97% or less. In further embodiments, the adhesive can comprise an average transmittance measured over optical wavelengths in a range from 400 nm to 700 nm in a range from about 90% to 100%, from about 94% to 100%, from about 95% to 100%, from about 95% to about 99%, from about 95% to about 98%, from about 96% to about 98%, from about 96% to about 97%, or any range or subrange therebetween.

The adhesive can comprise a haze as a function of an angle of illumination relative to a direction normal to a surface of the adhesive. In some embodiments, the haze at about 0° and/or 10° relative to an angle of incidence normal to the surface of the adhesive measured through a 1.0 mm thick piece of the adhesive can be about 1% or less, about 0.5% or less, about 0.2% or less, about 0.1% or less, or about 0.01% or more, or about 0.05% or more. In some embodiments, the haze at about 0° and/or 10° relative to an angle of incidence normal to the surface of the adhesive measured through a 1.0 mm thick piece of the adhesive can be in a range from 0% to about 1%, from 0% to 0.5%, from 0% to 0.2%, from about 0.01% to about 0.2%, from about 0.05% to about 0.2%, from about 0.05% to about 0.1%, or any range or subrange therebetween. In some embodiments, the haze at about 20° relative to an angle of incidence normal to the surface of the adhesive can be within one or more of the ranges specified above for 0° and/or 10°. Providing an adhesive comprising low haze can enable good visibility through adhesive.

The adhesive can comprise a glass transition (Tg) temperature. In some embodiments, the glass transition temperature of the adhesive can be about −40° C. or less, about −60° C. or less, about −70° C. or less, about −130° C. or more, or about −120° C. or more, about −100° C. or more, or about −80° C. or more, or about −75° C. or more. In some embodiments, the glass transition temperature of the adhesive can in a range from about −130° C. to about −40° C., from about −130° C. to about −60° C., from about −120° C. to about −60° C., from about −100° C. to about −60° C., from about −100° C. to about −70° C., from about −80° C. to about −70° C., from about −75° C. to about −70° C., or any range or subrange therebetween. Providing an adhesive with a glass transition temperature outside of an operating range (e.g., outside of an operating range from about 0° C. to about 40° C., or outside of an operating range from about −20° C. to about 60° C.) can enable consistent properties across the operating range.

In some embodiments, the adhesive can comprise a storage modulus (i.e., modulus of elasticity) of about 1 MPa or more, about 2 MPa or more, about 5 MPa or more, about 5 MPa or more, about 25 MPa or less, about 20 MPa or less, about 15 MPa or less, or about 11 MPa or less. In some embodiments, the adhesive can comprise a storage modulus in a range from about 1 MPa to about 25 MPa, from about 1 MPa to about 20 MPa, from about 2 MPa to about 20 MPa, from about 2 MPa to about 15 MPa, from about 2 MPa to about 11 MPa, from about 3 MPa to about 11 MPa, from about 5 MPa to about 11 MPa, or any range or subrange therebetween.

In some embodiments, the adhesive can comprise a loss modulus of about 0.1 kPa or more, about 0.2 kPa or more, about 0.5 kPa or more, about 3 kPa or less, about 2 kPa or less, or about 1 kPa or less. In some embodiments, the adhesive can comprise a loss modulus in a range from about 0.1 kPa to about 3 kPa, from about 0.2 kPa to about 3 kPa, from about 0.2 kPa to about 2 kPa, from about 0.2 kPa to about 1 kPa, from about 0.5 kPa to about 1 kPa, or any range or subrange therebetween.

Throughout the disclosure, a tensile strength, ultimate elongation (e.g., strain at failure), and yield point of the adhesive and other materials is determined using ASTM D638 using a tensile testing machine, for example, an Instron 3400 or Instron 6800, at 23° C. and 50% relative humidity with a type I dogbone shaped sample. In some embodiments, a tensile strength of the adhesive can be about 1 MPa, about 3 MPa or more, about 10 MPa or more, about 50 MPa or less, about 35 MPa or less, about 25 MPa or less, or about 10 MPa or less. In some embodiments, a tensile strength of the adhesive can be in a range from about 1 MPa to about 50 MPa, from about 3 MPa to about 50 MPa, from about 3 MPa to about 35 MPa, from about 5 MPa to about 35 MPa, from about 10 MPa to about 35 MPa, from about 10 MPa to about 25 MPa, from about 1 MPa to about 10 MPa, or any range or subrange therebetween.

In some embodiments, an ultimate elongation of the adhesive can be about 50% or more, about 75% or more, about 100% or more, about 300% or more, about 1,000% or less, about 700% or less, or about 400% or less. In some embodiments, an ultimate elongation of the adhesive can be in a range from about 50% to about 1,000%, from about 50% to about 750%, from about 75% to about 700%, from about 100% to about 700%, from about 300% to about 700%, from about 300% to about 400%, or any range or subrange therebetween.

In some embodiments, an elastic modulus of the adhesive can be about 1 MPa or more, about 10 MPa or more, about 25 MPa or more, about 40 MPa or more, about 100 MPa or less, about 75 MPa or less, or about 60 MPa or less. In some embodiments, an elastic modulus of the adhesive can be in a range from about 1 MPa to about 100 MPa, from about 1 MPa to about 75 MPa, from about 10 MPa to about 75 MPa, from about 25 MPa to about 75 MPa, from about 25 MPa to about 60 MPa, from about 40 MPa to about 60 MPa, or any range or subrange therebetween.

Haze and transmittance of the adhesives can be evaluated as included in a shattered pane. The shattered pane (described below) can comprise the adhesive positioned between at least an adjacent pair of the plurality of shattered pieces comprising the shattered pane. As used herein, the transmittance and haze of the adhesive included in an apparatus comprising the shattered pane comprises the shattered pane comprising a 1 mm thick glass-based substrate comprising Composition 1 (see below) and a second material comprising a thickness of 75 μm comprising the material listed in parenthesis. Unless indicated otherwise, the second material comprises KrystalFlex PESOS available from Huntsman for measuring the transmittance and haze of the adhesive included in an apparatus comprising the shattered pane. In some embodiments, the average transmittance of the adhesive included in an apparatus comprising the shattered pane can be about 80% or more, about 85% or more, about 90% or more, about 99% or less, about 95% or less, or about 93% or less. In some embodiments, the average transmittance of the adhesive included in an apparatus comprising the shattered pane can be in a range from about 80% to about 99%, from about 85% to about 99%, from about 85% to about 95%, from about 90% to about 95%, from about 90% to about 93%, or any range or subrange therebetween. In some embodiments, the haze of the adhesive included in an apparatus comprising the shattered pane can be about 40% or less, about 35% or less, about 30% or less, about 25% or less, about 0.1% or more, about 1% or more, about 5% or more, about 10% or more or about 20% or more. In some embodiments, the haze of the adhesive included in an apparatus comprising the shattered pane can be in a range from about 0.1% to about 40%, from about 1% to about 40%, from about 1% to about 35%, from about 5% to about 35%, from about 5% to about 30%, from about 10% to about 30%, from about 10% to about 25%, from about 20% to about 25%, or any range or subrange therebetween.

The adhesive described above can be formed as the product of curing a composition. Methods of forming the adhesive described above will now be described.

Methods of forming the adhesive can comprise creating a composition. In some embodiments, the composition can comprise a silane-hydride-terminated siloxane. Exemplary embodiments of silane-hydride-terminated siloxanes include phenylmethylsiloxane (e.g., HPM-502 (Gelest)) and poly(phenylmethylsiloxane) (e.g., PMS-H11 (Gelest)). In some embodiments, the composition can comprise the silane-hydride terminated siloxane in a weight % (wt %) of about 10% or more, about 20% or more, about 25 wt % or more, about 27 wt %, about 29 wt % or more, about 35 wt % or less, about 33 wt % or less, or about 31 wt % or less. In some embodiments, the composition can comprise the silane-hydride terminated siloxane in a weight % (wt %) ranging from about 10 wt % to about 35 wt %, from about 20 wt % to about 35 wt %, from about 25 wt % to about 35 wt %, from about 25 wt % to about 33 wt %, from about 27 wt % to about 33 wt %, from about 27 wt % to about 31 wt %, from about 29 wt % to about 31 wt %, or any range or subrange therebetween.

In some embodiments, the composition can comprise a vinyl-terminated siloxane. In some embodiments, the vinyl-terminated siloxane can comprise three or more vinyl-terminated ends, for example, a vinyl T-structure siloxane polymer (e.g., MTV-112 (Gelest)). In some embodiments, the vinyl-terminated siloxane can comprise a short (e.g., 10 carbons or less), vinyl-terminated alkyl chain, for example, vinyltrimethoxysilane. In some embodiments, the vinyl-terminated siloxane can comprise a copolymer, including terpolymers. In further embodiments, the vinyl-terminated siloxane copolymer can comprise a copolymer comprising diphenyl siloxane and/or a copolymer comprising dimethyl siloxane. Exemplary embodiments of vinyl-terminated siloxane copolymers include vinyl-terminated dimethylsiloxane copolymer (e.g., PDV-2331 (Gelest)) and a vinyl-methylsiloxane-phenylmethylsiloxane-dimethylsiloxane terpolymer (e.g., VPT-1323 (Gelest). In some embodiments, the composition can comprise the vinyl-terminated siloxane in a weight % (wt %) of about 65 wt % or more, about 67 wt % or more, about 69 wt % or more, about 90 wt % or less, about 80 wt % or less, about 75% or less, about 73% or less, or about 71% of less. In some embodiments, the composition can comprise the vinyl-terminated siloxane in a weight % (wt %) ranging from about 65 wt % to about 90 wt %, from about 65 wt % to about 80 wt %, from about 65 wt % to about 75 wt %, from about 67 wt % to about 75 wt %, from about 67 wt % to about 73 wt %, from about 69 wt % to about 73 wt %, from about 69 wt % to about 71 wt %, or any range or subrange therebetween.

In some embodiments, the composition can comprise a thiol-containing siloxane. An exemplary embodiment of a thiol-containing siloxane includes (mercaptopropyl)methylsiloxane (e.g., SMS 922 (Gelest)). In some embodiments, the composition can comprise the thiol-containing siloxane in a weight % (wt %) of about 10 wt % or more, about 20 wt % or more, about 25 wt % or more, about 27 wt %, about 29 wt % or more, about 35 wt % or less, about 33 wt % or less, or about 31 wt % or less. In some embodiments, the composition can comprise the thiol-containing siloxane in a weight % (wt %) ranging from about 10 wt % to about 35 wt %, from about 20 wt % to about 35 wt %, from about 25 wt % to about 35 wt %, from about 25 wt % to about 33 wt %, from about 27 wt % to about 33 wt %, from about 27 wt % to about 31 wt %, from about 29 wt % to about 31 wt %, or any range or subrange therebetween. In some embodiments, the composition can comprise the thiol-containing siloxane in a weight % (wt %) of about 90 wt % or more, about 95 wt % or more, 98 wt % or more, or 100 wt % or less. In some embodiments, the composition can comprise the thiol-containing siloxane in a weight % (wt %) in a range from about 10 wt % to 100 wt %, from about 25 wt % to 100 wt %, from about 90 wt % to 100 wt %, from about 95 wt % to 100 wt %, from about 98 wt % to 100 wt %, or any range or subrange therebetween.

In some embodiments, the composition can comprise a silane coupling agent. In further embodiments, the silane coupling agent can comprise 3-mercaptopropyltrimethoxysilane, (3-mercaptopropyl)methyldimethoxysilane, tertaethylorthosilicate, tetraethylmethoxysilane, 3-mercaptopropyltriethoxysilane, (3-mercaptopropyl)methyldiethoxysilane, tertaethylorthosilicate, and/or tetraethylethoxysilane. An exemplary embodiment of the silane coupling agent comprises 3-mercaptopropyltrimethoxysilane. In some embodiments, the composition can comprise the silane coupling agent in a weight % (wt %) of about 0.1 wt % or more, about 0.2 wt % or more, about 0.5 wt % or more, about 5 wt % or less, about 2 wt % or less, or about 1 wt % or less. In some embodiments, the composition can comprise the silane coupling agent in a weight % (wt %) ranging from about 0.1 wt % to about 5 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween.

In some embodiments, the composition can comprise a photo-initiator. The photo-initiator can comprise one or more of the photo-initiators discussed above with regards to the composition for the polymer-based portion. Exemplary embodiments of photo-initiators include acetophenone-based compounds, for example, dimethoxyphenyl acetophenone. In some embodiments, the composition can comprise the photo-initiator in a weight % (wt %) of about 0.1 wt % or more, about 0.2 wt % or more, about 0.5 wt % or more, about 3 wt % or less, about 2 wt % or less, or about 1 wt % or less. In some embodiments, the composition can comprise the silane coupling agent in a weight % (wt %) ranging from about 0.1 wt % to about 3 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween.

In some embodiments, the composition can comprise a catalyst. In some embodiments, the catalyst can comprise one or more platinum group metals, for example, ruthenium, rhodium, palladium, osmium, iridium, and/or platinum. In some embodiments, the catalyst can comprise a platinum-based Karstedt's catalyst solution. Exemplary embodiments of platinum-based catalysts include chloroplatinic acid, platinum-fumarate, colloidal platinum, metallic platinum, and/or platinum-nickel nanoparticles. In some embodiments, the composition can comprise the photo-initiator in a weight % (wt %) of about 0.1 wt % or more, about 0.2 wt % or more, about 0.5 wt % or more, about 3 wt % or less, about 2 wt % or less, or about 1 wt % or less. In some embodiments, the composition can comprise the silane coupling agent in a weight % (wt %) ranging from about 0.1 wt % to about 3 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween.

In some embodiments, the composition can be substantially solvent-free. In further embodiments, the composition can be solvent-free. In even further embodiments, the composition can be entirely solvent-free. Providing a composition that is substantially solvent-free (e.g., entirely solvent-free) can reduce (e.g. decrease, eliminate) the use of additives, for example, rheology modifiers, and increase composition homogeneity, which can improve the quality of the resulting adhesive (e.g., increased transmittance, decreased haze, increased mechanical properties).

Methods of forming the adhesive can comprise curing the composition to form the adhesive. In some embodiments, curing the composition to form the adhesive can comprise heating, ultraviolet (UV) irradiation, and/or waiting for a predetermined period of time. In some embodiments where the composition comprises a photo-initiator, curing can comprise irradiating the composition with at least one wavelength of light that the photo-initiator is sensitive to. In some embodiments, the irradiating can comprise impinging the composition with a light beam emitted from a light source. In further embodiments, the light source can be configured to emit a light beam comprising an ultra-violet (UV) wavelength or a visible wavelength. In even further embodiments, the wavelength of the light beam can be in a range from about 10 nm to about 400 nm, from about 100 nm to about 400 nm, from about 200 nm to about 400 nm, from about 10 nm to about 300 nm, from about 100 nm to about 300 nm, from about 200 nm to about 300 nm, from about 10 nm to about 200 nm, from about 100 nm to about 200 nm, or any range or subrange therebetween. In even further embodiments, an operating wavelength range of the light source may be over a range of optical wavelengths from about 315 nm to about 400 nm, from about 280 nm to about 315 nm, from about 100 nm to about 280 nm, or from 122 nm to about 200 nm. In even further embodiments, the wavelength of the light beam can be in a range from about 300 nm to about 1,000 nm, from about 350 nm to about 900 nm, from about 400 to about 800 nm, from about 500 nm to about 700 nm, or any range or subrange therebetween. In still further embodiments, the wavelength of the light beam can be about 365 nm, about 415 nm, or about 590 nm.

In some embodiments, curing can comprise heating the composition at a temperature for a time. In further embodiments, the temperature can be about 80° C. or more, about 100° C. or more, about 120° C. or more, about 140° C. or more, about 250° C. or less, about 200° C. or less, about 180° C. or less, or about 160° C. or less. In further embodiments, the temperature can be in a range from about 80° C. to about 250° C., from about 80° C. to about 200° C., from about 100° C. to about 200° C., from about 100° C. to about 180° C., from about 120° C. to about 180° C., from about 120° C. to about 160° C., from about 140° C. to about 160° C., or any range or subrange therebetween. In further embodiments, the time can be about 15 minutes or more, about 30 minutes or more, 1 hour or more about 12 hours or less, about 6 hours or less, about 3 hours or less, or about 2 hours or less. In further embodiments, the time can be in a range from about 15 minutes to about 12 hours, from about 15 minutes to about 6 hours, from about 15 minutes to about 3 hours, from about 30 minutes to about 3 hours, from about 1 hour to about 3 hours, from about 1 hour to about 2 hours, or any range or subrange therebetween.

In some embodiments, curing the composition to form the adhesive can result in a volume change of the adhesive relative the composition. In further embodiments, a magnitude of a difference of the volume the adhesive relative the composition as a percentage of the volume of the composition can be about 5% or less, about 2% or less, about 1% or less, about 0.5% or less, about 0.1% or less, about 0.01% or more, about 0.1% or more, about 0.5% or more, about 1% or more. In further embodiments, a magnitude of a difference of the volume the adhesive relative the composition as a percentage of the volume of the composition can be in a range from 0% to about 5%, from 0% to about 2%, from 0% to about 1%, from 0.01% to about 1%, from about 0.1% to about 1%, from about 0.5% to about 1%, from about 0.01% to about 5%, from about 0.01% to about 2%, from about 0.1% to about 2%, from about 0.5% to about 2%, or any range or subrange therebetween.

It is to be understood that any of the above ranges for the above-mentioned components can be combined in embodiments of the disclosure. Example ranges of some embodiments of the disclosure are presented in Table 2. R10 and R13 are the broadest of the ranges in Table 2 while R12, R14, and R16 are the narrowest ranges of the ranges in Table 2. R11 and R15 represent intermediate ranges. R10-R13 comprise a silane-hydride-terminated siloxane, R10-12 and R15-R16 comprise a vinyl-terminated siloxane, R13-R16 comprise a thiol-containing siloxane, and R13 can optionally include a vinyl-terminated siloxane. Again, it is to be understood that other ranges or subranges discussed above for these components can be used in combination with any of the ranges presented in Table 2.

TABLE 2
Composition ranges (wt %) of embodiments
of polymer-based portions

| Range | R10 | R11 | R12 | R13 | R14 | R15 | R16 |
|---|---|---|---|---|---|---|---|
| Silane- | 10-35 | 25-35 | 10-25 | 0 | 0 | 0 | 0 |
| hydride- | | | | | | | |
| terminated | | | | | | | |
| Siloxane | | | | | | | |
| Vinyl- | 65-90 | 65-75 | 75-90 | 0-90 | 0 | 65-90 | 65-75 |
| terminated | | | | | | | |
| Siloxane | | | | | | | |
| Thiol- | 0 | 0 | 0 | 10-100 | 90-100 | 10-35 | 25-35 |
| containing | | | | | | | |
| Siloxane | | | | | | | |
| Photo- | 0-3 | 0-3 | 0-3 | 0-3 | 0-3 | 0-3 | 0-3 |
| initiator | | | | | | | |
| Catalyst | 0-3 | 0-3 | 0-3 | 0-3 | 0-3 | 0-3 | 0-3 |
| Silane | 0-5 | 0-5 | 0-5 | 0-5 | 0-5 | 0-5 | 0-5 |
| Coupling | | | | | | | |
| Agent | | | | | | | |

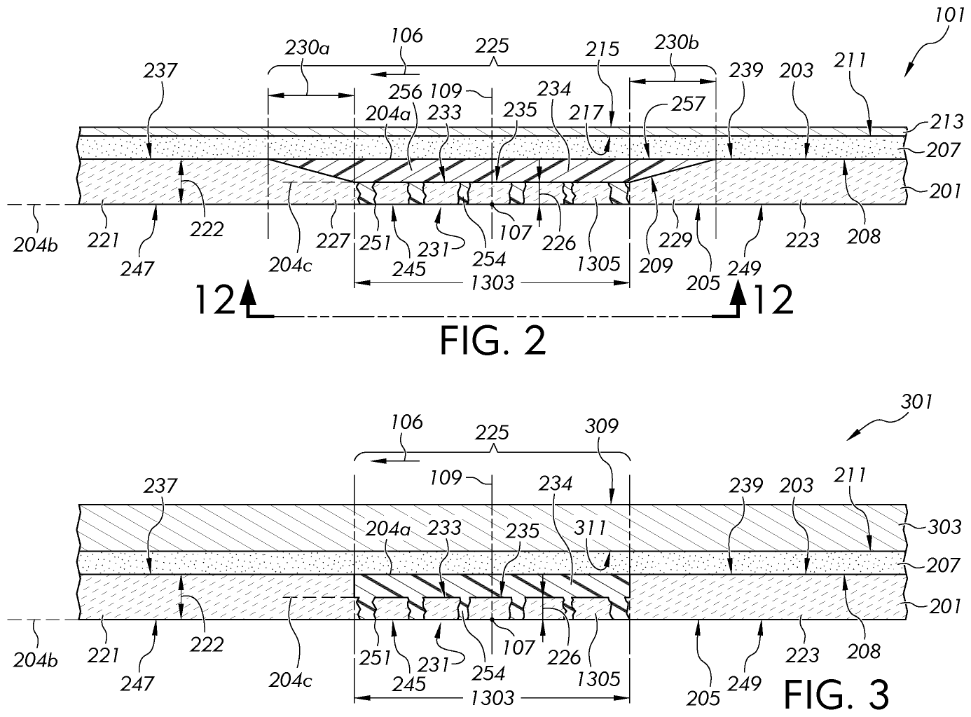

FIGS. 1-10 and 17-18 schematically illustrate example embodiments of foldable apparatus 101, 301, 401, 501, 601, 701, 801, 901, 1001, 1701, and 1801 illustrated in FIGS. 1-10 and 17-18. in accordance with embodiments of the disclosure in an unfolded (e.g., flat) configuration while FIGS. 13-15, and 24 demonstrate a foldable apparatus 1402, 1501, and 2401 or a foldable test apparatus 1101 in accordance with embodiments of the disclosure in a folded configuration. As shown in FIGS. 2-10 and 17-18, the foldable apparatus 101, 301, 401, 501, 601, 701, 801, 901, 1001, 1701, and 1801 can comprise a foldable substrate 201 or 803 comprising a first portion 221 and a second portion 223. As shown in FIGS. 2-4, 6-7, 9-10, and 17-18, the foldable apparatus 101, 301, 401, 601, 701, 901, 1001, 1701, and 1801 can further comprise a central portion 225 attaching the first portion 221 to the second portion 223.

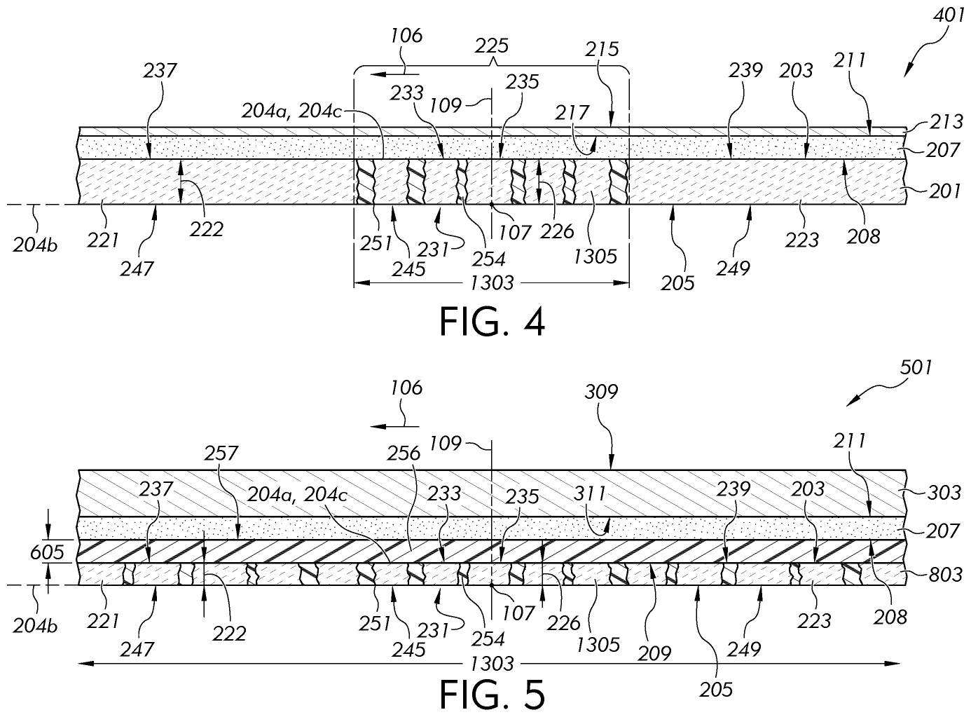

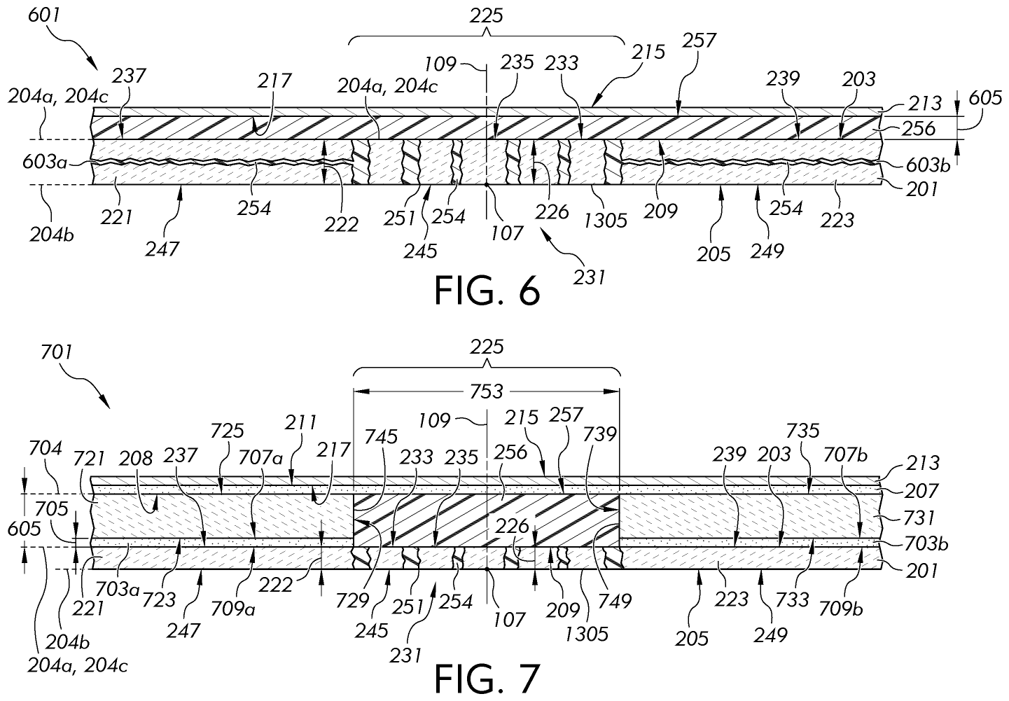

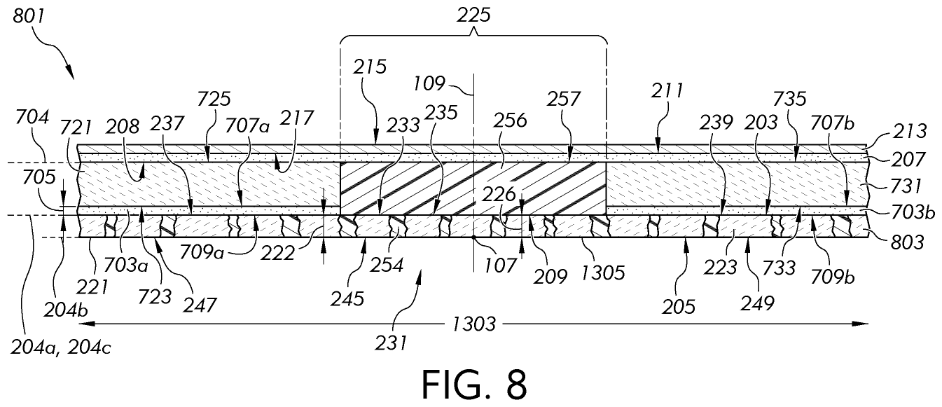

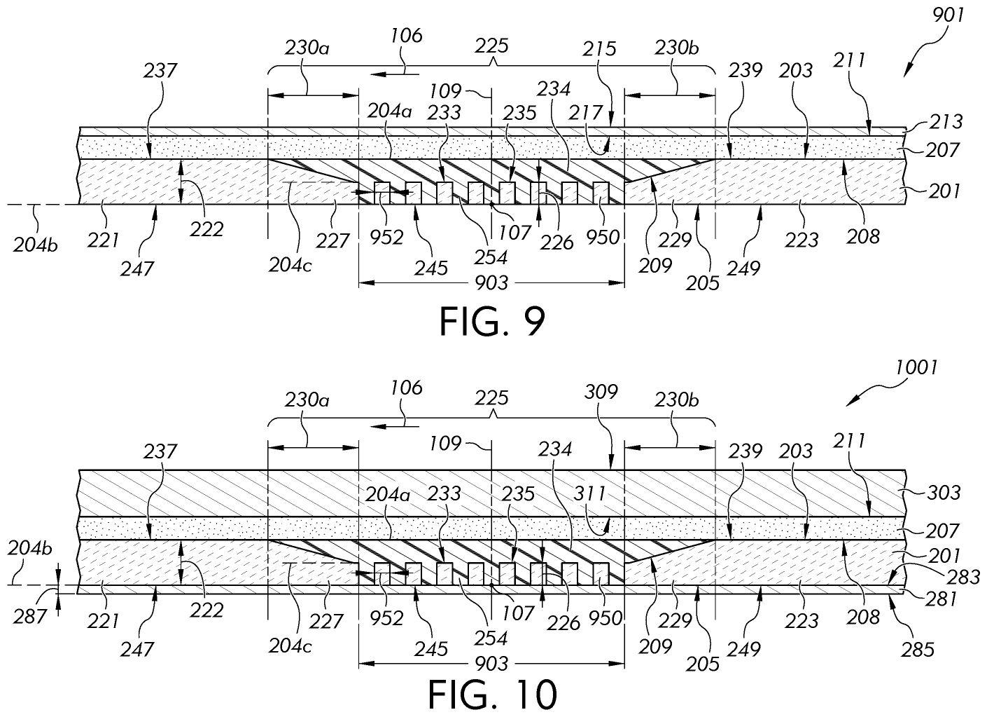

In some embodiments, as shown in FIGS. 2-4 and 6-7, the central portion 225 can comprise a shattered pane 231 that may not extend in the first portion 221 and/or the second portion 223. For example, in some embodiments, as shown in FIGS. 2-4 and 6-7, the first portion 221 and the second portion 223 may not be shattered. In further embodiments, as shown in, the central portion 225 can comprise the shattered pane 231 that can extend to at least a portion of the first portion 221 and/or the second portion 223. For example, as shown in FIGS. 5 and 8, the entire foldable substrate 803 including the entire first portion 221 and the entire second portion 223 may comprise the shattered pane 231 although less than the entire central portion 225, less than the entire first portion 221 and/or less than the entire second portion 223 may comprise the shattered pane 231 in further embodiments. In some embodiments, as shown in FIG. 6, the first portion 221 and/or the second portion 223 can comprise cracks 603a, 603b internal to the foldable substrate 201. As illustrated in FIG. 6, the first portion 221 and the second portion 223 are not illustrated as comprising the shattered pane 231 since the cracks 603a, 603b do not comprise nor intersect a first major surface 203 or a second major surface 205 of the foldable substrate 201 and are therefore internal to the foldable substrate. In some embodiments, as shown in FIGS. 9-10, the central portion 225 can comprise a plurality of panes 950. In some embodiments, as shown in FIG. 18, the central portion 225 can comprise a plurality of cracks 1821. In further embodiments, as shown, the foldable apparatus 1801 can comprise a first plurality of cracks 1831 and/or a second plurality of cracks 1833 positioned outside of the central portion 225. In some embodiments, as shown in FIGS. 2-3, 9-10, 13-15, and 17, the central portion 225 can comprise a recess 234 or 1709.

In some embodiments, as shown in FIGS. 2-3, 9-10, and 13-15, the foldable apparatus 101, 301, 901, 1001, 1402, and 1501 or the foldable test apparatus 1101 can comprise a central thickness 226 less than a first thickness 222 of the first portion 221. In some embodiments, as shown in FIGS. 4-8, the foldable apparatus 401, 501, 601, 701, and 801 can comprise a central thickness 226 substantially equal to the first thickness 222 of the first portion 221. In further embodiments, as shown in FIG. 2, the foldable apparatus 101 can comprise a first transition portion 227 attaching the first portion 221 to the shattered pane 231 and/or a second transition portion 229 attaching the second portion 223 to the shattered pane 231. In further embodiments, as shown in FIG. 9, the foldable apparatus 901 can comprise a first transition portion 227 attaching the first portion 221 to the plurality of panes 950 and/or a second transition portion 229 attaching the second portion 223 to the plurality of panes 950. As shown in FIGS. 2-8 and 13-14, the foldable apparatus 101, 301, 401, 501, 601, 701, 801, and 1402 or the foldable test apparatus 1101 can comprise a first material 254 attaching a pair of shattered pieces of a plurality of shattered pieces 1305 comprising the shattered pane 231. In some embodiments, as shown in FIGS. 2, 5-8, and 13, the foldable apparatus 101, 501, 601, 701, and 801 or the foldable test apparatus 1101 can further comprise a second material 256. In further embodiments, as shown in FIGS. 7-8, the foldable apparatus 701 and 801 can comprise the second material 256 at least partially positioned between a first substrate 721 and a second substrate 731. In some embodiments, as shown in FIGS. 9-10 and 15, the foldable apparatus 901, 1001, and 1501 can comprise a first material 254 attaching a pair of panes 950 of the plurality of panes, although the second material can replace the first material in other embodiments.

In some embodiments, as shown in FIGS. 2, 4, 6-9, the foldable apparatus 101, 401, 601, 701, 801, and 901 can comprise a release liner 213 although other substrates may be used in further embodiments rather than the illustrated release liner 213. In some embodiments, as shown in FIGS. 3, 5, 10, and 14-15, the foldable apparatus 301, 501, 1001, 1402, and 1501 can comprise a display device 303. It is to be understood that any of the foldable apparatus of the disclosure can comprise a second substrate, a release liner 213, and/or a display device 303. Further, the foldable apparatus of the disclosure can comprise a second substrate, a release liner and/or a display device disposed over either major surface of the foldable substrate of the foldable apparatus.

Throughout the disclosure, with reference to FIG. 1, a width 103 of the foldable apparatus is considered the dimension of the foldable apparatus taken between opposed edges of the foldable apparatus in a direction 104 of a fold axis 102 of the foldable apparatus. Furthermore, throughout the disclosure, the length 105 of the foldable apparatus is considered the dimension of the foldable apparatus taken between opposed edges of the foldable apparatus in a direction 106 perpendicular to the fold axis 102 of the foldable apparatus.

Foldable apparatus 101, 301, 401, 501, 601, 701, 801, 901, 1001, 1402, 1501, 1701, and 1801 the disclosure can comprise a foldable substrate 201 or 803. In some embodiments, the foldable substrate 201 or 803 can comprise a glass-based substrate and/or a ceramic-based substrate having a pencil hardness of 8H or more, for example, 9H or more.

In some embodiments, the foldable substrate 201 or 803 can comprise a glass-based substrate. As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion-exchange of larger ions for smaller ions in the surface of the substrate, as discussed below. However, other strengthening methods known in the art, for example, thermal tempering, or utilizing a mismatch of the coefficient of thermal expansion between portions of the substrate to create compressive stress and central tension regions, may be utilized to form strengthened substrates. Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. In one or more embodiments, a glass-based material may comprise, in mole percent (mol %): SiO₂ in a range from about 40 mol % to about 80%, Al₂O₃ in a range from about 5 mol % to about 30 mol %, B₂O₃ in a range from 0 mol % to about 10 mol %, ZrO₂ in a range from 0 mol % to about 5 mol %, P₂O₅ in a range from 0 mol % to about 15 mol %, TiO₂ in a range from 0 mol % to about 2 mol %, R₂O in a range from 0 mol % to about 20 mol %, and RO in a range from 0 mol % to about 15 mol %. As used herein, R₂O can refer to an alkali metal oxide, for example, Li₂O, Na₂O, K₂O, Rb₂O, and Cs₂O. As used herein, RO can refer to MgO, CaO, SrO, BaO, and ZnO. In some embodiments, a glass-based substrate may optionally further comprise in a range from 0 mol % to about 2 mol % of each of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, Mn₂O₇. “Glass-ceramics” include materials produced through controlled crystallization of glass. In some embodiments, glass-ceramics have about 1% to about 99% crystallinity. Examples of suitable glass-ceramics may include Li₂O—Al₂O₃—SiO₂ system (i.e. LAS-System) glass-ceramics, MgO—Al₂O₃—SiO₂ system (i.e. MAS-System) glass-ceramics, ZnO×Al₂O₃×nSiO₂ (i.e. ZAS system), and/or glass-ceramics that include a predominant crystal phase including β-quartz solid solution, β-spodumene, cordierite, petalite, and/or lithium disilicate. The glass-ceramic substrates may be strengthened using the chemical strengthening processes. In one or more embodiments, MAS-System glass-ceramic substrates may be strengthened in Li₂SO₄ molten salt, whereby an exchange of 2Li⁺ for Mg²⁺ can occur.

In some embodiments, the foldable substrate 201 or 803 can comprise a ceramic-based substrate. As used herein, “ceramic-based” includes both ceramics and glass-ceramics, wherein glass-ceramics have one or more crystalline phases and an amorphous, residual glass phase. Ceramic-based materials may be strengthened (e.g., chemically strengthened). In some embodiments, a ceramic-based material can be formed by heating a glass-based material to form ceramic (e.g., crystalline) portions. In further embodiments, ceramic-based materials may comprise one or more nucleating agents that can facilitate the formation of crystalline phase(s). In some embodiments, the ceramic-based materials can comprise one or more oxide, nitride, oxynitride, carbide, boride, and/or silicide. Example embodiments of ceramic oxides include zirconia (ZrO₂), zircon zirconia (ZrSiO₄), an alkali metal oxide (e.g., sodium oxide (Na₂O)), an alkali earth metal oxide (e.g., magnesium oxide (MgO)), titania (TiO₂), hafnium oxide (Hf₂O), yttrium oxide (Y₂O₃), iron oxide, beryllium oxide, vanadium oxide (VO₂), fused quartz, mullite (a mineral comprising a combination of aluminum oxide and silicon dioxide), and spinel (MgAl₂O₄). Example embodiments of ceramic nitrides include silicon nitride (Si₃N₄), aluminum nitride (AlN), gallium nitride (GaN), beryllium nitride (Be₃N₂), boron nitride (BN), tungsten nitride (WN), vanadium nitride, alkali earth metal nitrides (e.g., magnesium nitride (Mg₃N₂)), nickel nitride, and tantalum nitride. Example embodiments of oxynitride ceramics include silicon oxynitride, aluminum oxynitride, and a SiAlON (a combination of alumina and silicon nitride and can have a chemical formula, for example, Si_{12°m°n}Alₘ₊ₙOₙN₁₆₋ₙ, Si₆₋ₙAlₙOₙN₈₋ₙ, or Si₂₋ₙAlₙO₁₊ₙN₂₋ₙ, where m, n, and the resulting subscripts are all non-negative integers). Example embodiments of carbides and carbon-containing ceramics include silicon carbide (SiC), tungsten carbide (WC), an iron carbide, boron carbide (B₄C), alkali metal carbides (e.g., lithium carbide (Li₄C₃)), alkali earth metal carbides (e.g., magnesium carbide (Mg₂C₃)), and graphite. Example embodiments of borides include chromium boride (CrB₂), molybdenum boride (Mo₂B₅), tungsten boride (W₂B₅), iron boride, titanium boride, zirconium boride (ZrB₂), hafnium boride (HfB₂), vanadium boride (VB₂), Niobium boride (NbB₂), and lanthanum boride (LaB₆). Example embodiments of silicides include molybdenum disilicide (MoSi₂), tungsten disilicide (WSi₂), titanium disilicide (TiSi₂), nickel silicide (NiSi), alkali earth silicide (e.g., sodium silicide (NaSi)), alkali metal silicide (e.g., magnesium silicide (Mg₂Si)), hafnium disilicide (HfSi₂), and platinum silicide (PtSi).

FIGS. 2-10 and 17-18 schematically illustrate example embodiments of foldable apparatus 101, 301, 401, 501, 601, 701, 801, 901, 1001, 1701, and 1801 in accordance with embodiments of the disclosure in an unfolded (e.g., flat) configuration. As shown in FIGS. 2-10 and 17-18, the foldable substrate 201 or 803 can comprise a first major surface 203 and a second major surface 205 opposite the first major surface 203. As shown in, the first major surface 203 can extend along a first plane (e.g., first plane 204a), and/or the second major surface 205 can extend along a second plane (e.g., second plane 204b). In some embodiments, as shown, the second plane 204b can be parallel to the first plane 204a. The first thickness 222 (e.g., see FIGS. 2-10) can be defined between the first plane 204a and the second plane 204b of the foldable substrate 201 or 803. In some embodiments, the first thickness 222 can be in a range from about 10 μm to about 2 mm, from about 20 μm to about 2 mm, from about 40 μm to about 2 mm, from about 40 μm to about 1 mm, from about 60 μm to about 1 mm, about 80 μm to about 1 mm, from about 80 μm to about 500 μm, from about 80 μm to about 300 μm, from about 200 μm to about 2 mm, from about 200 μm to about 1 mm, from about 200 μm to about 500 μm, from about 10 μm to about 200 μm, from about 10 μm to about 100 μm, from about 20 μm to about 100 μm, from about 40 μm to about 100 μm, or any range or subrange therebetween. Based on results from the Pen Drop Test (discussed below with reference to FIG. 16), increased puncture resistance can be achieved by selecting thicknesses of the foldable substrate that is greater than about 80 micrometers (μm). In some embodiments, the first thickness 222 can be in a range from about 80 μm to about 2 mm, from about 80 μm to about 1 mm, from about 80 μm to about 500 μm, from about 80 μm to about 300 μm, from about 200 μm to about 2 mm, from about 200 μm to about 1 mm, from about 200 μm to about 500 μm, from about 500 μm to about 2 mm, from about 500 μm to about 1 mm, or any range or subrange therebetween.

As shown in FIGS. 2-10 and 17-18, the first portion 221 of the foldable substrate 201 or 803 can comprise a first glass-based portion. In some embodiments, the first portion 221 can comprise a first ceramic-based portion. The first portion 221 can comprise a first surface area 237 of the first major surface 203 of the foldable substrate 201 or 803. As shown, the first portion 221 of the foldable substrate 201 or 803 can also comprise a second surface area 247 of the second major surface 205 of the foldable substrate 201 or 803. In some embodiments, as shown in FIGS. 2-10, the first portion 221 can comprise a thickness substantially equal to the first thickness 222. In some embodiments, the thickness of the first portion 221 may be substantially uniform across a corresponding length 105 of the foldable apparatus 101 (see FIG. 1) and/or a corresponding width 103 of the foldable apparatus 101 (see FIG. 1).

As further shown in FIGS. 2-10 and 17-18, the second portion 223 can comprise a second glass-based portion. In some embodiments, the second portion 223 can comprise a second ceramic-based portion. As shown in FIGS. 2-10 and 17, the second portion 223 can comprise a third surface area 239 of the first major surface 203 of the foldable substrate 201 or 803. As shown in FIGS. 2-10 and 17-18, the second portion 223 of the foldable substrate 201 or 803 can also comprise a fourth surface area 249 of the second major surface 205 of the foldable substrate 201 or 803.

As shown in FIGS. 2-10, the second portion 223 can comprise a thickness substantially equal to the first thickness 222. In some embodiments, a thickness of the first portion 221 can be substantially equal to a thickness of the second portion 223. For example, the thickness of the first portion 221 and the thickness of the second portion 223 can be substantially equal to the first thickness 222. In some embodiments, the thickness of the second portion 223 may be substantially uniform across its corresponding length 105 and/or its corresponding width 103.

As also shown in FIGS. 2-10 and 17-18, the central portion 225 can comprise a central glass-based portion. In further embodiments, the central portion 225 can comprise a central glass-based portion while the first portion 221 and the second portion 223 comprise corresponding ceramic-based portions. In further embodiments, the central portion 225, the first portion 221, and the second portion 223 can comprise corresponding glass-based portions. In some embodiments, the central portion 225 can comprise a central ceramic-based portion. In some embodiments, as shown in FIGS. 2-10, the central portion 225 can comprise a first central surface area 233 positioned between the first surface area 237 of the first major surface 203 and the third surface area 239 of the first major surface 203. The central thickness 226 of the central portion 225 can be defined between a second central surface area 245 and the first central surface area 233 of the central portion 225. In some embodiments, the central thickness 226 of the central portion 225 can be equal to the distance between the second plane 204b and the first central surface area 233 of the central portion 225. In some embodiments, the first central surface area 233 can comprise a central major surface 235 that may extend along a third plane 204c although the first central surface area 233 may be provided as a nonplanar area in further embodiments. Providing the central major surface 235 of the central portion 225 that extends along a third plane 204c parallel to the second plane 204b or coincident with the first plane 204a can provide a uniform central thickness 226 across the central portion 225 to provide enhanced bending performance at a predetermined thickness for the central thickness 226. A uniform central thickness 226 across the central portion 225 can improve bending performance by preventing stress concentrations that would occur if a portion of the central portion 225 was thinner than the rest of the central portion 225.

As discussed previously, as shown in FIGS. 2-10, the central thickness 226 can be equal to or less than the first thickness 222 of the first portion 221 of the foldable substrate 201 or 803. In some embodiments, as shown in FIGS. 4-8, the central thickness 226 can be substantially equal to (e.g., equal to) the first thickness 222. In some embodiments, as shown in FIGS. 2-3, 9-10, and 13-15, the central thickness 226 can be less than the first thickness 222. In some embodiments, the central thickness 226 can be about 0.5% or more, about 1% or more, about 2% or more, about 5% or more, about 13% or less, about 10% or less, or about 5% or less of the first thickness 222. In some embodiments, the central thickness 226 as a percentage of the first thickness 222 can be in a range from about 0.5% to about 13%, from about 1% to about 13%, from about 1% to about 10%, from about from about 2% to about 10%, from about 2% to about 5%, or any range or subrange therebetween. In further embodiments, the central thickness 226 can be within one or more of the ranges for the first thickness 222 while being less than the first thickness 222. In further embodiments, the central thickness 226 can be about 10 μm or more, about 25 μm or more, about 50 μm or more, about 80 μm or more, about 220 μm or less, about 125 μm or less, about 100 μm or less, about 60 μm or less, or about 40 μm or less. In even further embodiments, the central thickness 226 can be in a range from about 10 μm to about 220 μm, from about 25 μm to about 220 μm from about 50 μm to about 220 μm, from about 80 μm to about 220 μm, from about 100 μm to about 220 μm from about 125 μm to about 220 μm, from about 80 μm to about 125 μm, from about 80 μm to about 100 μm, or any range or subrange therebetween. Also, the test results of the unshattered substrate tested shown in FIG. 16 suggests that increased puncture resistance can be achieved in the central portion by selecting thicknesses of the foldable substrate that is less than about 50 micrometers (μm) or greater than about 80 μm based on results from the Pen Drop Test discussed below with reference to FIG. 16. In even further embodiments, the central thickness 226 can be greater than about 80 μm, for example, about 80 μm or more, about 100 μm or more, about 125 μm or more, about 220 μm or less, about 175 μm or less, or about 150 μm or less. In even further embodiments, the central thickness 226 can be in a range from about 80 μm to about 220 μm, from about 100 μm to about 220 μm, from about 100 μm to about 175 μm, from about 125 μm to about 175 μm, from about 125 μm to about 150 μm, or any range or subrange therebetween. In further embodiments, the central thickness 226 can be in a range from about 10 μm to about 60 μm, from about 25 μm to about 60 μm, from about 25 μm to about 50 μm, from about 10 μm to about 40 μm, from about 25 μm to about 40 μm, or any range or subrange therebetween. In even further embodiments, the central thickness 226 can be less than about 50 μm, for example, about 10 μm or more, about 25 μm or more, about 30 μm or more, about 50 μm or less, about 45 μm or less, or about 40. In even further embodiments, the central thickness 226 can be in a range from about 10 μm to about 50 μm, from about 10 μm to about 45 μm, from about 25 μm to about 45 μm, from about 30 μm to about 45 μm, from about 30 μm to about 40 μm or any range or subrange therebetween.

In some embodiments, as shown in FIGS. 2-3 and 9-10, a recess 234 can be defined between the first central surface area 233 and the first plane 204a. The central portion 225 can comprise the second central surface area 245 of the second major surface 205 positioned between the second surface area 247 of the second major surface 205 in the first portion 221 and the fourth surface area 249 of the second major surface 205 in the second portion 223. In some embodiments, as shown in FIGS. 2-3 and 9-10, a material can fill the recess 234. In further embodiments, as shown in FIGS. 3 and 9-10, the first material 254 can fill the recess 234. In further embodiments, as shown in FIG. 2, the second material 256 can fill the recess 234. In some embodiments, although not shown, the recess may not be totally filled, for example, to leave room for electronic devices and/or mechanical devices.

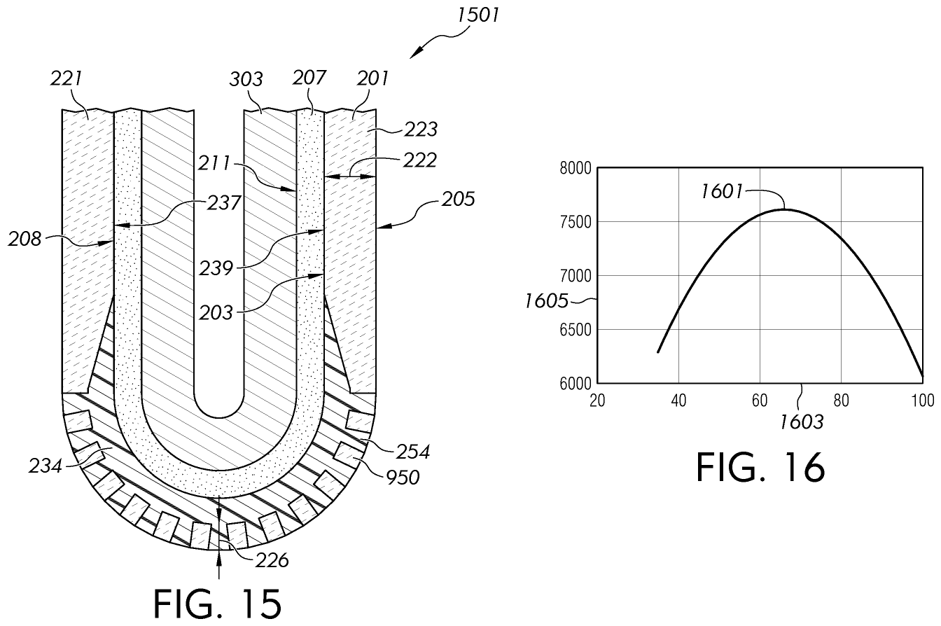

As shown in FIGS. 2 and 9-10, the central portion 225 can comprise a first transition portion 227 that can attach the first portion 221 to the shattered pane 231. Although not numbered, FIGS. 13-14 also show the first transition portion that can attach the first portion to the shattered pane. In some embodiments, as shown in FIGS. 9-10, the first transition portion 227 can attach the first portion 221 to the plurality of panes 950. Although not numbered, FIG. 15 also illustrates that the first transition portion can attach the first portion to the plurality of panes 950. A thickness of the first transition portion 227 can be defined between the first central surface area 233 and the first plane 204a. As shown in FIGS. 2 and 9-10, the thickness of the first transition portion 227 can continuously increase from the central thickness 226 (e.g., the shattered pane 231, the plurality of panes 950) at the first central surface area 233 to the first thickness 222 (e.g., the first portion 221) at the first plane 204a. In some embodiments, as shown, the thickness of the first transition portion 227 can increase at a constant rate from the central thickness 226 (e.g., the shattered pane 231, the plurality of panes 950) to first thickness 222 (e.g., the first portion 221). In some embodiments, although not shown, the thickness of the first transition portion 227 may increase more slowly where shattered pane 231 or plurality of panes 950 meets the first transition portion 227 than in the middle of the first transition portion 227. In some embodiments, although not shown, the thickness of the first transition portion 227 may increase more slowly where the first portion 221 meets the first transition portion 227 than in the middle of the first transition portion 227. In some embodiments, as shown in FIG. 3, the central portion may not comprise a first transition portion.

As shown in FIGS. 2 and 9-10, the central portion 225 can comprise a second transition portion 229 that can attach the second portion 223 to the shattered pane 231. Although not numbered, FIGS. 13-14 also shows the second transition portion that can attach the first portion to the shattered pane. In some embodiments, as shown in FIGS. 9-10, the second transition portion 229 can attach the second portion 223 to the plurality of panes 950. A thickness of the second transition portion 229 can be defined between the first central surface area 233 and the first plane 204a. As shown in FIGS. 2 and 9-10, the thickness of the second transition portion 229 can continuously increase from the central thickness 226 (e.g., the shattered pane 231, the plurality of panes 950) at the first central surface area 233 to first thickness 222 (e.g., the second portion 223) at the first plane 204a. In some embodiments, as shown, the thickness of the second transition portion 229 can increase at a constant rate from the central thickness 226 (e.g., the shattered pane 231, the plurality of panes 950) to first thickness 222 (e.g., the second portion 223). In some embodiments, although not shown, the thickness of the second transition portion 229 may increase more slowly where the shattered pane 231 or the plurality of panes 950 meets the second transition portion 229 than in the middle of the second transition portion 229. In some embodiments, although not shown, the thickness of the second transition portion 229 may increase more slowly where the second portion 223 meets the second transition portion 229 than in the middle of the second transition portion 229. In some embodiments, as shown in FIG. 3, the central portion may not comprise a second transition portion.

A width 230a of the first transition portion 227 can be defined between the shattered pane 231 or the plurality of panes 950 and the first portion 221 in the direction 106 of the length 105 of the foldable apparatus. A width 230b of the second transition portion 229 can be defined between the shattered pane 231 or the plurality of panes 950 and the second portion 223 in the direction 106 of the length 105 of the foldable apparatus. In some embodiments, the width 230a of the first transition portion 227 and/or the width 230b of the second transition portion 229 can be sufficiently large (e.g., 1 mm or more) to avoid optical distortions that may otherwise occur at a step transition or small transition width (e.g., less than 1 mm) between the first and central thickness. In some embodiments, the width 230a of the first transition portion 227 and/or the width 230b of the second transition portion 229 can be reduced (e.g., 5 millimeters (mm) or less) to minimize the extent that the transition portions that have a thickness in the vicinity of 65 μm (e.g., in a range from about 50 μm to about 80 μm), thereby enhancing the puncture resistance of a larger area of the foldable substrate. In some embodiments, to enhance puncture resistance of the foldable substrate while also avoiding optical distortions, the width 230a of the first transition portion 227 and/or the width 230b of the second transition portion 229 can be about 1 mm or more, about 2 mm or more, about 3 mm or more, about 5 mm or less, about 4 mm or less, or about 3 mm or less. In some embodiments, the width 230a of the first transition portion 227 and/or the width 230b of the second transition portion 229 can be in a range from about 1 mm to about 5 mm, from about 1 mm to about 4 mm, from about 1 mm to about 3 mm, from about 2 mm to about 5 mm, from about 2 mm to about 4 mm, from about 2 mm to about 3 mm, or any range or subrange therebetween.

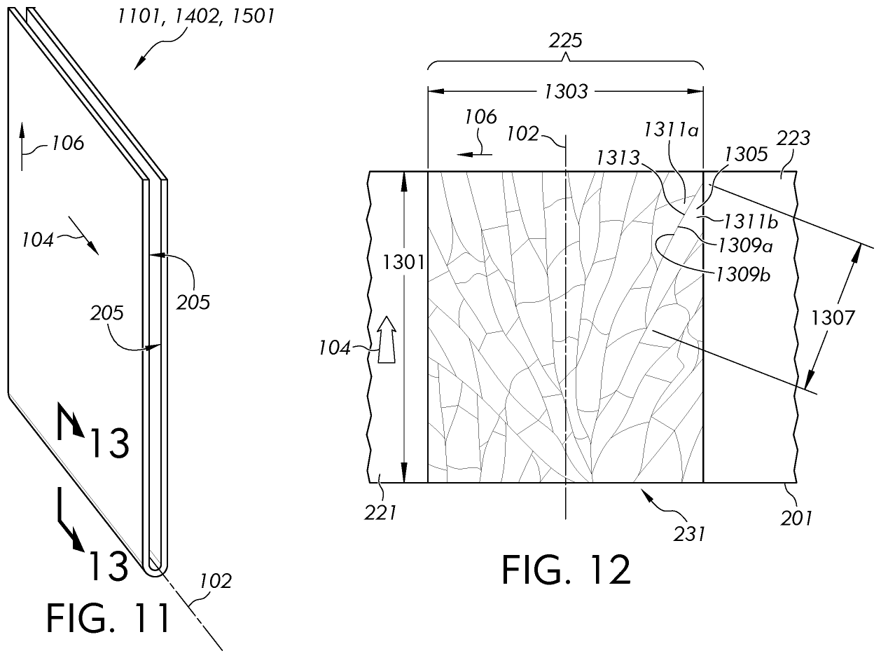

As mentioned previously, as shown in FIGS. 2-8 and 12-14, the foldable substrate 201 or 803 can comprise the shattered pane 231. As shown in FIG. 12, the shattered pane 231 can include a length 1301 extending in the direction 104 of the fold axis 102 of the foldable apparatus 101 and a width 1303 extending in the direction 106 perpendicular to the fold axis 102. The shattered pane 231 can comprise a plurality of shattered pieces 1305. One or more shattered pieces 1305 can be separated from another one or more shattered pieces 1305 by one or more cracks extending from the second major surface 205 to the first central surface area 233 while also extending through the second major surface 205 and the first central surface area 233. One or more shattered pieces 1305 of the plurality of shattered pieces 1305 can comprise a maximum dimension 1307 that is less than the length 1301 and less than the width 1303 of the shattered pane 231. In some embodiments, substantially all of the shattered pieces 1305 of the plurality of shattered pieces 1305 can comprise a maximum dimension 1307 that is less than the length 1301 and less than the width 1303 of the shattered pane 231. In some embodiments, the one or more shattered pieces 1305 that comprise a maximum dimension 1307 that is less than the length 1301 and less than the width 1303 of the shattered pane 231 can comprise 10% or more, 20% or more, 30% or more, 40% or more, 50% or more, 60% or more, 70% or more, 80% or more, 90% or more, or 100% of the plurality of shattered pieces 1305. In addition or alternatively, the one or more shattered pieces 1305 can comprise a maximum dimension 1307 that from about 0.1% to about 95%, from about 1% to about 95%, from about 1% to about 80%, from about 1% to about 60%, from about 1% to about 50%, from about 1% to about 40%, from about 1% to about 30%, from about 1% to about 20% and/or from about 1% to about 10% of the length 1301 and/or width 1303 of the shattered pane 231. In some embodiments, the one or more shattered pieces 1305 can comprise a minimum dimension measured perpendicular to the maximum dimension 1307. In further embodiments, the minimum dimension can be about 1 μm or more, about 10 μm or more, about 20 μm or more, about 30 μm or more, about 500 μm or less, about 200 μm or less, about 100 μm or less, or about 60 μm or less. In further embodiments, the minimum dimension can be in a range from about 1 μm to about 500 μm, from about 10 μm to about 500 μm, from about 10 μm to about 200 μm, from about 20 μm to about 200 μm, from about 20 μm to about 100 μm, from about 30 μm to about 100 μm, from about 30 μm to about 60 μm, from about 40 μm to about 60 μm, or any range or subrange therebetween. In some embodiments, one or more of the shattered pieces 1305 are not identical to one or more of the other shattered pieces 1305. For example, one or more shattered pieces 1305 may have a different maximum dimension 1307, a different number of sides, different major surface areas or other characteristics than one or more of the other shattered pieces 1305. Providing the shattered pane 231 with the above-described plurality of shattered pieces 1305 can help further reduce the effective minimum bend radii while providing good puncture and scratch resistance.

In some embodiments, a density of the plurality of shattered pieces 1305 in the shattered pane 231 can be about 5 pieces per square centimeter (pc/cm²) or more. As used herein, a density of shattered pieces is measured over a surface area (e.g., first central surface area, second central surface area) of the shattered pane comprising one of the first major surface, the second major surface, or the first central surface area of the foldable substrate, where the surface area is in a range from about 1 cm² to about 5 cm². As used herein, any portion of a shattered piece within the surface area measured counts as a whole shattered piece for the purposes of calculating the density of shattered pieces. In further embodiments, the shattered pane 231 can comprise at least a portion of the central portion 225 and the surface area can be at least a portion of the second central surface area 245.

In some embodiments, as shown in FIGS. 5 and 8, the first portion 221 of the foldable apparatus 501 and 801 can comprise the shattered pane 231. In further embodiments, as shown, at least a portion of the first portion 221 and the central portion 225 can comprise the shattered pane 231. In even further embodiments the first portion 221 can comprise one or more shattered pieces 1305 and the central portion 225 may comprise another one or more shattered pieces 1305. In even further embodiments, as shown, the shattered pane 231 can comprise the entire first portion 221 and the entire central portion 225. In even further embodiments, as shown, at least a portion of the first portion 221, the central portion 225, and the second portion 223 can comprise the shattered pane 231. In still further embodiments, as shown, the shattered pane 231 can comprise the entire first portion 221, the entire central portion 225, and the entire second portion 223. In further embodiments, although not shown, the central portion can comprise the shattered pane and the first portion can comprise a second shattered pane comprising a second plurality of shattered pieces. In even further embodiments, the one or more of the second plurality of shattered pieces can comprise a maximum dimension that is less than a length of the second shattered pane and less than the width of the second shattered pane.

In some embodiments, as shown in FIGS. 5 and 8, the second portion 223 of the foldable apparatus 501 and 801 can comprise the shattered pane 231. In further embodiments, as shown, at least a portion of the second portion 223 and the central portion 225 can comprise the shattered pane 231. In even further embodiments, the second portion 223 can comprise one or more shattered pieces 1305 and the central portion 225 can comprise another one or more shattered pieces 1305. In even further embodiments, as shown, the shattered pane 231 can comprise the entire second portion 223 and the entire central portion 225. In further embodiments, although not shown, the central portion can comprise the shattered pane and the second portion can comprise a third shattered pane comprising a third plurality of shattered pieces. In even further embodiments, the one or more of the third plurality of shattered pieces can comprise a maximum dimension that is less than a length of the third shattered pane and less than a width of the third shattered pane. In even further embodiments, the first portion can comprise the second shattered pane.

In some embodiments, a shattered piece of the plurality of shattered pieces 1305 of the foldable substrate 201 or 803 can comprise a glass-based material and/or a ceramic-based material. In some embodiments, an elastic modulus of a shattered piece of the plurality of shattered pieces 1305 of the foldable substrate 201 or 803 can be about 1 GigaPascal (GPa) or more, about 3 GPa or more, about 5 GPa or more, about 10 GPa or more, about 100 GPa or less, about 90 GPa or less, about 80 GPa or less, about 70 GPa or less, about 60 GPa or less, or about 20 GPa or less. In some embodiments, an elastic modulus of a shattered piece of the plurality of shattered pieces 1305 of the foldable substrate 201 or 803 can be in a range from about 1 GPa to about 100 GPa, from about 1 GPa to about 90 GPa, from about 1 GPa to about 80 GPa, from about 3 GPa to about 80 GPa, from about 3 GPa to about 70 GPa, from about 3 GPa to about 60 GPa, from about 5 GPa to about 60 GPa, from about 5 GPa to about 20 GPa, from about 10 GPa to about 20 GPa, or any range or subrange therebetween. In further embodiments, the shattered piece can comprise a glass-based portion or a ceramic-based portion comprising an elastic modulus in a range from about 10 GPa to about 100 GPa, from about 40 GPa to about 100 GPa, from about 60 GPa to about 100 GPa, from about 60 GPa to about 80 GPa, from about 60 GPa to about 70 GPa, from about 70 GPa to about 100 GPa, from about 80 GPa to about 100 GPa, from about 80 GPa to about 90 GPa, or any range or subrange therebetween.

The shattered pane 231 will now be described with reference to the foldable apparatus 101 of FIG. 2 with the understanding that such description of the shattered pane 231, unless otherwise stated, can also apply to the shattered panes of foldable apparatus 301, 401, 501, 601, 701, 801, and/or 1402 or the foldable test apparatus 1101 illustrated in FIGS. 3-8 and 13-14 as well as different shattered panes (e.g., second shattered pane, third shattered panes) and embodiments where the first portion 221 and/or the second portion 223 comprises the shattered pane (e.g., see FIGS. 5 and 8). Referring to FIG. 2, a pair of shattered pieces of the plurality of shattered pieces 1305 can be connected together by the first material 254 positioned between the pair of shattered pieces 1305. The first material 254 can comprise an elastic modulus that is less than an elastic modulus of a shattered piece 1305 of the plurality of shattered pieces of the shattered pane 231. Providing the shattered pieces 1305 can help provide the shattered pane 231 with increased durability, increased puncture resistance and scratch resistance than can be achieved by flexible material having a lower elastic modulus than the shattered pieces 1305. At the same time, attaching the shattered pieces 1305 of the shattered pane 231 together with the first material 254 having an elastic modulus that is less than the elastic modulus of the shattered piece 1305 can provide the shattered pane 231 with a degree of flexibility to allow a lower effective bend radius than can be achieved with a comparable pane that is not shattered and only comprised of the glass-based or ceramic-based material of the foldable substrate 201. In some embodiments, the elastic modulus of the first material 254 can be an order of magnitude less than the elastic modulus of the shattered piece 1305. Additionally, by providing a shattered pane with a plurality of shattered pieces attached together by a first material having an elastic modulus that is less than an elastic modulus of a shattered piece of the plurality of shattered pieces, a foldable substrate can limit the extent of damage to the foldable apparatus. For example, the damage resistance of the foldable apparatus may increase because damage to the foldable apparatus may be limited to a shattered piece impacted rather than the entire substrate. Additionally, the first material between pairs of shattered pieces can improve the ability of the foldable apparatus to absorb impacts without failure. Further, the net mechanical properties of the foldable apparatus can be adjusted by changing the relationship between the elastic modulus of the first material relative to the elastic modulus of a piece of the shattered pieces.

In some embodiments, a total mass of the first material 254 as a percentage of a total mass of the plurality of shattered pieces 1305 can be about 20% or less, about 15% or less, about 10% or less, about 8% or less, about 6% or less, about 5% or less, about 4% or less, about 2% or less, about 0.1% or more, about 0.5% or more, about 1% or more, about 2% or more, about 3% or more, or about 4% or more. In some embodiments, a total mass of the first material 254 as a percentage of a total mass of the plurality of shattered pieces 1305 can be in a range from about 0.1% to about 20%, from about 0.1% to about 15%, from about 0.5% to about 15%, from about 0.5% to about 10%, from about 1% to about 10%, from about 1% to about 8%, from about 2% to about 8%, from about 2% to about 6%, from about 3% to about 6%, from about 3% to about 5%, from about 4% to about 5%, or any range or subrange therebetween. In further embodiments, the total mass of the first material 254 as a percentage of the total mass of the plurality of shattered pieces 1305 can be in a range from about 0.1% to about 5%, from about 0.5% to about 5%, from about 1% to about 5%, from about 2% to about 5%, from about 3% to about 5%, from about 0.1% to about 4%, from about 0.1% to about 3%, from about 0.1% to about 2%, from about 0.1% to about 1%, from about 0.5% to about 1%, or any range or subrange therebetween. By minimizing a total mass of first material (e.g., about 10% or less of a total weight of the plurality of shattered pieces), scratch resistance, impact resistance, and/or puncture resistance of the foldable apparatus can be further improved. In some embodiments, the first material 254 can be substantially devoid of air pockets. In further embodiments, a total volume of air pockets within the total volume of the first material can be about 5% or less, about 2% or less, or about 1% or less.

In some embodiments, as shown in FIG. 6, the foldable apparatus 601 can comprise a first plurality of cracks 603a internal to the first portion 221. As used herein, a crack is internal to a portion if the crack does not comprise nor intersect the first major surface 203 or the second major surface 205. For example, with reference to FIG. 6, the plurality of cracks 603a are internal to the foldable apparatus 601 (e.g., first portion 221) because they do not comprise nor do they intersect the first major surface 203 (e.g., first surface area 237) or the second major surface 205 (e.g., second surface area 247). In further embodiments, as shown, the first plurality of cracks 603a can be at least partially filled with the first material 254. As used herein, a crack is at least partially filled with a first material if the first material is positioned within at least a portion of the crack. In even further embodiments, the first material 254 can substantially fill, for example, entirely fill, the first plurality of cracks 603a. As used herein, a first material entirely fills a crack if the first material is positioned within the crack for the entire length of the crack. In even further embodiments, as shown, the foldable apparatus can comprise a second plurality of cracks 603b internal to the second portion 223. In still further embodiments, as shown, the second plurality of cracks 603b can be at least partially filled with the first material 254. In yet further embodiments, as shown, the first material 254 can substantially fill, for example, entirely fill, the second plurality of cracks 603b. In even further embodiments, although not shown, the first portion 221 and/or the second portion 223 may comprise both cracks internal to the portion as well as a shattered pane, although in different regions of the portion. By providing cracks internal to the foldable apparatus that are at least partially filled with a first material, the incidence of damage (e.g., fracture, puncture) to the foldable apparatus in the first portion and/or second portion can be reduced (e.g., decreased) because the surface(s) of the foldable apparatus in the corresponding portion(s) are not modified.

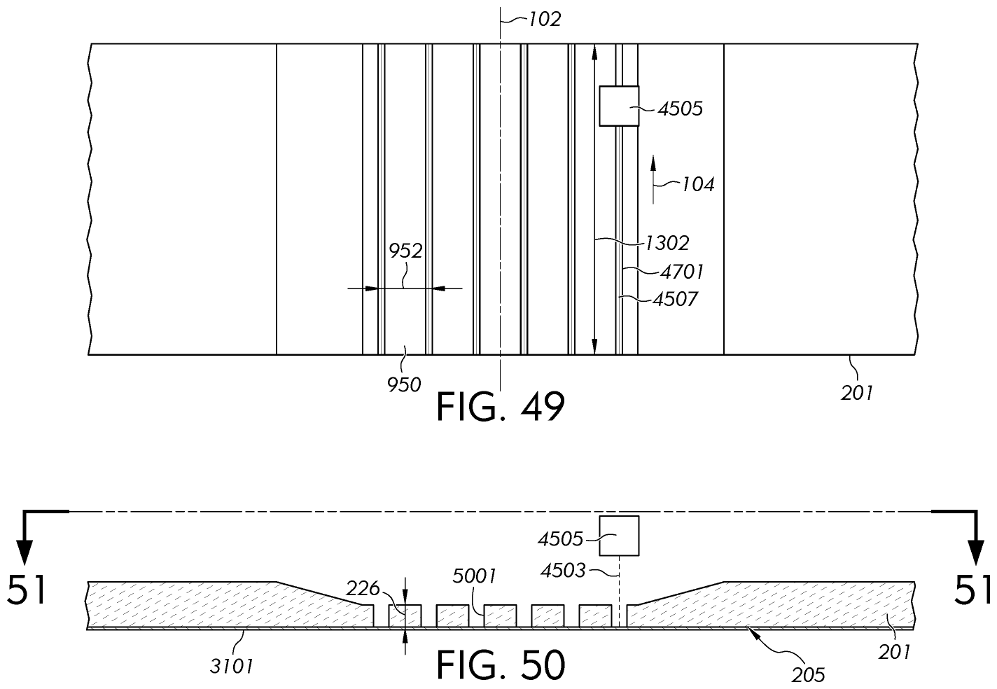

As shown in FIGS. 9-10, the central portion 225 can comprise a plurality of panes 950 that each comprise a length 1302 (see FIGS. 46 and 49) and a width 952. The length 1302 of each pane 950 can extend in the direction 104 of the fold axis 102 and/or the width 103 of the foldable apparatus 901 or 1001 while being perpendicular to the central thickness 226. The width 952 of each pane 950 can extend in the direction 106 perpendicular to the direction 104 of the fold axis 102 and/or the width 103, and the width 952 of each pane can extend in the direction 106 of the length 105 of the foldable apparatus 901 or 1001 while also being perpendicular to a direction of the central thickness 226 of the central portion 225 and perpendicular to a direction of the length 1302 of the pane 950. In some embodiments, the width 952 of each pane 950 of the plurality of panes can be in a range of from about 1 micrometer to about 200 micrometers.

As shown in FIGS. 9-10, 46, and 49, all of the plurality of panes 950 can be identical to one another (e.g., including the same thickness, width and length), although one or more of the panes 950 may have different dimensions than other panes 950. For instance, the width 952 and/or thickness of one or more of the panes 950 may be different from one or more of the remaining panes. Providing different widths and/or thicknesses can help accommodate different bending characteristics across a width 1303 of the plurality of panes 950 in the central portion 225 in the direction 106 perpendicular to the fold axis 102. For example, the outermost pair of panes 950 spaced farthest apart from one another within the central portion 225 (e.g., plurality of panes 950) can include a first width and/or first thickness and an inner pane of the plurality of panes 950 positioned between the outermost pair of panes 950 can include a second width that is less than the first width and/or a central thickness that is less than the first thickness. In some embodiments, each successive pair of panes of the panes 950 moving inward from the outermost pair of panes can include width and/or thickness that is the same or smaller than the corresponding width and/or thickness of the pair of panes 950 previously encountered, which can allow a decreased effective minimum bend radius of the central portion 225 compared to a plurality of panes 950 where each pane comprises substantially the same width and/or thickness. Providing panes with inwardly decreasing width and/or thickness can allow a decreased effective minimum bend radii because smaller effective bend radii are associated with smaller bending lengths in direction 106, where relatively high stresses and strains are encountered that may be reduced by providing panes comprising reduced widths and/or thicknesses.

Referring to FIG. 9, a pair of panes of the plurality of panes 950 can be connected together by a first material 254 positioned between the pair of panes 950. The first material 254 can comprise an elastic modulus that is less than an elastic modulus of the foldable substrate 201. Providing the panes 950 can help provide the central portion 225 with increased durability, increased puncture resistance and scratch resistance than can be achieved by flexible material having a lower elastic modulus than the panes 950. At the same time, attaching the panes 950 together with the first material 954 having an elastic modulus that is less than the elastic modulus of the foldable substrate 201 can provide the central portion 225 with a degree of flexibility to allow a lower effective bend radius than can be achieved with a comparable central portion only comprised of the same material as the foldable substrate 201 (e.g., glass-based substrate, ceramic-based substrate). In some embodiments, the elastic modulus of the first material 254 can be at least an order of magnitude less than the elastic modulus of the foldable substrate 201.

In some embodiments, a shattered piece of the plurality of panes 950 of the foldable substrate 201 can comprise a glass-based material and/or a ceramic-based material. In some embodiments, an elastic modulus of a shattered piece of the plurality of panes 950 of the foldable substrate 201 can be about 1 GigaPascal (GPa) or more, about 3 GPa or more, about 5 GPa or more, about 10 GPa or more, about 100 GPa or less, about 90 GPa or less, about 80 GPa or less, about 70 GPa or less, about 60 GPa or less, or about 20 GPa or less. In some embodiments, an elastic modulus of a shattered piece of the plurality of panes 950 of the foldable substrate 201 can be in a range from about 1 GPa to about 100 GPa, from about 1 GPa to about 90 GPa, from about 1 GPa to about 80 GPa, from about 3 GPa to about 80 GPa, from about 3 GPa to about 70 GPa, from about 3 GPa to about 60 GPa, from about 5 GPa to about 60 GPa, from about 5 GPa to about 20 GPa, from about 10 GPa to about 20 GPa, or any range or subrange therebetween. In further embodiments, the shattered pane of the plurality of panes 950 can comprise a glass-based portion or a ceramic-based portion comprising an elastic modulus in a range from about 10 GPa to about 100 GPa, from about 40 GPa to about 100 GPa, from about 60 GPa to about 100 GPa, from about 60 GPa to about 80 GPa, from about 60 GPa to about 70 GPa, from about 70 GPa to about 100 GPa, from about 80 GPa to about 100 GPa, from about 80 GPa to about 90 GPa, or any range or subrange therebetween.

In some embodiments, a total mass of the first material 254 as a percentage of a total mass of the plurality of panes 950 can be about 20% or less, about 15% or less, about 10% or less, about 8% or less, about 6% or less, about 5% or less, about 4% or less, about 2% or less, about 0.1% or more, about 0.5% or more, about 1% or more, about 2% or more, about 3% or more, or about 4% or more. In some embodiments, a total mass of the first material 254 as a percentage of a total mass of the plurality of panes 950 can be in a range from about 0.1% to about 20%, from about 0.1% to about 15%, from about 0.5% to about 15%, from about 0.5% to about 10%, from about 1% to about 10%, from about 1% to about 8%, from about 2% to about 8%, from about 2% to about 6%, from about 3% to about 6%, from about 3% to about 5%, from about 4% to about 5%, or any range or subrange therebetween. In further embodiments, the total mass of the first material 254 as a percentage of the total mass of the plurality of panes 950 can be in a range from about 0.1% to about 5%, from about 0.5% to about 5%, from about 1% to about 5%, from about 2% to about 5%, from about 3% to about 5%, from about 0.1% to about 4%, from about 0.1% to about 3%, from about 0.1% to about 2%, from about 0.1% to about 1%, from about 0.5% to about 1%, or any range or subrange therebetween. By minimizing a total mass of first material (e.g., about 10% or less of a total weight of the plurality of shattered pieces), scratch resistance, impact resistance, and/or puncture resistance of the foldable apparatus can be further improved. In some embodiments, the first material 254 can be substantially devoid of air pockets. In further embodiments, a total volume of air pockets within the total volume of the first material can be about 5% or less, about 2% or less, or about 1% or less.

In some embodiments, as shown in FIGS. 2-10, the first central surface area 233 of the central portion 225 can comprise a central major surface 235. In further embodiments, as shown in FIGS. 2-10, the central major surface 235 of the first central surface area 233 can extend along a third plane 204c. As shown in FIGS. 2-3, in even further embodiments, the third plane 204c can be parallel to the first plane 204a. In even further embodiments, as shown in FIGS. 2-3 and 9-10, the third plane 204c can be parallel to the second plane 204b. In still further embodiments, as shown in FIGS. 2-3 and 9-10, the third plane 204c can be non-coplanar with the first plane 204a and the second plane 204b. In still further embodiments, as shown in FIGS. 4-8, the third plane 204c can be coplanar with the first plane 204a. In some embodiments, the thickness of one or more of the shattered pieces 1305 can be equal to the central thickness 226 of the shattered pane 231. In some embodiments, the thickness of one or more of the panes 950 can be less than the thickness of the first portion 221 and/or the thickness of the second portion 223. For example, the thickness of one or more (e.g., all) of the panes 950 can be equal to the central thickness 226 of the central portion 225.

Providing the thickness of the shattered pieces 1305 with the central thickness 226 within the ranges discussed above can help reduce stress concentrations of a first material 254 positioned between adjacent pairs of shattered pieces. In further embodiments, a reduced thickness of the shattered pieces 1305 can reduce the strain on the first material 254 positioned between corresponding outer edges 251 of pairs of adjacent shattered pieces 1305 to accommodate folding of the foldable apparatus about the fold axis 102. The reduced strain of the first material 254 can reduce the tensile force on the first material 254 positioned between the outer edges 251 that can reduce the probability of rupturing of the first material 254. Additionally, reducing the tensile force can reduce the stress at the bonding interface between the first material 254 and the shattered pieces 1305, thereby reducing the probability of delamination of the first material 254 from the shattered pieces 1305. Furthermore, due to the reduced tensile force and/or reduced stress at the bonding interface provided by the reduced thickness of the shattered pieces 1305, the types of materials suitable for use as the first material 254 can be broader than otherwise permitted because of the lower tensile force and/or lower stress provided by the reduced thickness of the shattered pieces 1305. These additional types of materials may have more desirable characteristics for use as a filler material between the shattered pieces 1305 that may not be available due to the higher tensile force and/or higher stress at the bonding interface that may result from using shattered pieces 1305 with a greater thickness (e.g., a thickness equal to the thickness of the first portion 221 and/or the thickness of the second portion 223).

Providing the thickness of the panes 950 with the central thickness 226 within the ranges discussed above can help reduce stress concentrations of material positioned between adjacent pairs of panes. Indeed, a reduced thickness of the panes 950 can reduce the strain on the first material 254 positioned between corresponding outer edges (e.g., side walls 5701 or 5801 shown in FIGS. 57-58) of pairs of adjacent panes 950 to accommodate folding of the foldable apparatus about the fold axis 102. The reduced strain of the first material 254 can reduce the tensile force on the first material 254 positioned between the outer edges (e.g., side walls 5701 or 5801 shown in FIGS. 57-58) that can reduce the probability of rupturing of the first material 254. Additionally, reducing the tensile force can reduce the stress at the bonding interface between the first material 254 and one or more of the panes 950, thereby reducing the probability of delamination of the first material 254 from one or more of the panes 950. Furthermore, due to the reduced tensile force and/or reduced stress at the bonding interface provided by the reduced thickness of the panes 950, the types of materials suitable for use as the first material 254 can be broader than otherwise permitted because of the lower tensile force and/or lower stress provided by the reduced thickness of the panes 950. These additional types of materials may have more desirable characteristics for use as a filler material between the panes 950 that may not be available due to the higher tensile force and/or higher stress at the bonding interface that may result from using panes 950 with a greater thickness (e.g., a thickness equal to the thickness of the first portion 221 and/or the thickness of the second portion 223).

In some embodiments, the elastic modulus of the first material 254 can be about 18 GigaPascals (GPa) or less at 23° C. For example, in some embodiments, the elastic modulus of the first material 254 at 23° C. can be about 0.01 MPa or more, about 0.1 MPa or more, about 1 MegaPascal (MPa) or more, about 30 MPa or more, about 100 MPa or more, 300 MPa or more, about 500 MPa or more, about 1,000 MPa or more, about 3,000 MPa or less, about 18,000 MPa or less, about 10,000 MPa or less, about 5,000 MPa or less, about 3,000 MPa or less, about 2,000 MPa or less, or about 1,000 MPa or less. In some embodiments, the elastic modulus of the first material 254 at 23° C. can be in a range from about 0.01 MPa to about 18,000 MPa, from about 0.01 MPa to about 10,000 MPa, from about 0.1 MPa to about 10,000 MPa, from about 0.1 MPa to about 5,000 MPa, from about 1 MPa to about 5,000 MPa, from about 1 MPa to about 3,000 MPa, from about 30 MPa to about 3,000 MPa, from about 30 MPa to about 1,000 MPa, from about 100 MPa to about 1,000 MPa, from about 300 MPa to about 1,000 MPa, from about 500 MPa to about 1,000 MPa, or any range or subrange therebetween. In some embodiments, the elastic modulus of the first material 254 can comprise a elastic modulus in a range from about 1,000 MPa to about 18,000 MPa, from about 1,000 MPa to about 10,000 MPa, from about 3,000 MPa to about 10,000 MPa, from about 3,000 MPa to about 5,000 MPa, from about 5,000 MPa to about 10,000 MPa, or any range or subrange therebetween. In some embodiments, the elastic modulus of the first material 254 at 23° C. can be in a range from about 1 MPa to about 500 MPa, from about 10 MPa to about 500 MPa, from about 10 MPa to about 400 MPa, from about 30 MPa to about 400 MPa, from about 30 MPa to about 300 MPa, from about 50 MPa to about 300 MPa, from about 100 MPa to about 300 MPa, from about 100 MPa to about 300 MPa, or any range or subrange therebetween.

In some embodiments, the first material 254 can comprise a polymeric material (e.g., optically transparent polymer, adhesive). In further embodiments, the first material 254 can comprise the adhesive described above. In further embodiments, the first material 254 can comprise one or more of a silicone-based polymer, an acrylate-based polymer, an epoxy-based polymer, a thiol-containing polymer, or a polyurethane. In even further embodiments, the silicone-based polymer can comprise a silicone elastomer. Exemplary embodiments of a silicone elastomer include PP2-0E50 available from Gelest and LS 8941 available from NuSil. In even further embodiments, the first material 254 can comprise one or more of an optically transparent: an acrylic (e.g., polymethylmethacrylate (PMMA)), an epoxy, a silicone, and/or a polyurethane. Examples of epoxies include bisphenol-based epoxy resins, novolac-based epoxies, cycloaliphatic-based epoxies, and glycidylamine-based epoxies. In further embodiments, the first material can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and polyether ether ketone (PEEK). Example embodiments of polyolefins include low molecular weight polyethylene (LDPE), high molecular weight polyethylene (HDPE), ultrahigh molecular weight polyethylene (UHMWPE), and polypropylene (PP). Example embodiments of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example embodiments of elastomers include rubbers (e.g., polybutadiene, polyisoprene, chloroprene rubber, butyl rubber, nitrile rubber) and block copolymers (e.g., styrene-butadiene, high-impact polystyrene, poly(dichlorophosphazene)). In some embodiments, the first material 254 can comprise a sol-gel material.

In some embodiments, the first material 254 can comprise a polymer-based material comprising a glass-transition (Tg) temperature. Throughout the disclosure, a storage modulus (i.e., modulus of elasticity) and/or a loss modulus is measured for a polymeric material (e.g., polymer-based portion, adhesive) at 23° C. unless indicated otherwise. In further embodiments, the glass transition temperature of the first material 254 can be about 0° C. or less, about −20° C. or less, or about −40° C. or less. In further embodiments, the glass transition temperature of the first material 254 can be in a range from about −200° C. to about 0° C., from about −160° C. to about 0° C., from about −100° C. to about 0° C., from about −100° C. to about −20° C., from about −80° C. to about −20° C., from about −80° C. to about −40° C., or any range or subrange therebetween. In further embodiments, the glass transition temperature of the first material 254 can be about 40° C. or more, about 50° C. or more, about 60° C. or more, or about 70° C. or more. In further embodiments, the glass transition temperature of the first material 254 can be in a range from about 40° C. to about 250° C., from about 50° C. to about 220° C., from about 60° C. to about 200° C., from about 60° C. to about 180° C., from about 60° C. to about 150° C., from about 60° C. to about 120° C., from about 70° C. to about 100° C., or any range or subrange therebetween. Providing a first material with a glass transition temperature outside of an operating range (e.g., from about 0° C. to about 40° C., from about −20° C. to about 60° C.) of a foldable apparatus can enable the foldable apparatus to have consistent properties across the operating range.

Without wishing to be bound by theory, the elastic modulus can be substantially equal to or greater than the storage modulus (i.e., modulus of elasticity of a polymeric material). In some embodiments, a storage modulus of the first material 254 can change by a multiple of about 200 or less, about 100 or less, about 50 or less, about 20 or less, about 10 or less, or about 5 or less when a temperature of the first material 254 is changed from about 100° C. to about −20° C. In some embodiments, a storage modulus of the first material 254 can change when a temperature of the first material 254 is changed from about 100° C. to about −20° C. by a multiple in a range from about 1 to about 200, from about 5 to about 200, from about 10 to about 100, from about 20 to about 100, from about 50 to about 100, from about 1 to about 100, from about 1 to about 50, from about 1 to about 20, from about 1 to about 10, or any range or subrange therebetween.

In some embodiments, the first material 254 can comprise a polymer-based material comprising a glassy plateau. In further embodiment, the storage modulus (i.e., modulus of elasticity) of the first material 254 in the glassy plateau can be about 0.1 MPa or more, about 1 MPa or more, about 30 MPa or more, about 100 MPa or more, 300 MPa or more, about 500 MPa or more, about 1,000 MPa or more, about 3,000 MPa or less, about 18,000 MPa or less, about 10,000 MPa or less, about 5,000 MPa or less, about 3,000 MPa or less, about 2,000 MPa or less, or about 1,000 MPa or less. In some embodiments, the storage modulus of the first material 254 in the glassy plateau can be in a range from about 0.01 MPa to about 18,000 MPa, from about 0.01 MPa to about 10,000 MPa, from about 0.1 MPa to about 10,000 MPa, from about 0.1 MPa to about 5,000 MPa, from about 1 MPa to about 5,000 MPa, from about 1 MPa to about 3,000 MPa, from about 30 MPa to about 3,000 MPa, from about 30 MPa to about 1,000 MPa, from about 100 MPa to about 1,000 MPa, from about 300 MPa to about 1,000 MPa, from about 500 MPa to about 1,000 MPa, or any range or subrange therebetween. In some embodiments, the storage modulus of the first material 254 in the glassy plateau can be in a range from about 1,000 MPa to about 18,000 MPa, from about 1,000 MPa to about 10,000 MPa, from about 3,000 MPa to about 10,000 MPa, from about 3,000 MPa to about 5,000 MPa, from about 5,000 MPa to about 10,000 MPa, or any range or subrange therebetween. In some embodiments, the storage modulus of the first material 254 in the glassy plateau can be can be in a range from about 1 MPa to about 500 MPa, from about 10 MPa to about 500 MPa, from about 10 MPa to about 400 MPa, from about 30 MPa to about 400 MPa, from about 30 MPa to about 300 MPa, from about 50 MPa to about 300 MPa, from about 100 MPa to about 300 MPa, from about 100 MPa to about 300 MPa, or any range or subrange therebetween.

In some embodiments, the first material 254 and/or the second material 256 can remain within an elastic deformation regime. As used herein, an elastic deformation regime includes the range of the deformations that a material can recover 99% or its original dimension after being deformed to that deformation. Without wishing to be bound by theory, a first material may remain within its elastic deformation regime when the tensile strength of the first material is less than the product of the first material's elastic modulus and the first material's thickness divided by the product of twice the first material's volume fraction and the effective minimum bend radius of the foldable apparatus when the thickness of the first material divided by the effective minimum bend radius of the foldable apparatus is less than the first material's yield strain. As used herein, a yield strain is a material's strain at yield. As used herein, the first material's volume fraction means the ratio of a combined volume of the first material in a region between the first central surface area and the second material surface circumscribed by an outer periphery of the shattered pane to the total volume of the region between the first central surface area and the second material surface circumscribed by an outer periphery of the shattered pane. For example, a first material would be within its elastic deformation regime if it is in a foldable apparatus comprising an effective minimum bend radius of 1 mm as the thickness of the first material is 100 μm as long as the yield strain of the first material is 0.1 and the tensile strength of the first material is more than 10 times the elastic modulus of the first material. In some embodiments, the first material 254 and/or the second material 256 can comprise a strain at yield of about 5% or more, about 8% or more, about 10% or more, about 12% or more, or about 20% or more. In some embodiments, the first material 254 and/or the second material 256 can comprise a strain at yield in a range from about 5% to about 10,000%, from about 5% to about 5,000%, from about 8% to about 1,000%, from about 8% to about 500%, from about 10% to about 300%, from about 10% to about 100%, from about 12% to about 100%, from about 20% to about 100%, from about 20% to about 50%, or any range or subrange therebetween. In some embodiments, the first material can comprise one or more of a polyamide, LDPE, HDPE, PTFE, perfluoroalkoxyethylene, PVF, ETFE, polybutadiene rubber, nitrile rubber, and styrene-butadiene rubber. In some embodiments, the second material can comprise the polymer-based portion described above. In some embodiments, as described below, the first material 254 may be cured in a bent configuration (e.g., when a bending force is applied to the foldable substrate), although it is to be understood that the second material 256 may be cured in a bent configuration in addition to or alternatively to curing the first material 254 in a bent configuration. Curing the first material in a bent configuration can reduce the effective maximum strain on the first material as the foldable apparatus is bent between unfolded and folded configurations, which can allow more materials to be used as first materials while still keeping the first material within its elastic deformation regime.

In some embodiments, the first material 254 and/or the second material 256 can comprise a negative coefficient of thermal expansion (CTE). As used herein, a coefficient of thermal expansion is measured in accordance with ASTM E289-17 using a Picoscale Michelson Interferometer between -20° C. and 40° C. In some embodiments, the first material 254 and/or the second material 256 can comprise particles of one or more of copper oxide, beta-quartz, a tungstate, a vanadate, a pyrophosphate, and/or a nickel-titanium alloy. In some embodiments, the first material 254 and/or the second material 256 can comprise a CTE of about −20×10⁻⁷° C.⁻¹ or more, about −10×10⁻⁷° C.⁻¹ or more, about −5×10⁻⁷° C.⁻¹ or more, about −2×10⁻⁷° C.⁻¹ or more, about 10×10⁻⁷° C.⁻¹ or less, about 5×10⁻⁷° C.⁻¹ or less, about 2×10⁻⁷° C.⁻¹ or less, about 1×10⁻⁷° C.⁻¹ or less, or 0° C.⁻¹ or less. In some embodiments, the first material 254 and/or the second material 256 can comprise a CTE in a range from about −20×10⁻⁷° C.⁻¹ to about 10×10⁻⁷° C.⁻¹, from about −20×10⁻⁷° C.⁻¹ to about 5×10⁻⁷° C.⁻¹, from about −10×10⁻⁷° C.⁻¹, to about 5×10⁻⁷° C.⁻¹, from about −10×10⁻⁷° C.⁻¹ to about 2×10⁻⁷° C.⁻¹, from about −10×10⁻⁷° C.⁻¹ to 0° C.⁻¹, from about −5×10⁻⁷° C.⁻¹ to 0° C.⁻¹ from about −2×10⁻⁷° C.⁻¹ to about 0° C.⁻¹, or any range or subrange therebetween. By providing a polymer-based portion comprising a low (e.g., negative) coefficient of thermal expansion, warp caused by volume changes during curing of the polymer-based portion can be mitigated.

In some embodiments, as shown in FIG. 10, the foldable apparatus 1001 can comprise a coating 281. As shown, the coating 281 can comprise a third major surface 283 and a fourth major surface 285 opposite the third major surface 283. A coating thickness 287 can be defined between the third major surface 283 and the fourth major surface 285. In further embodiments, the coating thickness can be about 0.1 μm or more, about 1 μm or more, about 5μm or more, about 10 μm or more, about 15 μm or more, about 20 μm or more, about 25 μm or more, about 40 μm or more, about 50 μm or more, about 60 μm or more, about 70 μm or more, about 80 μm or more, about 90 μm or more, about 200 μm or less, about 100 μm or less, or about 50 μm or less, about 30 μm or less, about 25 μm or less, about 20 μm or less, about 20 μm or less, about 15 μm or less, or about 10 μm or less. In some embodiments, the coating thickness 287 can be in a range from about 0.1 μm to about 200 μm, from about 1 μm to about 200 μm, from about 10 μm to about 200 μm, from about 50 μm to about 200 p.m, from about 0.1 μm to about 100 μm, from about 1 μm to about 100 μm, from about 10 μm to about 100 μm, from about 20 μm to about 100 μm, from about 30 μm to about 100 μm, from about 40 μm to about 100 μm, from about 50 μm to about 100 μm, from about 60 μm to about 100 μm, from about 70 μm to about 100 μm, from about 80 μm to about 100 μm, from about 90 μm to about 100 μm, from about 0.1 μm to about 50 p.m, from about 1 μm to about 50 μm, from about 10 μm to about 50 μm, or any range or subrange therebetween. In further embodiments, the coating thickness 287 can be in a range from about 0.1 μm to about 50 μm, from about 0.1 μm to about 30 μm, from about 0.1 μm to about 25 μm, from about 0.1 μm to about 20 μm, from about 0.1 μm to about 15 μm, from about 0.1 μm to about 10 μm. In some embodiments, the coating thickness 287 can be in a range from about 1 μm to about 30 μm, from about 1 μm to about 25 μm, from about 1 μm to about 20 μm, from about 1 μm to about 15 μm, from about 1 μm to about 10 μm. In some embodiments, the coating thickness 287 can be in a range from about 5μm to about 30 μm, from about 5μm to about 25 μm, from about 5 μm to about 20 μm, from about 5μm to about 15 μm, from about 5μm to about 10 p.m, from about 10 μm to about 30 μm, from about 10 μm to about 25 μm, from about 10 μm to about 20 μm, from about 10 μm to about 15 μm, from about 15 μm to about 30 μm, from about 15 μm to about 25 μm, from about 15 μm to about 20 μm, from about 20 μm to about 30 μm, from about 20 μm to about 25 μm, or any range or subrange therebetween. In some embodiments, the coating thickness 287 can be in a range from about 5μm to about 30 μm, from about 5μm to about 25 μm, from about 10 μm to about 25 μm, from about 10 μm to about 20 μm, from about 10 μm to about 15 μm, or any range or subrange therebetween.

In some embodiments, as shown in FIG. 10, the coating 281 can be disposed over the first portion 221, the second portion 223, and the central portion 225. In further embodiments, as shown, the coating 281 can be disposed over the second surface area 247 of the first portion 221, the fourth surface area 249 of the second portion 223, and the second central surface area 245 of the central portion 225 (e.g., plurality of panes 950).

The second major surface 205 of the foldable substrate 201 or 803 can comprise the coating 281. In some embodiments, the coating, 281 if provided, may comprise one or more of an easy-to-clean coating, a low-friction coating, an oleophobic coating, a diamond-like coating, a scratch-resistant coating, or an abrasion resistant coating. A scratch-resistant coating may comprise an oxynitride, for example, aluminum oxynitride or silicon oxynitride with a thickness of about 500 micrometers or more. In such embodiments, the abrasion resistant layer may comprise the same material as the scratch resistant layer. In some embodiments, a low friction coating may comprise a highly fluorinated silane coupling agent, for example, an alkyl fluorosilane with oxymethyl groups pendant on the silicon atom. In such embodiments, an easy-to-clean coating may comprise the same material as the low friction coating. In other embodiments, the easy-to-clean coating may comprise a protonatable group, for example, an amine, for example, an alkyl aminosilane with oxymethyl groups pendant on the silicon atom. In such embodiments, the oleophobic coating may comprise the same material as the easy-to-clean coating. In some embodiments, a diamond-like coating comprises carbon and may be created by applying a high voltage potential in the presence of a hydrocarbon plasma.

In some embodiments, the coating 281 may be an optically transparent polymeric hard-coat layer that can be disposed over and/or bonded to the foldable substrate. Suitable materials for an optically transparent polymeric hard-coat layer include, but are not limited to: a cured acrylate resin material, an inorganic-organic hybrid polymeric material, an aliphatic or aromatic hexafunctional urethane acrylate, a siloxane based hybrid material, and a nanocomposite material, for example, an epoxy and urethane material with nanosilicate. In some embodiments, an optically transparent polymeric hard-coat layer may consist essentially of one or more of these materials. In some embodiments, an optically transparent polymeric hard-coat layer may consist of one or more of these materials. As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulates dispersed within an organic matrix. More specifically, suitable materials for an optically transparent polymeric (OTP) hard-coat layer include, but are not limited to, a polyimide, a polyethylene terephthalate (PET), a polycarbonate (PC), a poly methyl methacrylate (PMMA), organic polymer materials, inorganic-organic hybrid polymeric materials, and aliphatic or aromatic hexafunctional urethane acrylates. In some embodiments, an OTP hard-coat layer may consist essentially of an organic polymer material, an inorganic-organic hybrid polymeric material, or aliphatic or aromatic hexafunctional urethane acrylate. In some embodiments, an OTP hard-coat layer may consist of a polyimide, an organic polymer material, an inorganic-organic hybrid polymeric material, or aliphatic or aromatic hexafunctional urethane acrylate. In some embodiments, an OTP hard-coat layer may include a nanocomposite material. In some embodiments, an OTP hard-coat layer may include a nano-silicate at least one of epoxy and urethane materials. Suitable compositions for such an OTP hard-coat layer are described in U.S. Pat. Pub. No. 2015/0110990, which is hereby incorporated by reference in its entirety by reference thereto. As used herein, “organic polymer material” means a polymeric material comprising monomers with only organic components. In some embodiments, an OTP hard-coat layer may comprise an organic polymer material manufactured by Gunze Limited and having a hardness of 9H, for example, Gunze's “Highly Durable Transparent Film.” As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulates dispersed within an organic matrix. In some embodiments, the inorganic-organic hybrid polymeric material may include polymerized monomers comprising an inorganic silicon-based group, for example, a silsesquioxane polymer. A silsesquioxane polymer may be, for example, an alky-silsesquioxane, an aryl-silsesquioxane, or an aryl alkyl-silsesquioxane having the following chemical structure: (RSiO_{1.5})ₙ, where R is an organic group for example, but not limited to, methyl or phenyl. In some embodiments, an OTP hard-coat layer may comprise a silsesquioxane polymer combined with an organic matrix, for example, SILPLUS manufactured by Nippon Steel Chemical Co., Ltd. In some embodiments, an OTP hard-coat layer may comprise 90 wt % to 95 wt % aromatic hexafunctional urethane acrylate (e.g., PU662NT (Aromatic hexafunctional urethane acrylate) manufactured by Miwon Specialty Chemical Co.) and 10 wt % to 5 wt % photo-initiator (e.g., Darocur 1173 manufactured by Ciba Specialty Chemicals Corporation) with a hardness of 8H or more. In some embodiments, an OTP hard-coat layer composed of an aliphatic or aromatic hexafunctional urethane acrylate may be formed as a stand-alone layer by spin-coating the layer on a polyethylene terephthalate (PET) substrate, curing the urethane acrylate, and removing the urethane acrylate layer from the PET substrate. An OTP hard-coat layer may have a thickness in the range of 1 μm to 150 μm, for example, from 10 μm to 140 μm, from 20 μm to 130 μm, 30 μm to 120 μm, from 40 μm to 110 pm, from 50 μm to 100 μm, from 60 μm to 90 μm, 70 μm, 80 μm, 2μm to 140 μm, from 4μm to 130 μm, 6μm to 120 μm, from 8μm to 110 μm, from 10 μm to 100 μm, from 10 μm to 90 μm, 10 μm, 80 μm, 10 μm, 70 μm, 10 μm, 60 μm, 10 μm, 50 μm, or within a range having any two of these values as endpoints. In some embodiments, an OTP hard-coat layer may be a single monolithic layer.

In some embodiments, an OTP hard-coat layer may be an inorganic-organic hybrid polymeric material layer or an organic polymer material layer having a thickness in the range of 80 μm to 120 μm, including subranges. For example, an OTP hard-coat layer comprising an inorganic-organic hybrid polymeric material or an organic polymer material may have a thickness of from 80 μm to 110 μm, 90 μm to 100 μm, or within a range having any two of these values as end points. In some embodiments, an OTP hard-coat layer may be an aliphatic or aromatic hexafunctional urethane acrylate material layer having a thickness in the range of 10 μm to 60 μm, including subranges. For example, an OTP hard-coat layer comprising an aliphatic or aromatic hexafunctional urethane acrylate material may have a thickness of 10 μm to 55 μm, 10 μm to 50 μm, 10 μm to 40 μm, 10 μm to 45 μm, 10 μm to 40 μm, 10 μm to 35 μm, 10 μm to 30 μm, 10 μm to 25 μm, 10 μm to 20 μm, or within a range having any two of these values as end points.

In some embodiments, the foldable substrate (e.g., first portion 221, second portion 223, shattered pane 231, and/or plurality of panes 950) may comprise a foldable glass-based substrate and/or foldable ceramic-based substrate where one or more portions of the foldable substrate may comprise a compressive stress region. In some embodiments, the compressive stress region may be created by chemically strengthening the foldable substrate. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the foldable substrate can enable small (e.g., smaller than about 10 mm or less) bend radii because the compressive stress from the chemical strengthening can counteract the bend-induced tensile stress on the outermost surface of the foldable substrate (e.g., first major surface 203 in FIG. 13, second major surface 205 in FIG. 14). A compressive stress region may extend into a portion of the foldable substrate for a depth called the depth of compression. As used herein, depth of compression means the depth at which the stress in the chemically strengthened substrates described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example, the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than about 75 μm, SCALP is used to measure the depth of compression and central tension (CT). Where the stress in the substrate is generated by exchanging both potassium and sodium ions into the glass, and the article being measured is thicker than about 75 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate (e.g., sodium, potassium). Through the disclosure, when the central tension cannot be measured directly by SCALP (as when the article being measured is thinner than about 75 μm) the maximum central tension can be approximated by product of a maximum compressive stress and a depth of compression divided by the difference between the thickness of the substrate and twice the depth of compression, wherein the compressive stress and depth of compression are measured by FSM.

In some embodiments, the first portion 221 may be chemically strengthened to form a first compressive stress region extending to a first depth of compression from the first surface area 237 of the first major surface 203. In some embodiments, the second portion 223 may be chemically strengthened to form a third compressive stress region extending to a third depth of compression from the third surface area 239 of the first major surface 203. In even further embodiments, the first depth of compression (e.g., from the first surface area 237 of the first major surface 203) and/or third depth of compression (e.g., from the third surface area 239 of the first major surface 203) as a percentage of the first thickness 222 can be about 1% or more, about 5% or more, about 10% or more, about 30% or less, about 25% or less, or about 20% or less. In even further embodiments, the first depth of compression and/or the third depth of compression as a percentage of the first thickness 222 can be in a range from about 1% to about 30%, from about 1% to about 25%, from about 5% to about 25%, from about 5% to about 20%, from about 10% to about 20%, or any range or subrange therebetween.

In some embodiments, the central portion 225 may be chemically strengthened to form a first central compressive stress region extending to a first central depth of compression from the first central surface area 233 of the central portion 225. For example, in some embodiments, the shattered pane 231 of the central portion 225 may be chemically strengthened to a first central depth of compression from the first central surface area 233 of the central portion 225. For example, in some embodiments, the plurality of panes 950 of the central portion 225 may be chemically strengthened to a first central depth of compression from the first central surface area 233 of the central portion 225. In even further embodiments, the first central depth of compression (e.g., from the first central surface area 233 (e.g., central major surface 235) of the central portion 225) as a percentage of the central thickness 226 can be about 1% or more, about 5% or more, about 10% or more, about 20% or more, about 25% or more, about 40% or less, about 35% or less, or about 30% or less, or about 28% or less. In even further embodiments, the first central depth (e.g., depth of compression from the first central surface area 233 (e.g., central major surface 235) of the central portion 225) as a percentage of the central thickness 226 can be in a range from about 1% to about 40%, from about 5% to about 40%, from about 10% to about 40%, from about 15% to about 40%, from about 15% to about 35%, from about 20% to about 35%, from about 25% to about 30%, from about 25% to about 28%, or any range or subrange therebetween.

In even further embodiments, the first depth (e.g., depth of compression from the first surface area 237 of the first major surface 203) can be greater than the first central depth (e.g., depth of compression from the first central surface area 233 (e.g., central major surface 235) of the central portion 225). In even further embodiments, the third depth of compression (e.g., from the third surface area 239 of the first major surface 203) can be greater than the first central depth of compression (e.g., from the first central surface area 233 (e.g., central major surface 235) of the central portion 225). In even further embodiments, the first depth of compression (e.g., from the first surface area 237 of the first major surface 203) may be substantially equal to the third depth of compression (e.g., from the third surface area 239 of the first major surface 203). In some embodiments, the first depth of compression, the third depth of compression, and/or the first central depth of compression can be about 1 μm or more, about 10 μm or more, about 50 μm or more, about 200 μm or less, about 150 μm or less, or about 100 μm or less. In some embodiments, the first depth of compression, the third depth of compression, and/or the first central depth of compression can be in a range from about 1 μm to about 200 μm, from about 1 μm to about 150 μm, from about 10 μm to about 150 μm, from about 50 μm to about 150 μm, from about 50 μm to about 100 μm, or any range or subrange therebetween. By providing a first portion, second portion, and/or central portion comprising a glass-based and/or ceramic-based portion comprising a first depth of compression, a third depth of compression, and/or a first central depth of compression, respectively, in a range from about 1% to about 30% of the first thickness, good impact and/or puncture resistance can be enabled.

In some embodiments, the first portion 221 may be chemically strengthened to form a second compressive stress region extending to a second depth of compression from the second surface area 247 of the second major surface 205. In some embodiments, the second portion 223 may be chemically strengthened to form a fourth compressive stress region extending to a fourth depth of compression from the fourth surface area 249 of the second major surface 205. In even further embodiments, the second depth of compression (e.g., from the second surface area 247 of the second major surface 205) and/or fourth depth of compression (e.g., from the fourth surface area 249 of the second major surface 205) as a percentage of the first thickness 222 can be about 1% or more, about 5% or more, about 10% or more, about 30% or less, about 25% or less, or about 20% or less. In even further embodiments, the second depth of compression and/or the fourth depth of compression as a percentage of the first thickness 222 can be in a range from about 1% to about 30%, from about 1% to about 25%, from about 5% to about 25%, from about 5% to about 20%, from about 10% to about 20%, or any range or subrange therebetween.

In some embodiments, the central portion 225 may be chemically strengthened to form a second central compressive stress region extending to a second central depth of compression from a second central surface area 245 of the second major surface 205 opposite the first central surface area 233 of the central portion 225. For example, in some embodiments, the shattered pane 231 of the central portion 225 may be chemically strengthened to a second central depth from the second central surface area 245 of the second major surface 205 opposite the first central surface area 233 of the central portion 225. In even further embodiments, the second central depth of compression (e.g., from the second central surface area 245 of the second major surface 205) as a percentage of the central thickness 226 can be about 1% or more, about 5% or more, about 10% or more, about 20% or more, about 25% or more, about 40% or less, about 35% or less, or about 30% or less, or about 28% or less. In even further embodiments, the second central depth as a percentage of the central thickness 226 can be in a range from about 1% to about 40%, from about 5% to about 40%, from about 10% to about 40%, from about 15% to about 40%, from about 15% to about 35%, from about 20% to about 35%, from about 25% to about 30%, from about 25% to about 28%, or any range or subrange therebetween.

In even further embodiments, the second depth of compression (e.g., from the second surface area 247 of the second major surface 205) can be greater than the second central depth of compression (e.g., from the second central surface area 245 of the second major surface 205). In even further embodiments, the fourth depth of compression (e.g., from the fourth surface area 249 of the second major surface 205) can be greater than the second central depth of compression (e.g., from the second central surface area 245 of the second major surface 205). In even further embodiments, the second depth of compression (e.g., from the second surface area 247 of the second major surface 205) may be substantially equal to the fourth depth of compression (e.g., from the fourth surface area 249 of the second major surface 205). In some embodiments, the first depth of compression (e.g., from the first surface area 237 of the first major surface 203) may be substantially equal to the second depth of compression (e.g., depth of compression from the second surface area 247 of the second major surface 205). In some embodiments, the third depth of compression (e.g., from the third surface area 239 of the first major surface 203) may be substantially equal to the fourth depth of compression (e.g., from the fourth surface area 249 of the second major surface 205). In some embodiments, the first central depth of compression (e.g., from the first central surface area 233 (e.g., central major surface 235) of the central portion 225) may be substantially equal to the second central depth of compression (e.g., depth of compression from the second central surface area 245 of the second major surface 205). In some embodiments, the second depth of compression, the fourth depth of compression, and/or the second central depth of compression can be about 1 μm or more, about 10 μm or more, about 50 μm or more, about 200 μm or less, about 150 μm or less, or about 100 μm or less. In some embodiments, the second depth of compression, the fourth depth of compression, and/or the second central depth of compression can be in a range from about 1 μm to about 200 μm, from about 1 μm to about 150 μm, from about 10 μm to about 150 μm, from about 50 μm to about 150 μm, from about 50 μm to about 100 μm, or any range or subrange therebetween. By providing a first portion, second portion, and/or central portion comprising a glass-based and/or ceramic-based portion comprising a second depth of compression, a fourth depth of compression, and/or a second central depth of compression, respectively, in a range from about 1% to about 30% of the first thickness, good impact and/or puncture resistance can be enabled.

In some embodiments, the first portion 221 can comprise a first depth of layer of one or more alkali metal ions associated with the first compressive stress region and/or a second depth of layer of one or more alkali metal ions associated with the second compressive stress region. In some embodiments, the second portion 223 can comprise a third depth of layer of one or more alkali metal ions associated with the third compressive stress region and/or a fourth depth of layer of one or more alkali metal ions associated with the fourth compressive stress region. In some embodiments, the first depth of layer, second depth of layer, third depth of layer, and/or fourth depth of layer as a percentage of the corresponding thickness (e.g., substrate thickness, first thickness 222, second thickness) can be about 1% or more, about 5% or more, about 10% or more, about 15% or more, about 20% or more, about 35% or less, about 30% or less, about 25% or less, or about 22% or less. In some embodiments, the first depth of layer, second depth of layer, third depth of layer, and/or fourth depth of layer as a percentage of the corresponding thickness (e.g., substrate thickness, first thickness 222, second thickness) can be in a range from about 1% to about 35%, from about 5% to about 35%, from about 5% to about 30%, from about 10% to about 30%, from about 10% to about 25%, from about 15% to about 25%, from about 15% to about 22%, from about 20% to about 22%, or any range or subrange therebetween. In some embodiments, the first depth of layer, second depth of layer, third depth of layer, and/or fourth depth of layer can be about 1 μm or more, about 10 μm or more, about 50 μm or more, about 200 μm or less, about 150 μm or less, or about 100 μm or less. In some embodiments, the first depth of layer, second depth of layer, third depth of layer, and/or fourth depth of layer can be in a range from about 1 μm to about 200 μm, from about 1 μm to about 150 μm, from about 10 μm to about 150 μm, from about 50 μm to about 150 μm, from about 50 μm to about 100 μm, or any range or subrange therebetween.

In some embodiments, the central portion 225 (e.g., shattered pane 231) can comprise a first central depth of layer of one or more alkali metal ions associated with the first central compressive stress region and/or a second central depth of layer of one or more alkali metal ions associated with the second central compressive stress region. In some embodiments, the first central depth of layer and/or the second central depth of layer as a percentage of the central thickness 226 can be about 10% or more, about 20% or more, about 25% or more, about 30% or more, about 35% or more, about 38% or more, about 50% or less, about 45% or less, about 42% or less, or about 40% or less. In some embodiments, the first central depth of layer and/or the second central depth of layer as a percentage of the central thickness 226 can be in a range from about 10% to about 50%, from about 20% to about 50%, from about 25% to about 50%, from about 30% to about 50%, from about 35% to about 50%, from about 35% to about 45%, from about 38% to about 45%, from about 38% to about 42%, from about 38% to about 40%, or any range or subrange therebetween. In some embodiments, the first central depth of layer and/or second central depth of layer can be about 5μm or more, about 50 μm or more, about 100 μm or more, about 150 μm or more, about 500 μm or less, about 300 μm or less, about 250 μm or less, or about 200 μm or less. In some embodiments, the first central depth of layer and/or second central depth of layer can be in a range from about 5μm to about 500 μm, from about 50 μm to about 500 μm, from about 50 μm to about 300 μm, from about 100 μm to about 300 μm, from about 100 μm to about 250 μm, from about 150 μm to about 250 μm, from about 150 μm to about 200 μm, or any range or subrange therebetween.

In some embodiments, the first compressive stress region can comprise a maximum first compressive stress. In some embodiments, the second compressive stress region can comprise a maximum second compressive stress. In further embodiments, the maximum first compressive stress and/or the maximum second compressive stress can be about 100 MegaPascals (MPa) or more, about 300 MPa or more, about 500 MPa or more, about 700 MPa or more, about 1,500 MPa or less, about 1,200 MPa or less, about 1,000 MPa or less, or about 900 MPa or less. In further embodiments, the maximum first compressive stress and/or the maximum second compressive stress can be in a range from about 100 MPa to about 1,500 MPa, from about 100 MPa to about 1,200 MPa, from about 300 MPa to about 1,200 MPa, from about 300 MPa to about 1,000 MPa, from about 500 MPa to about 1,000 MPa, from about 700 MPa to about 1,000 MPa, from about 700 MPa to about 900 MPa, or any range or subrange therebetween. Providing a maximum first compressive stress and/or a maximum second compressive stress in a range from about 100 MPa to about 1,500 MPa can enable good impact and/or puncture resistance. In some embodiments, the third compressive stress region can comprise a maximum third compressive stress within one or more of the ranges discussed above in this paragraph. In some embodiments, the fourth compressive stress region can comprise a maximum fourth compressive stress within one or more of the ranges discussed above in this paragraph.

In some embodiments, the first central compressive stress region can comprise a maximum first central compressive stress. In some embodiments, the second central compressive stress region can comprise a maximum second central compressive stress. In some embodiments, the maximum first central compressive stress and/or the maximum second central compressive stress can be about 50 MPa or more, about 100 MPa or more, about 200 MPa or more, about 250 MPa or more, about 750 MPa or less, about 600 MPa or less, about 500 MPa or less, about 450 MPa or less, about 400 MPa or less, about 350 MPa or less, or about 300 MPa or less. In some embodiments, the maximum first central compressive stress and/or the maximum second central compressive stress can be in a range from about 50 MPa to about 750 MPa, from about 50 MPa to about 600 MPa, from about 100 MPa to about 600 MPa, from about 100 MPa to about 500 MPa, from about 200 MPa to about 500 MPa, from about 200 MPa to about 450 MPa, from about 250 MPa to about 450 MPa, from about 250 MPa to about 350 MPa, from about 250 MPa to about 300 MPa, or any range or subrange therebetween.

Throughout the disclosure, if a first layer, material and/or component is described as “disposed over” a second layer, material and/or component, other layers, materials and/or components may or may not be present between the first layer, material and/or component and the second layer, material and/or component. As used herein, if a first layer, material and/or component described as “bonded to” a second layer, material and/or component means that the layers, materials and/or components are bonded to each other, either by direct contact and/or bonding between the two layers, materials and/or components or via an adhesive layer. In some embodiments, although not shown, the recess may not be totally filled, for example, to leave room for electronic devices and/or mechanical devices.

In some embodiments, as shown in FIGS. 2, 5-8, the foldable apparatus 101, 501, 601, 701, and 801 can comprise the second material 256 that can be disposed over at least the first central surface area 233 of the central portion 225. In further embodiments, as shown in FIG. 2, the second material 256 can be positioned in and partially or entirely fill the recess 234 defined between the first central surface area 233 (e.g., third plane 204c) and the first plane 204a. In further embodiments, as shown in FIGS. 5-6, the second material 256 can further be disposed over at least a portion of the first surface area 237. In even further embodiments, as shown, the second material 256 can contact the first surface area 237. In even further embodiments, as shown, the second material can be disposed over substantially the entire first surface area 237. In even further embodiments, as shown, the second material 256 can further be disposed over at least a portion of the third surface area 239. In still further embodiments, as shown, the second material 256 can contact the third surface area 239. In still further embodiments, as shown, the second material 256 can be disposed over substantially the entire third surface area 239. In some embodiments, as shown in FIGS. 3 and 9-10, the first material 254 can be disposed over at least the first central surface area 233 of the central portion 225. In further embodiments, as shown in FIGS. 3 and 9-10, the first material 254 can be positioned in and partially or entirely fill the recess 234 defined between the first central surface area 233 (e.g., third plane 204c) and the first plane 204a.

The second material 256 can comprise a first contact surface 209. In some embodiments, as shown in FIGS. 2, 5-10, and 12-15, the first contact surface 209 of the second material 256 can face the first central surface area 233 of the central portion 225. In further embodiments, as shown, the first contact surface 209 of the second material 256 can contact the first central surface area 233 of the central portion 225, and the second material 256 can be bonded to the first central surface area 233.

The second material 256 can comprise a second contact surface 257 opposite the first contact surface 209. As shown in FIGS. 6-7, a thickness 605 of the second material 256 can be measured as an average distance between the first contact surface 209 and the second contact surface 257. In some embodiments, the thickness 605 of the second material 256 can be about 1 μm or more, about 10 μm or more, about 20 μm or more, about 50 μm or more, about 2 mm or less, about 500 μm or less, about 250 μm or less, about 150 μm or less, about 100 μm or less, or about 50 μm or less. In some embodiments, the thickness 605 of the second material 256 can be in a range from about 1 μm to about 2 mm, from about 1 μm to about 500 μm, from about 10 μm to about 250 μm, from about 10 μm to about 150 μm, from about 10 μm to about 100 μm, from about 10 μm to about 50 μm, from about 20 μm to about 250 p.m, from about 20 μm to about 150 μm, from about 20 μm to about 100 μm, from about 20 μm to about 50 μm, or any range or subrange therebetween. In further embodiments, as shown in FIGS. 5-8, the thickness 605 of the second material 256 can be substantially uniform across its length and/or width. In further embodiments, as shown in FIG. 2, the thickness 605 of the second material 256 can be non-uniform across its length and/or width (e.g., tapering towards the extremes of a portion comprising the second material 256).

In some embodiments, the elastic modulus of the second material 256 can be about 5 GigaPascals (GPa) or less at 23° C. For example, in some embodiments, the elastic modulus of the second material 256 at 23° C. can be about 0.01 MegaPascal (MPa) or more, about 0.1 MPa or more, about 1 MPa or more, about 30 MPa or more, about 100 MPa or more, 300 MPa or more, about 500 MPa or more, about 1,000 MPa or more, about 5,000 MPa or less, about 3,000 MPa or less, about 2,000 MPa or less, or about 1,000 MPa or less. In some embodiments, the elastic modulus of the second material 256 at 23° C. can be in a range from about 0.01 MPa to about 5,000 MPa, from about 0.1 MPa to about 5,000 MPa, from about 0.1 MPa to about 3,000 MPa, from about 1 MPa to about 3,000 MPa, from about 1 MPa to about 1,000 MPa, from about 30 MPa to about 1,000 MPa, from about 100 MPa to about 1,000 MPa, from about 300 MPa to about 1,000 MPa, from about 500 MPa to about 1,000 MPa, or any range or subrange therebetween. In some embodiments, the elastic modulus of the second material can comprise an elastic modulus in a range from about 1,000 MPa to about 5,000 MPa, from about 3,000 MPa to about 5,000 MPa, from about 1 MPa to about 500 MPa, from about 10 MPa to about 500 MPa, from about 10 MPa to about 400 MPa, from about 30 MPa to about 400 MPa, from about 30 MPa to about 300 MPa, from about 50 MPa to about 300 MPa, from about 100 MPa to about 300 MPa, from about 100 MPa to about 300 MPa, or any range or subrange therebetween.

In some embodiments, the second material 256 can comprise a greater elastic modulus than the first material 254. By providing a second material comprising a higher modulus than the first material, bend-induced stresses on the substrate can be reduced, for example, by shifting a neutral axis of the substrate closer to the second material than a mid-plane of the substrate. Further, providing a second material disposed over substantially an entire second major surface of a foldable substrate can present a contact surface with consistent properties across its length and/or width for coupling components to (e.g., substrates, coatings, release liners, display devices). In some embodiments, a first portion and a second portion can be positioned opposite a first major surface of the substrate. Providing a first portion and a second portion with the second material positioned therebetween can provide good bending performance as well as minimize a region of the foldable apparatus with a lower impact resistance (e.g., the portion including the second material compared to the portions comprising the first portion or the second portion).

In some embodiments, the second material 256 can comprise a lesser elastic modulus than the first material 254. By providing a second material comprising a lesser elastic modulus than that of a first material 254 and that of a shattered piece, flexibility of the foldable apparatus can be increased by reducing bending-induced stresses. In some embodiments, the elastic modulus of the first material 254 can be substantially equal to the elastic modulus of the second material 256.

In some embodiments, the second material 256 can comprise a polymer-based material. In further embodiments, the second material 256 can comprise the polymer-based portion described above. In further embodiments, the second material 256 can comprise a silicone-based polymer, an acrylate-based polymer, an epoxy-based polymer, a polyimide-based material, or a polyurethane. In even further embodiments, the second material 256 can comprise an ethylene acid copolymer. An exemplary embodiment of an ethylene acid copolymer includes SURLYN available from Dow (e.g., Surlyn PC-2000, Surlyn 8940, Surlyn 8150). Examples of epoxies include bisphenol-based epoxy resins, novolac-based epoxies, cycloaliphatic-based epoxies, and glycidylamine-based epoxies. In further embodiments, the second material can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and polyether ether ketone (PEEK). Example embodiments of polyolefins include low molecular weight polyethylene (LDPE), high molecular weight polyethylene (HDPE), ultrahigh molecular weight polyethylene (UHMWPE), and polypropylene (PP). Example embodiments of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example embodiments of elastomers include rubbers (e.g., polybutadiene, polyisoprene, chloroprene rubber, butyl rubber, nitrile rubber) and block copolymers (e.g., styrene-butadiene, high-impact polystyrene, polydichlorophosphazene) comprising one or more of polystyrene, polydichlorophosphazene, and poly(5-ethylidene-2-norbornene). Example of embodiments of polyurethanes comprise thermoset polyurethanes, for example, Dispurez 102 available from Incorez and thermoplastic polyurethanes, for example, KrystalFlex PE505 available from Huntsman. In some embodiments, the second material 256 can comprise one or more of a polyimide, a polyethylene terephthalate (PET), a polycarbonate (PC), or a poly methyl methacrylate (PMMA). An additional exemplary embodiment for the second material 256 comprises Eleglass w802-GL044 available from Axalta with from 1 wt % to 2 wt % cross-linker. In some embodiments, the second material 256 can comprise the same material(s) as the first material 254. In further embodiments, the second material 256 can comprise the same material composition (e.g., mixture, proportions) as the first material 254. For example, the first material 254 and the second material 256 can both comprise the adhesive described above or the polymer-based portion described above.

In some embodiments, the second material 256 can comprise a polymer-based material comprising a glass-transition (Tg) temperature. In further embodiments, the glass transition temperature of the second material 256 can be within one or more of the ranges discussed above for the glass transition temperature of the first material 254. Providing a second material with a glass transition temperature outside of an operating range (e.g., from about 0° C. to about 40° C., from about −20° C. to about 60° C.) of a foldable apparatus can enable the foldable apparatus to have consistent properties across the operating range.

In some embodiments, a storage modulus (i.e., modulus of elasticity) of the second material 256 can change by a multiple of about 200 or less, about 100 or less, about 50 or less, about 20 or less, about 10 or less, or about 5 or less when a temperature of the second material 256 is changed from about 100° C. to about −20° C. In some embodiments, a storage modulus of the second material 256 can change when a temperature of the second material 256 is changed from about 100° C. to about −20° C. by a multiple in a range from about 1 to about 200, from about 5 to about 200, from about 10 to about 100, from about 20 to about 100, from about 50 to about 100, from about 1 to about 100, from about 1 to about 50, from about 1 to about 20, from about 1 to about 10, or any range or subrange therebetween. In some embodiments, the storage modulus of the second material 256 may change by a greater multiple than the storage modulus of the first material 254. In some embodiments, the storage modulus of the second material 256 may change by a lesser multiple than the storage modulus of the first material 254. In some embodiments, the storage modulus of the second material 256 may change by a substantially the same multiple as the storage modulus of the first material 254.

In some embodiments, the second material 256 can comprise a polymer-based material comprising a glassy plateau. In further embodiment, the storage modulus (e.g., modulus of elasticity) of the second material 256 in the glassy plateau can within one or more of the ranges discussed above for the storage modulus of the first material 254 in the glassy plateau. In further embodiments, the storage modulus of the second material 256 in the glassy plateau can be greater than the storage modulus of the first material 254 in the glass plateau. In further embodiments, the storage modulus of the second material 256 in the glassy plateau can be less than the storage modulus of the first material 254 in the glass plateau. In further embodiments, the storage modulus of the second material 256 in the glassy plateau can be substantially equal to the storage modulus of the first material 254 in the glass plateau.

In some embodiments, the second material 256 can remain within an elastic deformation regime. In some embodiments, the second material 256 can comprise a strain at yield of about 10% or more, about 50% or more, about 100% or more, about 150% or more, or about 200% or more. In some embodiments, the second material 256 can comprise a strain at yield in a range from about 10% to about 10,000%, from about 50% to about 5,000%, from about 100% to about 1,000%, from about 100% to about 500%, from about 100% to about 300%, from about 100% to about 200%, from about 150% to about 1,000%, from about 150% to about 500%, from about 200% to about 500%, or any range or subrange therebetween. In some embodiments, the second material can comprise one or more of a polyamide, LDPE, HDPE, PTFE, perfluoroalkoxyethylene, PVF, ETFE, polybutadiene rubber, nitrile rubber, and styrene-butadiene rubber. In some embodiments, as described below, the second material 256 may be cured in a bent configuration (e.g., when a bending force is applied to the foldable substrate). Curing the second material in a bent configuration can reduce the effective maximum strain on the second material as the foldable apparatus is bent between unfolded and folded configurations, which can allow more materials to be used as second materials while still keeping the first material within its elastic deformation regime.

As shown in FIGS. 2-5, 7-10, and 14-15, the foldable apparatus 101, 301, 401, 501, 701, 801, 901, 1001, 1402, and 1501 can comprise an adhesive layer 207 and, as shown in FIG. 13, the foldable test apparatus 1101 can comprise a test adhesive layer 1409. The adhesive layer 207 can comprise the adhesive (e.g., optically clear adhesive (OCA)) described above. The adhesive layer 207 can comprise a first contact surface 208. In some embodiments, as shown, the adhesive layer 207 can be disposed over the first major surface 203 of the foldable substrate 201, 803. In some embodiments, as shown, the adhesive layer 207 can be disposed over the first surface area 237 of the first major surface 203 in the first portion 221. In further embodiments, as shown in FIGS. 2-5, 9-10, and 14-15, the first contact surface 208 of the adhesive layer 207 can contact the first surface area 237 of the first major surface 203 in the first portion 221, and the adhesive layer 207 can be bonded to the first surface area 237. In some embodiments, as shown in FIGS. 2-5, 7-10, and 14-15, the first contact surface 208 of the adhesive layer 207 can be disposed over the third surface area 239 of the first major surface 203 in the second portion 223. In further embodiments, as shown in FIGS. 2-5, 9-10, and 14-15, the first contact surface 208 of the adhesive layer 207 can contact the third surface area 239 of the first major surface 203 in the second portion 223, and the adhesive layer 207 can be bonded to the third surface area 239. In some embodiments, as shown in FIGS. 2, 5, and 7-8, the first contact surface 208 of the adhesive layer 207 can be disposed over the second material 256. In further embodiments, as shown in FIG. 2, the first contact surface 208 of the adhesive layer 207 can be disposed over the second material 256 filling the recess 234. In further embodiments, as shown in FIGS. 2, 5, and 7-8, the first contact surface 208 of the adhesive layer 207 can contact the second contact surface 257 of the second material 256 and the adhesive layer 207 can be bonded to the second contact surface 257 of the second material 256. In some embodiments, the second material 256 can comprise the adhesive layer 207, and the adhesive layer 207 can fill the recess 234 defined between the first plane 204a and the first central surface area 233 of the central portion 225. In further embodiments, as shown in FIGS. 3-4, 9-10, and 14-15, the adhesive layer 207 can contact the first material 254.

As shown, the adhesive layer 207 can comprise a second contact surface 211 that can be opposite the first contact surface 208 and spaced from the first contact surface 208. In some embodiments, as shown in FIGS. 2-5 and 7-10, the second contact surface 211 of the adhesive layer 207 can comprise a planar surface. In further embodiments, as shown, the planar surface of the second contact surface 211 of the adhesive layer 207 can be parallel to the first plane 204a. A thickness of the adhesive layer 207 measured from a first surface area 237 and/or the third surface area 239 of the first major surface 203 of the foldable substrate to the second contact surface 211 of the adhesive layer 207 can be about 1 μm or more, about 5μm or more, about 10 μm or more, about 20 μm or more, about 100 μm or less, about 50 μm or less, or about 30 μm or less. In some embodiments, the thickness of the adhesive layer 207 can be in a range from about 1 μm to about 100 μm, from about 5μm to about 100 μm, from about 10 μm to about 100 μm, from about 20 μm to about 100 μm, from about 1 μm to about 50 μm, from about 5μm to about 50 μm, from about 10 μm to about 50 μm, from about 20 μm to about 50 μm, from about 1 μm to about 30 μm, from about 5μm to about 30 μm, from about 10 μm to about 30 μm, from about 20 μm to about 30 μm, or any range or subrange therebetween.

In some embodiments, the adhesive layer 207 can comprise an elastic modulus within one or more ranges discussed above with reference to elastic modulus of the first material 254. In some embodiments, the adhesive layer 207 can comprise an elastic modulus within one or more ranges discussed above with reference to the elastic modulus of the second material 256. In some embodiments, the adhesive layer 207 can comprise an elastic modulus of about 0.01 MegaPascals (MPa) or more, about 1 MPa or more, about 10 MPa or more, about 100 MPa or more, about 3,000 MPa or less, about 1,000 MPa or less, or about 300 MPa or less. In some embodiments, the adhesive layer 207 can comprise an elastic modulus in a range from about 0.01 MPa to about 3,000 MPa, from about 0.01 MPa to about 1 ,000 MPa, from about 0.01 MPa to about 300 MPa, from about 1 MPa to about 3,000 MPa, from about 1 MPa to about 1,000 MPa, from about 1 MPa to about 1,000 MPa, from about 1 MPa to about 500 MPa, from about 1 MPa to about 300 MPa, from about 10 MPa to about 3,000 MPa, from about 10 MPa to about 1,000 MPa, from about 10 MPa to about 300 MPa, from about 100 MPa to about 3,000 MPa, from about 100 MPa to about 1,000 MPa, from about 100 MPa to about 300 MPa, or any range or subrange therebetween. In further embodiments, the elastic modulus of adhesive layer 207 can be substantially identical to the elastic modulus of the first material 254 and/or the second material 256. In further embodiments, the elastic modulus of the adhesive layer 207 can be less than the elastic modulus of the first material 254 and/or the elastic modulus of the second material 256. In even further embodiments, the elastic modulus of the adhesive layer 207 may be less than the elastic modulus of the first material 254 by a multiple of 10 or more.

As shown in FIGS. 7-8, the first substrate 721 of the foldable apparatus 701 and 801 can comprise a sixth surface area 725 and a seventh surface area 723 opposite the sixth surface area 725. In some embodiments, as shown, the seventh surface area 723 of the first substrate 721 can face the first major surface 203 of the foldable substrate 201 or 803. In some embodiments, as shown, the seventh surface area 723 of the first substrate 721 can be disposed over the fifth contact surface 707a of the first adhesive portion 703a with the fifth contact surface 707a facing the seventh surface area 723 of the first substrate 721. In further embodiments, as shown, the seventh surface area 723 of the first substrate 721 can contact (e.g., be bonded to) the fifth contact surface 707a of the first adhesive portion 703a. In some embodiments, as shown, the seventh surface area 723 of the first substrate 721 can be a planar surface. In some embodiments, as shown, the sixth surface area 725 of the first substrate 721 can comprise a planar surface. In further embodiments, as shown, the sixth surface area 725 can be parallel to the seventh surface area 723. In further embodiments, as shown, the sixth surface area 725 can face the first contact surface 208 of the adhesive layer 207. In even further embodiments, as shown, the sixth surface area 725 can contact and be bonded with the first contact surface 208 of the adhesive layer 207.

A first substrate thickness can be defined between the sixth surface area 725 of the first substrate 721 and the seventh surface area 723 of the first substrate 721. In some embodiments, the first substrate thickness can be about 10 μm or more, about 25 μm or more, about 30 μm or more, about 50 μm or more, 80 μm or more, about 100 μm or more, about 125 μm or more, about 2 mm or less, about 500 μm or less, about 400 μm or less, about 200 μm or less, or about 125 μm or less. In some embodiments, the first substrate thickness can be in a range from about 10 μm to about 2 mm, from about 30 μm to about 2 mm, from about 50 μm to about 2 mm, from about 80 μm to about 2 mm, from about 80 μm to about 500 μm, from about 80 μm to about 400 μm, from about 80 μm to about 200 μm, from about 125 μm to about 200 μm, or any range or subrange therebetween. In some embodiments, the first substrate thickness can be in a range from about 10 μm to about 200 μm, from about 10 μm to about 125 μm, from about 10 μm to about 60 μm, from about 25 μm to about 60 μm, from about 30 μm to about 60 μm, from about 50 μm to about 60 μm, or any range or subrange therebetween. In some embodiments, the thickness of the first substrate 721 may be substantially uniform between the seventh surface area 723 and the sixth surface area 725 across its corresponding length (i.e., in the direction of the length 105 of the foldable apparatus) and/or its corresponding width (i.e., in the direction of the width 103 of the foldable apparatus).

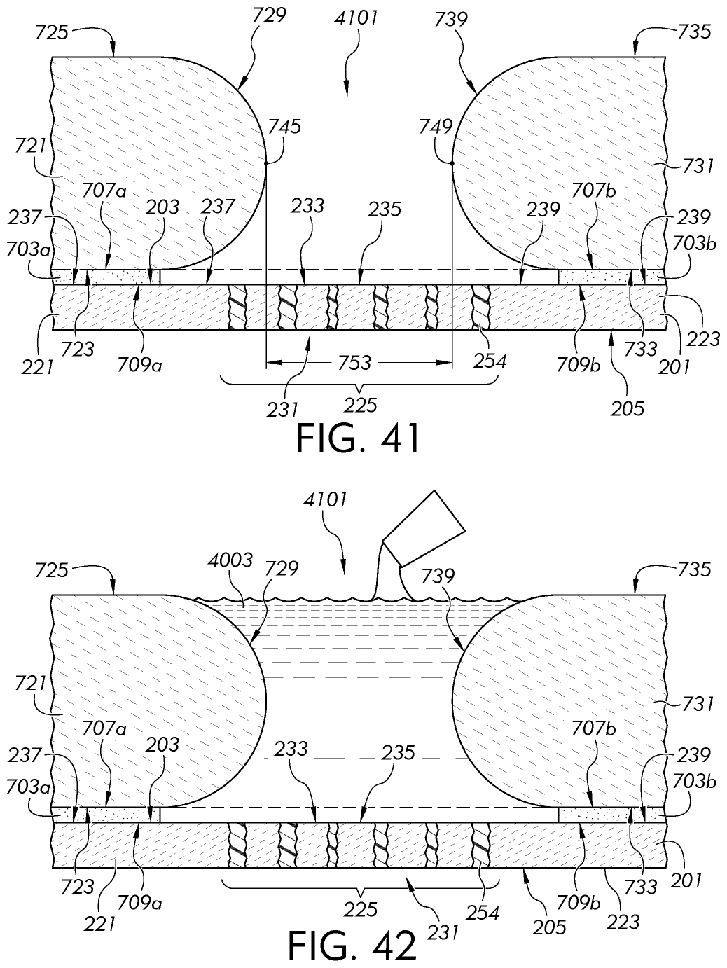

The first substrate 721 can comprise a first edge surface 729 defined between the sixth surface area 725 and the seventh surface area 723. The first edge surface 729 comprises an outer peripheral portion 745. In some embodiments, as shown, the first edge surface 729 can comprise a substantially right angle with the seventh surface area 723. In some embodiments, as shown in FIG. 41-42, the first edge surface can comprise a blunted edge surface. As used herein, a portion is considered to have a blunted edge if a surface of the edge forms an obtuse internal angle with the first surface area at an intersection between the first surface area and the surface of the edge and/or if a surface of the edge forms an obtuse internal angle with the second surface area at an intersection between the second surface area and the surface of the edge. As used herein, an internal angle is measured internally within the portion. As used herein, an obtuse angle is greater than 90 degrees and less than 180 degrees. For example, a blunted edge surface can be a chamfered edge surface, a curved surface, a rounded edge surface, an elliptical edge surface, a circular edge surface, or a combination thereof (e.g., compound edge surface).

As shown in FIGS. 7-8, the second substrate 731 of the foldable apparatus 701 and 801 can comprise an eighth surface area 735 and a ninth surface area 733 opposite the eighth surface area 735. In some embodiments, as shown, the ninth surface area 733 of the second substrate 731 can face the first major surface 203 of the foldable substrate 201 or 803. In some embodiments, as shown, the ninth surface area 733 of the second substrate 731 can be disposed over the seventh contact surface 707b of the second adhesive portion 703b. In further embodiments, as shown, the ninth surface area 733 of the second substrate 731 can contact (e.g., be bonded to) the seventh contact surface 707b of the second adhesive portion 703b. In some embodiments, as shown, the ninth surface area 733 of the second substrate 731 can be a planar surface. In some embodiments, as shown, the eighth surface area 735 of the second substrate 731 can comprise a planar surface. In further embodiments, as shown, the eighth surface area 735 can be parallel to the ninth surface area 733. In further embodiments, as shown, the eighth surface area 735 can face the first contact surface 208 of the adhesive layer 207. In even further embodiments, as shown, the eighth surface area 735 can contact and be bonded to the first contact surface 208 of the adhesive layer 207.

A second substrate thickness can be defined between the eighth surface area 735 of the second substrate 731 and the ninth surface area 733 of the second substrate 731. In some embodiments, the second substrate thickness can be within one or more of the ranges discussed above for the first substrate thickness. In further embodiments, the first substrate thickness can be substantially equal to the second substrate thickness. In some embodiments, the thickness of the second substrate 731 may be substantially uniform between the ninth surface area 733 and the eighth surface area 735 across its corresponding length (i.e., in the direction of the length 105 of the foldable apparatus) and/or its corresponding width (i.e., in the direction of the width 103 of the foldable apparatus).

In some embodiments, the first substrate 721 can comprise a glass-based substrate. For example, the first substrate 721 can comprise a glass-based substrate while the second substrate 731 can be a glass-based substrate and/or a ceramic-based substrate. In some embodiments, the first substrate 721 can comprise a ceramic-based substrate. For example, the first substrate 721 can comprise a ceramic-based substrate while the second substrate 731 can be a glass-based substrate and/or a ceramic-based substrate. In some embodiments, the first substrate 721 and/or the second substrate 731 can comprise an elastic modulus at 23° C. that can be within one or more of the ranges discussed for the elastic modulus of the foldable substrate 201 (e.g., first portion 221, shattered pieces). In some embodiments, the elastic modulus of the first substrate 721 can be substantially equal to the elastic modulus of the second substrate 731. In some embodiments, the elastic modulus of the first substrate 721 can be greater than the elastic modulus of the second material 256. In further embodiments, the elastic modulus of the second substrate 731 can be greater than the elastic modulus of the second material 256. Providing a first substrate and/or a second substrate comprising an elastic modulus greater than the elastic modulus of the second material can facilitate good bending performance and increase impact resistance.

In some embodiments, the first substrate 721 may be chemically strengthened. In further embodiments, the first substrate 721 may be chemically strengthened to form a seventh compressive stress region extending to a seventh depth from the sixth surface area 725. In further embodiments, the first substrate 721 may be chemically strengthened to form an eighth compressive stress region extending to an eighth depth from the seventh surface area 723. In some embodiments, the second substrate 731 may be chemically strengthened. In further embodiments, the second substrate 731 may be chemically strengthened to form a ninth compressive stress region extending to a ninth depth from the eighth surface area 735. In further embodiments, the second substrate 731 may be chemically strengthened to form a tenth compressive stress region extending to a tenth depth from the ninth surface area 733. The seventh depth, eighth depth, ninth depth, and/or tenth depth may comprise depths of compression in a range from about 10% to about 30% of the corresponding substrate thickness (e.g., first substrate thickness, second substrate thickness). The seventh compressive stress region can comprise a seventh maximum compressive stress that can be within one or more of the ranges discussed for the first maximum compressive stress. The eighth compressive stress region can comprise an eighth maximum compressive stress that can be within one or more of the ranges discussed for the first maximum compressive stress. The ninth compressive stress region can comprise a ninth maximum compressive stress that can be within one or more of the ranges discussed for the first maximum compressive stress. The tenth compressive stress region can comprise a tenth maximum compressive stress that can be within one or more of the ranges discussed for the first maximum compressive stress.

The second substrate 731 can comprise a second edge surface 739 defined between the eighth surface area 735 and the ninth surface area 733. The second edge surface 739 comprises an outer peripheral portion 749. In some embodiments, as shown, the second edge surface 739 can comprise a substantially right angle with the ninth surface area 733. In some embodiments, as shown in FIG. 41-42, the second edge surface can comprise a blunted edge surface. In some embodiments, as shown, the second edge surface 739 can substantially be a mirror image of the first edge surface 729.

As shown in FIG. 7, a minimum distance 753 can be defined between the outer peripheral portion 745 of the first edge surface 729 and the outer peripheral portion 749 of the second edge surface 739. In some embodiments, as shown in FIGS. 7-8, the second material 256 can be at least partially positioned between the first substrate 721 and the second substrate 731. Indeed, as shown in FIG. 7, the second material 256 can be positioned between the first edge surface 729 and the second edge surface 739 that faces the first edge surface 729. In further embodiments, as shown, the second material 256 can contact the first edge surface 729. In further embodiments, as shown, the second material 256 can contact the second edge surface 739. In some embodiments, as shown, the sixth surface area 725 and the eighth surface area 735 can extend along a plane 704. In further embodiments, as shown, a recess can be defined between the plane 704 and the first central surface area 233 of the foldable substrate 201 or 803. In even further embodiments, the second material 256 can fill (e.g., substantially entirely fill) the recess defined between the plane 704 and the first central surface area 233 of the foldable substrate 201 or 803.

In further embodiments, as shown, the first adhesive portion 703a can comprise a sixth contact surface 709a opposite the fifth contact surface 707a. In some embodiments, as shown, the sixth contact surface 709a can face the first surface area 237 of the first portion 221. In further embodiments, the sixth contact surface 709a can contact the first surface area 237 of the first portion 221. A thickness 705 of the first adhesive portion 703a can be defined between the first surface area 237 of the first portion 221 and the seventh surface area 723 of the first substrate 721. The thickness 705 of the first adhesive portion 703a can be within one or more of the ranges discussed above for the thickness of the adhesive layer 207 (e.g., from about 1 μm to about 30 μm). In some embodiments, the first adhesive portion 703a can attach the first surface area 237 to the seventh surface area 723.

In further embodiments, as shown, the second adhesive portion 703b can comprise an eighth contact surface 709b opposite the seventh contact surface 707b. In some embodiments, as shown, the eighth contact surface 709b can face the third surface area 239 of the second portion 223. In further embodiments, the eighth contact surface 709b can contact the third surface area 239 of the second portion 223. A thickness of the second adhesive portion 703b can be defined between the third surface area 239 of the second portion 223 and the ninth surface area 733 of the second substrate 731.The thickness of the second adhesive portion 703b can within one or more of the ranges discussed above for the thickness of the adhesive layer 207 (e.g., from about 1 μm to about 30 μm). In some embodiments, the second adhesive portion 703b can attach the third surface area 239 to the ninth surface area 733.

In some embodiments, the adhesive layer 207, the first adhesive portion 703a, and/or the second adhesive portion 703b can comprise an optically clear adhesive comprising a polymeric material (e.g., optically transparent polymer). Exemplary embodiments of optically clear adhesives can comprise, but are not limited to acrylic adhesives (e.g., 3M 8212 adhesive), an optically transparent liquid adhesive (e.g., a LOCTITE optically transparent liquid adhesive), and transparent acrylics, epoxies, silicones, and polyurethanes. For example, the optically transparent liquid adhesive could comprise one or more of LOCTITE AD 8650, LOCTITE AA 3922, LOCTITE EA E-05MR, LOCTITE UK U-09LV, which are all available from Henkel. In some embodiments, the adhesive layer can comprise the adhesive described above. In some embodiments, the adhesive layer 207, the first adhesive portion 703a, and/or the second adhesive portion 703b may not be optically transparent. In some embodiments, the adhesive layer 207, the first adhesive portion 703a, and/or the second adhesive portion 703b may comprise one or more of the materials discussed above for the first material 254 or the second material 256.

In some embodiments, the foldable substrate 201 or 803 can be optically transparent. In further embodiments, the first material 254 can be optically transparent. In further embodiments, the second material 256 can be optically transparent. In further embodiments, the adhesive layer 207 can be optically transparent (e.g., comprise an optically clear adhesive (OCA)). In still further embodiments, all of the foldable substrate 201 or 803, the first material 254, the second material 256, and the adhesive layer 207 can be optically transparent. In further embodiments, the first adhesive portion 703a can be optically transparent (e.g., comprise an optically clear adhesive (OCA)). In further embodiments, the second adhesive portion 703b can be optically transparent (e.g., comprise an optically clear adhesive (OCA)). In further embodiments, the first substrate 721 can be optically transparent. In further embodiments, the second substrate 731 can be optically transparent. In still further embodiments, all of the first adhesive portion 703a, the second adhesive portion 703b, the first substrate 721, and the second substrate 731 can be optically transparent.

The foldable substrate 201 or 803 can be optically transparent. One or more (e.g., all) pieces of the plurality of pieces comprising the shattered pane 231 can be optically transparent. In some embodiments, an index of refraction of the foldable substrate 201 or 803 (e.g., piece of the plurality of shattered pieces 1305 comprising the shattered pane 231) may be about 1 or more, about 1.3 or more, about 1.4 or more, about 1.45 or more, about 1.49 or more, about 3 or less, about 2 or less, about 1.7 or less, about 1.6 or less, or about 1.55 or less. In some embodiments, the index of refraction of the foldable substrate 201 or 803 (e.g., piece of the plurality of shattered pieces 1305 comprising the shattered pane 231, pane of the plurality of panes 950) can be in a range from about 1 to about 3, from about 1 to about 2 from about 1 to about 1.7, from about 1.3 to about 3, from about 1.3 to about 2, from about 1.3 to about 1.7, from about 1.4 to about 2, from about 1.4 to about 1.7, from about 1.45 to about 1.7, from about 1.45 to about 1.6, from about 1.49 to about 1.6, from about 1.49 to about 1.55, or any range or subrange therebetween.

As used herein, a first surface refractive index is measured at the first major surface comprising a shattered piece of the plurality of shattered pieces comprising the shattered pane or a pane of the plurality of panes. As used herein, a second surface refractive index is measured at the second major surface comprising a shattered piece of the plurality of shattered pieces comprising the shattered pane or a pane of the plurality of panes. As used herein, a central refractive index is measured at a midpoint of the substrate thickness comprising a shattered piece of the plurality of shattered pieces comprising the shattered pane or a pane of the plurality of panes. Unlike the other refractive indices discussed herein, the first surface refractive index, the second surface refractive index, and the central refractive index are measured through a portion of the shattered pane or plurality of panes substantially perpendicular to a direction of the thickness of the shattered pane or plurality of panes (e.g., central thickness 226). In some embodiments, the first surface refractive index can be substantially equal to the second surface refractive index. In some embodiments, the second surface refractive index can be greater than the first surface refractive index.

Throughout the disclosure, a magnitude of a difference between two values or an absolute difference between two values is the absolute value of the difference between the two values. In some embodiments, an absolute difference between the first surface refractive index and the central refractive index is about 0.006 or less, about 0.005 or less, about 0.004 or less, about 0.001 or more, about 0.001 or more, or about 0.003. In some embodiments, an absolute difference between the first surface refractive index and the central refractive index can be in a range from about 0.001 to about 0.006, form about 0.001 to about 0.005, from about 0.002 to about 0.005, from about 0.002 to about 0.004, from about 0.003 to about 0.004, or any range or subrange therebetween. In some embodiments, the first surface refractive index can be greater than the central refractive index.

In some embodiments, an absolute difference between the second surface refractive index and the central refractive index is about 0.006 or less, about 0.005 or less, about 0.004 or less, about 0.001 or more, about 0.001 or more, or about 0.003. In some embodiments, an absolute difference between the second surface refractive index and the central refractive index can be in a range from about 0.001 to about 0.006, form about 0.001 to about 0.005, from about 0.002 to about 0.005, from about 0.002 to about 0.004, from about 0.003 to about 0.004, or any range or subrange therebetween. In some embodiments, the second surface refractive index can be greater than the central refractive index.

In some embodiments, the first material 254 can be optically transparent. In some embodiments, the first material 254 can comprise an index of refraction that can be within any of the ranges for the index of refraction of the foldable substrate 201 or 803 discussed above. The first material 254 can further be selected to have an index of refraction that substantially matches an index of refraction of the shattered piece of the plurality of shattered pieces 1305 to avoid optical distortions that may otherwise occur with a mismatched index of refraction. For example, to avoid optical distortions, a differential equal to the absolute value of the difference between the index of refraction of the shattered piece of the plurality of shattered pieces 1305 and the index of refraction of the first material 254 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In some embodiments, the index of refraction of the shattered piece of the plurality of shattered pieces 1305 may be greater than or less than the index of refraction of first material 254. In further embodiments, the magnitude of the difference between the index of refraction of the first material 254 and the index of refraction of the shattered piece of the plurality of shattered pieces 1305 can be at least 0.02 in order achieve angular-dependent haze properties, as discussed below. In further embodiments, the magnitude of the difference can be about 0.02 or more, about 0.03 or more, about 0.05 or more, about 0.07 or more, about 0.10 or less, about 0.08 or less, or about 0.06 or less. In further embodiments, the magnitude of the difference can be in a range from about 0.02 to about 0.10, from about 0.02 to about 0.08, from about 0.02 to about 0.06, from about 0.03 to about 0.06, from about 0.03 to about 0.05, from about 0.03 to about 0.10, from about 0.05 to about 0.10, from about 0.05 to about 0.08, from about 0.05 to about 0.06, from about 0.07 to about 0.10, from about 0.07 to about 0.08, or any range or subrange therebetween. In some embodiments, an absolute difference between the first surface refractive index and the refractive index of the first material 254 can be within one or more of the ranges discussed above in this paragraph. In some embodiments, an absolute difference between the central refractive index and the refractive index of the first material 254 can be within one or more of the ranges discussed above in this paragraph. In some embodiments, an absolute difference between the second surface refractive index and the refractive index of the first material 254 can be within one or more of the ranges discussed above in this paragraph.

In some embodiments, the second material 256 can comprise an index of refraction in a range of the index of refraction of the first material 254 discussed above. In some embodiments, the second material 256 can further be selected to have an index of refraction that substantially matches an index of refraction of the shattered piece of the plurality of shattered pieces 1305 to avoid optical distortions that may otherwise occur with a mismatched index of refraction. For example, to avoid optical distortions, a differential equal to the absolute value of the difference between the index of refraction of the shattered piece of the plurality of shattered pieces 1305 and the index of refraction of the second material 256 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In further embodiments, the differential can be in a range from about 0.0001 to about 0.02, from about 0.005 to about 0.02, from about 0.01 to about 0.02, from about 0.0001 to about 0.01, from about 0.005 to about 0.01, or any range or subrange therebetween. In some embodiments, the index of refraction of the shattered piece of the plurality of shattered pieces 1305 may be greater than or less than the index of refraction of the second material 256.

In some embodiments, the adhesive layer 207 can comprise an optically clear adhesive comprising an index of refraction in a range of the index of refraction of the first material 254 discussed above. In some embodiments, the adhesive layer 207 can further be selected to have an index of refraction that substantially matches an index of refraction of the shattered piece of the plurality of shattered pieces 1305 to avoid optical distortions that may otherwise occur with a mismatched index of refraction. For example, to avoid optical distortions, a differential equal to the absolute value of the difference between the index of refraction of the shattered piece of the plurality of shattered pieces 1305 and the index of refraction of the adhesive layer 207 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In some embodiments, the index of refraction of the shattered piece of the plurality of shattered pieces 1305 may be greater than or less than the index of refraction of the adhesive layer 207.

In some embodiments, the first substrate 721 can comprise an index of refraction in a range of the index of refraction of the first material 254 discussed above. In some embodiments, the first substrate 721 can further be selected to have an index of refraction that substantially matches an index of refraction of the shattered piece of the plurality of shattered pieces 1305 to avoid optical distortions that may otherwise occur with a mismatched index of refraction. For example, to avoid optical distortions, a differential equal to the absolute value of the difference between the index of refraction of the shattered piece of the plurality of shattered pieces 1305 and the index of refraction of the first substrate 721 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In further embodiments, the differential can be in a range from about 0.0001 to about 0.02, from about 0.005 to about 0.02, from about 0.01 to about 0.02, from about 0.0001 to about 0.01, from about 0.005 to about 0.01, or any range or subrange therebetween. In some embodiments, the index of refraction of the shattered piece of the plurality of shattered pieces 1305 may be greater than or less than the index of refraction of the first substrate 721.

In some embodiments, the second substrate 731 can comprise an index of refraction in a range of the index of refraction of the first material 254 discussed above. In some embodiments, the second substrate 731 can further be selected to have an index of refraction that substantially matches an index of refraction of the shattered piece of the plurality of shattered pieces 1305 to avoid optical distortions that may otherwise occur with a mismatched index of refraction. For example, to avoid optical distortions, a differential equal to the absolute value of the difference between the index of refraction of the shattered piece of the plurality of shattered pieces 1305 and the index of refraction of the second substrate 731 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In further embodiments, the differential can be in a range from about 0.0001 to about 0.02, from about 0.005 to about 0.02, from about 0.01 to about 0.02, from about 0.0001 to about 0.01, from about 0.005 to about 0.01, or any range or subrange therebetween. In some embodiments, the index of refraction of the shattered piece of the plurality of shattered pieces 1305 may be greater than or less than the index of refraction of the second substrate 731.

In some embodiments, the coating 281 can comprise an index of refraction in a range of the index of refraction of the first material 254 discussed above. In some embodiments, the coating 281 can further be selected to have an index of refraction that substantially matches an index of refraction of the shattered piece of the plurality of shattered pieces 1305 to avoid optical distortions that may otherwise occur with a mismatched index of refraction. For example, to avoid optical distortions, a differential equal to the absolute value of the difference between the index of refraction of the shattered piece of the plurality of shattered pieces 1305 and the index of refraction of the coating 281 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In further embodiments, the differential can be in a range from about 0.0001 to about 0.02, from about 0.005 to about 0.02, from about 0.01 to about 0.02, from about 0.0001 to about 0.01, from about 0.005 to about 0.01, or any range or subrange therebetween. In some embodiments, the index of refraction of the shattered piece of the plurality of shattered pieces 1305 may be greater than or less than the index of refraction of the coating 281.

In some embodiments, the first material 254 can further be selected to have an index of refraction that substantially matches an index of refraction of the pane of the plurality of panes 950 to avoid optical distortions that may otherwise occur with a mismatched index of refraction. For example, to avoid optical distortions, a differential equal to the absolute value of the difference between the index of refraction of the pane of the plurality of panes 950 and the index of refraction of the first material 254 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In some embodiments, the index of refraction of the pane of the plurality of panes 950 may be greater than or less than the index of refraction of first material 254. In further embodiments, the magnitude of the difference between the index of refraction of the first material 254 and the index of refraction of the pane of the plurality of panes 950 can be at least 0.02 in order achieve angular-dependent haze properties, as discussed below. In further embodiments, the magnitude of the difference can be about 0.02 or more, about 0.03 or more, about 0.05 or more, about 0.07 or more, about 0.10 or less, about 0.08 or less, or about 0.06 or less. In further embodiments, the magnitude of the difference can be in a range from about 0.02 to about 0.10, from about 0.02 to about 0.08, from about 0.02 to about 0.06, from about 0.03 to about 0.06, from about 0.03 to about 0.05, from about 0.03 to about 0.10, from about 0.05 to about 0.10, from about 0.05 to about 0.08, from about 0.05 to about 0.06, from about 0.07 to about 0.10, from about 0.07 to about 0.08, or any range or subrange therebetween. In some embodiments, an absolute difference between the first surface refractive index and the refractive index of the first material 254 can be within one or more of the ranges discussed above in this paragraph. In some embodiments, an absolute difference between the central refractive index and the refractive index of the first material 254 can be within one or more of the ranges discussed above in this paragraph. In some embodiments, an absolute difference between the second surface refractive index and the refractive index of the first material 254 can be within one or more of the ranges discussed above in this paragraph.

In some embodiments, the second material 256 can further be selected to have an index of refraction that substantially matches an index of refraction of the pane of the plurality of panes 950 to avoid optical distortions that may otherwise occur with a mismatched index of refraction. For example, to avoid optical distortions, a differential equal to the absolute value of the difference between the index of refraction of the pane of the plurality of panes 950 and the index of refraction of the second material 256 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In further embodiments, the differential can be in a range from about 0.0001 to about 0.02, from about 0.005 to about 0.02, from about 0.01 to about 0.02, from about 0.0001 to about 0.01, from about 0.005 to about 0.01, or any range or subrange therebetween. In some embodiments, the index of refraction of the pane of the plurality of panes 950 may be greater than or less than the index of refraction of the second material 256.

In some embodiments, the adhesive layer 207 can further be selected to have an index of refraction that substantially matches an index of refraction of the pane of the plurality of panes 950 to avoid optical distortions that may otherwise occur with a mismatched index of refraction. For example, to avoid optical distortions, a differential equal to the absolute value of the difference between the index of refraction of the pane of the plurality of panes 950 and the index of refraction of the adhesive layer 207 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In some embodiments, the index of refraction of the pane of the plurality of panes 950 may be greater than or less than the index of refraction of the adhesive layer 207.

In some embodiments, the first substrate 721 and/or the second substrate 731 can further be selected to have an index of refraction that substantially matches an index of refraction of the pane of the plurality of panes 950 to avoid optical distortions that may otherwise occur with a mismatched index of refraction. For example, to avoid optical distortions, a differential equal to the absolute value of the difference between the index of refraction of the shattered piece of the pane of the plurality of panes 950 and the index of refraction of the first substrate 721 and/or the second substrate 731 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In further embodiments, the differential can be in a range from about 0.0001 to about 0.02, from about 0.005 to about 0.02, from about 0.01 to about 0.02, from about 0.0001 to about 0.01, from about 0.005 to about 0.01, or any range or subrange therebetween. In some embodiments, the index of refraction of the pane of the plurality of panes 950 may be greater than or less than the index of refraction of the first substrate 721 and/or the second substrate 731.

In some embodiments, the coating 281 can comprise an index of refraction in a range of the index of refraction of the first material 254 discussed above. In some embodiments, the coating 281 can further be selected to have an index of refraction that substantially matches an index of refraction of the shattered piece of the pane of the plurality of panes 950 to avoid optical distortions that may otherwise occur with a mismatched index of refraction. For example, to avoid optical distortions, a differential equal to the absolute value of the difference between the index of refraction of the pane of the plurality of panes 950 and the index of refraction of the coating 281 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In further embodiments, the differential can be in a range from about 0.0001 to about 0.02, from about 0.005 to about 0.02, from about 0.01 to about 0.02, from about 0.0001 to about 0.01, from about 0.005 to about 0.01, or any range or subrange therebetween. In some embodiments, the index of refraction of the pane of the plurality of panes 950 may be greater than or less than the index of refraction of the coating 281.

In some embodiments, a differential equal to the absolute value of the difference between the index of refraction of the first material 254 and the index of refraction of the second material 256 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In further embodiments, the differential can be in a range from about 0.0001 to about 0.02, from about 0.005 to about 0.02, from about 0.01 to about 0.02, from about 0.0001 to about 0.01, from about 0.005 to about 0.01, or any range or subrange therebetween. In some embodiments, the index of refraction of the first material 254 may be greater than or less than the index of refraction of the second material 256.

In some embodiments, a differential equal to the absolute value of the difference between the index of refraction of the first material 254 and the index of refraction of the adhesive layer 207 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In further embodiments, the differential can be in a range from about 0.0001 to about 0.02, from about 0.005 to about 0.02, from about 0.01 to about 0.02, from about 0.0001 to about 0.01, from about 0.005 to about 0.01, or any range or subrange therebetween. In some embodiments, the index of refraction of the first material 254 may be greater than or less than the index of refraction of the adhesive layer 207.

In some embodiments, a differential equal to the absolute value of the difference between the index of refraction of the adhesive layer 207 and the index of refraction of the second material 256 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.001 to about 0.05, from about 0.01 to about 0.1, from about 0.01 to about 0.07, from about 0.01 to about 0.05, from about 0.02 to about 0.1, from about 0.02 to about 0.07, from about 0.02 to about 0.05, or any range or subrange therebetween. In further embodiments, the differential can be in a range from about 0.0001 to about 0.02, from about 0.005 to about 0.02, from about 0.01 to about 0.02, from about 0.0001 to about 0.01, from about 0.005 to about 0.01, or any range or subrange therebetween. In some embodiments, the index of refraction of the adhesive layer 207 may be greater than or less than the index of refraction of the second material 256.

The foldable apparatus can comprise a haze as a function of an angle of illumination relative to a direction normal to the second major surface of the foldable apparatus. In some embodiments, the haze at about 0° relative to an angle of incidence normal to the second major surface 205 of the foldable substrate 201 or 803 of the foldable apparatus can be about 10% or less, about 8% or less, about 5% or less, about 2% or less, or about 1% or less. In some embodiments, the haze at about 0° relative to an angle of incidence normal to the second major surface 205 of the foldable substrate 201 or 803 of the foldable apparatus can be in a range from 0% to about 20%, from 0% to 15%, from 0% to 10%, from about 1% to about 10%, from about 2% to about 10%, from about 5% to about 10%, from about 8% to about 10%, from about 1% to about 8%, from about 1% to about 5%, from about 2% to about 5%, or any range or subrange therebetween. In some embodiments, the haze at about 10° relative to an angle of incidence normal to the second major surface 205 of the foldable apparatus can be within one or more of the ranges specified above for 0°. In some embodiments, the haze at about 20° relative to an angle of incidence normal to the second major surface 205 of the foldable apparatus can be within one or more of the ranges specified above for 0°. Providing a substrate comprising low haze can enable good visibility through the substrate.

In some embodiments, the haze at about 20° relative to an angle of incidence normal to the second major surface 205 of the foldable substrate 201 or 803 of the foldable apparatus can be about 50% or less, about 30% or less, about 20% or less, about 15% or less, about 10% or less, 0% or more, about 1% or more, about 2% or more, about 5% or more, about 8% or more. In some embodiments, the haze at about 20° relative to an angle of incidence normal to the second major surface 205 of the foldable substrate 201 or 803 of the foldable apparatus can be in a range from 0% to about 50%, from 0% to about 30%, from about 1% to about 30%, from about 1% to about 20%, from about 2% to about 20%, from about 5% to about 20%, from about 5% to about 15%, from about 5% to about 10%, from about 8% to about 10%, or any range or subrange therebetween. In some embodiments, the haze at about 20° can be greater than the haze at 0° by about 1% or more, about 2% or more, 5% or more, about 15% or less, about 10% or less, or about 8% or less. Providing a first material comprising a similar (e.g., a magnitude of a difference of about 0.02 or less) refractive index than a refractive index of a shattered piece can reduce an angle-dependent visibility (e.g., haze, color shift) through the foldable apparatus.

In some embodiments, the haze at about 20° relative to an angle of incidence normal to the second major surface 205 of the foldable substrate 201 or 803 of the foldable apparatus can be about 10% or more, about 15% or more, about 20% or more, about 25% or more, about 30% or more, or about 50% or more. In some embodiments, the haze at about 20° relative to an angle of incidence normal to the second major surface 205 of the foldable substrate 201 or 803 of the foldable apparatus can be in a range from 10% to about 200%, from 10% to 150%, from 10% to 100%, from about 10% to about 80%, from about 10% to about 50%, from about 15% to about 50%, from about 20% to about 50%, from about 25% to about 50%, from about 30% to about 50%, from about 25% to about 200%, from about 25% to about 150%, from about 25% to about 100%, from about 25% to about 50%, or any range or subrange therebetween. In some embodiments, the haze at about 20° can be greater than the haze at 0° by about 5% or more, about 10% or more, about 25% or more, about 50% or more, or about 100% or more. Providing a first material comprising a different (e.g., a magnitude of a difference of about 0.02 or more) refractive index than a refractive index of a shattered piece can produce an angle-dependent visibility (e.g., haze, color shift) through the foldable apparatus. In further embodiments, providing the different refractive indices can be useful as a privacy screen. For example, visibility may be at a maxima (e.g., maximum) when viewed at a direction normal to the surface (e.g., first major surface) of the foldable apparatus, and that visibility may decrease (e.g., increasing haze) as an angle relative to a direction normal to the surface is increased. In some embodiments, the haze at about 20° can be greater than the haze at about 10° by an amount that is within one or more of the ranges discussed above in this paragraph for the amount that the haze at about 20° can be greater than the haze at 0°.

Providing a foldable apparatus comprising a shattered pane or a plurality of panes with a low difference (e.g., about 0.008 or less) between a refractive index at a major surface of the foldable apparatus and a central location of the foldable apparatus can minimize optical distortions from the plurality of shattered pieces comprising the shattered pane or the plurality of panes. Also, Providing a foldable apparatus comprising a shattered pane or a plurality of panes with a low difference (e.g., about 0.008 or less) between a refractive index at a major surface of the foldable apparatus and a central location of the foldable apparatus can minimize optical distortions between an adjacent pair of shattered pieces of the plurality of shattered pieces or an adjacent pair of panes of the plurality panes and a first material positioned therebetween, if provided. Also, providing a shattered pane with a plurality of shattered pieces attached together by a first material can provide a smooth (e.g., regular, planar) surface (e.g., first major surface), especially when the shattered pane was generated from a substrate deposed on a backer when it was shattered. Providing a smooth surface of the foldable apparatus can reduce optical distortions. Likewise, providing a second material disposed over substantially an entire second major surface of a foldable substrate can reduce optical distortions. In some embodiments, the first material can substantially match (e.g., a magnitude of a difference of about 0.1 or less) a refractive index of a shattered piece or a pane, which can minimize the visibility of the shattered pane or the plurality of panes to a user. In some embodiments, providing the first material between a pair of shattered pieces or a pair of shattered panes can produce an anti-glare and/or anti-reflective property in the foldable apparatus that can improve visibility of an electronic device that the foldable apparatus may be disposed over. In some embodiments, providing a first material comprising a different (e.g., a magnitude of a difference of about 0.02 or more) refractive index than a refractive index of a shattered piece or a pane can produce an angle-dependent visibility (e.g., haze, color shift) through the foldable apparatus. In further embodiments, providing the different refractive indices can be useful as a privacy screen. For example, visibility may be at a maxima (e.g., maximum) when viewed at a direction normal to the surface (e.g., first major surface) of the foldable apparatus, and that visibility may decrease (e.g., increasing haze) as an angle relative to a direction normal to the surface is increased.

In some embodiments, as shown in FIGS. 2, 4, and 6-9, the release liner 213 can be disposed over the adhesive layer 207. In even further embodiments, as shown, the release liner 213 can directly contact (e.g., be bonded to) the second contact surface 211 of the adhesive layer 207. In some embodiments, as shown in FIGS. 2, and 6-8, the release liner 213 can be disposed over the second contact surface 257 of the second material 256. In further embodiments, as shown in FIG. 6, the release liner 213 can contact the second contact surface 257 of the second material 256. The release liner 213 can comprise a first major surface 215 and a second major surface 217 opposite the first major surface 215. As shown in FIGS. 2, 4, and 7-9, the release liner 213 can be disposed on the adhesive layer 207 by attaching the second contact surface 211 of the adhesive layer 207 to the second major surface 217 of the release liner 213. As shown in FIG. 6, the release liner 213 can be disposed on the second material 256 by attaching the second contact surface 257 of the second material 256 to the second major surface 217 of the release liner 213. In some embodiments, as shown, the first major surface 215 of the release liner 213 can comprise a planar surface. In some embodiments, as shown, the second major surface 217 of the release liner 213 can comprise a planar surface. The release liner 213 can comprise a paper and/or a polymer. Exemplary embodiments of paper comprise kraft paper, machine finished paper, polycoated paper (e.g., polymer coated, glassine paper, siliconized paper), or clay coated paper. Exemplary embodiments of polymers comprise polyesters (e.g., polyethylene terephthalate (PET)) and polyolefins (e.g., low-density polyethylene (LDPE), high-density polyethylene (HDPE), polypropylene (PP)).

In some embodiments, as shown in FIGS. 3, 5, 10, and 14-15, the display device 303 of the foldable apparatus 301, 501, 1001, 1402, and 1501 can be disposed over the adhesive layer 207. In further embodiments, as shown, the display device 303 can directly contact (e.g., be bonded to) to the second contact surface 211 of the adhesive layer 207. In some embodiments, producing the foldable apparatus 301 may be achieved by removing the release liner 213 of the foldable apparatus 101, 401, 601, 701, 801, and 901 of FIGS. 2, 4, and 6-9 and attaching the display device 303 to the second contact surface 211 of the adhesive layer 207. Alternatively, for example with reference to FIG. 3, the foldable apparatus 301 may be produced without the extra step of removing a release liner 213 before attaching the display device 303 to the second contact surface 211 of the adhesive layer 207, for example, when a release liner 213 is not applied to the second contact surface 211 of the adhesive layer 207. The display device 303 can comprise a first major surface 309 and a second major surface 311 opposite the first major surface 309. As shown, the display device 303 can be disposed on the adhesive layer 207 by attaching the second contact surface 211 of the adhesive layer 207 to the second major surface 311 of the display device 303. In some embodiments, as shown, the first major surface 309 of the display device 303 can comprise a planar surface. In some embodiments, as shown, the second major surface 311 of the display device 303 can comprise a planar surface. In some embodiments, as shown in FIG. 5, the display device 303 can be disposed over the second contact surface 257 of the second material 256. In further embodiments, although not shown, it is to be understood that the adhesive layer 207 could be omitted such that the display device 303 contacts the second contact surface 257 of the second material 256 similar to the arrangement shown in FIG. 6 with the release liner 213. The display device 303 can comprise a liquid crystal display (LCD), an electrophoretic displays (EPD), an organic light emitting diode (OLED) display, or a plasma display panel (PDP). In some embodiments, the display device 303 can be part of a portable electronic device, for example, a smartphone, a tablet, a wearable device, or a laptop.

In some embodiments, the foldable apparatus 101, 301, 401, 501, 601, 701, 801, 901, and 1001 may be substantially symmetric about a plane (e.g., see plane 109 in FIGS. 1-10). The plane 109, in some embodiments, may comprise a central axis 107 of the foldable apparatus that can be positioned at the second major surface 205 of the foldable substrate 201. As further illustrated, in some embodiments, the plane 109 may comprise the fold axis 102 of the foldable apparatus. In some embodiments, the foldable apparatus can be folded in a direction 111 (e.g., see FIG. 1) about the fold axis 102 to form a folded configuration (e.g., see FIGS. 13-15). As shown, the foldable apparatus may include a single fold axis to allow the foldable apparatus to comprise a bifold wherein, for example, the foldable apparatus may be folded in half. In further embodiments, the foldable apparatus may include two or more fold axes with each fold axis including a corresponding central portion similar or identical to the central portion 225 discussed above. For example, providing two fold axes can allow the foldable apparatus to comprise a trifold wherein, for example, the foldable apparatus may be folded with three portions comprising the first portion 221, the second portion 223 and a third portion similar or identical to the first or second portion.

FIGS. 11 and 13-15 schematically illustrate example embodiments of the foldable apparatus 1402 and 1501 or the foldable test apparatus 1101 in accordance with embodiments of the disclosure in the folded configuration. Although not shown, the foldable apparatus can be folded such that the display device 303 is on the outside of the folded foldable apparatus while the second major surface 205 of the foldable substrate 201 is on the inside of the folded foldable apparatus, for example if a PET sheet 1407 was replaced with the display device 303 for the test foldable apparatus 1101 shown in FIG. 13. A user would view the display device 303 through the foldable substrate 201 and, thus, would be viewing from the side of the second major surface 205. Alternatively, a display device 303 could be disposed over the second major surface 205, so that a user would view the display device 303 from the side of the first major surface 203. In this alternative configuration, the foldable apparatus could be bent in a direction so that either the first major surface 203 faces itself (similar to the configuration in FIG. 14) or in a direction so that the second major surface 205 faces itself (similar to the configuration in FIG. 13).

FIGS. 14-15 schematically illustrates the foldable apparatus 1402 and 1501 in accordance with further embodiments of the disclosure in the folded configuration. FIGS. 14-15 shows that the foldable apparatus 1402 and 1501 is folded such that the second major surface 205 of the foldable substrate 201 is on the outside of the folded foldable apparatus 1402 and 1501 while the display device 303 is on the inside of the folded foldable apparatus 1402 and 1501. That is, a user would be viewing from the side of the second major surface 205 to view the display device 303 through the foldable substrate 201. Again, though, a user would be positioned on the side of the second major surface 205 to view the display device 303 through the foldable substrate 201.

As used herein, “foldable” includes complete folding, partial folding, bending, flexing, or multiple capabilities. As used herein, the terms “fail,” “failure” and the like refer to breakage, destruction, delamination, or crack propagation. A foldable substrate achieves an effective bend radius of “X,” or has an effective bend radius of “X,” or comprises an effective bend radius of “X” if it resists failure when the substrate is held at an effective bend radius of “X” for 24 hours at about 60° C. and about 90% relative humidity.

As used herein, the “effective minimum bend radius” and the “parallel plate distance” of a foldable substrate (e.g., foldable substrate 201 or 803) or a foldable substrate is measured with the following test configuration and process using a parallel plate apparatus 1401 (see FIG. 13) that comprises a pair of parallel rigid stainless-steel plates 1403, 1405 comprising a first rigid stainless-steel plate 1403 and a second rigid stainless-steel plate 1405. When measuring the “effective minimum bend radius” or the “parallel plate distance”, a test adhesive layer 1409 comprises a thickness of 50 μm between the second contact surface 1413 of the test adhesive layer 1409 and the first surface area 237 and/or the third surface area 239 of the first major surface 203 of the foldable substrate 201 (e.g., first contact surface 1415 of the test adhesive layer 1409). The test adhesive layer comprises an optically clear adhesive comprising an elastic modulus of 0.1 MPa. When measuring the “effective minimum bend radius” and the “parallel plate distance”, the test is conducted with a 100 μm thick sheet 1407 of polyethylene terephthalate (PET) rather than the display device 303 shown in FIGS. 3, 5, and 10 or the release liner 213 shown in FIGS. 2, 4, and 6-9. Thus, during the test to determine the “effective minimum bend radius” and the “parallel plate distance”, neither the display device 303 nor the release liner 213 is used. Rather than the display device 303 or release liner 213, the 100 μm thick sheet of polyethylene terephthalate (PET) is attached to the second contact surface 1413 of the test adhesive layer 1409 in an identical manner that the release liner 213 is attached to the second contact surface 211 of the adhesive layer 207 as shown in FIG. 2. When preparing a foldable test apparatus for foldable apparatus 101 shown in FIG. 2, the release liner 213 and the adhesive layer 207 are removed, and then the first contact surface 1415 of the test adhesive layer 1409 is attached to the first surface area 237, the third surface area 239, and the fourth contact surface 257 of the second material 256 with the PET sheet 1407 attached to the second contact surface 1413 of the test adhesive layer 1409. When preparing a foldable test apparatus for foldable apparatus 301, 901, or 1001 shown in FIGS. 3 and 9-10, the display device 303 or the release liner 213 and the adhesive layer 207 is removed, and then the first contact surface 1415 of the test adhesive layer 1409 is attached to the first surface area 237, the third surface area 239, and the first material 254 with the PET sheet 1407 attached to the second contact surface 1413 of the test adhesive layer 1409. When preparing a foldable test apparatus for foldable apparatus 401 shown in FIG. 4, the release liner 213 and the adhesive layer 207 are removed, and then the first contact surface 1415 of the test adhesive layer 1409 is attached the first major surface 203 (e.g., first surface area 237, third surface area 239, first central surface area 235) of the foldable substrate 201 with the PET sheet 1407 attached to the second contact surface 1413 of the test adhesive layer 1409. When preparing a foldable test apparatus for foldable apparatus 501 shown in FIG. 5, the display device 303 and the adhesive layer 207 are removed, and then the first contact surface 1415 of the test adhesive layer 1409 is attached to the fourth contact surface 257 of the second material 256 with the PET sheet 1407 attached to the second contact surface 1413 of the test adhesive layer 1409. When preparing a foldable test apparatus for foldable apparatus 601 shown in FIG. 6, the release liner 213 is removed, and then first contact surface 1415 of the test adhesive layer 1409 is attached to the fourth contact surface 257 of the second material 256 with the PET sheet 1407 attached to the second contact surface 1413 of the test adhesive layer 1409. When preparing a foldable test apparatus for foldable apparatus 701 or 801 shown in FIGS. 7-8, the release liner 213 and the adhesive layer 207 are removed, and then the first contact surface 1415 of the test adhesive layer 1409 is attached to the sixth surface area 725 of the first substrate 721, the eighth surface area 735 of the second substrate 731, and the fourth contact surface 257 of the second material 256 with the with the PET sheet 1407 attached to the second contact surface 1413 of the test adhesive layer 1409. The assembled foldable test apparatus include the 50 μm thick test adhesive layer 1409 and 100 μm thick sheet 1407 of PET is placed between the pair of parallel rigid stainless-steel plates 1403, 1405 such that the foldable substrate 201 or 803 will be on the inside of the bend, similar to the configuration shown in FIG. 13. The distance between the parallel plates is reduced at a rate of 50 μm/second until the parallel plate distance 1411 is equal to twice the “effective minimum bend radius” to be tested. Then, the parallel plates are held at twice the effective minimum bend radius to be tested for 24 hours at about 60° C. and about 90% relative humidity. As used herein, the “effective minimum bend radius” is the smallest effective bend radius that the foldable substrate 201 can withstand without failure under the conditions and configuration described above.

In some embodiments, the foldable substrate 201 or 803 of the foldable apparatus can achieve an effective minimum bend radius of 100 mm or less, 50 mm or less, 20 mm or less, or 10 mm or less. In further embodiments, the foldable substrate 201 or 803 of the foldable apparatus can achieve an effective bend radius of 10 millimeters (mm), or 7 mm, or 5 mm, or of 1 mm. In some embodiments, the foldable substrate 201 or 803 of the foldable apparatus can comprise an effective minimum bend radius of about 10 mm or less, about 7 mm or less, about 5 mm or less, about 1 mm or more, about 2 mm or more, or about 5 mm or more. In some embodiments, the foldable substrate 201 or 803 of the foldable apparatus can comprise an effective minimum bend radius in a range from about 1 mm to about 10 mm, from about 1 mm to about 7 mm, from about 1 mm to about 5 mm, from about 2 mm to about 10 mm, from about 2 mm to about 7 mm, from about 2 mm to about 5 mm, from about 5 mm to about 10 mm, from about 5 mm to about 7 mm, from about 7 mm to about 10 mm or any range or subrange therebetween.

In some embodiments, the foldable apparatus 101, 301, 401, 501, 601, 701, 801, 901, 1001, 1402, 1501, 1701, or 1801 can achieve an effective minimum bend radius of 100 mm or less, 50 mm or less, 20 mm or less, or 10 mm or less. In further embodiments, the foldable apparatus 101, 301, 401, 501, 601, 701, 801, 901, 1001, 1402, 1501, 1701, or 1801 can achieve an effective bend radius of 10 millimeters (mm), or 7 mm, or 5 mm, or of 1 mm. In some embodiments, the foldable apparatus 101, 301, 401, 501, 601, 701, 801, 901, 1001, 1402, 1501, 1701, or 1801 can comprise an effective minimum bend radius of about 10 mm or less, about 7 mm or less, about 5 mm or less, about 1 mm or more, about 2 mm or more, or about 5 mm or more. In some embodiments, the foldable apparatus 101, 301, 401, 501, 601, 701, 801, 901, 1001, 1402, 1501, 1701, or 1801 can comprise an effective minimum bend radius in a range from about 1 mm to about 10 mm, from about 1 mm to about 7 mm, from about 1 mm to about 5 mm, from about 2 mm to about 10 mm, from about 2 mm to about 7 mm, from about 2 mm to about 5 mm, from about 5 mm to about 10 mm, from about 5 mm to about 7 mm, from about 7 mm to about 10 mm or any range or subrange therebetween.

In some embodiments, the first material 254, second material 256, and/or foldable apparatus 101, 301, 401, 501, 601, 701, 801, 901, or 1001 can withstand a cyclic bending test. As used herein, the cyclic bending test comprises placing a testing apparatus comprising the material to be tested in the parallel plate apparatus 1401 (see FIG. 13) and bending the foldable test apparatus 1101 to achieve a predetermined parallel plate distance, between plates 1403, 1405, a predetermined number of times at 23° C. with a relative humidity of 50%. The testing apparatus comprises attaching a 100 μm thick portion of the material to be tested to a 100 μm thick PET sheet 1407 with the PET sheet facing the pair of rigid stainless-steel plates 1403, 1405. In some embodiments, the second material 256 can withstand 2,000 bending cycles at a parallel plate distance of 3 millimeters. In some embodiments, the second material 256 can withstand 2,000 bending cycles at a parallel plate distance of 3 millimeters. In further embodiments, the second material 256 can withstand 20,000 bending cycles at a parallel plate distance of 3 millimeters. In even further embodiments, the second material 256 can withstand 200,000 bending cycles at a parallel plate distance of 3 millimeters. In some embodiments, the first material 254 can withstand 2,000 bending cycles at a parallel plate distance of 3 millimeters. In some embodiments, the first material 254 can withstand 2,000 bending cycles at a parallel plate distance of 3 millimeters. In further embodiments, the first material 254 can withstand 20,000 bending cycles at a parallel plate distance of 3 millimeters. In even further embodiments, the first material 254 can withstand 200,000 bending cycles at a parallel plate distance of 3 millimeters. In some embodiments, the foldable apparatus 101, 301, 401, 501, 601, 701, 801, 901, or 1001 can withstand 2,000 bending cycles at a parallel plate distance of 3 millimeters. In some embodiments, the foldable apparatus 101, 301, 401, 501, 601, 701, 801, 901, or 1001 can withstand 2,000 bending cycles at a parallel plate distance of 3 millimeters. In further embodiments, the foldable apparatus 101, 301, 401, 501, 601, 701, 801, 901, or 1001 can withstand 20,000 bending cycles at a parallel plate distance of 3 millimeters. In even further embodiments, the foldable apparatus 101, 301, 401, 501, 601, 701, 801, 901, or 1001 can withstand 200,000 bending cycles at a parallel plate distance of 3 millimeters.

Furthermore, in some embodiments, the central thickness 226 of the shattered pieces 1305 can be less than the first thickness 222 of the first portion 221 and/or the second portion 223 to help prevent failure of the bond interface between the first material 254 and the shattered piece 1305 or pane 950. For example, decreasing the central thickness 226 can reduce the tensile stress of the first material 254 between the corresponding outer edges 251 of the adjacent pair of shattered pieces 1305 or adjacent pair of shattered panes 950 and can thereby reduce the stress at the interface between the first material 254 and the corresponding outer edges (e.g., outer edge 251) compared to embodiments including a larger central thickness 226 of the shattered pieces 1305 or the plurality of panes 950 (e.g., a thickness equal to the first thickness 222 of the first portion 221 and/or the second portion 223). The reduced stress at the interface between the first material 254 and the corresponding outer edges (e.g., outer edge 251) can reduce failure that may otherwise occur by the first material 254 ripping away from the outer edges (e.g., outer edge 251) and/or can allow use of alternative materials that may have better scratch resistance and/or better puncture resistance that may not be an option with the shattered pieces 1305 or the plurality panes 950 including a larger central thickness 226 due to unacceptable stress at the interface.

Referring to FIG. 12, the width 1303 of the shattered pane 231 of the foldable substrate 201 or 801 is defined as the maximum distance in a direction 106 perpendicular to the fold axis 102 between (i) a portion of a first crack separating a first shattered piece of the plurality of shattered pieces 1305 and a second shattered piece of the plurality of shattered pieces 1305 and (ii) a portion of a second crack separating a third shattered piece of the plurality of shattered pieces 1305 and a fourth shattered piece of the plurality of shattered pieces 1305, where the portion of the first crack and the portion of the second crack are as far apart as possible in the direction 106 and may or may not be aligned on an axis extending in the direction 106. In some embodiments, as shown in FIGS. 3-4, and 6-7, the width 1303 of the shattered pane 231 of the foldable substrate 201 can be substantially equal to the distance between the first portion 221 and the second portion 223 in the direction 106 perpendicular to the fold axis 102. In some embodiments, as shown in FIGS. 5 and 8, the width 1303 of the shattered pane 231 can be substantially equal to the length 105 of the foldable apparatus 501, 801. In some embodiments, the width 1303 of the shattered pane 231 can be about 3 times the effective minimum bend radius or more. Without wishing to be bound by theory, the length of a bent portion in a circular configuration between parallel plates can be about 1.6 times the parallel plate distance 1411 (e.g., about 3 times the effective minimum bend radius, about 3.2 times the effective minimum bend radius). In some embodiments, the width 1303 of the shattered pane 231 can be about 3 mm or more, about 6 mm or more, about 9 mm or more, about 1,000 mm or less, 500 mm or less, 100 mm or less, 45 mm or less, about 32 mm, or less, or about 22 mm or less. In some embodiments, the width 1303 of the shattered pane 231 can be in a range from about 3 mm to about 1,000 mm, from about 3 mm to about 500 mm, from about 3 mm to about 100 mm, from about 3 mm to about 45 mm, from about 6 mm to about 45 mm, from about 6 mm to about 32 mm, from about 9 mm to about 32 mm, from about 9 mm to about 22 mm, or any range of subrange therebetween. In some embodiments, the width of the shattered pane 231 can comprise, as a percentage of the length 105 of the foldable apparatus, a width in a range from about 0.1% to 100%, from about 0.1% to about 50%, from about 0.1% to about 20%, from about 0.1% to about 15%, from about 0.1% to about 10%, from about 1% to about 10%, from about 2% to about 10%, from about 2% to about 5%, from about 10% to 100%, from about 20% to 100%, from about 50% to 100%, from about 60% to 100%, from 60% to about 95%, from 60% to about 90%, from 80% to about 90%, or any range or subrange therebetween. It is to be understood that, in some embodiments, the central major surface 235 of the shattered pane 231 extending along a third plane 204c parallel to the second plane 204b can comprise a width within the ranges specified above in this paragraph.

In some embodiments, the width 1303 of the shattered pane 231 can be about 4.4 times the effective minimum bend radius or more. Without wishing to be bound by theory, the length of a bent portion in an elliptical configuration between parallel plates can be about 2.2 times the parallel plate distance 1411 (e.g., about 4.4 times the effective minimum bend radius). In some embodiments, the width 1303 of the shattered pane 231 can be substantially equal to or greater than the bend length of the foldable substrate at its effective minimum bend radius. In some embodiments, the width 1303 of the shattered pane 231 can extend from the first transition portion 227 to the second transition portion 229. In some embodiments, the width 1303 of the shattered pane 231 can be about 4 mm or more, about 10 mm or more, about 20 mm or more, about 45 mm or less, about 40 mm or less, or about 30 mm or less. In some embodiments, the width 1303 of the shattered pane 231 can be in a range from about 4 mm to about 45 mm, from about 4 mm to about 40 mm, from about 4 mm to about 30 mm, from about 4 mm to about 20 mm, from about 4 mm to about 10 mm, from about 10 mm to about 45 mm, from about 10 mm to about 40 mm, from about 10 mm to about 30 mm, from about 10 mm to about 20 mm, from about 20 mm to about 45 mm, from about 20 mm to about 40 mm, from about 20 mm to about 30 mm, from about 30 mm to about 45 mm, from about 30 mm to about 40 mm, from about 40 mm to about 45 mm, or any range of subrange therebetween. It is to be understood that, in some embodiments, the central major surface 235 of the shattered pane 231 extending along a third plane 204c parallel to the second plane 204b can comprise a width within the ranges specified above in this paragraph.

Dividing the central portion 225 into the plurality of panes 950 illustrated in FIGS. 9-10 can further facilitate reduction of the bend radius with the first material 254 connecting adjacent pairs of panes 950 together. In some embodiments, the width 952 of each pane 950 of the plurality of panes 950 can be in a range of from about 1 micrometer (μall) to less than about 50 percent of the effective minimum bend radius. In some embodiments, the width 952 of a pane 950 of the plurality of panes can be about 1 μm or more, about 10 μm or more, about 100 μm or more, about 500 μm or more, about 10 millimeters (mm) or less, about 5 mm or less, about 2 mm or less, about 0.5 mm or less, or about 0.2 or less. In some embodiments, the width 952 of a pane 950 of the plurality of panes 950 can be in a range from about 1 μm to about 10 mm, from about 10 μm to about 10 mm, from about 100 μm to about 10 mm, from about 500 μm to about 10 mm, from about 1 μm to about 5 mm, from about 10 μm to about 5mm, from about 100 μm to about 5 mm, from about 500 μm to about 5 mm, from about 1 μm to about 2 mm, from about 10 μm to about 2 mm, from about 100 μm to about 2 mm, from about 500 μm to about 2 mm, from about 1 μm to about 0.5 mm, from about 10 μm to about 0.5 mm, from about 100 μm to about 0.5 mm, from about 500 μm to about 0.5 mm, from about 1 μm to about 0.2 mm, from about 10 μm to about 0.2 mm, from about 100 μm to about 0.2 mm, from about 500 μm to about 0.2 mm, or any range or subrange therebetween. In further embodiments, the width 952 of each pane 950 of the plurality of panes 950 can be within one or more of the above ranges. In some embodiments, the width 952 of a pane 950 of the plurality of panes 950 as a percentage of the effective minimum bend radius can be about 0.5% or more, about 5% or more, about 20% or more, about 50% or less, about 30% or less, or about 20% or less. In some embodiments, the width 952 of a pane 950 of the plurality of panes 950 as a percentage of the effective minimum bend radius can be in a range from about 0.5% to about 50%, from about 5% to about 50%, from about 20% to about 50%, from about 0.5% to about 30%, from about 5% to about 30%, from about 20% to about 30%, from about 0.5% to about 20%, from about 5% to about 20%, or any range or subrange therebetween. In some embodiments, the width 952 of a pane 950 of the plurality of panes 950 as a percentage of the effective minimum bend radius can be in a range from 1 μm to about 50%, from about 5μm to about 50%, from about 10 μm to a about 30%, from about 100 μm to about 30%, from about 100 μm to about 20%, from about 500 μm to about 20%, from about 1 mm to about 20%, or any range or subrange therebetween. In further embodiments, the width 952 of each pane 950 of the plurality of panes can be within the above range. In even further embodiments, the width 252 of each pane 950 of the plurality of panes can be substantially the same. In some embodiments, the plurality of panes can comprise a plurality of glass-based panes. In some embodiments, the plurality of panes can comprise a plurality of ceramic-based panes

The width 903 of the plurality of panes 950 of the foldable substrate 201 is defined as the maximum distance in a direction 106 perpendicular to the fold axis 102 between (i) a first separation between the first portion 221 or first transition portion 227, if present, and a first pane of the plurality of panes 950 and (ii) a portion of a second separation between the second portion 223 or the second transition portion 229, if present, and a second pane of the plurality of panes 950, where the first separation and the second separation as far apart as possible in the direction 106. In some embodiments, as shown in FIGS. 9-10, the width 903 of the plurality of panes 950 of the foldable substrate 201 can be substantially equal to the distance between the first transition portion 227 and the second transition portion 229 in the direction 106 perpendicular to the fold axis 102. In some embodiments, although not shown, the width 903 of the plurality of panes 950 of the foldable substrate 201 can be substantially equal to the distance between the first portion 221 and the second portion 223 in the direction 106 perpendicular to the fold axis 102, for example when no first transition portion and no second transition portion are present. In some embodiments, although not shown, the width 903 of the plurality of panes 950 can be substantially equal to the length 105 of the foldable apparatus. In some embodiments, the width 903 of the plurality of panes 950 can be about 3 times the effective minimum bend radius or more. In some embodiments, the width 903 of the plurality of panes 950 can be about 4.4 times the effective minimum bend radius or more. In some embodiments, the width 903 of the plurality of panes 950 can be within one or more of the ranges discussed above with reference to the width 1303 (e.g., as a multiple of the effective minimum bend radius, in absolute distance, as a percentage of the length).

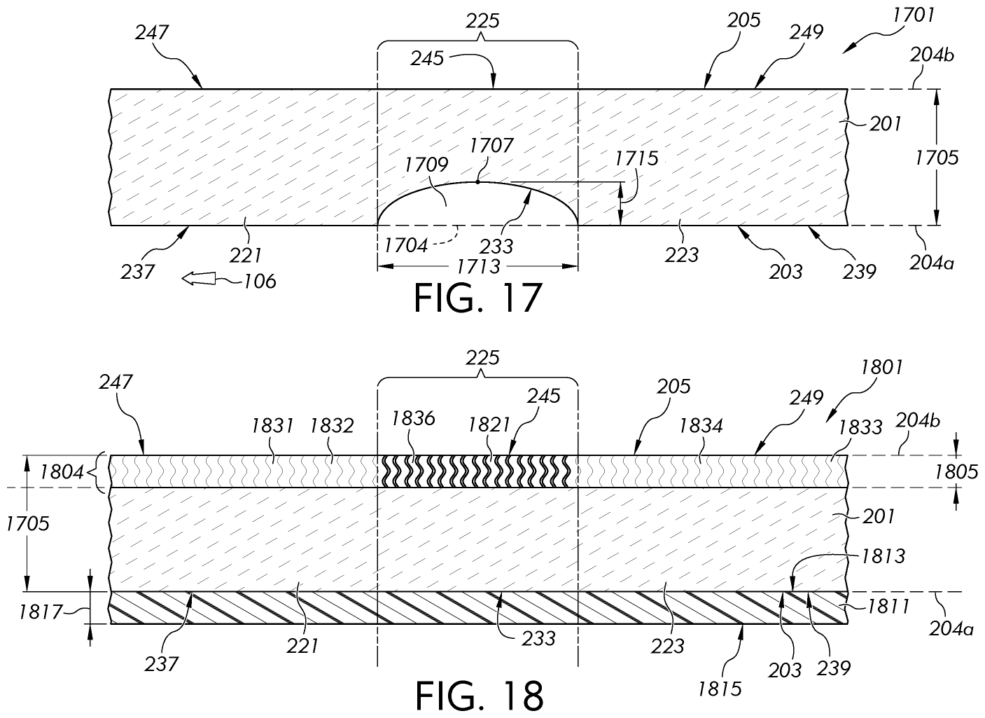

The foldable apparatus may have an impact resistance defined by the capability of the first portion 221 and/or second portion 223 of the foldable substrate 201 or 803 of the foldable apparatus to avoid failure at a pen drop height (e.g., 5 centimeters (cm) or more, 8 cm or more, 10 cm or more, 12 cm or more, 15 cm or more), when measured according to the “Pen Drop Test.” As used herein, the “Pen Drop Test” is conducted such that samples of foldable apparatus are tested with the load (i.e., from a pen dropped from a certain height) imparted to an outer surface (e.g., second major surface 205 of foldable substrate 201 or 803 shown in FIGS. 2-9, 13-15, and 17, fourth major surface 285 of the coating 281 shown in FIG. 10, first major surface 203 of foldable substrate in FIGS. 17-18) of the foldable apparatus configured as in the parallel plate test with the with 100 μm thick sheet 1407 of PET attached to the second contact surface 1413 of the test adhesive layer 1409 (e.g., instead of the release liner 213 shown in FIG. 2). As such, the PET layer in the Pen Drop Test is meant to simulate a flexible electronic display device (e.g., an OLED device). During testing, the foldable substrate bonded to the PET layer is placed on an aluminum plate (6063 aluminum alloy, as polished to a surface roughness with 400 grit paper) with the PET layer in contact with the aluminum plate. No tape is used on the side of the sample resting on the aluminum plate.

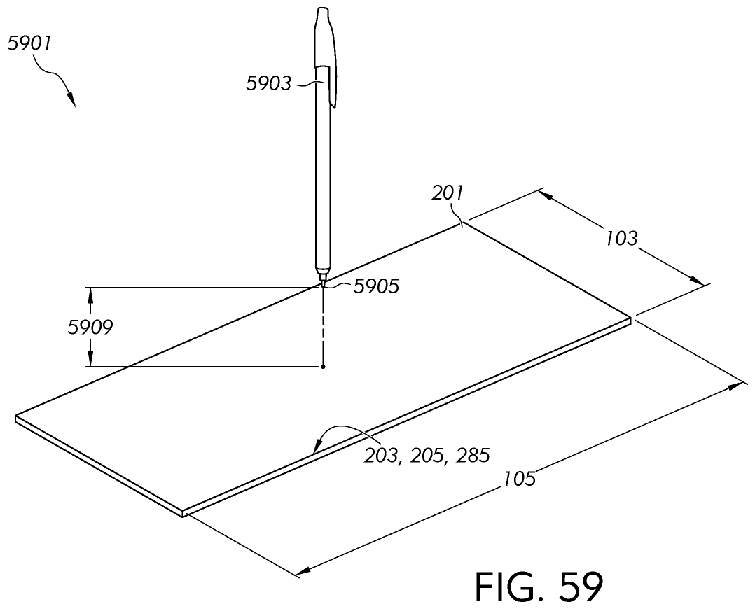

As shown in FIG. 59, the pen drop apparatus 5901 comprises the ballpoint pen 5903. The pen employed in Pen Drop Test is a BIC Easy Glide Pen, Fine comprising a tungsten carbide ballpoint tip 5905 of 0.7 mm (0.68 mm) diameter, and a weight of 5.73 grams (g) including the cap (4.68 g without the cap). The ballpoint pen 5903 is held a predetermined height 5909 from an outer surface (e.g., second major surface 205 of foldable substrate 201 or 803 shown in FIGS. 2-9, 13-15, and 17, fourth major surface 285 of the coating 281 shown in FIG. 10, first major surface 203 of foldable substrate in FIGS. 17-18) of the foldable apparatus comprising the foldable substrate (e.g., foldable substrate 201 or 803). A tube (not shown for clarity) is used for the Pen Drop Test to guide the ballpoint pen 5903 to the outer surface of the foldable apparatus, and the tube is placed in contact with the outer surface of the foldable apparatus so that the longitudinal axis of the tube is substantially perpendicular to the outer surface of the foldable apparatus. The tube has an outside diameter of 1 inch (2.54 cm), an inside diameter of nine-sixteenths of an inch (1.4 cm) and a length of 90 cm. An acrylonitrile butadiene (“ABS”) shim is employed to hold the ballpoint pen 5903 at a predetermined height 5909 for each test. After each drop, the tube is relocated relative to the foldable apparatus to guide the ballpoint pen 5903 to a different impact location on the foldable apparatus. It is to be understood that the Pen Drop Test can be used for any of the foldable apparatus of embodiments of the disclosure.

A tube is used for the Pen Drop Test to guide a pen to the outer surface (e.g., second major surface 205 of foldable substrate 201 or 803, fourth major surface 285 of the coating 281) of the foldable apparatus (e.g., comprising foldable substrate 201 or 803), and the tube is placed in contact with the outer surface of the foldable apparatus so that the longitudinal axis of the tube is substantially perpendicular to the outer surface with the longitudinal axis of the tube extending in the direction of gravity. The tube has an outside diameter of 1 inch (2.54 cm), an inside diameter of nine-sixteenths of an inch (1.4 cm) and a length of 90 cm. An acrylonitrile butadiene (ABS) shim is employed to hold the pen at a predetermined height for each test. After each drop, the tube is relocated relative to the sample to guide the pen to a different impact location on the sample (e.g., foldable apparatus). The pen employed in Pen Drop Test is a BIC Easy Glide Pen, Fine, having a tungsten carbide ballpoint tip of 0.7 mm (0.68 mm) diameter, and a weight of 5.73 grams (g) including the cap (4.68 g without the cap).

For the Pen Drop Test, the ballpoint pen 5903 is dropped with the cap attached to the top end (i.e., the end opposite the tip) so that the ballpoint tip 5905 can interact with the outer surface (e.g., second major surface 205 of foldable substrate 201 or 803, fourth major surface 285 of the coating 281) of the foldable apparatus. In a drop sequence according to the Pen Drop Test, one pen drop is conducted at an initial height of 1 cm, followed by successive drops in 0.5 cm increments up to 20 cm, and then after 20 cm, 2 cm increments until failure of the foldable apparatus. After each drop is conducted, the presence of any observable fracture, failure, or other evidence of damage to the foldable apparatus is recorded along with the particular predetermined height 5909 for the pen drop. Using the Pen Drop Test, multiple foldable apparatus (e.g., samples) can be tested according to the same drop sequence to generate a population with improved statistical accuracy. For the Pen Drop Test, the ballpoint pen 5903 is to be changed to a new pen after every 5 drops, and for each new foldable apparatus tested. In addition, all pen drops are conducted at random locations on the foldable apparatus at or near the center of the foldable apparatus unless indicated otherwise, with no pen drops near or on the edge of the foldable apparatus.

For purposes of the Pen Drop Test, “failure” means the formation of a visible mechanical defect in a laminate. The mechanical defect may be a crack or plastic deformation (e.g., surface indentation). The crack may be a surface crack or a through crack. The crack may be formed on an interior or exterior surface of a laminate. The crack may extend through all or a portion of the foldable substrate 201 or 803 and/or the coating 281. A visible mechanical defect has a minimum dimension of 0.2 millimeters or more.

FIG. 16 shows a curve 1601 of the maximum principal stress 1605 in MegaPascals (MPa) on the first major surface of a foldable substrate comprising a glass-based substrate as a function of a thickness 1603 in micrometers of an undivided foldable substrate (i.e., without a plurality a panes, without a shattered pane, without first substrate or second substrate, comprising a uniform substrate thickness) based on a pen drop height of 2 cm onto the second major surface of the foldable substrate comprising a glass-based substrate. As shown in FIG. 16, the maximum principal stress on the first major surface of the foldable substrate comprising a glass-based substrate is greatest around 65 μm. This suggests that it pen drop performance can be improved by avoiding thicknesses around 65 μm, for example, less than about 50 μm or greater than about 80 μm when the foldable substrate comprises a glass-based substrate.

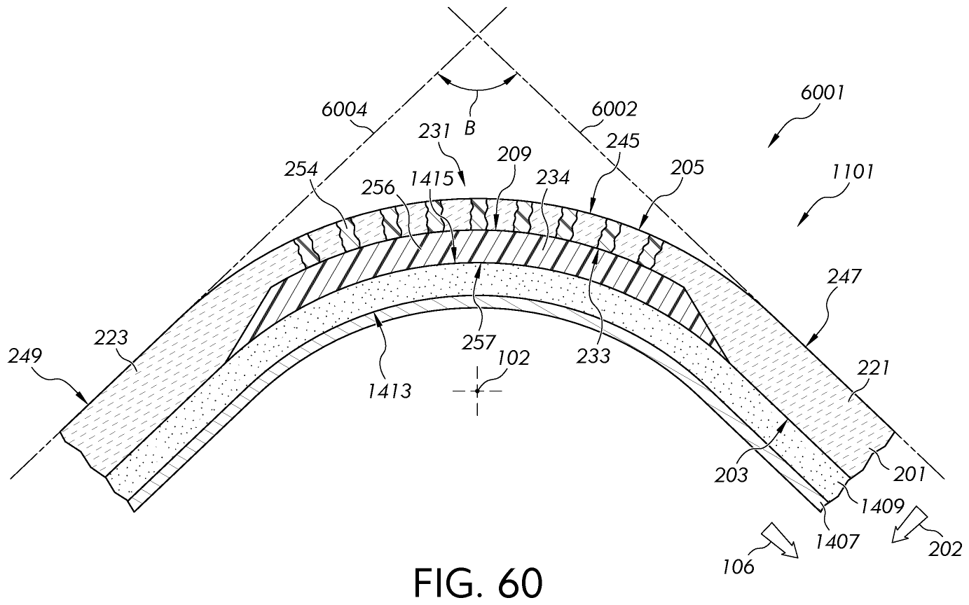

The foldable apparatus 101, 301, 401, 501, 601, 701, 801, 901, 1001, 1402, and 1501 can comprise a neutral stress configuration. Throughout the disclosure, the “neutral stress configuration” is measured with the following test configuration and process. When measuring the “neutral stress configuration”, the foldable test apparatus 6001 as shown in FIG. 60 comprises the test adhesive layer 1409 comprising a thickness of 50 μm between the first contact surface 1415 of the test adhesive layer 1409 and the second contact surface 1413 of the test adhesive layer 1409 as well as a 100 μm thick PET sheet 1407 rather than the release liner 213 of FIGS. 2, 4, and 6-9 or the display device 303 shown in FIGS. 3, 5, and 10. For example, the foldable test apparatus 6001, as shown in FIG. 60, can resemble the foldable test apparatus 1101 shown in FIG. 13 for measuring the “effective bend radius” and or “parallel plate distance.” To test the test foldable apparatus 6001, the foldable test apparatus 6001 is placed on its side such that a cross-section taking perpendicular to the direction of gravity resembles FIG. 60. The foldable apparatus 6001 rests on a surface comprising SAE grade 304 (e.g., ISO A2) stainless steel with an arithmetic mean deviation of the surface (surface roughness (Ra)) of 3μm or less (e.g., 2.40 μm, mill finish number 3). As shown, a plane substantially comprising a direction 202 of the first thickness 222 and the direction 106 of the length 105 of the foldable substrate is substantially perpendicular to the direction of gravity and the direction 104 (see FIG. 1) of the fold axis 102 is also the direction of gravity. Then, the test foldable apparatus is allowed to relax 1 hour to achieve an equilibrium configuration, as shown in FIGS. 60. In some embodiments, as shown in FIG. 60, the neutral stress configuration can comprise a bent configuration. As used herein a bent configuration is a non-flat configuration (in contrast to the flat configuration shown in FIGS. 1-10). In further embodiments, as shown in FIG. 60, the first major surface 203 and/or the second major surface 205 of the foldable substrate 201 may substantially deviate from a shape of a plane.

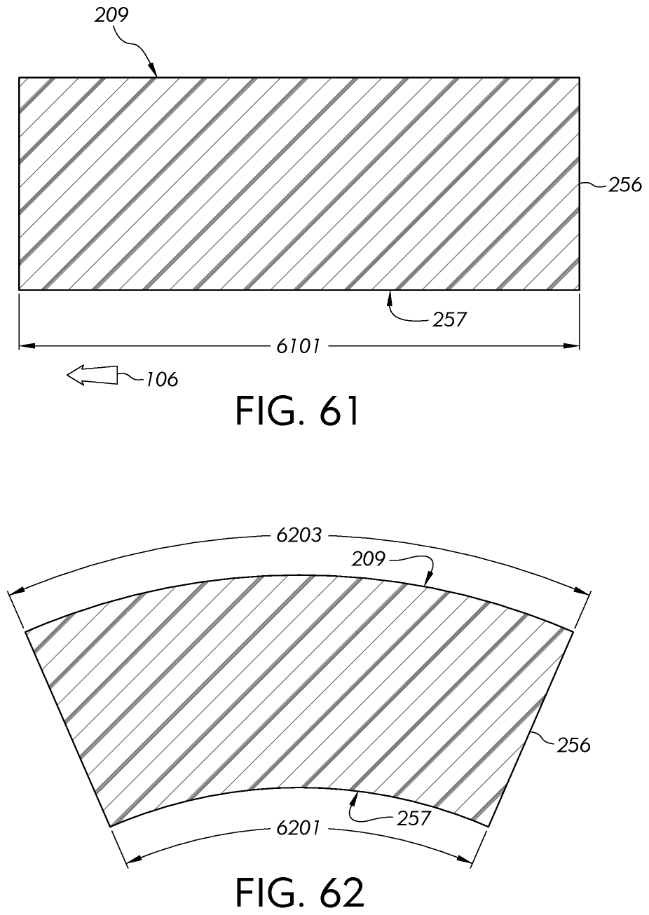

In some embodiments, the deviation of the neutral stress configuration from the flat configuration can be quantified using a maximum magnitude of a deviatoric strain. As used herein, “deviatoric strain” means the shape changing component of the strain tensor (e.g., the strain tensor minus the as the hydrostatic strain—average of the on-diagonal components of the strain tensor). The strain tensor can be measured using digital image recognition and/or topography of a portion (e.g., second material) of the folded apparatus to compare the shape and dimensions between the flat configuration and the neutral stress configuration. For example, as shown in FIG. 61, an example second material 256 is shown in a flat configuration. In this flat configuration, the length 6101 of the second material 256 (e.g., measured in the direction 106 of the length of the foldable apparatus) at the first contact surface 209 and the length 6101 of the second material 256 at the second contact surface 257 are substantially equal. For example, as shown in FIG. 62, an example second material 256 is shown in the neutral stress configuration. For ease of comprehension, the volume of the second material 256 in FIG. 61 is the same as the volume of the second material 256 in FIG. 62, which would be the case after removing the hydrostatic strain from the digitally captured shape and dimensions of the neutral stress configuration. As shown in FIG. 62, a first length 6203 measured along the first contact surface 209 is different (e.g., greater than) a second length 6201 measured along the second contact surface 257. As used herein, strain means the difference in length of a portion between a flat configuration and a neutral stress configuration divided by a reference length from the flat configuration. For example, a strain (e.g., deviatoric strain when the hydrostatic strain is removed as discussed above) between FIGS. 61-62 measured at the first contact surface 209 would be equal to the difference of the first length 6203 in the neutral stress configuration and the length 6101 in the flat configuration divided by the length 6101 in the flat configuration. For example, a strain (e.g., deviatoric strain when the hydrostatic strain is removed as discussed above) between FIGS. 61-62 measured at the second contact surface 257 would be equal to the difference of the second length 6201 in the neutral stress configuration and the length 6101 in the flat configuration divided by the length 6101 in the flat configuration. It is to be understood that strain (e.g., deviatoric strain) can be measured for any shape of a portion of material by comparing the length (e.g., length 6101) in the flat configuration and the length (e.g., first length 6203, second length 6203) in the neutral stress configuration for a surface as the difference of the length in the neutral stress configuration and the length in the flat configuration divided by the length in the flat configuration. As used herein, the magnitude of a value (e.g., scalar value) is the absolute value of the value. As used herein, the maximum magnitude of a tensor (e.g., strain tensor, deviatoric strain tensor) means the component of the tensor (e.g., deviatoric strain tensor) with the largest (e.g., maximum) value. As used herein, the maximum magnitude of the deviatoric strain of the second material 256, means the largest value of the maximum magnitude of the deviatoric strain calculated at the first contact surface 209 and the second contact surface 257 of the second material. In some embodiments, the maximum magnitude of the deviatoric strain of the second material 256 can be about 1% or more, about 2% or more, about 3% or more, about 4% or more, about 10% or less, about 8% or less, about 7% or less, about 6% or less, or about 5% or less. In some embodiments, the maximum magnitude of the deviatoric strain of the second material 256 can be in a range from about 1% to about 10%, from about 1% to about 8%, from about 1% to about 7%, from about 2% to about 7%, from about 2% to about 6%, from about 2% to about 5%, from about 3% to about 5%, from about 3% to about 4%, from about 2% to about 10%, from about 2% to about 8%, from about 3% to about 8%, from about 4% to about 8%, from about 4% to about 7%, from about 4% to about 6%, or any range or subrange therebetween.

In some embodiments, the deviation of the neutral stress configuration from the flat configuration can be quantified using an angle “B” measured between a first line extending in the direction of the length from the first portion and a second line extending in the direction of the length from the second portion. For example, with reference to FIG. 60, the angle “B” is measured between a first line 6002 and a second line 6004. The first line 6002 extends in the direction 106 of the length of the test foldable apparatus 6001 at and from the first portion 221 of the foldable substrate 201 (e.g., second surface area 247). In some embodiments, as shown in FIG. 60, the first line 6002 can extend along a plane that the second surface area 247 can extend along. The second line 6004 extends in the direction 106 of the length of the test foldable apparatus 6001 at and from the second portion 223 of the foldable substrate 201 (e.g., fourth surface area 249). In some embodiments, as shown in FIG. 60, the second line 6004 can extend along a plane that the fourth surface area 249 can extend along. In some embodiments, the magnitude of the difference between the angle “B” in the neutral stress configuration and the flat configuration (e.g.,)180° can be about 1° or more, about 2° or more, about 5° or more, about 10° or more, about 40° or less, about 20° or less, about 15° or less, or about 8° or less. In some embodiments the magnitude of the difference between the angle “B” in the neutral stress configuration and the flat configuration (e.g., 180°) can be in a range from about 1° to about 40°, from about 1° to about 20°, from about 2° to about 20°, from about 5° to about 20°, from about 5° to about 15°, from about 10° to about 15°, from about 2° to about 15°, from about 5° to about 15°, from about 5° to about 8°, from about 1° to about 8°, from about 2° to about 8°, or any range or subrange therebetween.

By providing a neutral stress configuration when the foldable apparatus is in a bent configuration, the force to bend the foldable apparatus to a predetermined parallel plate distance can be reduced. Further, providing a neutral stress configuration when the foldable apparatus is in a bent state can reduce the maximum stress and/or strain experienced by the second material during normal use conditions, which can, for example, enable increased durability and/or reduced fatigue of the foldable apparatus. In some embodiments, the neutral stress configuration can be generated by providing a second material that expands as a result of curing. In some embodiments, the neutral stress configuration can be generated by curing the second material in a bent configuration. In some embodiments, the neutral stress configuration can be generated by bending a ribbon at an elevated temperature (e.g., when the ribbon comprises a viscosity in a range from about 10⁴ Pascal-seconds and about 10⁷ Pascal-seconds).

As shown in FIGS. 17-18, the foldable apparatus 1701 and 1801 can comprise the foldable substrate 201 comprising a substrate thickness 1705 defined between the first major surface 203 and the second major surface 205. In some embodiments, the substrate thickness 1705 can be within one or more of the ranges discussed above for the first thickness 222. In some embodiments, the substrate thickness 1705 can be in a range from about 25 μm to about 5,000 μm, for example, from about 50 μm to about 5,000 μm, from about 100 μm to about 5,000 μm, from about 100 μm to about 4,500 μm, from about 100 μm to about 4,000 μm, from about 100 μm to about 3,000 μm, from about 100 μm to about 2,500 μm, from about 100 μm to about 2,000 μm, from about 100 μm to about 1,500 μm, from about 100 μm to about 1,000 μm, from about 100 μm to about 750 μm, from about 100 μm to about 500 μm, from about 100 μm 250 μm, or any range or subrange therebetween. In some embodiments, the substrate thickness 1705 can be in a range from about 25 μm to 5,000 μm, from about 25 μm to about 4,500 μm, from about 25 μm to about 4,000 μm, from about 25 μm from about 3,500 μm, from about 25 μm to about 3,000 μm, from about 25 μm to 2,500 μm, from about 25 μm to about 2,000 μm, from about 25 μm to about 1,500 μm, from about 25 μm to about 1,000 μm, from about 25 μm to about 750 μm, from about 25 μm to about 500, from about 25 μm to about 250 μm, or any range or subrange therebetween. In some embodiments, the elastic modulus of the foldable substrate can be within one or more of the ranges discussed above with reference to the foldable substrate 201 or 803.

As discussed above, the foldable substrate 201 can comprise a glass-based material and/or a ceramic-based material. In some embodiments, the foldable substrate 201 can comprise alkali-containing aluminosilicate, borosilicate, boroaluminosilicate, and/or silicate glass compositions. In certain aspects, alkaline earth modifiers can be added to any of the foregoing compositions for the foldable substrate 201. In some embodiments, the foldable substrate 201 can comprise: SiO₂ at 50 to 75% (by mol %); Al₂O₃ at 5 to 20%; B₂O₃ at 8 to 23%; MgO at 0.5 to 9%; CaO at 1 to 9%; SrO at 0 to 5%; BaO at 0 to 5%; SnO₂ at 0.1 to 0.4%; ZrO₂ at 0 to 0.1%; Na₂O at 0 to 10%; K₂O at 0 to 5%; and Li₂O at 0 to 10%. In some embodiments, the foldable substrate 201 can comprise: SiO₂ at 64 to 69% (by mol %); Al₂O₃ at 5 to 12%; B₂O₃ at 8 to 23%; MgO at 0.5 to 2.5%; CaO at 1 to 9%; SrO at 0 to 5%; BaO at 0 to 5%; SnO₂ at 0.1 to 0.4%; ZrO₂ at 0 to 0.1%; and Na₂O at 0 to 1%. In some embodiments, the foldable substrate 201 can comprise: SiO₂ at ˜67.4% (by mol %); Al₂O₃ at ˜12.7%; B₂O₃ at ˜3.7%; MgO at ˜2.4%; CaO at 0%; SrO at 0%; SnO₂ at ˜0.1%; and Na₂O at ˜13.7%. In further embodiments, the foldable substrate 201 can comprise: SiO₂ at 68.9% (by mol %); Al₂O₃ at 10.3%; Na₂O at 15.2%; MgO at 5.4%; and SnO₂ at 0.2%. In some embodiments, the foldable substrate 201 can comprise the following glass composition (“Glass 1”): SiO₂ at ˜64% (by mol %); Al₂O₃ at ˜16%; Na₂O at ˜11 mol %; Li₂O at ˜6 mol %; ZnO at ˜1 mol %; and P₂O₅ at ˜2%. In further embodiments, the foldable substrate 201 can comprise: SiO₂ at 68.9% (by mol %); Al₂O₃ at 10.3%; Na₂O at 15.2%; MgO at 5.4%; and SnO2 at 0.2%. Exemplary embodiments of glass compositions for the foldable substrate 201 denoted Glasses A-E are listed in Table 3.

TABLE 3
Properties of Glasses A-E

| | Glass ID | | | | |
|---|---|---|---|---|---|
| oxide (mol %) | A | B | C | D | E |
| SiO₂ | 66.4 | 69.2 | 69.11 | 67.37 | 64.48 |
| B₂O₃ | 0.6 | | | 3.67 | 7.00 |
| Al₂O₃ | 10.3 | 8.5 | 10.19 | 12.73 | 13.92 |
| Na₂O | 13.8 | 13.9 | 15.09 | 13.75 | 14.04 |
| K₂O | 2.4 | 1.2 | 0.01 | 0.01 | 0.49 |
| MgO | 5.7 | 6.5 | 5.48 | 2.36 | |
| CaO | 0.6 | 0.5 | | | |
| Fe₂O₃ | | | 0.01 | 0.01 | 0.03 |
| ZrO₂ | | | 0.01 | 0.01 | |
| SnO₂ | 0.2 | 0.2 | 0.1 | 0.09 | 0.04 |
| Annealing Temp (° C.) | 600 | 609 | 650 | 632 | 600 |
| Softening Temp (° C.) | 843 | 844 | 892 | 899 | 862 |

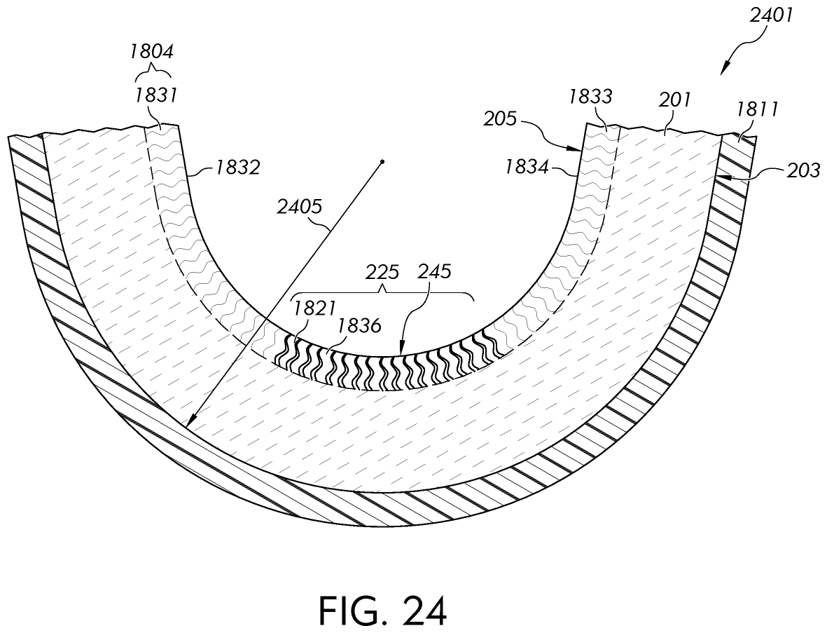

Foldable apparatus 1701 and/or 1801 can be characterized by about zero residual stress in an as-bent configuration, for example, in the configuration shown in FIG. 24 for foldable apparatus 2401. In some embodiments, as described above, the as-bent configuration can be a neutral stress configuration. It is to be understood that in some embodiments discussion of an as-bent configuration can apply to and/or be interchanged with a discussion of a neutral stress configuration. In some embodiments, the as-bent configuration (e.g., neutral stress configuration) can be in a range from greater than 0° to about 90° with a diameter of curvature in a range from about 2 mm to about 20 mm. As used herein, “diameter of curvature” and variations of the same are intended to refer to a bent configuration (e.g., as-bent configuration, neutral stress configuration) of the foldable apparatus of embodiments of the disclosure. More particularly, the diameter of curvature of a foldable substrate of the foldable apparatus is two times the radius of curvature of the substrate in its bent configuration (e.g., as-bent configuration, neutral stress configuration), as measured relative to its substantially non-bent, planar configuration. With reference to FIG. 24, the foldable apparatus 2401 is in a bent configuration (e.g., as-bent configuration, neutral stress configuration) with a diameter of curvature of the foldable substrate 201 equal to twice the radius of curvature 2405. In some embodiments, the foldable apparatus and/or the foldable substrate can be characterized by about zero residual stress in a bent configuration (e.g., as-bent configuration, neutral stress configuration) comprising a diameter of curvature from 2 mm to about 20 mm and a bend angle in a range from greater than 0° to about 90°, from 0° to 80°, from 0° to 70°, from 0° to 60°, from 0° to 50°, from 0° to 45°, from 0° to 40°, from 0° to 30°, from 0° to 20°, or any range or subrange therebetween. In some embodiments, the foldable apparatus and/or the foldable substrate can be characterized by about zero residual stress in a bent configuration (e.g., as-bent configuration, neutral stress configuration) comprising a diameter of curvature from 2 mm to about 20 mm and a bend angle in a range from greater than 0° to about 90°, from 10° to 90°, from 20° to 90°, from 30° to 90°, from 40° to 90°, from 45° to 90°, from 45° to 80°, from 45° to 70°, from 45° to 60°, or any range or subrange therebetween. In some embodiments, the foldable apparatus and/or foldable substrate can be characterized by about zero residual stress in a bent configuration (e.g., as-bent configuration, neutral stress configuration) comprising a bend angle from greater than 0° to about 90° and a dimeter of curvature in a range from 2 mm to about 20 mm, from 3 mm to about 20 mm, from 4 mm to about 20 mm, from 5 mm to about 20 mm, from 6 mm to about 20 mm, from 7 mm to about 20 mm, from 8 mm to about 20 mm, from 9 mm to about 20 mm, from 10 mm to about 20 mm, from 15 mm to about 20 mm, or any range or subrange therebetween. For example, the foldable apparatus and/or foldable substrate can be characterized by about zero residual stress in a bent configuration (e.g., as-bent configuration, neutral stress configuration) comprising a bend angle of about 90° and a diameter of curvature of about 4.75 mm. For example, the foldable apparatus and/or foldable substrate can be characterized by about zero residual stress in a bent configuration (e.g., as-bent configuration, neutral stress configuration) comprising a bend angle of 45° and a diameter of curvature of about 3 mm.

Referring to foldable apparatus 1701 and 1801 shown in FIGS. 17-18, the foldable apparatus 1701 and 1801 and/or the foldable substrate 201 can be characterized by a residual tensile stress at the second major surface 205 of the foldable substrate 201 of at least 500 MPa and a residual compressive stress at the first major surface 203 of at least 500 MPa in a substantially non-bent configuration, for example, the configuration shown in FIGS. 17-18. In some embodiments, the residual tensile stress at the second major surface 205 of the foldable substrate 201 in a substantially non-bent configuration can be at least 500 MPa, 550 MPa, 600 MPa, 650 MPa, 700 MPa, 750 MPa, 800 MPa, 850 MPa, 900 MPa, 950 MPa, 1000 MPa, 1050 MPa, 1100 MPa, 1150 MPa, 1200 MPa, or any value therebetween. In some embodiments, the residual tensile stress at the second major surface 205 of the foldable substrate 201 in a substantially non-bent configuration can be in a range from about 500 MPa to about 1,500 MPa, from about 500 MPa to about 1,200 MPa, from about 550 MPa to about 1,200 MPa, from about 600 MPa to about 1,150 MPa, from about 650 MPa to about 1,100 MPa, from about 700 MPa to about 1,050 MPa, from about 750 MPa to about 1,000 MPa, from about 800 MPa to about 1,000 MPa, from about 800 MPa to about 950 MPa, from about 800 MPa to about 900 MPa, from about 800 MPa to about 850 MPa, or any range of subrange therebetween. In some embodiments, the residual compressive stress at the first major surface 203 of the foldable substrate 201 in a substantially non-bent configuration can be at least 500 MPa, 550 MPa, 600 MPa, 650 MPa, 700 MPa, 750 MPa, 800 MPa, 850 MPa, 900 MPa, 950 MPa, 1000 MPa, 1050 MPa, 1100 MPa, 1150 MPa, 1200 MPa, or any value therebetween. In some embodiments, the residual compressive stress at the first major surface 203 of the foldable substrate 201 in a substantially non-bent configuration can be in a range from about 500 MPa to about 1,500 MPa, from about 500 MPa to about 1,200 MPa, from about 550 MPa to about 1,200 MPa, from about 600 MPa to about 1,150 MPa, from about 650 MPa to about 1,100 MPa, from about 700 MPa to about 1,050 MPa, from about 750 MPa to about 1,000 MPa, from about 800 MPa to about 1,000 MPa, from about 800 MPa to about 950 MPa, from about 800 MPa to about 900 MPa, from about 800 MPa to about 850 MPa, or any range of subrange therebetween.

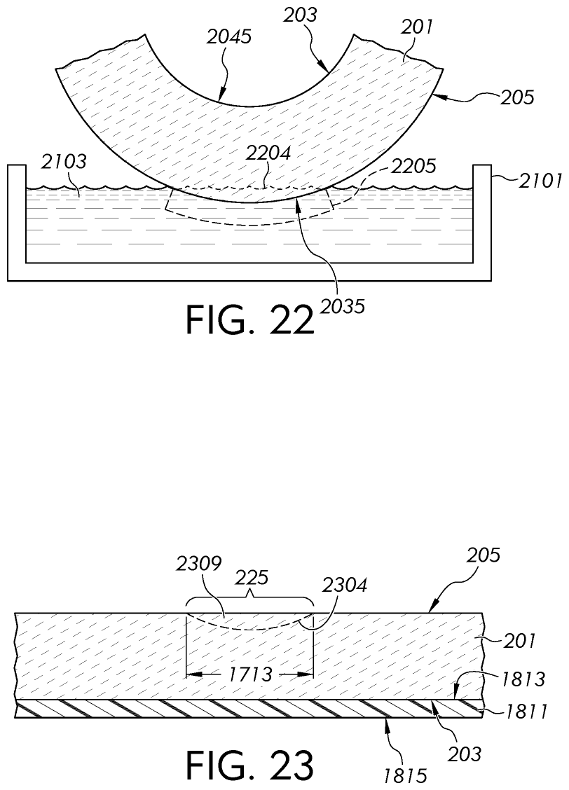

In some embodiments, as shown in FIG. 17, the foldable apparatus 1701 can comprise a recess 1709. Providing a recess like recess 1709 can reduce the stress intensity within the foldable substrate 201 as the foldable apparatus 1701 is folded from the shown configuration to a concave up configuration (e.g., see FIG. 24). The recess 1709 can be defined between a first plane 204a that the first major surface 203 extends along in a substantially non-bent configuration and the first central surface area 233. As shown in FIG. 17, a recess depth 1715 is defined as the maximum distance in a direction of the substrate thickness 1705 between the first plane 204a and a point 1707 on the first central surface area 233 when the foldable apparatus is in a substantially non-bent configuration. In some embodiments, the recess depth 1715 of the recess 1709 as a percentage of the substrate thickness 1705 can be in a range from about 1% to about 50%. For example, the recess depth 1715 of the recess 1709 as a percentage of the substrate thickness 1705 can be about 1%, 5%, 10%, 15%, 20%, 25%, 30%, 35%, 40%, 45%, 50%, or any value therebetween. In some embodiments, as shown, a recess width 1713 of the recess 1709 as a percentage of the width (e.g., width 103) of the foldable apparatus and/or foldable substrate can be in a range from about 5% to about 75%. For example, the recess width 1713 of the recess 1709 as a percentage of the width of the foldable substrate and/or foldable apparatus can be about 5%, 10%, 15%, 20%, 25%, 30%, 35%, 40%, 45%, 50%, 55%, 60%, 65%, 70%, 75%, or any value therebetween. In some embodiments, the recess 1709 can comprise a curved surface defined by the first central surface area 233, for example, comprising a cross-section in the view shown in FIG. 17 that is semi-circular, semi-elliptical. In some embodiments, the recess 1709 can comprise a rectilinear surface defined by the first central surface area 233, for example, comprising a cross-section in the view shown in FIG. 17 that is chamfered or squared. In some embodiments, the recess 1709 can comprise a recess width 1713 that is defined as the maximum distance in the direction 106 of the length between two points on the first central surface area 233 that are recessed from the first plane 204a and are as far apart as possible in the direction 106. In further embodiments, the recess width 1713 can comprise one or more of the ranges discussed above for the width 1303 of the shattered pane 231. In some embodiments, as discussed below with reference to FIGS. 22-23 and step 1709, the foldable substrate can comprise a recess 2309 in the second major surface 205 that can be opposite the recess 1709 in the first major surface 203, if provided.

In some embodiments, as shown in FIG. 18, the foldable apparatus 1801 can comprise a shattered region 1804. In further embodiments, the shattered region 1804 can comprise a central shattered region 1836 positioned in the central portion 225. Providing a shattered region 1804 can reduce the stress intensity within the foldable substrate 201 as it is folded from the shown configuration in FIG. 18 to a concave up configuration (e.g., see FIG. 24), which can allow for smaller diameters of curvature (e.g., twice the radius of curvature 2405).

In some embodiments, as shown in FIG. 18, the shattered region 1804 comprises a first shattered region 1832, a second shattered region 1834, and a central shattered region 1836 positioned therebetween. In further embodiments, as shown, the central shattered region 1836 comprises a plurality of micro-cracks 1821. In even further embodiments, a longest dimension of the plurality of micro-cracks can be in a range from 0.01 μm to 2,000 μm, from 0.01 μm to 1,500 μm, from 0.01 μm to 1,000 μm, from 0.01 μm to 500 μm, from 0.01 μm to 250 μm, from 0.01 μm to 100 μm, from 0.01 μm to 50 μm, or any range or subrange therebetween. As used herein, the “longest dimension” of a “micro-crack”, “a plurality of micro-cracks” and a “glass particle” is measured using the Nikon Instruments Inc. NIS-Elements Advanced Research software with an optical microscope, with the micro-crack(s) and/or particles chosen manually to obtain an impartial average, as understood by those of ordinary skill in the field of this disclosure. Alternatively, the “Gwyddion” open source data visualization software (supported by the Department of Nanometrology, Czech Metrology Institute) can also be used with an optical microscope to make the longest dimension measurements, along with other parameters, such as percent of micro-cracks or glass particles within a given frame or area.

In some embodiments, as shown in FIG. 18, the shattered region 1804 (e.g., central shattered region 1836) can extend from the second major surface 205 of the foldable substrate 201 to a shattered depth 1805. In further embodiments, the shattered depth 1805 as a percentage of the substrate thickness 1705 can be in a range from about 1% to about 50%, for example, about 1%, 5%, 10%, 15%, 20%, 25%, 30%, 35%, 40%, 45%, 50%, or any value therebetween. In some embodiments, a width of the central shattered region 1821 as a percentage of the width of the foldable substrate 201 can be 5%, 10%, 15%, 20%, 25%, 30%, 35%, 40%, 45%, 50%, 55%, 60%, 65%, 70%, 75%, or any value therebetween. In further embodiments, the shattered depth 1805 can be in a range from 0.01 μm to 2,000 μm, from 0.01 μm to 1,500 μm, from 0.01 μm to 1,000 μm, from 0.01 μm to 500 μm, from 0.01 μm to 250 μm, from 0.01 μm to 100 μm, from 0.01 μm to 50 μm, or any range or subrange therebetween.

In further embodiments, the micro-cracks of the plurality of micro-cracks 1821 in the central shattered region 1836 can be oriented substantially normal to the first major surface 203 and/or the second major surface 205 of the foldable substrate 201. In further embodiments, the first shattered region 1832 can comprise a first plurality of micro-cracks 1831 extending from the second surface area 247, and the micro-cracks of the first plurality of micro-cracks 1831 can be oriented in a substantially random fashion within the first portion 221 of the foldable substrate 201 while remaining substantially normal to the first major surface 203 and/or the second major surface 205. In further embodiments, the second shattered region 1834 can comprise a second plurality of micro-cracks 1833 extending from a fourth surface area 249, and the micro-cracks of the second plurality of micro-cracks 1833 can be oriented in a substantially random fashion within the second portion 223 of the foldable substrate 201 while remaining substantially normal to the first major surface 203 and/or the second major surface 205.

In some embodiments, the foldable substrate 201 of the foldable apparatus 1701 and/or 1801 can comprise one or more of the compressive stress regions discussed above for the foldable substrate 201 or 803. For example, the foldable substrate 201 can comprise one or more compressive stress regions extending from the second major surface 205, a first major surface 203, and/or a first central surface area 233. The foldable substrate can comprise a second compressive stress region extending to a second depth of compression from the second surface area 247 of the first portion 221 comprising the second major surface 205 and/or a second depth of layer of one or more alkali metal ions associated with the second compressive stress region. The foldable substrate 201 can comprise a fourth compressive stress region extending to a fourth depth of compression from the fourth surface area 249 of the second portion 223 comprising the second major surface 205 and/or a fourth depth of layer of one or more alkali metal ions associated with the fourth compressive stress region. The foldable substrate can comprise a second central compressive stress region extending to a second central depth of compression from the second central surface area 245 of the central portion 225 and/or a second central depth of layer of one or more alkali metal ions associated with the second central compressive stress region. For example, the foldable substrate 201 can comprise one or more compressive stress regions extending from the first major surface 203 and/or the first central surface area 233. The foldable substrate can comprise a first compressive stress region extending to a first depth of compression from the first surface area 237 of the first portion 221 comprising the first major surface 203 and/or a first depth of layer of one or more alkali metal ions associated with the first compressive stress region. The foldable substrate 201 can comprise a third compressive stress region extending to a third depth of compression from the third surface area 239 of the second portion 223 comprising the first major surface 203 and/or a third depth of layer of one or more alkali metal ions associated with the third compressive stress region. The foldable substrate can comprise a first central compressive stress region extending to a first central depth of compression from the first central surface area 233 of the central portion 225 and/or a first central depth of layer of one or more alkali metal ions associated with the first central compressive stress region. The compressive stress regions discussed above can comprise a corresponding maximum compressive stress that can be within one or more of the ranges discussed above for the corresponding compressive stress region. In some embodiments, the corresponding maximum compressive stress can be in a range from about 500 MPa to about 1,500MPa, from about 600 MPa to about 1,500 MPa, from about 800 MPa to about 1,500 MPa, or any range or subrange therebetween. In some embodiments, the corresponding maximum compressive stress can exceed 1,000 MPa at the corresponding surface, up to 2,000 MPa. Providing one or more compressive stress regions can offset tensile stresses generated in the substrate upon folding of the foldable apparatus 1701 and 1801, particularly tensile stresses that reach a maximum on the first major surface 203 or the second major surface 205, depending on the direction of the fold.

In some embodiments, the shattered region 1804 can include one or more polymeric material having a refractive index that substantially matches a refractive index of the foldable substrate 201 or a refractive index intended to differ from the refractive index of the foldable substrate 201, as detailed in U.S. Provisional Patent Application No. 62/958117, filed on Jan. 7, 2020, the salient portions of which are hereby incorporated by reference in this disclosure.

In some embodiments, as shown in FIG. 18, the foldable apparatus 1801 can comprise a polymer layer 1811 disposed on the first major surface 203 of the foldable substrate 201. In further embodiments, as shown, the polymer layer can comprise a third contact surface 1813 that can face and/or contact the first major surface 203 of the foldable substrate 201. In further embodiments, as shown, the polymer layer 1811 can comprise a polymer thickness 1817 defined between the third contact surface 1813 and a fourth contact surface 1815 opposite the third contact surface 1813. In even further embodiments, the polymer thickness 1817 can be within one or more ranges discussed above for the coating thickness 287. Providing the polymer layer 1811 can ensure that any loose pieces (e.g., glass pieces) from the shattered region 1804 are not released from the foldable substrate 201, for example if a loose piece was generated by one or more cracks extended through the substrate thickness 1705 of the foldable substrate 201 to the first major surface 203 of the foldable substrate 201 that contacts the polymer layer 1811. In further embodiments, the polymer layer 1811 can comprise any of the materials discussed above for the first material 254 or the second material 256. In further embodiments, the polymer layer 1811 can comprise any suitable polymer at a prescribed thickness sufficient to achieve this function, as understood by those of ordinary skill in the field of the disclosure.

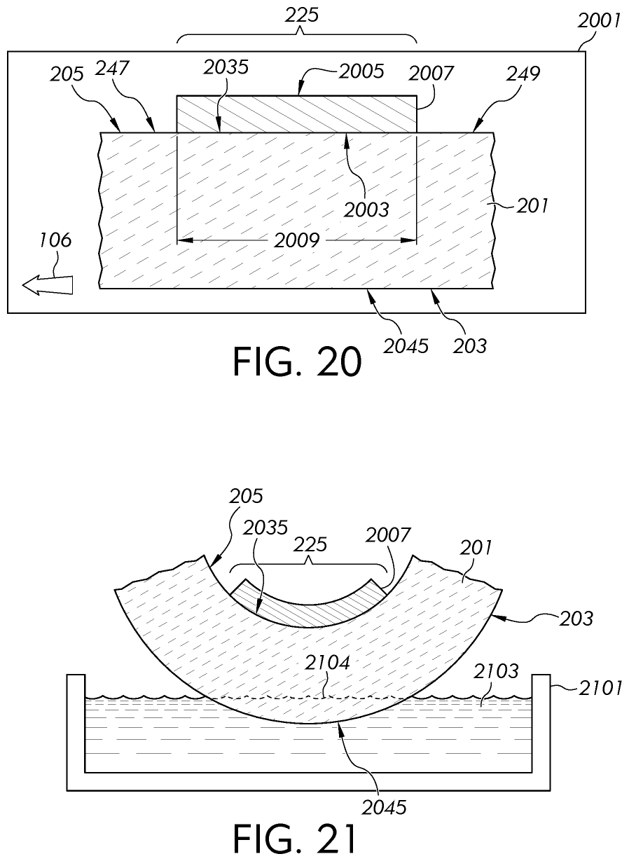

In some embodiments, as discussed below with reference to step 1903 and/or 1905 and FIGS. 20-22, an oxide coating 2007 can be disposed over the second major surface 205 of the foldable substrate 201. In further embodiments, the oxide coating 2007 can be formed by annealing a sol-gel coating disposed on the second major surface 205 of the foldable substrate 201, and the oxide coating can comprise one or more oxidized components of the sol-gel coating discussed below. In further embodiments, the oxide coating 2007 can comprise a coating thickness defined between the first contact surface 2003 and a second contact surface 2005 opposite the first contact surface 2003. In even further embodiments, the oxide coating 2007 can have a thickness in a range from about 0.1 μm to about 20 μm, from about 0.1 μm to about 15 μm, from about 0.1 μm to about 10 μm, or any range or subrange therebetween. In even further embodiments, as shown in FIGS. 20-21, the first contact surface 2003 of the oxide coating can contact and be attached to the second major surface 205 (e.g., second central surface area 2035) of the foldable substrate 201. In further embodiments, a width 2009 of the oxide coating 2007 can be defined in the direction 106 of the length (e.g., length of the foldable substrate 201 and/or length of the foldable apparatus). In even further embodiments, the width 2009 of the oxide coating 2007 can be in a range from about 1 mm to about 200 mm, from about 1 mm to about 150 mm, from about 1 mm to about 100 mm, from about 1 mm to about 80 mm, from about 5 mm to about 60 mm, from about 10 mm to about 50 mm, from about 20 mm to about 40 mm, or any range or subrange therebetween. In even further embodiments, the width 2009 of the oxide coating 2007 as a percentage of a longest dimension of the foldable substrate (e.g., length of the foldable substrate 201) of the foldable substrate 201 can be in a range from about 5% to about 70%, from about 5% to about 50%, or from about 5% to about 30%, from about 10% to about 25%, or any range or subrange therebetween.

In some embodiments, foldable apparatus can be further characterized by bend fatigue resistance, for example, using the Clamshell Cyclic Fatigue Test. As used herein, the “Clamshell Cyclic Fatigue Test” is conducted by situating a foldable apparatus between two plates of a test fixture. In particular, the ends of the foldable apparatus are held in contact and normal to these plates, and each bend cycle involves moving the plates toward each other to a spacing of a specified, predetermined value (e.g., 10 mm) to bend the foldable apparatus and then returning the plates to a spacing such that the foldable apparatus is substantially planar. Unless otherwise noted, the Clamshell Cyclic Fatigue Test is conducted according to the following test conditions: an auto speed of 30%, a jog speed of 20%, a delay of 0.3 seconds, and a test rate of ˜31 cycles per minute. Further, the Clamshell Cyclic Fatigue Test can be conducted on a number of samples within a particular configuration (N) and the cycles-to-failure values are tabulated for each such sample. The data for each sample configuration can then be reported according to standard statistical measures over the given sample size (N), e.g., a mean, an average, a standard deviation, no failures over a specified number of cycles (e.g., 25,000 cycles), etc., as would be understood by those of ordinary skill in the field of the disclosure. In some embodiments, the foldable apparatus and/or foldable substrate can be characterized with no failures upon being subjected to at least 25,000 bend cycles in a Clamshell Cyclic Fatigue Test with a 10 mm plate separation. In some embodiments, the foldable apparatus and/or foldable substrate can be characterized with no failures upon being subject to at least 25,000 bend cycles in a Clamshell Cyclic Fatigue Test with a 5 mm, 6 mm, 7 mm, 8 mm, 9 mm, 10 mm, 12 mm, 14 mm, 16 mm, 18 mm, or 20 mm plate separation, including plate separations therebetween. In some embodiments, the foldable apparatus and/or the foldable substrate can be characterized with no failures upon being subjected to at least 5,000, 10,000, 15,000, 20,000, 25,000, 30,000, 40,000, or 50,000 bend cycles in a Clamshell Cyclic Fatigue Test with a 10 mm plate separation, including values therebetween.

Embodiments of the disclosure can comprise a consumer electronic product. The consumer electronic product can comprise a front surface, a back surface and side surfaces. The consumer electronic product can further comprise electrical components at least partially within the housing. The electrical components can comprise a controller, a memory, and a display. The display can be at or adjacent the front surface of the housing. The consumer electronic product can comprise a cover substrate disposed over the display. In some embodiments, at least one of a portion of the housing or the cover substrate comprises the foldable apparatus discussed throughout the disclosure.

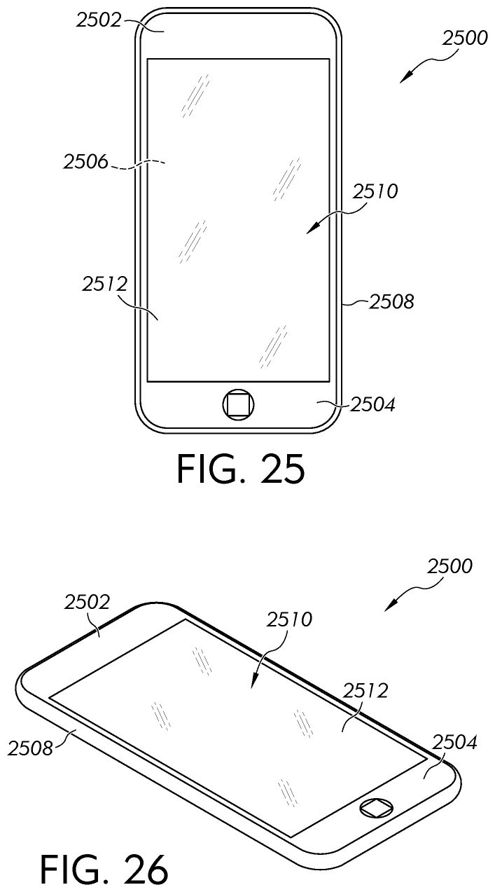

The foldable apparatus disclosed herein may be incorporated into another article, for example, an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the foldable apparatus disclosed herein is shown in FIGS. 25 and 26. Specifically, FIGS. 25 and 26 show a consumer electronic device 2500 including a housing 2502 having a front surface 2504, a back surface 2506, and side surfaces 2508. The consumer electronic device 2500 can comprise electrical components (not shown) that are at least partially inside or entirely within the housing and including at least a controller, a memory, and a display 2510 at or adjacent to the front surface of the housing. The consumer electronic device 2500 can comprise a cover substrate 2512 at or over the front surface of the housing such that it is over the display. In some embodiments, at least one of the cover substrate 2512 or a portion of housing 2502 may include any of the foldable apparatus disclosed herein.

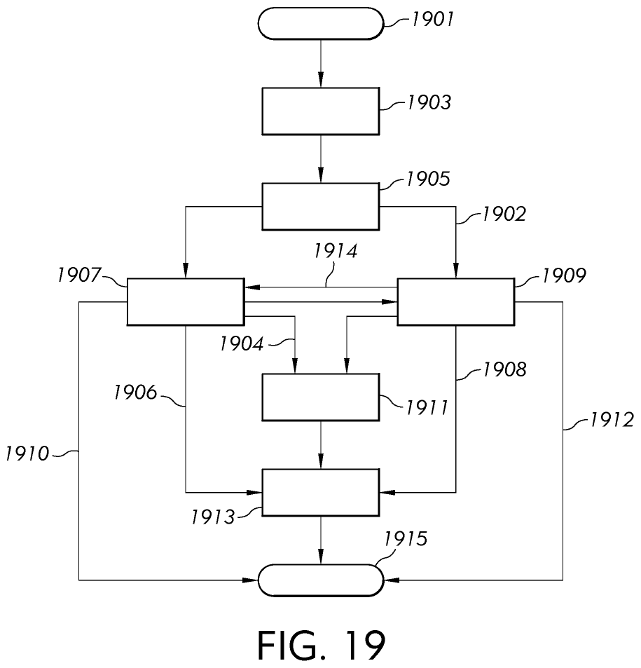

Embodiments of methods of making the foldable apparatus in accordance with embodiments of the disclosure will be discussed with reference to the flow charts in FIGS. 19, 27, and 43-44 and example method steps illustrated in FIGS. 20-24, 28-42, and 45-58.

Embodiments of methods of making the foldable apparatus 1701 and 1801 in accordance with embodiments of the disclosure will be discussed with reference to the flow chart in FIG. 19 and example method steps illustrated in FIGS. 20-24.

With reference to the flow chart of FIG. 19, methods can start 1901 with providing a substrate. In some embodiments, the substrate can resemble the foldable substrate 201 of FIGS. 17-18 with or without a shattered region (e.g., central shattered region), a recess (e.g., recess 1709), and/or a polymer layer 1811. In some embodiments, the substrate can be provided by purchase or otherwise obtaining a substrate or by forming the substrate. In some embodiments, the substrate can comprise a glass-based substrate and/or a ceramic-based substrate. In further embodiments, glass-based substrates can be provided by forming them with a variety of ribbon forming processes, for example, slot draw, down-draw, fusion down-draw, up-draw, press roll, redraw or float.

After step 1901, as shown in FIG. 20, methods can proceed to step 1903 comprising disposing a sol-gel coating on the second major surface 205 of the foldable substrate 201, which can subsequently be heated to form the oxide coating 2007 in step 1905. In some embodiments, the sol-gel can comprise a silicon-containing constituent and a titanium-containing constituent. In further embodiments, the foldable substrate 201 can comprise the substrate thickness defined between the first major surface 203 and the second major surface 205 that can be within one or more of the ranges discussed above for the substrate thickness 1705 while comprising a sol-gel coating comprising silicon-containing constituent and a titanium-containing constituent disposed on the second major surface 205. In further embodiments, the silicon-containing constituent and the titanium-containing constituents are reduced forms of the corresponding constituents of the sol-gel coating 2007 that can be oxidized to form the sol-gel coating 2007 in step 1905. In further embodiments, the sol-gel coating can comprise diphenylsilanediol, methyltriethoxysilane, tetraethoxysilane, hydroxyl poly(dimethylsiloxane), water, boron n-butoxide, tetrakistrimethylsilyltitanium, and/or n-propyl acetate. For example, the sol-gel coating can include: 9 g of diphenylsilanediol, 20 ml of methyltriethoxysilane, 2 ml of tetraethoxysilane, 2 ml of hydroxyl poly(dimethylsiloxane), 3 ml of water, 2 ml of boron n-butoxide, and 2 ml of tetrakistrimethylsilyltitanium, as mixed with n-propyl acetate at a 1:1 ratio. In further embodiments, the sol-gel coating can comprise a di-functional silane or siloxane (e.g., diphenylsilanediol or hydroxy poly(dimethylsiloxane)) that can react (e.g., in step 1903 or 1905) with a tri-functional silane in the presence of an acid to produce long, low cross-link density chains. In further embodiments, the boron-containing species in the sol-gel coating can help soften the sol-gel so that it does not become too brittle during curing (e.g., heating in step 1905). In further embodiments, the titanium-containing species in the sol-gel coating can serve as the acid. An exemplary embodiment of an acid titanium-containing is tetrakistrimethylsilyltitanium, which has trimethylsilyl ligands that can help with network formation during consolidation (e.g., curing, heating in step 1905). In further embodiments, a boron-containing material, tristrimethylsilylboron, can be used in place of boron-n-butxide in the sol-gel coating. It is to be understood that any di-functional silane (e.g., dimethyldimethoxy silane, dimethyldiethoxy silane, etc.) could play the role of the diol. In further embodiments, methyl and ethyltriacetoxysilane can be employed as the acid generator in the sol-gel coating. In further embodiments, water can be present in the sol-gel coating to enable hydrolysis of materials, and the water content can be adjusted to higher levels to increase sol-gel viscosity. In further embodiments, the sol-coating can comprise the tetraethoxy silane to ensure some crosslinking during the gelation reaction.

In some embodiments, in step 1903, the sol-gel coating can be disposed over the central portion 225 of the second major surface 205 (e.g., existing second central surface area 2035). In further embodiments, the sol-gel coating can comprise a width in the direction (e.g., direction 106) of the width of the foldable substrate 201 that can be within one or more of the ranges discussed above for the width 2009 of the oxide coating 2007 (e.g., from about 1 mm to about 200 mm or from about 5% to about 70% of the longest dimension (e.g., length) of the foldable substrate). In further embodiments, a thickness of the sol-gel coating can be about 0.1 μm or more, about 0.5 μm or more, about 1 μm or more, about 2μm or more, about 5μm or more, about 20 μm or less, about 15 μm or less, about 12 μm or less, about 10 μm or less, or about 8 μm or less. In further embodiments, a thickness of the sol-gel coating can be in a range from about 0.1 μm to about 20 μm, from about 0.1 μm to about 15 μm, from about 0.5 μm to about 15 μm, from about 0.5 μm to about 12 μm, from about 1 μm to about 12 μm, from about 1 μm to about 10 μm, from about 2 μm to about 10 μm, from about 2 μm to about 8 μm, from about 5 μm to about 8 μm, or any range or subrange therebetween. For example, the thickness of the sol-gel coating can be 0.1 μm, 0.5 μm, 1 μm, 2μm, 3μm, 4μm, 5μm, 6μm, 7μm, 8μm, 9μm, 10 μm, 11 μm, 12 μm, 13 μm, 14 μm, 15 μm, 16 μm, 17 μm, 18 μm, 19 μm, 20 μm, or any value therebetween.

After step 1903, as shown in FIG. 20, methods can proceed to step 1905 comprising heating the sol-gel coating and the foldable substrate 201 in air at an annealing temperature for a period of time to form an oxide coating 2007 on the second major surface 205 of the foldable substrate 201. In some embodiments, heating the sol-gel coating and the foldable substrate 201 can comprise placing the sol-gel coating and the foldable substrate 201 in an oven 2001 maintained at the annealing temperature. In some embodiments, the annealing temperature can be about 500° C. or more, about 550° C. or more, about 575° C. or more, about 700° C. or less, about 650° C. or less, or about 600° C. or less. In some embodiments, the annealing temperature can be in a range from about 500° C. to about 700° C., from about 550° C. to about 700° C., from about 550° C. to about 650° C., from about 575° C. to about 650° C., from about 575° C. to about 600° C., or any range or subrange therebetween. In some embodiments, the period of time can be about 10 minutes or more, about 20 minutes or more, about 30 minutes or more, about 45 minutes or more, about 180 minutes or less, about 150 minutes or less, about 120 minutes or less, about 90 minutes or less, or about 60 minutes or less. In some embodiments, the period of time can be in a range from about 10 minutes to about 180 minutes, from about 10 minutes to about 150 minutes, from about 20 minutes to about 150 minutes, from about 20 minutes to about 120 minutes, from about 30 minutes to about 120 minutes, from about 30 minutes to about 90 minutes, from about 45 minutes to about 90 minutes, from about 45 minutes to about 60 minutes, or any range or subrange therebetween.

In some embodiments, in step 1905, the heating can be conducted to define the foldable substrate 201 and oxide coating 2007 thereon in a bent configuration (e.g., as-bent configuration, neutral stress configuration). In further embodiments, the bent configuration (e.g., as-bent configuration, neutral stress configuration) can be achieved as the natural product of the heating, for example, as the organic components in the sol-gel coating are burned off (e.g., oxidized, removed) and the oxide coating is formed (e.g., consolidates). For example, the bent configuration (e.g., as-bent configuration, neutral stress configuration) can be within any of the ranges discussed above for the angle (e.g., from greater than 0° to about)90° and/or diameter of curvature (e.g., from 2 mm to about 20 mm). In some embodiments, as shown in FIG. 20, the oxide coating 2007 can comprise a thickness defined between the first contact surface 2003 and the second contact surface 2005 that can be within one or more of the ranges discussed above for the thickness of the oxide coating 2007. In some embodiments, the first contact surface 2003 of the oxide coating 2007 can contact the second major surface 205 of the foldable substrate 201 (e.g., the existing second central surface area 2035) in the central portion 225. In some embodiments, the oxide coating 2007 can comprise a width 2009 in a direction (e.g., direction 106) of the longest dimension (e.g., length) of the foldable substrate 201 that can be within one or more of the ranges discussed above for the width 2009. In some embodiments, step 1905 can further comprise cooling the oxide coating 2007 and the foldable substrate 201 to an ambient temperature (e.g., from about 20° C. to about 30° C.).

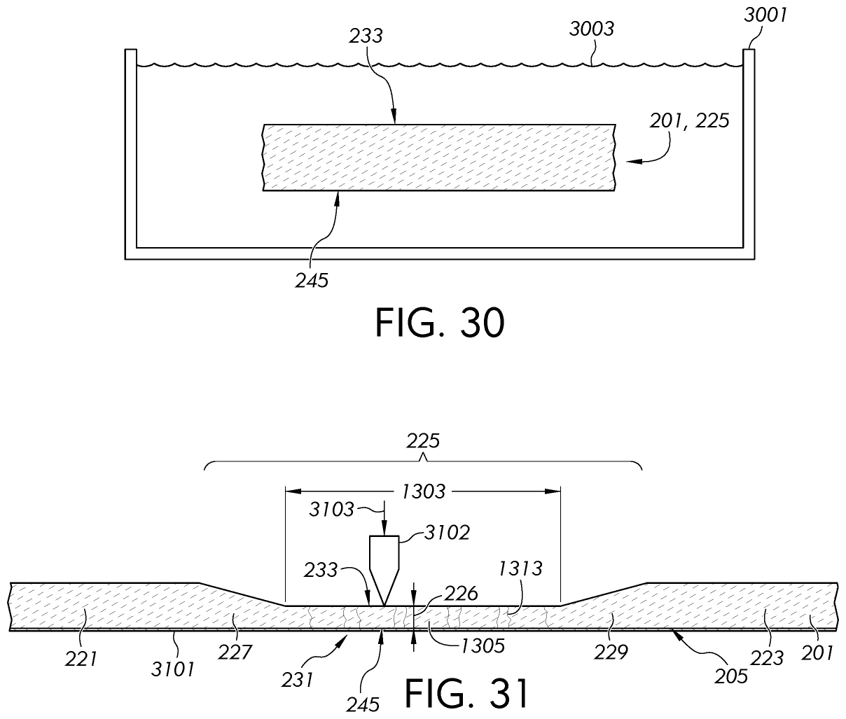

After step 1905 or 1909, methods can proceed to step 1907 comprising chemically strengthening the foldable substrate 201. In some embodiments, step 1907 can comprise contacting (e.g., immersing) the foldable substrate with an ion-exchange bath (e.g., salt solution 3003 contained in a salt bath 3001) as discussed below with reference to step 2703 and FIG. 30. In further embodiments, the salt solution can comprise a temperature within one or more of the ranges discussed below with reference to step 2703. In further embodiments, the foldable substate 201 can contact the salt solution for a period of time within one or more of the ranges discussed below with reference to step 2703. In some embodiments, chemically strengthening the foldable substrate can form one or more compressive stress region(s) extending from the second major surface 205 to a corresponding depth of compression. For example, a second compressive stress region can extend from the second surface area 247 to a second depth of compression, a fourth compressive stress region can extend from the fourth surface area 249 to a fourth depth of compression, and/or a second central compressive stress region can extend from the second central surface area 245 to a second central depth of compression. In some embodiments, chemically strengthening the foldable substrate can form one or more compressive stress region(s) extending from the first major surface 203 to a corresponding depth of compression. For example, a first compressive stress region can extend from the first surface area 237 to a first depth of compression, a third compressive stress region can extend from the third surface area 239 to a third depth of compression, and/or a first central compressive stress region can extend from the first central surface area 233 to a first central depth of compression. In further embodiments, the compressive stress region(s) formed in step 1907 can comprise a maximum compressive stress within one or more of the ranges discussed above for the maximum compressive stress (e.g., at least 500 MPa, 800 MPa, or 1,000 MPa at the second major surface 205). In further embodiments, step 1907 can comprise chemically strengthening the first major surface 203 (e.g., first central surface area 233) sufficient to for frangibility of at least a portion of the foldable substrate 201 (e.g., central portion 225). In even further embodiments, the foldable substrate 201 can comprise a bent configuration resembling the configuration shown in FIG. 21 such that the central portion 225 (e.g., first central surface area 233) is in contact with the salt solution for an extended duration (e.g., longer than the first surface area and/or second surface area). Without wishing to be bound by theory, creating a compressive stress region extending from the first major surface sufficient for frangibility allows for the efficient development of microcracks in the shattered region 1804 (e.g., central shattered region 1836, first shattered region 1832, second shattered region 1834) in step 1913, discussed below.

In further embodiments, the chemically strengthening in step 1907 can be conducted while the foldable substrate comprising the oxide coating 2007 disposed over the existing second central surface area 2035, for example, resembling one of the configurations shown in FIGS. 21-22. In even further embodiments, the second compressive stress region can be substantially unaffected by presence of the oxide coating 2007, for example, if the oxide coating 2007 comprises a high diffusivity of alkali metal ions (e.g., see Example 10 below). Generally, the ion-exchange compressive stress region extending from the second major surface 205 of the foldable substrate 201 is additive to the residual stress developed from the heating in step 1905 and serves to further offset tensile stresses developed in the foldable apparatus 1701 and/or 1801 upon folding the foldable substrate 201 in a concave-up configuration, as shown in FIG. 24.

After step 1905 or 1907, as shown in FIGS. 21-22, methods can proceed to step 1909 comprising etching. In some embodiments, step 1909 can comprise etching the oxide coating (e.g., oxide coating 2007 shown in FIGS. 20-21) from the foldable substrate 201. In further embodiments, as shown in FIG. 21, etching the oxide coating can comprise contacting the oxide coating and/or the first major surface 203 of the foldable substrate 201 with an etchant 2103 that can be contained in an etchant bath 2101. In further embodiments, the etchant 2103 can comprise one or more mineral acids (e.g., HCl, HF, H₂SO₄, HNO₃). In further embodiments, as shown in FIG. 22, the etchant 2103 can remove material in an etching region 2205 that can contain the oxide coating and/or a portion of the second major surface 205 of the foldable substrate. For example, as shown in FIG. 22, the etchant 2103 can extend to an etchant level 2204 on the foldable substrate 201, which can be considered a boundary of the etching region 2205 that can include an existing second central surface area 2035 that can be etched to reveal the second central surface area 245. In some embodiments, etching the existing second central surface area 2035 in step 1909 can form a recess 2309 in the second major surface 205, as shown in FIG. 23, although a recess in the second major surface 205 may not be formed in other embodiments. In even further embodiments, although not shown, the recess 2309 in the second major surface 205 can be opposite the recess 1709 in the first major surface 203 (see FIGS. 17 and 23). For example, as shown, the foldable substrate 201 can be manipulated into the configuration shown in FIG. 22 to present the surface(s) to be etched to the etchant 2103 while avoiding (e.g., minimizing) contact of other portions of the foldable substrate 201 with the etchant 2103. In some embodiments, although not shown, surfaces of the foldable substrate 201 not being etched in 201 can be protected with an etch mask. In some embodiments, the foldable substrate can be manipulated from a configuration resembling that shown in FIG. 21 to another configuration resembling that shown in FIG. 22 to present the oxide coating 2007 and/or the second major surface 205. In some embodiments, although not shown, the etchant can be dispensed such that it contacts the oxide coating without substantially contacting the foldable substrate. In some embodiments, as shown in FIG. 22, an existing second central surface area 2045 can be opposite the existing first central surface area 2035, for example, if the existing second central surface area 2045 has not been etched to form a recess.

In some embodiments, step 1909 can comprise etching a recess (e.g., recess 1709 in the first major surface 203 shown in FIG. 17 or a recess 2309 in the second major surface 205 shown in FIG. 23) in the foldable substrate 201. In further embodiments, as shown in FIG. 21, etching the recess 1709 in the first major surface 203 can comprise contacting a portion of the first major surface 203 (e.g., in the central portion 225) with the etchant 2103, which can be contained in the etchant bath 2101. In further embodiments, as shown in FIG. 21, the portion to be etched can be below an etchant level 2104. In even further embodiments, as shown in FIG. 17, the recess 1709 defined by the first central surface area 233 can be curved even though the etchant level 2104 (see FIG. 21) can extend along a plane, for example, when the foldable substrate 201 is in a bent configuration during the etching. In some embodiments, as shown in FIG. 22 and discussed above, etching a recess (e.g., recess 2309) can comprise contacting a portion (e.g., central portion 225) of the second major surface 205 with the etchant 2103, which can be conducted while the oxide coating is disposed thereon. In further embodiments, the recess can be etched by contacting (e.g., immersing the portion below the etchant level 2204) for a sufficient period of time for the oxide coating 2007 to be etched, if present, and the recess 2309 to be formed. In further embodiments, the etching the oxide coating 2007, discussed above, can etch a portion of the central portion 225 at the second major surface 205 comprising the existing second central surface area 2035 to reveal a second central surface area (e.g., dashed line 2304) defining the recess 2309. In even further embodiments, as shown in FIG. 23, the recess 2309 defined by the dashed line 2204 can be curved even though the etchant level 2204 (see FIG. 22) can extend along a plane, for example, when the foldable substrate 201 is in a bent configuration during etching.

After step 1907 or 1909, as shown in FIG. 23, methods can proceed to step 1911 comprising disposing a polymer layer 1811 over the foldable substrate 201. In some embodiments, as shown, the polymer layer 1811 can be disposed on the first major surface 203 of the foldable substrate 201. As discussed above, the polymer layer 811 can be configured to ensure that any loose glass pieces in the shattered region 1804 are not released from the foldable substrate 201. In further embodiments, the polymer layer 1811 can comprise any of the materials discussed above for the first material 254 or the second material 256. In further embodiments, the polymer layer 1811 can comprise any suitable polymer at a prescribed thickness sufficient to achieve this function, as understood by those of ordinary skill in the field of the disclosure. In some embodiments, the polymer layer 1811 can be disposed by spin coating, dip coating, roll coating, or any other suitable method or any suitable material.

After step 1907, 1909, or 1911, as shown in FIGS. 17-18, methods can proceed to step 1913 comprising folding the foldable substrate 201 to form a foldable apparatus (e.g., foldable apparatus 1701 or 1801) in a substantially non-bent configuration. In further embodiments, the substantially non-bent configuration resulting from folding the foldable substrate 201 to form a foldable apparatus can be characterized by a residual tensile stress at the second major surface 205 and/or a residual compressive stress at the first major surface 203 that can be within one or more of the ranges discussed above (e.g., about 500 MPa or more) for the residual compressive stress and/or the residual tensile stress, respectively.

In some embodiments, as shown in FIG. 18, step 1913 can comprise folding the foldable substrate 1801 into the substantially non-bent (e.g., planar) configuration shown to form the shattered region 1804. In further embodiments, as shown in FIGS. 18, the shattered region 1804 can comprise the central shattered region 1836, which can comprise plurality of micro-cracks 1821 that can be oriented substantially normal to the first major surface 203 and/or the second major surface 205 of the foldable substrate 201. In even further embodiments, a longest dimension of the plurality of micro-cracks can be within one or more of the ranges discussed above for the longest dimension. In some embodiments, as shown in FIG. 18, the shattered region 1804 (e.g., central shattered region 1821) can extend from the first major surface 203 of the foldable substrate 201 to a shattered depth 1805 that can be within one or more of the ranges discussed above for the shattered depth 1805. Without being bound by theory, the action of folding the foldable substrate 201 and the polymer layer 1811 to a non-bent configuration imparts tensile stresses on the first major surface 203 with the polymer layer 1811 and compressive stresses on the second major surface 205 opposite the polymer layer 1811, which results in the formation of shattered region 1804. That is, the shift from the as-bent configuration (e.g., neutral stress configuration) to the substantially non-bent (e.g., planar) configuration causes the foldable substrate 201 to shatter the second major surface 205 experiencing the compressive stress, essentially stressing the glass to a condition of localized cracking at this surface. In further embodiments, as shown in FIG. 24, folding the foldable substrate 201 can further comprise folding the polymer layer 1811 such that the polymer layer 1811 is on the outside of the fold. In further embodiments, the shattered region 1804 (e.g., central shattered region 1821) can be infused (in a subsequent step) with one or more polymeric materials a refractive index that substantially matches that of the foldable substrate 201, or a refractive index intended to differ from the refractive index of the foldable substrate 201. In even further embodiments, the one or more polymeric materials can comprise the first material 254 and/or the second material 256 discussed above.

After step 1913, methods can be complete at step 1915. In some embodiments, as shown in FIG. 24, the foldable substrate 201 can resemble the foldable apparatus 2401 can be characterized by substantially zero residual stress in the as-bent configuration (e.g., neutral stress configuration), as discussed above. In further embodiments, the configuration (e.g., as-bent configuration, neutral stress configuration) characterized by substantially zero residual stress can be defined as a result of the heating in step 1905. In further embodiments, the configuration (e.g., as-bent configuration, neutral stress configuration) characterized by substantially zero residual stress can comprise a bend angle and/or a diameter of curvature within one or more of the ranges discussed above for the bend angle and/or diameter of curvature, respectively (e.g., a bend angle from 0° to about 90° and a diameter of curvature from 2 mm to about 20 mm). For example, the foldable substrate 201 can be characterized by about zero residual stress at a bend angle of about 90° with a diameter of curvature of about 4.75 mm. As another example, the foldable substrate 201 can be characterized by about zero residual stress at a bend angle of 45° with a diameter of curvature of about 3 mm. In even further embodiments, the one or more polymeric materials can comprise the materials detailed in U.S. Provisional Patent Application No. 62/958117, filed on Jan. 7, 2020, the salient portions of which are hereby incorporated by reference in this disclosure.

In some embodiments, the foldable apparatus 1701 and/or 1801 formed by the methods discussed above can be characterized by fatigue resistance, for example, by no failures upon being subjected to at least 25,000 bend cycles in a Clamshell Cyclic Fatigue Test with a 10 mm plate separation. In further embodiments, the foldable substrate 201 of the foldable apparatus 1701 and/or 1801 can be characterized with no failures upon being subjected to at least 25,000 bend cycles in a Clamshell Cyclic Fatigue Test with a 5 mm, 6 mm, 7 mm, 8 mm, 9 mm, 10 mm, 12 mm, 14 mm, 16 mm, 18 mm, or 20 mm plate separation, including all values therebetween. In further embodiments, the foldable substrate 201 of the foldable apparatus 1701 and/or 1801 can be characterized with no failures upon being subjected to at least 5,000, 10,000, 15,000, 20,000, 25,000, 30,000, 40,000, or 50,000 bend cycles in a Clamshell Cyclic Fatigue Test with a 10 mm plate separation, including all other bend cycles therebetween.

In some embodiments, as discussed above with reference to the flow chart in FIG. 19, methods can start at step 1901 and then proceed sequentially through steps 1903, 1905, 1907, 1909, 1911, 1913, and 1915. In some embodiments, arrows 1902 and 1914 can be followed, reversing the order of steps 1907 and 1909, for example, if the foldable substrate 201 is to be etched before it is to be chemically strengthened. In some embodiments, arrow 1902 and 1908 can be followed, omitting step 1907 comprising chemically strengthening the foldable substrate and step 1911 comprising disposing the polymer layer 1811, for example, if step 1909 comprising etching to form a recess to make the foldable apparatus 1701 shown in FIG. 17. In some embodiments, arrow 1904 can be followed from step 1907 to step 1911, omitting step 1909 comprising etching the foldable substrate 201, for example, if the foldable substrate 201 is already etched or is not be etched. In some embodiments, arrow 1906 can be followed from step 1907 to 1913, omitting step 1909 comprising etching the foldable substrate 201 and step 1911 comprising disposing a polymer layer 1811, for example, to make the foldable apparatus 1801 shown in FIG. 18. In some embodiments, arrow 1908 can be followed from step 1909 to step 1913, omitting step 1911 comprising disposing a polymer layer 1811, for example, to make the foldable apparatus 1701 shown in FIG. 17 when step 1909 comprises etching to form a recess. In some embodiments, arrow 1910 can be followed from step 1907 to step 1915, omitting disposing the polymer layer 1811 in step 1913 and folding the foldable substrate 201 in step 1913, for example, if the foldable substrate 201 is not to comprise a shattered region 1804 (e.g., resembling foldable substrate 1701 in FIG. 17). In some embodiments, arrow 1912 can be followed from step 1909 to step 1915, omitting disposing the polymer layer 1811 in step 1913 and folding the foldable substrate 201 in step 1913 and folding the foldable substrate 201 in step 1913, for example, if the foldable substrate 201 is not to comprise a shattered region 1804 (e.g., resembling foldable substrate 1701 in FIG. 17). Any of the above options may be combined to make a foldable apparatus in accordance with embodiments of the disclosure.

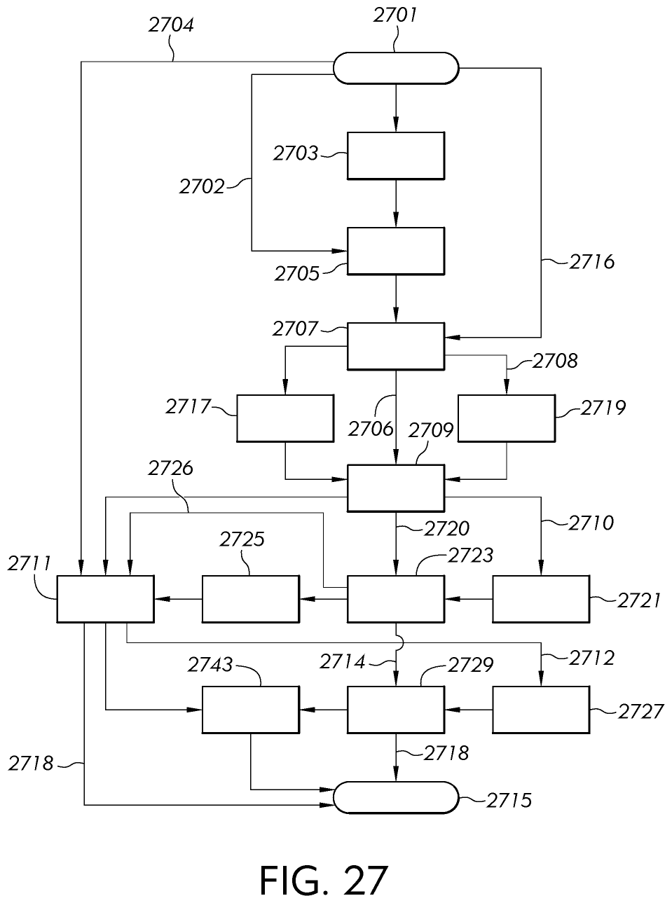

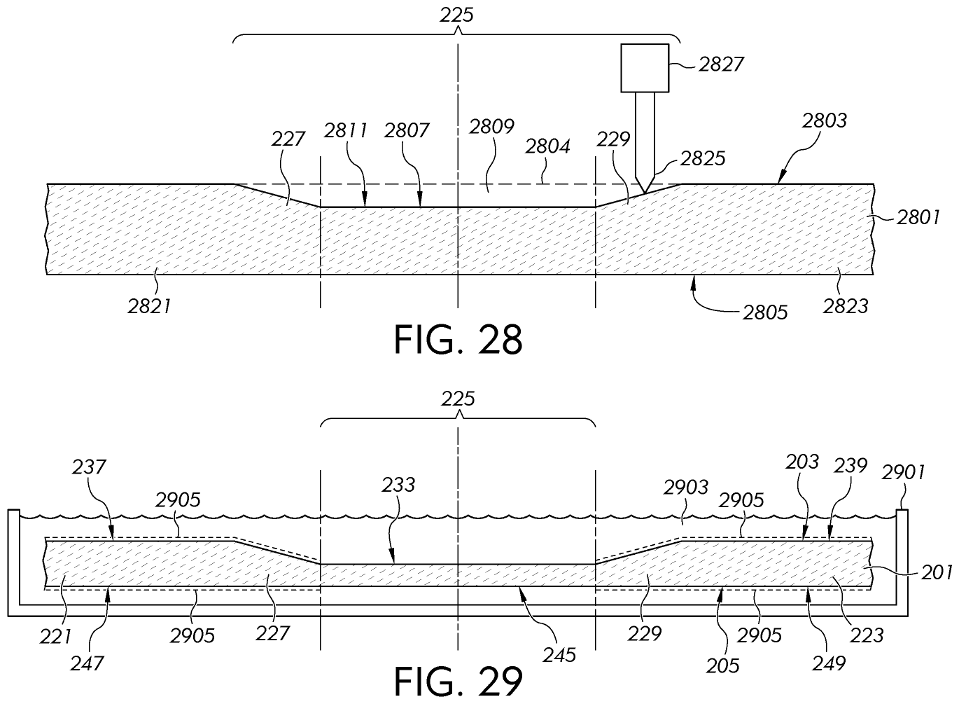

Embodiments of methods of making the foldable apparatus 101, 301, 401, 501, 601, 701, and 801 in accordance with embodiments of the disclosure will be discussed with reference to the flow chart in FIG. 27 and example method steps illustrated in FIGS. 28-42. With reference to the flow chart of FIG. 27, methods can start 2701 with providing a substrate. In some embodiments, the substrate can resemble the foldable substrate 201 or 803 of FIGS. 2-8 and 13-14 with or without a shattered pane comprising a central thickness 226 less than the first thickness 222. In some embodiments, the substrate can resemble the foldable substrate 201 or 803 of FIGS. 4-8 with or without a shattered pane comprising a substantially uniform thickness (e.g., first thickness 222). In some embodiments, the substrate can be provided by purchase or otherwise obtaining a substrate or by forming the substrate. In some embodiments, the substrate can comprise a glass-based substrate and/or a ceramic-based substrate. In further embodiments, glass-based substrates can be provided by forming them with a variety of ribbon forming processes, for example, slot draw, down-draw, fusion down-draw, up-draw, press roll, redraw or float.

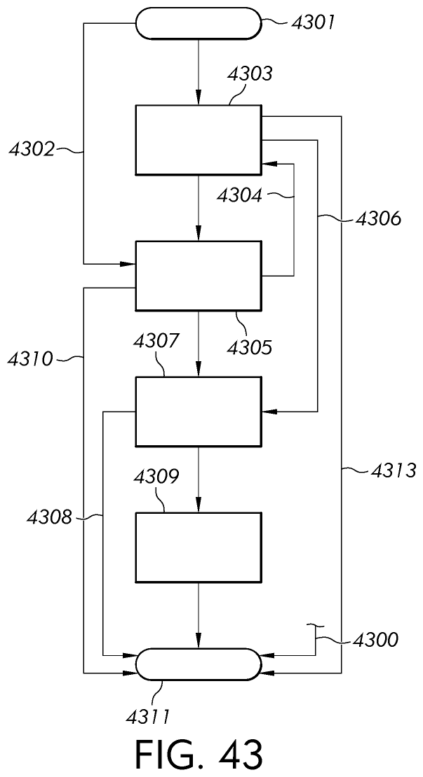

In some embodiments where there is a recess defined between (i) a first plane comprising the first surface area and the third surface area and (ii) a first central surface area, the recess may be formed by etching, laser ablation or mechanically working the first major surface. For example, the first major surface may be mechanically worked by diamond engraving (e.g., using computer numeric control (CNC)) to produce very precise patterns in foldable substrates. Materials other than diamond can be used for engraving with a CNC machine. Furthermore, other methods of forming the recess include lithography, etching, and laser ablation. In some embodiments, the substrate can be etched by placing it in an etching bath comprising one or more mineral acids (e.g., HCl, HF, H₂SO₄, HNO₃). Etching can comprise reducing a thickness of the substrate and/or removing surface flaws (e.g., surface imperfections generated during formation of the recess, surface imperfections generated during chemically strengthening). In further embodiments, etching can be designed to remove less than 5-10 nanometers (nm) of a compressive stress layer generated by chemical strengthening. In some embodiments, methods of forming a recess can follow the flow chart in FIG. 43 with reference to FIGS. 28-30 discussed below.

After step 2701, as shown in FIG. 30, methods can proceed to the step 2703 of chemically strengthening the foldable substrate 201 (e.g., central portion 225), for example, if the foldable substrate comprises a glass-based substrate and/or a ceramic-based substrate. For example, chemically strengthening the substrate by ion exchange can occur when a first cation within a depth of a surface of a substrate is exchanged with a second cation within a salt solution that has a larger radius than the first cation. For example, a lithium cation within the depth of the surface of the substrate can be exchanged with a sodium cation or potassium cation within a salt solution. Consequently, the surface of the foldable substrate 201 (e.g., central portion 225) is placed in compression and thereby chemically strengthened by the ion exchange process since the lithium cation has a smaller radius than the radius of the exchanged sodium cation or potassium cation within the salt solution 3003. Chemically strengthening the foldable substrate 201 (e.g., central portion 225) can comprise contacting at least a portion of a foldable substrate 201 comprising lithium cations and/or sodium cations with a salt bath 3001 comprising salt solution 3003 comprising potassium nitrate, potassium phosphate, potassium chloride, potassium sulfate, sodium chloride, sodium sulfate, and/or sodium nitrate, whereby lithium cations and/or sodium cations diffuse from the foldable substrate 201 to the salt solution 3003 contained in the salt bath 3001. In some embodiments, the temperature of the salt solution 3003 can be in a range from about 300° C. to about 500° C., from about 360° C. to about 500° C., from about 400° C. to about 500° C., from about 300° C. to about 460° C., from about 360° C. to about 460° C., from about 400° C. to about 460° C., from about 300° C. to about 400° C., from about 360° C. to about 400° C., or any range or subrange therebetween. In some embodiments, the foldable substrate 201 can be in contact with the salt solution 3003 for a time in a range from about 15 minutes to about 48 hours, from about 1 hour to about 48 hours, from about 3 hours to about 48 hours, from about 15 minutes to about 24 hours, from about 1 hour to about 24 hours, from about 3 hours to about 48 hours, from about 3 hours to about 24 hours, from about 3 hours to about 8 hours, or any range or subrange therebetween. In some embodiments, the entire foldable substrate may be strengthened. In some embodiments, chemical strengthening of the foldable substrate may be conducted to provide the central portion with a central tension that is higher than the central tension of the first portion and the central tension of the second portion. In such a manner, shattering of the central portion can result in more thorough shattering due to the high fracture energy and such cracking may be limited, for example, entirely limited to the central portion without propagating into the first and second portions due to the low central tension of these portions of the substrate. In some embodiments, chemically strengthening the substrate can be followed by etching the strengthened portion to remove less than 5-10 nanometers (nm) of a compressive stress layer generated by chemical strengthening, as discussed above.

In some embodiments, chemically strengthening the substrate can create a stored strain energy within at least a portion of the substrate. As used herein, stored strain energy refers to the product of a prefactor and an area integral of the square of tensile portions (e.g., central tension) of a stress profile between a midplane of the substrate and a surface of the substrate. The prefactor is the (1−v)/E, where v is Poisson's ratio of the substrate and E is the elastic modulus of the substrate. In some embodiments, the stored strain energy within at least a portion of the substrate can be about 10 Joules per meter squared (J/m²) or more, about 20 J/m² or more, about 25 J/m² or more, about 30 J/m² or more, about 100 J/m² or less, about 60 J/m² or less, about 40 J/m² or less. In some embodiments, the stored strain energy within at least a portion of the substrate can be in a range from about 10 J/m² to about 100 J/m², from about 10 J/m² to about 60 J/m², from about 20 J/m² to about 60 J/m², from about 25 J/m² to about 60 J/m², from about 25 J/m², to about 40 J/m², from about 30 J/m² to about 40 J/m², from about 25 J/m² to about 100 J/m², from about 30 J/m² to about 100 J/m², from about 30 J/m² to about 60 J/m², or any range or subrange therebetween. In further embodiments, the central portion can comprise the stored strain energy. In further embodiments, the first portion and/or the second portion can comprise the stored strain energy. In even further embodiments, at least a portion of the first portion, the second portion, and the central portion can comprise the stored strain energy. Providing a stored strain energy within one or more of the above-mentioned ranges can facilitate the formation of a shattered pane.

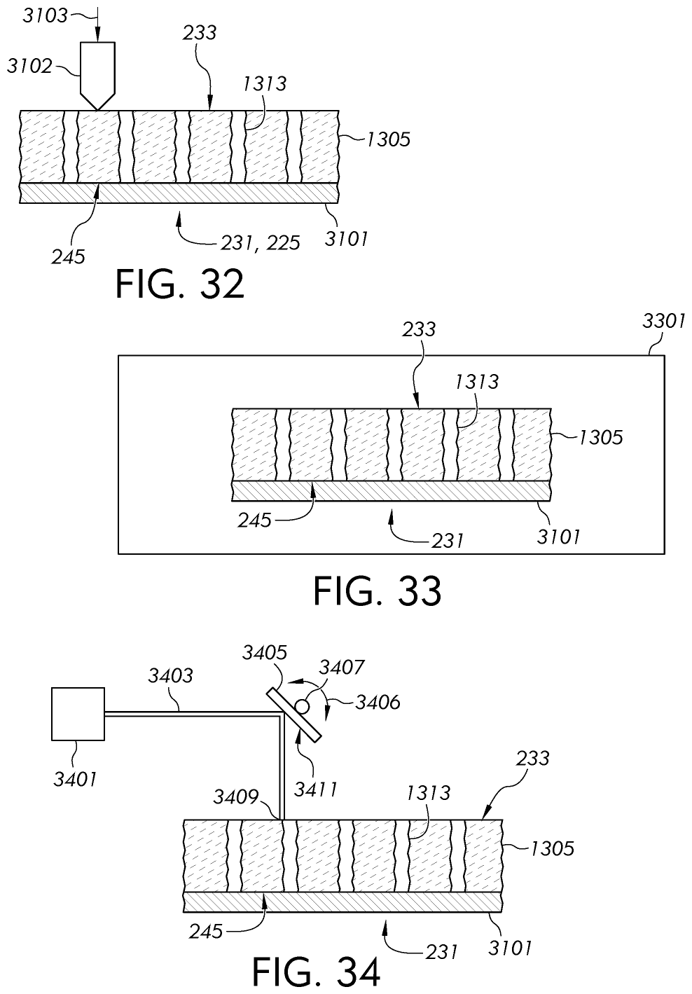

In some embodiments, as shown in FIGS. 31-32, after the step 2703 of chemically strengthening the foldable substrate 201, methods can proceed to the step 2705 of disposing a backer layer 3101 over at least the central portion 225 prior to shattering the central portion 225 into the shattered pane 231. As shown in FIG. 31, in some embodiments, the backer layer 3101 can be applied to the second major surface 205. In further embodiments, as shown in FIG. 32, the backer layer 3101 can be applied to the second central surface area 245 of the central portion 225. Providing the backer layer 3101 can help maintain the relative positions of the shattered pieces 1305 in a nested configuration as the shattered pane 231 without ejecting the shattered pieces or otherwise rearranging the shattered pieces 1305 after shattering the central portion 225. Furthermore, as shown, in some embodiments, the backer layer 3101 may extend over the entire second major surface 205 to help protect the second major surface 205 from damage while also helping maintain the relative positions of the shattered pieces 1305 as discussed above. In some embodiments, although not shown, the backer layer 3101 can be disposed over the first central surface area 233 of the central portion 225. In further embodiments, the backer layer 3101 can face (e.g., contact) the first central surface area 233 of the central portion 225.

The backer layer 3101 can comprise a flexible layer (e.g., a flexible film) and, in some embodiments, may be able to stretch to increase the length of the backer layer 3101. In some embodiments, the backer layer 3101 can comprise the second material 256, as discussed above. In some embodiments, the backer layer 3101 can comprise a removable layer that may be removed by a wide range of techniques, for example, peeling off the layer, heating the layer, exposing the layer to light or other techniques. In some embodiments, the backer layer 3101 can comprise a polymeric material although the backer layer 3101 may be formed from other materials in further embodiments. In further embodiments, a liquid or other material may be sprayed, printed or otherwise applied to the second major surface 205 and cured into the backer layer 3101. In even further embodiments, the backer layer 3101 may comprise applying a previously formed layer to the second major surface 205. In further embodiments, the previously formed layer can comprise a tape that is adhered to the second major surface 205 of the foldable substrate 201. In even further embodiments, the backer layer 3101 can comprise a polymeric pressure sensitive adhesive, for example, a block copolymer (e.g., a styrene-rubber block copolymer). In still further embodiments, the pressure sensitivity adhesive can comprise a high-temperature release film, meaning that the adhesion of the polymeric adhesive to the foldable substrate 201 decreases above a predetermined temperature (e.g., 100° C., 150° C., 200° C., 300° C., 400° C.), which can comprise, for example, polypropylene, PVF, ETFE, FEP, polyimide, and/or polymethylpentene. In still further embodiments, the pressure sensitivity adhesive can comprise a low-temperature release film, meaning that the adhesion of the polymeric adhesive to the foldable substrate 201 decreases below a predetermined temperature (e.g., 100° C., 50° C., 30° C.). Providing a pressure sensitive adhesive that comprises a temperature sensitive release film (e.g., high-temperature release film, low-temperature release film) can reduce processing costs and potential damage to the foldable substrate associated with removing the layer.

In some embodiments, as shown in FIGS. 31-32, after the step 2705 of applying the backer layer 3101, methods can proceed to the step 2707 of shattering the central portion 225. In some embodiments, energy (e.g., a force) may be applied to shatter the central portion 225 by crushing or otherwise applying energy to the central portion 225. For example, embodiments where the central portion 225 comprises a ceramic central portion 225, the central portion 225 may be bent or otherwise crushed to create the shattered pane 231. In further embodiments, if a glass-based and/or ceramic-based pane has sufficient central tension (e.g., stored strain energy from chemically strengthening the central portion 225 prior to shattering the central portion 225), a poking device 3102 (see FIGS. 31-32) can be forced in a direction 3103 to create a stress fracture at the point of the poking device 3102. In further embodiments, the poking device 3102 can comprise a scribe (e.g., tungsten carbide scribe comprising a tip diameter of about 200 μm) or scissors. In some embodiments, the central portion 225 may be shattered by striking the central portion 225 (e.g., pressing with the poking device 3102 until the poking device 3102 penetrates to the central tension region of the central portion). Due to the internal central tension and the poking device 3102 there can be caused a cascading cracking effect across the portion of the foldable substrate that is under significant tension (e.g., the central portion 225). As other portions of the foldable substrate may not have significant central tension (e.g., the first portion 221 and/or the second portion 223), the cascading crack effect may not propagate into those areas of the foldable substrate.

As shown in FIG. 12, a portion (e.g., the central portion 225) of the substrate can be shattered into the shattered pane 231 comprising the length 1301 extending in the direction 104 of the fold axis 102 and the width 1303 extending in the direction 106 perpendicular to the fold axis 102. As mentioned previously, the shattered pane 231 can include the plurality of shattered pieces 1305 where one or more of the pieces comprise the maximum dimension 1307 that is less than the length 1301 and less than the width 1303 of the shattered pane 231. Furthermore, in some embodiments, the step 1505 of applying the backer layer 3101 to the central portion 225 prior to shattering the central portion 225 into the shattered pane 231, wherein the backer layer 3101 can adhere to the surface portion of the shattered pane 231 of the second major surface 205 to hold the plurality of shattered pieces 1305 together to allow them to remain in an assembled orientation with the matching edges 1309a, 1309b of an adjacent pair of shattered pieces 1311a, 1311b of the shattered pieces 1305 abutting one another along a separation crack 1313 separating adjacent pair of shattered pieces 1311a, 1311b along the matching edges 1309a, 1309b that abut one another along the separation crack 1313 (e.g., the entire separation crack). Separation cracks (e.g., separation crack 1313) of the shattered pane 231 can extend through the central thickness 226, through the central major surface 235, and through the second central surface area 245 to separate adjacent pairs of pieces (e.g., the adjacent pair of shattered pieces 1311a, 1311b). As shown in FIG. 12, the shattered pieces 1305 (e.g., held together by the backer layer 3101) can form a tiling puzzle of a number of shattered pieces 1305 that are fitted together with little or no space in between the shattered pieces 1305 that are separate but abut one another along their abutting adjacent matching edges 1309a, 1309b along the separation cracks 1313.

In some embodiments, as shown in FIGS. 31-32, the shattering of step 2707 can comprise shattering the central portion 225 into a shattered pane 231 comprising a plurality of shattered pieces 1305. In further embodiments, although not shown, the shattering step 2707 can comprise shattering at least a portion of the first portion 221 and/or at least a portion of the second portion 223 as well as the central portion 225 to form a shattered pane 231 comprising a plurality of shattered pieces 1305. For example, as shown in FIG. 32, the shattering step 2707 can comprise shattering the entire substrate into a shattered pane 231 comprising a plurality of shattered pieces 1305. In further embodiments, although not shown, the shattering step 2707 can further comprise shattering the first portion 221 into a second shattered pane comprising a second plurality of shattered pieces. In further embodiments, although not shown, the shattering step 2707 can further comprise shattering the second portion 223 into a third shattered pane comprising a third plurality of shattered pieces. In some embodiments, the shattering step 2707 can comprise shattering the first portion 221 into a second shattered pane and shattering the second portion 223 into a third shattered pane. In some embodiments, the shattering step 2707 can comprise shattering the first portion 221 into a second shattered pane without shattering the second portion. In some embodiments, the shattering step 2707 can comprise shattering the second portion 223 into a second shattered pane without shattering the first portion. In some embodiments, as discussed above, a density of the plurality of shattered pieces can be about 5 pc/cm² or more (or one or more of the densities discussed above). In further embodiments, the density of the plurality of shattered pieces in the central portion can be about 5 pc/cm² or more (or one or more of the densities discussed above) measured over an area of the second central surface area in a range from about 1 cm² to about 5 cm².

In some embodiments, as shown in FIG. 33, after the step 2707 of shattering at least a portion of the foldable substrate, methods can proceed to step 2717 comprising heating the shattered pane 231 at a first temperature from about 300° C. to about 400° C. for a first period of time from about 15 minutes to about 168 hours. As used herein, heating a shattered pane “at a first temperature” means that the shattered pane is placed in an environment (e.g., an oven) maintained at the first temperature. In further embodiments, as shown in FIG. 33, the shattered pane 231 (e.g., the foldable substrate 201) can be placed in an oven 3301 for the first period of time with the oven maintained at the first temperature. In further embodiments, the environment that the shattered pane 231 is placed in to be heated can be heated by one or more electric heater (e.g., resistance heater, infrared lighting) and/or a burner. If provided, the burner can be configured to emit fuel that can be ignited to form a flame. In some embodiments, the fuel can be a gas, for example, methane. In some embodiments, the fuel can comprise solid particles. In some embodiments, the fuel can comprise a liquid. The fuel can comprise one or more components. Exemplary embodiments of fuel components comprise alkanes, alkenes, alkynes (e.g., acetylene, propyne), alcohols, hydrazine or a hydrazine-derivative, and oxidizers. Example embodiments of alkanes include methane, ethane, propane, butane, pentane, hexane, heptane, and octane. Exemplary embodiments of alkenes include ethylene, propylene, and butylene. Exemplary embodiments of alcohols include methanol, ethanol, propanol, butanol, hexanol, and octanol. Exemplary embodiments of oxidizers include oxygen, nitrogen oxides (e.g., NO₂, N₂O₄), peroxides (e.g., H₂O₂), perchlorates (e.g., ammonia perchlorate). Although not shown, the burner can be in fluid communication with a fuel source, for example, a cannister, a cartridge, and/or a pressure vessel. In some embodiments, the burner can comprise a nozzle comprising a polygonal (e.g., triangular, quadrilateral, pentagonal, hexagonal, etc.) cross-section, a rounded (e.g., elliptical, circular) cross-section, or a curvilinear cross-section. In further embodiments, the first temperature can be about 300° C. or more, about 320° C. or more, about 340° C. or more, about 400° C. or less, about 380° C. or less, or about 360° C. or less. In further embodiments, the first temperature can be in a range from about 300° C. to about 400° C., from about 300° C. to about 380° C., from about 320° C. to about 380° C., from about 320° C. to about 360° C., from about 340° C. to about 360° C., or any range or subrange therebetween. In further embodiments, the first period of time can be about 15 minutes or more, about 30 minutes or more, about 45 minutes or more, about 1 hour or more, about 1.5 hours or more, about 168 hours or less, about 24 hours or less, about 8 hours or less, about 4 hours or less, about 3 hours or less, or about 2 hours or less. In further embodiments, the first period of time can be in a range from about 15 minutes to about 168 hours, from about 15 minutes to about 24 hours, from about 30 minutes to about 24 hours, from about 30 minutes to about 8 hours, from about 45 minutes to about 8 hours, from about 45 minutes to about 4 hours, from about 1 hour to about 4 hours, from about 1 hour to about 3 hours, from about 1.5 hours to about 3 hours, from about 1.5 hours to about 2 hours, or any range or subrange therebetween.

In some embodiments, as shown in FIG. 34, after step 2707 of shattering at least a portion of the foldable substrate, methods can proceed to step 2719 comprising heating the shattered pane 231 to a second temperature of about 600° C. or more for a second period of time from about 0.5 seconds to about 20 minutes. As used herein, heating a portion of a shattered pane “to a second temperature” means that the portion obtains at least the second temperature for the specified period of time as a result of the heating (e.g., impingement by a laser beam). In further embodiments, as shown in FIG. 34, heating the portion of the shattered pane can comprise impinging a location 3409 on the surface (e.g., first central surface area 233) of the shattered pane 231 (e.g., the foldable substrate 201) with a laser beam 3403 emitted from a laser 3401. In even further embodiments, as shown, the laser beam 3403 can be scanned across the surface (e.g., first central surface area 233) using a reflecting surface 3411 that can be rotated in a direction 3406. In still further embodiments, as shown, the reflecting surface 3411 can comprise a mirror 3405 rotated by a galvanometer 3407 in the direction 3406. In still further embodiments, although not shown, the reflecting surface can be a polygonal mirror. In further embodiments, although not shown, a plurality of laser beams (e.g., stationary, non-scanning laser beams emitted from a plurality of lasers or produced using a beam splitter) can impinge a corresponding plurality of locations on the surface. In further embodiments, the laser beam can comprise a wavelength of about 1.5 micrometers (pm) or more, about 2.5 μm or more, about 3.5 μm or more, about 5 μm or more, about 9μm or more, about 9.4 μm or more, about 20 μm or less, about 15 μm or less, about 12 μm or less, about 11 μm or less, or about 10.6 nm or less. In further embodiments, the laser beam can comprise a wavelength in a range from about 1.5 μm to about 20 μm, from about 1.5 μm to about 15 μm, from about 1.5 μm to about 12 μm, from about 1.5 μm to about 11 μm, from about 2.5 μm to about 20 μm, from about 2.5 μm to about 15 μm, from about 2.5 nm to about 12 μm, from about 3.6 μm to about 20 p.m, from about 3.6 μm to about 15 μm, from about 3.6 μm to about 12 μm, from about 5 μm to about 20 μm, from about 5μm to about 15 μm, from about 5μm to about 12 p.m, from about 5μm to about 11 μm, from about 9μm to about 20 μm, from about 9 μm to about 15 μm, from about 9μm to about 12 μm, from about 9μm to about 11 μm, from about 9μm to about 1.6 μm, from about 9.4 μm to about 15 μm, from about 9.4 μm to about 12 μm, from about 9.4 μm to about 11 μm, from about 9.4 μm to about 10.6 μm, or any range or subrange therebetween. Exemplary embodiments of lasers capable of producing a laser beam with a wavelength within the aforementioned ranges include a carbon dioxide (CO₂) laser and a nitrous oxide (N₂O) laser. In further embodiments, the portion can be heated to the second temperature of about 600° C. or more, about 650° C. or more, about 700° C. or more, about 750° C. or more, about 800° C. or more, about 850° C. or more, about 1200° C. or less, about 1100° C. or less, about 1000° C. or less, about 900° C. or less. In further embodiments, the portion can be heated to the second temperature in a range from about 600° C. to about 1200° C., from about 650° C. to about 1200° C., from about 650° C. to about 1100° C., from about 700° C. to about 1100° C., from about 700° C. to about 1000° C., from about 750° C. to about 1000° C., from about 750° C. to about 900° C., from about 800° C. to about 900° C., from about 800° C. to about 850° C., or any range or subrange therebetween. In further embodiments, the second period of time can be about 0.5 seconds or more about 1 second or more, about 5 seconds or more, about 10 seconds or more, about 20 seconds or more, about 30 seconds or more, about 45 seconds or more, about 1 minute or more, about 20 minutes or less, about 15 minutes or less, about 10 minutes or less, about 8 minutes or less, about 6 minutes or less, about 4 minutes or less, or about 2 minutes. In further embodiments, the second period of time can be in a range from about 0.5 seconds to about 20 minutes, from about 0.5 seconds to about 15 minutes, from about 1 second to about 15 minutes, from about 1 second to about 10 minutes, from about 5 seconds to about 10 minutes, from about 5 seconds to about 8 minutes, from about 10 seconds to about 8 minutes, from about 10 seconds to about 6 minutes, from about 20 seconds to about 6 minutes, from about 20 seconds to about 4 minutes, from about 30 seconds to about 4 minutes, from about 45 seconds to about 4 minutes, from about 45 seconds to about 2 minutes, from about 1 minute to about 2 minutes, or any range or subrange therebetween. In further embodiments, substantially the entire surface of the shattered plane can be heated to the second temperature for the second period of time (e.g., the portion comprises a plurality of portions corresponding to substantially the entire surface).

Without wishing to be bound by theory, heating the shattered pane (e.g., a portion of the shattered pane) after it has been chemically strengthened and then shattered can redistribute an ion-concentration gradient introduced by the chemically strengthening and, thereby reduce the compressive stress in the shattered pane. Also, redistributing the ion-concentration gradient can change a refractive index of the shattered pane and, thereby reduce a difference in refractive index from a surface of the shattered pane (e.g., first major surface, first central surface area, second major surface) and a refractive index at the midpoint of the substrate thickness, which can reduce optical distortions. Additionally, redistributing the ion-concentration gradient can reduce the maximum compressive stress of the corresponding compressive stress region at the heated surface. Without wishing to be bound by theory, heating the shattered pane (e.g., a portion of the shattered pane) after it has been chemically strengthened and then shattered can increase a depth of layer of the one or more alkali metal ions associated with the corresponding compressive stress region at the heated surface, for example, by increasing diffusion of the ions. Without wishing to be bound by theory, the period of time that the shattered pane is heated can be decreased as the temperature that the shattered pane is heated to and/or heated at is increased, for example, following an Arrhenius relationship to obtain a predetermined change in refractive index, maximum compressive stress, and/or depth of layer. Also, heating the shattered pane may reduce the compressive stress by causing stress relaxation in the composition matrix of the material of the shattered pieces.

In some embodiments, the heating of step 2717 or step 2719 can increase an existing depth of layer, increase an existing depth of compression, and/or reduce an existing maximum compressive stress. As used here, “existing” refers to prior to step 2717 or step 2719. An existing compressive stress region comprising an existing depth of compression and existing maximum compressive stress as well as an associated existing depth of layer can be provided, as a result of step 2703 comprising chemically strengthening the foldable substrate 201 or providing a foldable substrate 201 in step 2701 that has been chemically strengthened. In some embodiments, step 2717 or step 2719 can produce a first central depth of layer as a percent of the thickness (e.g., central thickness 226) of the shattered pane 231 that can be greater than an existing first central depth of layer as a percent of the thickness (e.g., central thickness 226) of the shattered pane 231 by about 1% or more, by about 2% or more, by about 5% or more, by about 8% or more, by about 10% or more, by about 12% or more, by about 30% or less, by about 25% or less, by about 20% or less, by about 18% or less, or about 15% or less. In some embodiments, step 2717 or step 2719 can produce a first central depth of layer as a percent of the thickness (e.g., central thickness 226) of the shattered pane 231 that can be greater than an existing first central depth of layer as a percent of the thickness (e.g., central thickness 226) of the shattered pane 231 in a range from about 1% to about 30%, from about 1% to about 25%, from about 2% to about 25%, from about 2% to about 20%, from about 5% to about 20%, from about 5% to about 18%, from about 8% to about 18%, from about 8% to about 15%, from about 10% to about 15%, from about 12% to about 15%, or any range or subrange therebetween. In some embodiments, step 2717 or step 2719 can produce a first maximum compressive stress of the first compressive stress region as a percentage of an existing first maximum compressive stress of the existing first compressive stress region of about 10% or more, about 20% or more, about 30% or more, about 40% or more, about 45% or more, about 90% or less, about 80% or less, about 70% or less, about 60% or less, about 55% or less, or about 50% or less. In some embodiments, step 2717 or step 2719 can produce a first maximum compressive stress of the first compressive stress region as a percentage of an existing first maximum compressive stress of the existing first compressive stress region in a range from about 10% to about 90%, from about 20% to about 90%, from about 20% to about 80%, from about 30% to about 80%, from about 30% to about 70%, from about 40% to about 70%, from about 40% to about 60%, from about 45% to about 60%, from about 45% to about 55%, from about 45% to about 50%, or any range subrange therebetween. In some embodiments, step 2717 or step 2719 can produce a first central depth of compression of the first compressive stress region that can be greater than an existing first central depth of compression of an existing first compressive stress region.

In some embodiments, the heating of step 2717 or step 2719 can decrease an existing surface refractive index. In further embodiments, the heating step 2717 or step 2719 can decrease an existing first surface refractive index to a first surface refractive index by about 0.001 or more, about 0.002 or more, about 0.003 or more, about 0.004 or more, about 0.02 or less, about 0.015 or less, about 0.01 or less, about 0.008 or less, about 0.006 or less, or about 0.005 or less. In further embodiments, the heating step 2717 or step 2719 can decrease an existing first surface refractive index to a first surface refractive index in a range from about 0.001 to about 0.02, from about 0.001 to about 0.015, from about 0.002 to about 0.015, from about 0.002 to about 0.01, from about 0.003 to about 0.01, from about 0.003 to about 0.008, from about 0.004 to about 0.008, from about 0.004 to about 0.006, from about 0.004 to about 0.005, or any range or subrange therebetween. In further embodiments, an absolute difference between the first surface refractive index and the central refractive index can be greater than an absolute difference between the existing first surface refractive index and the existing central refractive index can be within one or more of the ranges discussed above in this paragraph for the decreased in the existing first surface refractive index. In some embodiments, the heating step 2717 or step 2719 can decreases an existing second surface refractive index to a second surface refractive index within one or more of the ranges discussed above in this paragraph for the decreased in the existing first surface refractive index. In further embodiments, an absolute difference between the second surface refractive index and the central refractive index can be greater than an absolute difference between the existing second surface refractive index and the existing central refractive index can be within one or more of the ranges discussed above in this paragraph for the decreased in the existing first surface refractive index.

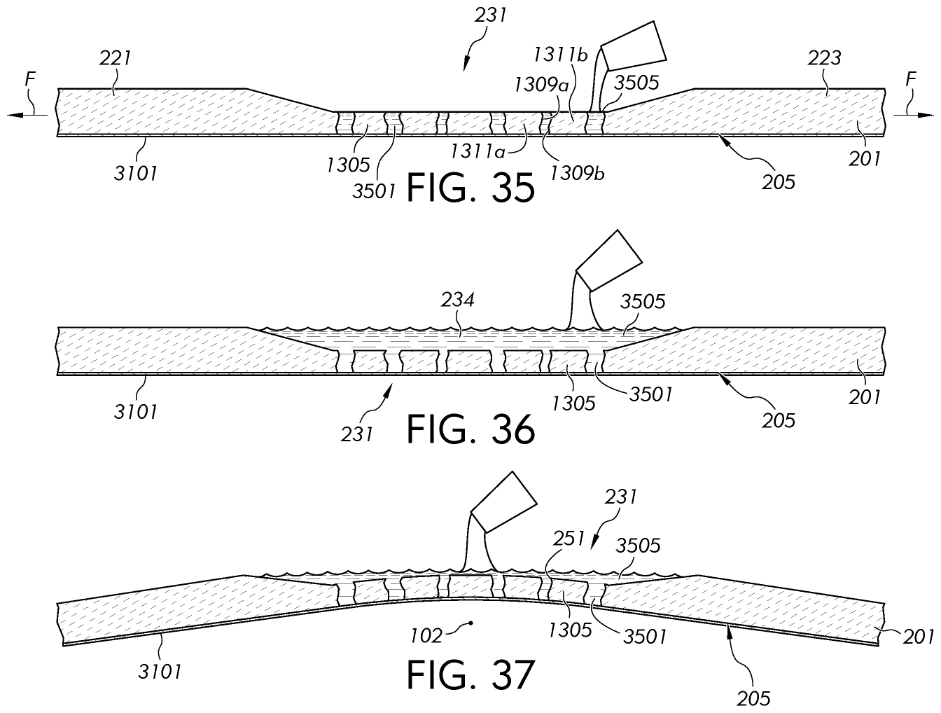

In some embodiments, as shown in FIGS. 35-37, after any of steps 2707, 2717, or 2719, methods can proceed to the step 2709 of flowing a first liquid 3505 into a space 3501 between one or more pairs of the shattered pieces 1311a, 1311b of the plurality of shattered pieces 1305. It is to be understood that the following discussion applies to a second shattered pane and/or a third shattered pane, if present, although the foregoing discussion is with regards to the shattered pane 231. In some embodiments, as shown in FIG. 35, the space 3501 may be created by stretching the backer layer 3101 to present spaces 3501 on opposite sides of the pairs of the shattered pieces 1311a, 1311b. In further embodiments, as shown in FIG. 35, a force “F” may be applied to the first portion 221 and the second portion 223 (e.g., with an actuator) to stretch the backer layer 3101 to form the spaces 3501. In even further embodiments, as shown in FIG. 36, the first liquid 3505 can flow into the space 3501 between pairs of shattered pieces 1311a, 1311b created at least in part by applying the force “F”. In further embodiments, as shown in FIG. 37, a bending moment can bend the substrate into a bent configuration, and the first liquid 3505 can flow into the space between pairs of shattered pieces 1311a, 1311b created at least in part by applying the bending moment to bend the shattered pane 231. As shown, methods can include bending the shattered pane 231 about the fold axis 102 to present the illustrated bent shattered pane. Methods can then include flowing the first liquid 3505 into the spaces 3501 while the shattered pane 231 is presented as the bent shattered pane. Methods can then comprise curing the first liquid 3505 to form the first material 254 connecting pairs of shattered pieces 1311a, 1311b together while the shattered pane 231 is presented as the bent shattered pane. In some embodiments, after curing the first liquid 3505 to form the first material 254, the foldable substrate 201 may then be flattened. In further embodiments, a force “F” is not applied to the first and second portion 221, 223 (e.g., with an actuator), but the weight of the material flowing into the recess 234 can force the shattered pieces 1305 apart to generate the spaces 3501 that are filled with the first material 254 creating the spaces. In such a method, the backer layer 3101 may stretch but as a result of the step 2709 of flowing the first material 254 into the separation cracks 1313 that pries the shattered pieces 1305 apart to create the space 3501 as the first material 254 fills the space 3501. Without wishing to be bound by theory, the first material 254 may flow into the space between pairs of shattered pieces 1311a, 1311b due to capillary action and gravity; in some embodiments a suction force, or other pressure differential force, may be used to assist the flow. Filling and curing to form the first material 254 in the spaces 3501 while the shattered pane 231 is bent can help reduce stress at the interface connection between the first material 254 and the shattered pieces 1305 during bending. For example, the first material 254 at the outer edges 251 of the shattered pieces 1305 in the bent orientation (see FIGS. 13-14) can be in tension that may cause an undesired magnitude of stress at the outer edges 251 that may cause delamination of the first material 254 from the shattered pieces 1305 originating at the outer edges 251. By curing the first material 254 while the shattered pane 231 is bent (see FIG. 37), tension (in the first material after curing and upon placing the shattered pane in a flat configuration or a configuration where it is bent to the same degree as when filling the spaces) is reduced since the shattered pane 231 is already partially bent with reduced or no stress in the first material 254 at the outer edges 251. Thus, deformation of the first material 254 is reduced to achieve the orientation shown in FIGS. 13-14 that reduces the stress on the first material 254 at the outer edges 251.

As further shown in FIGS. 36-37, flowing the first liquid 3505 into the spaces 3501 between the pairs of shattered pieces 1311a, 1311b of the plurality of shattered pieces 1305 can include first flowing the first liquid 3505 into the recess 234 that funnels the first material 254 into the spaces 3501. In further examples, as shown in FIG. 36, the first liquid 3505 can further fill the recess 234.

In some embodiments, the first liquid 3505 can comprise any of the materials or precursors of the first material 254 and can optionally comprise a solvent. Precursors can comprise, without limitation, one or more of a monomer, an accelerator, a curing agent, an epoxy, and/or inorganic particles. Example embodiments of solvents include polar solvents (e.g., water, an alcohol, an acetate, acetone, formic acid, dimethylformamide, acetonitrile, dimethyl sulfoxone, nitromethane, propylene carbonate, polyether ether ketone) and non-polar solvents (e.g., pentane, 1,4-dioxane, chloroform, dichloromethane, diethyl ether, hexane, heptane, benzene, toluene, xylene). In some embodiments, the first liquid 3505 can be substantially solvent free. In some embodiments, the first liquid 3505 can comprise the composition that can be cured to form the adhesive described above. In some embodiments, the first liquid 3505 can comprise a viscosity. As used herein, a viscosity of a liquid is measured at 23° C. using a rotational rheometer (e.g., RheolabQC from Anton Par or a Discovery Hybrid Rheometer (DHR-3) from TA Instruments) at a shear rates of about 0.01 1/second (s). In further embodiments, the first liquid 3505 can comprise a viscosity of about 10 milliPascal-seconds (mPa-s) or more, about 50 mPa-s or more, about 100 mPa-s or more, about 300 mPa-s or more, about 500 mPa-s or more, about 1,000 mPa-s or more, about 3,000 mPa-s or more, about 10,000 mPa-s or less, about 7,000 mPa-s or less, about 6,000 mPa-s or less, about 5,000 mPa-s or less, about 2,000 mPa-s or less, or about 1,000 mPa-s or less. In some embodiments, the first liquid 3505 can comprise a viscosity in a range from about 10 mPa-s to about 10,000 mPa-s, from about 10 mPa-s, to about 7,000 mPa-s, from about 10 mPa-s to about 6,000 mPa-s, from about 50 mPa-s to about 6,000 mPa-s, from about 100 mPa-s to about 6,000 mPa-s, from about 100 mPa-s to about 5,000 mPa-s, from about 300 mPa-s to about 5,000 mPa-s, from about 500 mPa-s to about 5,000 mPa-s, from about 1,000 mPa-s to about 5,000 mPa-s, from about 3,000 mPa-s to about 5,000 mPa-s, from about 100 mPa-s to about 3,000 mPa-s, from about 5,000 mPa-s to about 7,000 mPa-s, or any range or subrange therebetween. In some embodiments, the first material 254 can comprise the adhesive and/or the polymer-based portion discussed above, and the first liquid 3505 can comprise precursors of (e.g., the compositions described above to form) the corresponding material. In some embodiments, the first liquid 3505 can be substantially solvent free.

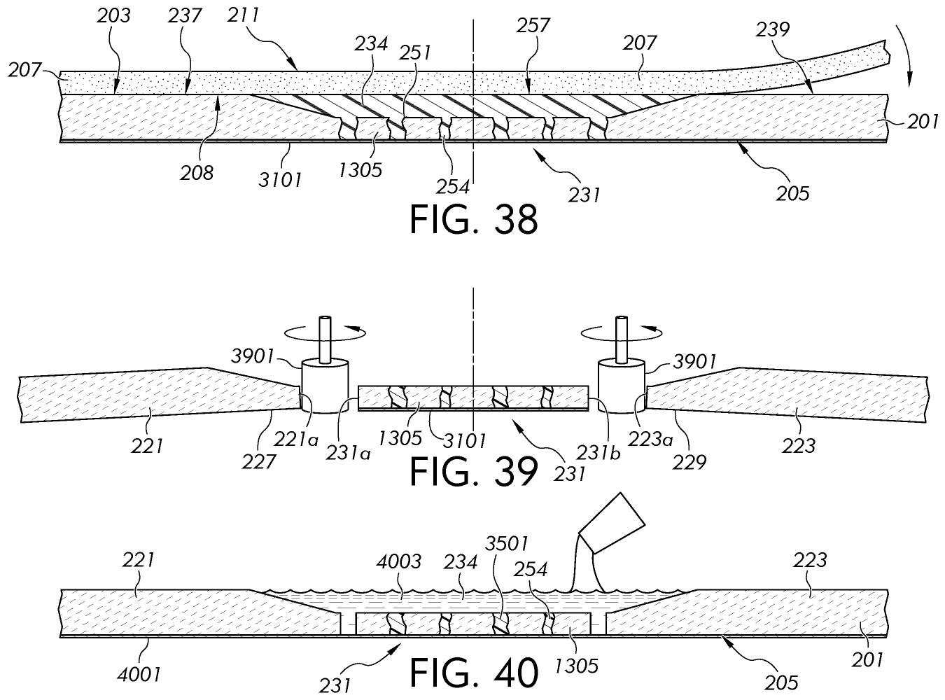

In some embodiments, step 2709 can further comprise curing the first liquid 3505 to form the first material 254. In further embodiments, as shown in FIGS. 38 and 40, the first liquid 3505 may be cured to form the first material 254 connecting the pairs of shattered pieces 1311a, 1311b together. In some embodiments, curing the first liquid 3505 to form the first material 254 can comprise heating, ultraviolet (UV) irradiation, and/or waiting for a predetermined period of time. In some embodiments, curing the first liquid 3505 to form a first material 254 can result in a volume change of the first material 254 relative the first liquid 3505. In further embodiments, a magnitude of a difference of the volume the first material 254 relative to the volume of the first liquid 3505 as a percentage of the volume of the first liquid 3505 can be about 5% or less, about 2% or less, about 1% or less, about 0.5% or less, about 0.1% or less, about 0.01% or more, about 0.1% or more, about 0.5% or more, about 1% or more. In further embodiments, a magnitude of a difference of the volume the first material 254 relative to the volume of the first liquid 3505 as a percentage of the volume of the first liquid 3505 can be in a range from 0% to about 5%, from 0% to about 2%, from 0% to about 1%, from 0.01% to about 1%, from about 0.1% to about 1%, from about 0.5% to about 1%, from about 0.01% to about 5%, from about 0.01% to about 2%, from about 0.1% to about 2%, from about 0.5% to about 2%, or any range or subrange therebetween.

The first material 254 can comprise an elastic modulus within one or more of the ranges discussed above for the elastic modulus of the first material 254 (e.g., in a range from about 10 kPa to about 18 GPa). In some embodiments, as discussed above, the elastic modulus of the first material 254 can be less than the elastic modulus of a shattered piece of the plurality of shattered pieces 1305. In some embodiments, the elastic modulus of the first material 254 can change as the temperature of the first material 254 goes from about 100° C. to about −20° C. by a multiple within one or more of the ranges discussed above (e.g., about 100 or less). In some embodiments, the first material 254 can comprise one or more of the materials discussed above for the first material 254. In further embodiments, the first material 254 can comprise one or more of a silicone-based polymer, an acrylate-based polymer, an epoxy-based polymer, a thiol-containing polymer, and/or a polyurethane. In further embodiments, the first material 254 can comprise a silicone elastomer. In some embodiments, the first material 254 can comprise a glass transition temperature within at least one of the ranges discussed above for the glass transition temperature of the first material 254 (e.g., about 0° C. or less, about −20° C. or less, about 60° C. or more). In some embodiments, the first material 254 can comprise a glassy plateau, and an elastic modulus of the first material 254 in the glassy plateau can be within one or more of the ranges discussed above for the first material 254 (e.g., in a range from about 100 kPa to about 18 GPa). In some embodiments, a total mass of the first material 254 as a percentage of the total mass of the plurality of shattered pieces can be within one or more of the ranges discussed above (e.g., about 10% or less).

After step 2709, as shown in FIG. 38, methods of the disclosure can proceed to step 2711, which comprises disposing an adhesive layer over the first major surface 203. In some embodiments, as shown, the step 2711 can comprise applying an adhesive layer 207 to contact the first surface area 237 of the first major surface 203 and the third surface area 239 of the first major surface 203. The first contact surface 208 of the adhesive layer 207 can contact the first surface area 237 of the first major surface 203 and the third surface area 239 of the first major surface 203. In further embodiments, as shown, the step 2711 can comprise contacting the second contact surface 257 of the first material 254 with the first contact surface 208 of the adhesive layer 207. In further embodiments, although not shown, the step 2711 can comprise contacting the second material 256 with the adhesive layer 207. In even further embodiments, the second material 256 can fill the recess 234. In some embodiments, methods may comprise step 2727 of applying the adhesive layer 207 without removing the backer layer 3101. For example, in some embodiments, the backer layer 3101 may still be applied to the foldable substrate 201 at the end at 2715 to allow the backer layer 3101 to also act as a protective layer that can protect the second major surface 205 until a later time (e.g., after the foldable substrate 201 is applied to the display device 303). In further embodiments, the backer layer 3101 can comprise the second material 256.

In some embodiments, after step 2711 methods can proceed to step 2743 comprising assembling the foldable apparatus by deposing one or more items over the adhesive layer. In further embodiments, a release liner (e.g., see release liner 213 in FIG. 2) may be disposed on the second contact surface 211 of the adhesive layer 207. In even further embodiments, when ready to apply the foldable substrate 201 to the display device 303, the release liner 213 may be removed and then the display device 303 can be disposed over the second contact surface 211 of the adhesive layer 207. In further embodiments the display device 303 can be disposed over the second contact surface 211 of the adhesive layer 207 without involving a release liner 213. As shown, in FIG. 27, methods can end at 2715, for example, after step 2743.

Further embodiments of the disclosure will now be discussed with reference to the flow chart of FIG. 27 and FIGS. 32-35 and 39-40. In some embodiments, the portion of the central portion 225 providing the shattered pane 231 may be provided separate from the first portion 221 and the second portion 223. As shown in FIG. 32, methods can comprise step 2707 comprising shattering the central portion 225 into the shattered pane 231 comprising the plurality of shattered pieces 1305 as discussed in methods of FIG. 27 above. In some embodiments, as shown in FIG. 33, after step 2707, methods can then proceed to heating the shattered pane 231 at a first temperature for a first period of time in step 2717, as described above. In some embodiments, as shown in FIG. 34, after step 2707, methods can then proceed to heating at least a portion of the shattered pane to a second temperature for a second period of time in step 2719, as described above. In some embodiments, methods can then proceed to the step 2709 comprising of flowing the first liquid 3505 into the spaces 3501 as discussed with respect FIG. 35 above. After curing the first liquid 3505 to form the first material 254 connecting the pair of shattered pieces together, as shown in FIG. 39, methods can then proceed to step 2721 of roughening the edges of the first and second transition portions 227, 229 (or edges of the first and second portions 221, 223) and/or the edges of the shattered pane 231. For example, as shown in FIG. 39, a grinding wheel 3901 can be used to grind, and therefore roughen, the edge 221a of the first transition portion 227 and/or the facing edge 231a of the shattered pane 231. The grinding wheel 3901 can further be used to grind, and therefore roughen, the edge 223a of the second transition portion 229 and/or the facing edge 231b of the shattered pane 231. Roughening one or more of the edges can increase the strength of a bonding between the first and second transition portions 227, 229 (or first and second portions 221, 223) and the shattered pane 231 by cured material, for example, first material 254 and/or second material 256 therebetween.

After step 2721, methods can proceed to step 2723 comprising removing the backer layer 3101. In some embodiments, as shown in FIG. 40, a new backer layer 4001 can be attached to the first portion 221, the second portion 223, and the shattered pane 231. Alternatively, in some embodiments, as illustrated by arrow 2720, methods may optionally skip the step 2721 of roughening the edges and proceed directly from step 2709 to step 2723 of removing the backer layer 3101, which can further comprise applying a new backer layer 4001. Providing a new backer layer 4001 can help space and align the shattered pane 231, first portion 221 and second portion 223 with one another as shown in FIG. 40. Once the new backer layer 4001 is applied, as shown in FIG. 40, methods can then proceed from the step 2723 to the step 2725 of forming the foldable substrate 201 by attaching the first portion 221 to the shattered pane 231 and attaching the second portion 223 to the shattered pane 231 such that the shattered pane 231 is positioned between the first portion 221 and the second portion 223 with the recess 234 defined by the central portion. As shown, the attaching of step 2725 can comprise deposing a second liquid 4003 over at least a corresponding portion of the central portion (e.g., shattered pane 231) of the foldable substrate 201. In some embodiments, the second liquid 4003 can be disposed between the first transition portion 227 (or first portion 221) and the second transition portion 229 (or second portion 223). The second liquid 4003 can be cured to form the second material 256. As discussed above with regards to the first liquid 3505, the second liquid 4003 comprise any of the materials or precursors of the second material 256 and can optionally comprise a solvent. In some embodiments, the second liquid 4003 can be substantially solvent free. In some embodiments, the second liquid 4003 can comprise the composition that can be cured to form the adhesive as described above. In some embodiments, the second liquid 4003 can comprise the composition that can be cured to form the polymer-based portion as described above.

Curing the second liquid 4003 to form the second material 256 can integrate and permanently attach the shattered pane 231 with respect to the first and second portions 221, 223 (e.g., by contacting the first and second transition portions 227, 229 or the first and second portions 221, 223). In some embodiments, as discussed above, the first material 254 and the second material 256 may comprise the same material although different materials may be provided in further embodiments.

The second material 256 can comprise an elastic modulus within one or more of the ranges discussed above for the elastic modulus of the second material 256 (e.g., in a range from about 100 kPa to about 5 GPa). In some embodiments, the storage modulus (i.e., modulus of elasticity) of the second material 256 can change as the temperature of the second material 256 goes from about 100° C. to about −20° C. by a multiple within one or more of the ranges discussed above (e.g., about 100 or less). In some embodiments, the second material 256 can comprise one or more of the materials discussed above for the first material 254 and/or the second material 256. In further embodiments, the second material 256 can comprise one or more of a silicone-based polymer, an acrylate-based polymer, an epoxy-based polymer, a polyimide-based material, and/or a polyurethane. In further embodiments, the second material 256 can comprise an ethylene acid copolymer. In some embodiments, the second material 256 can comprise a glass transition temperature within at least one of the ranges discussed above for the glass transition temperature of the second material 256 (e.g., about 0° C. or less, about −20° C. or less, about 60° C. or more). In some embodiments, the second material 256 can comprise a glassy plateau, and a storage modulus of the second material 256 in the glassy plateau can be within one or more of the ranges discussed above for the second material 256 (e.g., in a range from about 100 kPa to about 10 GPa). In some embodiments, a strain at yield of the second material 256 as a can be within one or more of the ranges discussed above (e.g., about 100% or more).

Further embodiments of the disclosure will now be discussed with reference to the flow chart of FIG. 27 and FIGS. 41-42. In some embodiments, as shown in FIG. 41, step 2711 of applying an adhesive can comprise deposing a first adhesive portion 703a over the first surface area 237 and deposing a second adhesive portion 703b over a third surface area 239. After step 2711, as shown in FIG. 41, method of the disclosure can proceed to step 2727 comprising deposing a first substrate 721 over the first portion 221 and disposing a second substrate 731 over the second portion 223. In some embodiments, the seventh surface area 723 of the first substrate 721 can be attached to the first surface area 237 of the first portion 221 by the first adhesive portion 703a. In some embodiments, the ninth surface area 733 of the second substrate 731 can be attached to the third surface area 239 by the second adhesive portion 703b. In some embodiments, as shown, the first substrate 721 can be spaced apart from the second substrate 731 such that a minimum distance 753 between the outer peripheral portion 745 of the first substrate 721 and the outer peripheral portion 749 of the second substrate 731 is within one or more of the ranges discussed above for the minimum distance 753. As discussed above, in some embodiments, the first substrate 721 can comprise a glass-based substrate. In further embodiments, the second substrate 731 can comprise a glass-based substrate. In further embodiments, the second substrate 731 can comprise a ceramic-based substrate. In some embodiments, the first substrate 721 can comprise a ceramic-based substrate. In some embodiments, the first substrate 721 and/or the second substrate 731 can be chemically strengthened, as discussed above.

After step 2727, as shown in FIG. 42, methods can proceed to step 2729 comprising filling a region 4101 defined between a first edge surface 729 of the first substrate 721 and the second edge surface 739 of the second substrate 731 with a second material 256. In some embodiments, as shown, filling the region 4101 with the second material 256 comprises filling the region 4101 with the second liquid 4003 and then curing the second liquid 4003 to form the second material 256. In some embodiments, step 2729 can further comprise depositing an adhesive layer 207 over the first substrate 721, the second substrate 731, and the second material 256. In some embodiments, methods can end 2715 after step 2729. In some embodiments, methods can then proceed to step 2743 comprising attaching a release liner 213 and/or a display device 303 to the adhesive layer 207. In other embodiments, step 2729 can further comprise depositing an adhesive layer 207 over the first portion 221, the second portion 223, and the shattered pane 231. In some embodiments, methods can end 2715 after step 2729. In some embodiments, methods can then proceed to step 2743 comprising attaching a release liner 213 and/or a display device 303 to the adhesive layer 207.

In some embodiments, as discussed above with reference to the flow chart in FIG. 27, methods can start at step 2701 and then proceed sequentially through steps 2703, 2705, 2707, 2717, 2709, 2711, and 2743. In some embodiments, the step 2703 of chemically strengthening the substrate can be omitted, for example, if the substrate is already chemically strengthened, by following arrow 2702. In some embodiments, arrow 2716 can be followed to omit steps 2703 and 2705, for example, if methods start with a substrate already comprising a shattered pane (e.g., shattered pane 231). In some embodiments, arrow 2704 can be followed to omit steps 2703, 2705, 2707, 2709, 2717, and 2719, for example, if methods start with a substrate already comprising a shattered pane (e.g., shattered pane 231) with the first material 254 attaching a pair of the plurality of shattered pieces of the shattered pane together. In some embodiments, step 2743 can be omitted by following arrow 2718 from step 2711 to step 2715. In some embodiments, arrow 2706 can be followed omitting step 2717 and/or step 2719. In some embodiments, arrow 2708 can be followed to substitute step 2719 comprising heating a portion of the shattered pane to a second temperature for step 2717 comprising heating the shattered pane at a first temperature. In some embodiments, arrow 2710 can be followed adding steps 2721, 2723, and 2725 between steps 2709 and 2711, for example, if a shattered pane is to be incorporated into a larger foldable apparatus. In some embodiments, arrows 2720 and 2726 can be followed to add step 2723 comprising removing the backer layer 3101 and applying a new backer layer 4001. In some embodiments, arrow 2712 can be followed to add steps 2727 and 2729 to (e.g., to resemble FIGS. 7-8). In some embodiments, arrow 2714 can be followed from step 2723 to step 2729. In some embodiments, arrow 2718 can be followed from step 2729 to step 2715. Any of the above options may be combined to make a foldable apparatus in accordance with embodiments of the disclosure.

In some embodiments, the foldable apparatus after step 2743 can comprise a neutral stress configuration when the foldable apparatus is in a bent configuration. In further embodiments, the foldable apparatus can comprise a maximum magnitude of the deviatoric strain of the polymer-based portion in one or more of the ranges discussed above (e.g., in a range from about 1% to about 8%, from about 2% to about 6%) in the neutral stress configuration. In further embodiments, the foldable apparatus can comprise an angle within one or more of the ranges discussed above in the neutral stress configuration. In some embodiments, the neutral stress configuration can correspond to a bent configuration as a result of curing the liquid (e.g., first liquid 3505, second liquid 4003) to form the second material 256 (or the first material 254) while the foldable substrate 201 was in a bent configuration. In some embodiments, the neutral stress configuration can correspond to a bent configuration as a result of an increase in volume in curing the liquid (e.g., first liquid 3505, second liquid 4003) to form the second material 256 (or the first material 254). In some embodiments, the neutral stress configuration can correspond to a bent configuration as a result of the second material 256 (or first material 254) comprising a negative coefficient of thermal expansion.

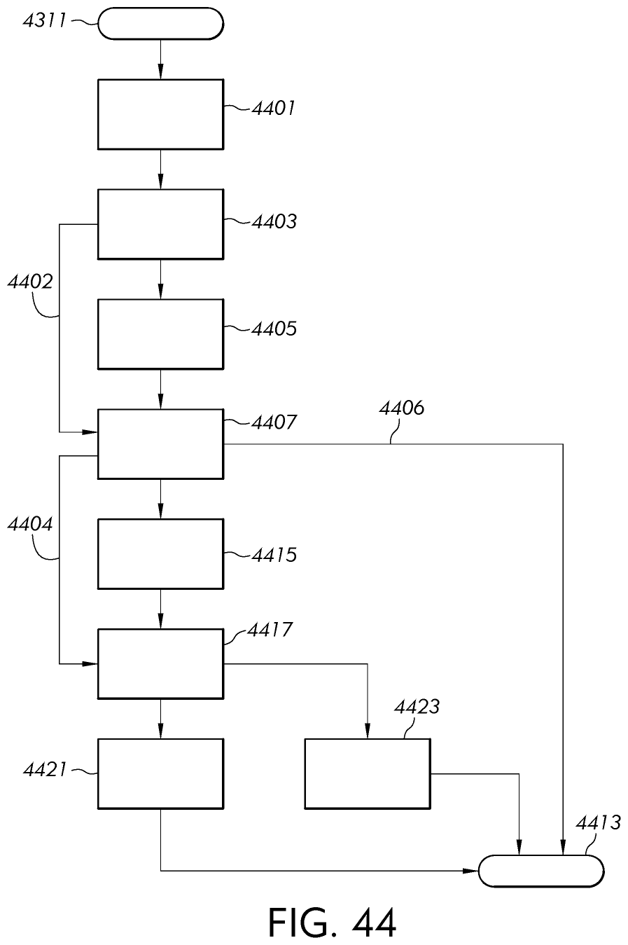

Embodiments of methods of making the foldable apparatus 901 and 1001 in accordance with embodiments of the disclosure will be discussed with reference to the flow chart in FIGS. 43-44 and example method steps illustrated in FIGS. 28-30 and 45-58.

Example embodiments of making the foldable apparatus 901 and 1001 can include providing the foldable substrate 201 as indicated at 4311 in FIG. 43. In some embodiments, as schematically illustrated by the arrow 4300 in FIG. 43, providing the foldable substrate 201 can comprise retrieving a previously fabricated foldable substrate 201, purchasing a foldable substrate 201, and/or otherwise obtaining a foldable substrate 201. In alternative embodiments, as shown by the steps of FIG. 43, the method of making the foldable apparatus 901 and 1001 can include providing the foldable substrate 201 by making a foldable substrate 201. Example methods of making the foldable substrate 201 illustrated in the flow chart in FIG. 43 with reference to FIGS. 28-30.

Referring to the flow chart in FIG. 43, a first step 4301 of methods of the disclosure, as shown in FIG. 28, can start with providing the foldable substrate 2801. In some embodiments, the foldable substrate 2801 may be provided by purchasing a foldable substrate or by forming the foldable substrate. In some embodiments, foldable substrates can be provided by forming them with a variety of ribbon forming processes, for example, slot draw, down-draw, fusion down-draw, up-draw, press roll, redraw or float. The foldable substrate 2801 may comprise a first major surface 2803 that can extend along a first plane 2804. The first major surface 2803 can be opposite a second major surface 2805.

After step 4301, as shown in FIG. 43, the method can optionally proceed to step 4303 comprising forming a recess 2809 in the first major surface 2803 of the foldable substrate 2801. As shown in FIG. 28, the recess 2809 may be formed by etching, laser ablation or mechanically working the first major surface 2803. For example, the first major surface 2803 may be mechanically worked by diamond engraving to produce very precise patterns in foldable substrates. As shown in FIG. 28, diamond engraving can be used to create the recess 2809 in the first major surface 2803 of the foldable substrate 2801 where a diamond-tip probe 2825 can be controlled using a computer numerical control (CNC) machine 2827. Materials other than diamond can be used for engraving with a CNC machine. Furthermore, other methods of forming the recess include lithography, etching, and laser ablation. Forming the recess 2809 in the first major surface 2803 can provide a central portion 225 between a first portion 2821 and a second portion 2823 of the foldable substrate 2801. The central portion 225 can comprise a first central surface area 2807 wherein the recess 2809 can be defined between the first central surface area 2807 and the first plane 2804 along which the first major surface 2803 extends. The central portion 225 can also comprise a first transition portion 227 attaching the first portion 2821 to the central portion 225 (e.g., central major surface 2811) and a second transition portion 229 attaching the second portion 2823 to the central portion 225 (e.g., central major surface 2811). In some embodiments, a thickness of the first transition portion 227 can continuously increase from the central portion 225 (e.g., central major surface 2811) to the first portion 2821. In further embodiments, a thickness of the second transition portion 229 can continuously increase from the central portion 225 (e.g., central major surface 2811) to the second portion 2823. As shown in FIG. 28, in some embodiments, the first central surface area 2807 can comprise a central major surface 2811 of the central portion 225 that, as shown, may be planar although nonplanar configurations may be provided in further embodiments. Furthermore, the central major surface 2811 can be planar with respect to the first plane 2804 and/or the second major surface 2805 as shown in FIG. 28.

After step 4303, as further shown in FIG. 43, the method can optionally proceed to step 4305 comprising reducing a thickness of the foldable substrate 2801 as shown in FIG. 29. In some embodiments, although not shown, the thickness of the foldable substrate 2801 can be reduced by mechanically working (e.g., grinding). In further embodiments, as shown in FIG. 29, the thickness of the foldable substrate 2801 can be reduced using chemical etching. In some embodiments, as shown, chemical etching can comprise contacting the foldable substrate 2801 with an etching solution 2903 contained in an etching bath 2901 to produce the foldable substrate 201 shown in FIG. 29. In further embodiments, the etching solution 2903 can comprise one or more mineral acids (e.g., HCl, HF, H₂SO₄, HNO₃).

In some embodiments, the thickness of the foldable substrate 2801 can be reduced by removing a layer from the first major surface 2803 of the foldable substrate 2801 to expose a new first major surface that can comprise the first major surface 203. In addition, or alternatively, the thickness of the foldable substrate 2801 can be reduced by removing a layer from the second major surface 2805 of the foldable substrate 2801 to expose a new second major surface that can comprise the second major surface 205.

In some embodiments, removing the layer from the first major surface 2803 can be beneficial to remove surface imperfections generated during formation of the recess 2809. For example, mechanically working the first major surface 2803 (e.g., with a diamond tip probe) to generate the recess 2809 may generate cracks or other imperfections that can present points of weakness where catastrophic failure of the foldable substrate 2801 may occur upon bending. Thus, by removing the layer from the first major surface 2803, surface imperfections generated in the layer during formation of the recess 2809 may be removed where a new first major surface 203 with less surface imperfections can be presented. As fewer surface imperfections are present, a smaller bend radius may be achieved without failure of the foldable substrate. Furthermore, some processing of foldable substrates comprising glass-based substrate may present differences in glass-based material properties at the first and second major surfaces of the glass-based substrate than central portions of the glass-based substrate. For example, during a down-draw process, properties of the glass-based substrate at the major surfaces of the glass-based substrate may be different than central portions of the glass-based substrate. Thus, by removing the layer from the first major surface 2803 at the first portion 2821 and the second portion 2823, the new first major surface 203 of these portions can have the same properties as the material forming the first central surface area 2807 to provide consistent optical properties across the length of the foldable substrate.

In some embodiments, the second major surface 2805 (e.g., the entire second major surface 2805) may be covered with the optional mask 2905 such that the second major surface 2805 is not etched and may provide the second major surface 2805 as the second major surface 205 discussed above. Preventing etching of the second major surface 2805 may be beneficial to preserve a pristine nature of the second major surface 2805 that may exist with some processing techniques (e.g., up draw or down draw). Maintaining the pristine surface may present a particularly smooth surface for the second major surface 2805 that may form the outermost surface of the foldable apparatus that may be observed and/or touched by a user of the foldable apparatus. Alternatively, the thickness of the foldable substrate 2801 can be reduced by removing the layer from the second major surface 2805, for example, to remove the skin layer to expose a central layer with more consistent optical properties across the length of the foldable substrate at discussed above. Thus, in some embodiments, a layer can be removed from the second major surface 2805 to expose a new second major surface that can comprise the second major surface 205.

In some embodiments, the layer can be removed from the first major surface 2803 to expose the new first major surface that can comprise the first major surface 203, and the layer can be removed from the second major surface 2805 to expose the new second major surface that can comprise the second major surface 205. Removing the layers from both the first and second major surfaces can remove that outer skin layers of the foldable substrate comprising a glass-based substrate that may have more inconsistent optical properties than the underlying interior portions of the foldable substrate. Consequently, the entire thickness throughout the length and the width of the foldable substrate may have more consistent optical properties to provide consistent optical performance with little or no distortions across the entire foldable substrate.

As shown in FIG. 29, the step 4305 can produce the foldable substrate 201, wherein the recess 2809 of the foldable substrate 2801 of FIG. 28 develops into the recess 234 of the foldable substrate 201. Furthermore, the central portion 225 of the foldable substrate 2801 can develop into the central portion 225 that can include the central major surface 235, first transition portion 227, and second transition portion 229 described previously. Still further, the first portion 2821 and the second portion 2823 of the foldable substrate 2801 can develop into the corresponding first portion 221 and the second portion 223 of the foldable substrate 201 described previously.

After step 4305, as further shown in FIG. 43, the method can optionally proceed to step 4307 comprising chemically strengthening the foldable substrate 201 comprising a glass-based substrate as shown in FIG. 30. Chemically strengthening a glass-based substrate by ion exchange can occur when a first cation within a depth of a surface of a glass-based substrate is exchanged with a second cation within a salt solution 3003 that has a larger radius than the first cation. For example, a lithium cation within the depth of the surface of the glass-based substrate can be exchanged with a sodium cation or potassium cation within a salt solution 3003. Consequently, the surface of the glass-based substrate is placed in compression and thereby chemically strengthened by the ion exchange process since the lithium cation has a smaller radius than the radius of the exchanged sodium cation or potassium cation within the salt solution 3003. Chemically strengthening the glass-based substrate can comprise contacting at least a portion of a glass-based substrate comprising lithium cations and/or sodium cations with a salt bath 3001 comprising salt solution 3003 comprising potassium nitrate, potassium phosphate, potassium chloride, potassium sulfate, sodium chloride, sodium sulfate, and/or sodium nitrate, whereby lithium cations and/or sodium cations diffuse from the glass-based substrate to the salt solution 3003 contained in the salt bath 3001. In some embodiments, the temperature of the salt solution 3003 can be about 300° C. or more, about 360° C. or more, about 400° C. or more, about 500° C. or less, about 460° C. or less, or about 400° C. or less. In some embodiments, the temperature of the salt solution 3003 can be in a range from about 300° C. to about 500° C., from about 360° C. to about 500° C., from about 400° C. to about 500° C., from about 300° C. to about 460° C., from about 360° C. to about 460° C., from about 400° C. to about 460° C., from about 300° C. to about 400° C., from about 360° C. to about 400° C., or any range or subrange therebetween. In some embodiments, the glass-based substrate can be in contact with the salt solution 3003 for about 15 minutes or more, about 1 hour or more, about 3 hours or more, about 48 hours or less, about 24 hours or less, or about 8 hours or less. In some embodiments, the glass-based substrate can be in contact with the salt solution 3003 for a time in a range from about 15 minutes to about 48 hours, from about 1 hour to about 48 hours, from about 3 hours to about 48 hours, from about 15 minutes to about 24 hours, from about 1 hour to about 24 hours, from about 3 hours to about 48 hours, from about 3 hours to about 24 hours, from about 3 hours to about 8 hours, or any range or subrange therebetween.

Chemically strengthening the foldable substrate 201 comprising a glass-based substrate can comprise chemically strengthening the first central surface area 233 of the central portion 225, chemically strengthening the first surface area 237 of the first portion 221 of the first major surface 203, chemically strengthening the third surface area 239 of the second portion 223 of the first major surface 203, and the second major surface 205 of the foldable substrate 201 comprising a glass-based substrate and/or a ceramic-based substrate. In some embodiments, chemically strengthening comprises chemically strengthening the first portion 221 to a first depth of compression from the first surface area 237 of the first major surface 203, chemically strengthening the second portion 223 to a third depth of compression from the third surface area 239 of the first major surface 203, and chemically strengthening the central portion 225 to a first central depth of compression from the first central surface area 233 of the central portion 225. In further embodiments, the first central depth of compression (e.g., of the central portion 225 from the first central surface area 233) can be less than the first depth of compression (e.g., of the first portion 221 from the first major surface 203). In further embodiments, the first central depth of compression (e.g., of the central portion 225 from the first central surface area 233) can be less than the third depth of compression (e.g., of the second portion 223 from the first major surface 203).

In some embodiments, chemically strengthening the second major surface 205 of the foldable substrate 201 comprising a glass-based substrate and/or a ceramic-based substrate can comprise chemically strengthening the second surface area 247 of the first portion 221 of the second major surface 205, chemically strengthening the fourth surface area 249 of the second portion 223 of the second major surface 205, and chemically strengthening the second central surface area 245 of the central portion 225 of second major surface 205. In some embodiments, chemically strengthening the second major surface 205 can comprise chemically strengthening the first portion 221 to a second depth of compression from the second surface area 247 of the second major surface 205, chemically strengthening the second portion 223 to a fourth depth of compression from fourth surface area 249 of the second major surface 205, and chemically strengthening the central portion 225 to a second central depth of compression from the second central surface area 245 of the second major surface 205.

In further embodiments, the second central depth of compression (e.g., of the central portion 225 from the second central surface area 245 of the second major surface 805) can be less than the second depth of compression (e.g., of the first portion 221 from the second surface area 247 of the second major surface 205). In further embodiments, the second central depth of compression (e.g., of the central portion 225 from the second central surface area 245 of the second major surface 805) can be less than the fourth depth of compression (e.g., of the second portion 223 from the fourth surface area 249 of the second major surface 205).

After step 4307, as further shown in FIG. 43, the method can optionally proceed to step 4309 comprising chemically etching the foldable substrate (e.g., similar to step 4305 illustrated in FIG. 29 with the following modifications). As described above with respect to step 4305 and FIG. 29, etching can comprise contacting the foldable substrate 201 with an etching solution 2903 contained in an etching bath 2901. The etching solution 2903 can comprise any of the compounds discussed above with regards to etching solution 2903. In some embodiments, the first major surface 203 and the first central surface area 233 are etched. In some embodiments, the second major surface 205 is etched. In further embodiments, the first major surface 203, the first central surface area 233, and the second major surface 205 are etched. The step 4309 of chemically etching can be designed to remove surface imperfections that may be left over from the step 4307, if carried out, of chemically strengthening the foldable substrate 201 comprising a glass-based substrate. Indeed, the step 4307 of chemically strengthening may result in surface imperfections that can affect the strength and/or optical quality of the glass-based substrate. By etching during step 4309, surface imperfections generated during the step 4307 of chemically strengthening can remove surface imperfections. Such etching during step 4309 can be designed to remove less than 5-10 nanometers of the compressive stress layer, thereby not substantially changing the thickness of the glass-based substrate or the surface compression achieved during step 4307 of chemically strengthening. After step 4309, the foldable substrate 201 can be provided at step 4311 that appears as the foldable substrate 201 illustrated in FIG. 29 prior to forming the plurality of panes, shattered pane, or shattered pane, or shattered region.

In some embodiments, methods of making the foldable substrate 201 appearing at step 4311 in FIG. 43 can comprise the steps disclosed above in the order disclosed above (e.g., 4301, 4303, 4305, 4307, 4309, 4311). In some embodiments, as shown in FIG. 43, the arrows 4302, 4304, 4306 may be sequentially followed, where the provided foldable substrate 201 (step 4301) is etched to reduce the thickness of the foldable substrate 201 (step 4305) before the recess 2809 is formed in the first major surface 203 of the foldable substrate 201 (step 4303) and the foldable substrate 201 comprising a glass-based substrate is chemically strengthened (e.g., ion exchange, step 4307). In some embodiments, arrow 4306 may be followed to skip etching the foldable substrate 201 to reduce the thickness of the foldable substrate, for example, when the provided foldable substrate 201 comprises a thickness substantially equal to the first thickness 222. In some embodiments, the arrow 4308 may be followed to skip etching the foldable substrate 201 after chemically strengthening the foldable substrate 201 comprising a glass-based substrate. Still further, in some embodiments, the arrow 4310 may be followed to skip the step 4307 of chemically strengthening and the step 4309 of etching. Furthermore, in some embodiments, arrow 4313 may be followed, after forming the recess (step 4303), wherein the steps of reducing the thickness (step 4305), the step of chemically strengthening (step 4307) and the step of etching (step 4309) may not be performed. Any of the above options may be combined to make the foldable substrate 201 (e.g., as illustrated in FIG. 29).

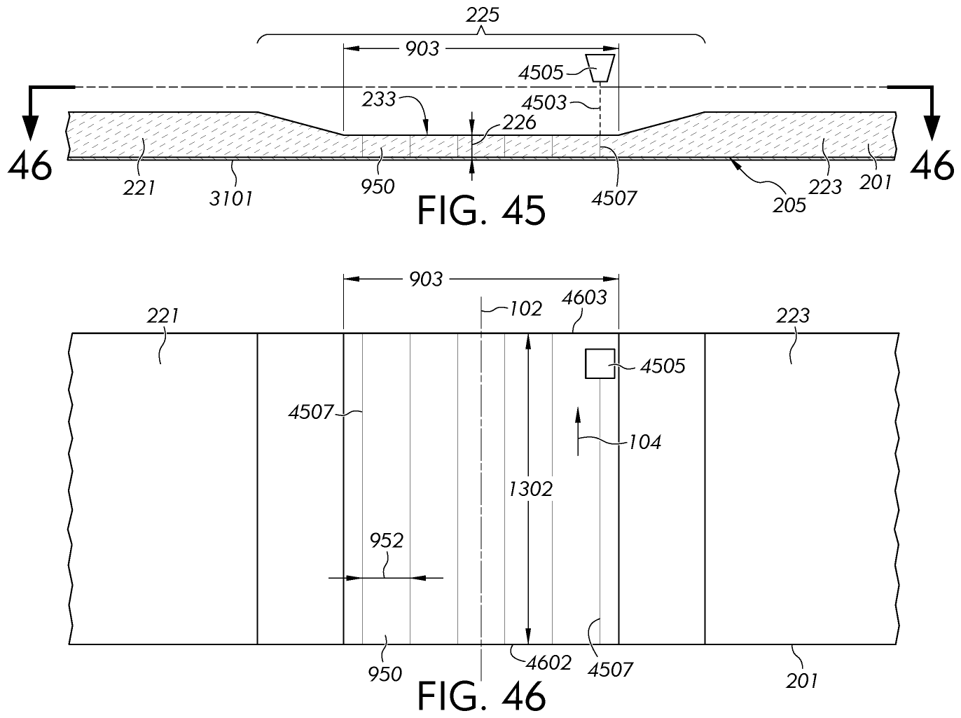

Methods of making the foldable apparatus 901 and 1001 from the provided foldable substrate 201 from FIG. 43 is illustrated in the flow chart of FIG. 44. In some embodiments, the method can proceed from the step 4311 of providing the foldable substrate 201 to step 4401 of applying a backer layer 3101 to the second major surface 205 of the foldable substrate 201 as shown in FIGS. 45, 47-48, and 50. The backer layer 3101 can comprise a flexible layer (e.g., a flexible film) and, in some embodiments, may be able to stretch to increase the length of the backer layer 3101. The backer layer 3101 can any of the materials and/or properties discussed above with reference to the backer layer 3101.

Methods of making the foldable apparatus 901 and 1001 can modify the foldable substrate 201 provided at step 4311 by dividing the central portion into the plurality of panes 950 as represented by step 4403 in FIG. 44. Embodiments of the step 4403 of dividing is illustrated in FIGS. 45-46. As shown in FIG. 45, in some embodiments, a laser beam 4503 produced by a laser 4505 may divide the central portion 225 by heating an area of the first central surface area 233 to produce a crack 4507 that can extend through the central thickness 226 of the central portion 225 from the first central surface area 233 to the second major surface 205 to divide the central portion 225 and thereby provide pairs of panes 950 that are separate from one another by a crack 4507. In some embodiments, as shown in FIG. 46, the laser 4505 may be scanned in a direction 104 (e.g., of the fold axis 102, of the width 103) to propagate the crack 4507 from one side edge 4602 of the foldable substrate 201 to an opposite side edge 4603 of the foldable substrate 201. As such, once formed, the crack 4507 can extend in the direction 104 and parallel to the fold axis 102. As shown in FIG. 46, the laser 4505 itself may be scanned in the direction 104 although optical mirrors (e.g., rotating optical mirrors) or other optical components may be designed to move the laser beam 4503 in the direction 104 to propagate the crack between the side edges 4602 and 4603.

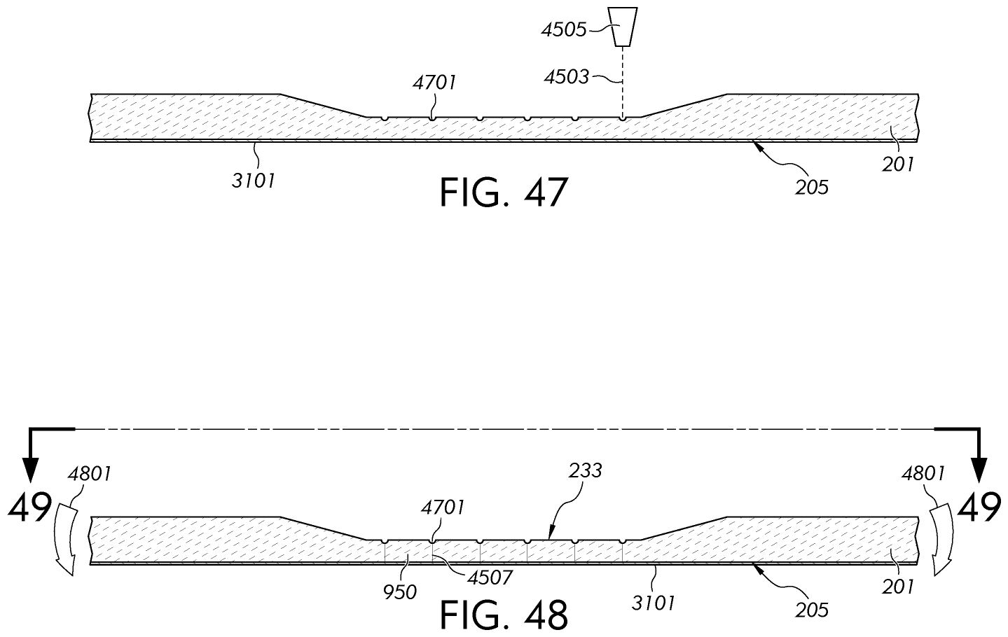

Other embodiments of the step 4403 of dividing is illustrated in FIGS. 47-49. As shown in FIG. 47, the method may include forming a groove 4701. In some embodiments, the groove 4701 may be formed by ablating a groove into the foldable substrate 201 with the laser beam 4503 generated by the laser 4505. Although not shown, other machining techniques (e.g., grinding) may be used to generate the groove. As shown in FIG. 49, a plurality of grooves 4701 may be generated, for example, by scanning the laser 4505 in the direction 104 (e.g., of the fold axis 102, of the width 103) such that the grooves 4701 extend in the direction 104 (e.g., of the fold axis 102, of the width 103) and parallel to the fold axis 102. The method of dividing the central portion 225 can then include separating panes 950 by forming the crack 4507 along the grooves 4701. In some embodiments, as shown in FIG. 48, bending moments 4801 may be applied to the foldable substrate 201 to cause the cracks 4507 to form along the grooves 4701. Indeed, the grooves 4701 can create lines of weakness along the first central surface area 233. When applying the bending moments 4801, a depth along the first central surface area 233 is placed in tension, wherein the cracks 4507 develop at the lines of weakness provided by the grooves 4701. The cracks 4507 can extend through the central thickness 226 of the central portion 225 from the first central surface area 233 to the second major surface 205 to divide the central portion 225 and thereby provide pairs of panes 950 that are separate from one another by a crack 1207. As such, the panes 950 can be provided with a predetermined size based on the locations of the grooves formed in the first central surface area 233.

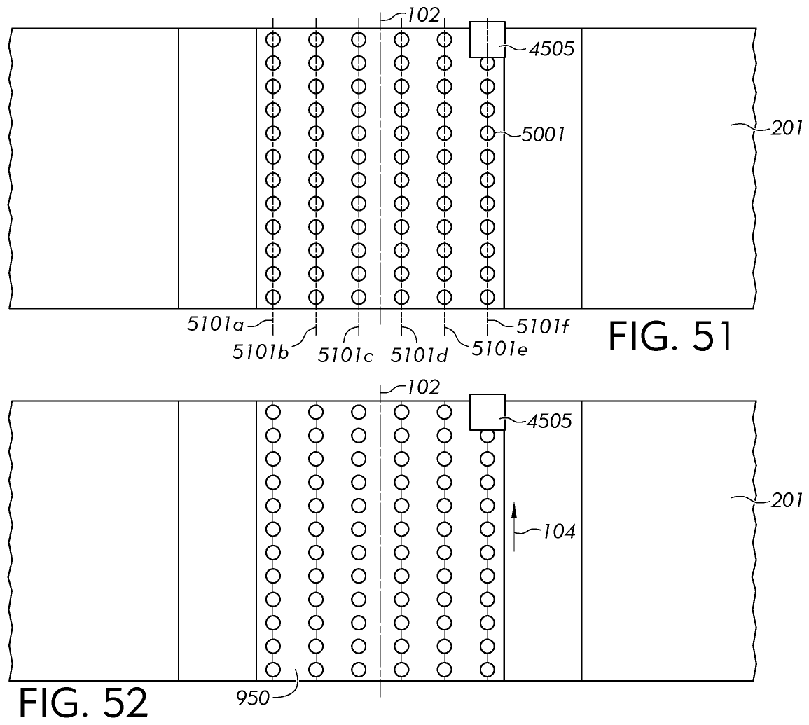

Other embodiments of the step 4403 of dividing is illustrated in FIGS. 50-52. As shown in FIGS. 50-51, the method may include forming holes 5001 extending through at least a portion of the central thickness 226 of the central portion 225. As shown, in some embodiments, the holes 5001 can comprise through holes that can extend through the first central surface area 233, through the second major surface 205 and through the central thickness 226 between the first central surface area 233 and the second major surface 205. Providing the holes 5001 as through holes can help further weaken the central portion 225 through the entire thickness. In some embodiments, the holes 5001 can comprise blind holes that may extend through one of the second major surface 205 and the first central surface area 233 without extending through the other of the second major surface 205 and the first central surface area 233 while only extending through a portion of the central thickness 226. Providing the holes 5001 as blind holes may help avoid the laser piercing the backer layer 3101 that may be adhered to the second major surface 205.

The holes 5001 (e.g., through holes) can be provided in a wide range of ways, for example, mechanical drilling, chemical etching, ablating with a laser or other techniques. By way of example, as shown in FIG. 50, the laser 4505 can produce the laser beam 4503 that ablates the hole 5001 as a through hole to extend through the first central surface area 233, the central thickness 226 and through the second major surface 205.

As shown in FIG. 51, sets of holes 5001 may comprise aligned paths of holes 5001 that can have centers that are positioned on a corresponding linear alignment axis 5101a-f and spaced from one another along the corresponding linear alignment axis 5101a-f. As shown, the centers of the holes 5001 may be spaced such that the holes do not touch one another although some or all of the holes may touch one another in further embodiments. In some embodiments, if the holes 5001 touch one another, the process of generating the holes 5001 as through holes may also act to divide the central portion 225 into pairs of panes along the aligned path of holes. Alternatively, if the holes are spaced from one another and/or comprise blind holes, cracks 4507 may be formed that extend through the central thickness 226 of the central portion 225 positioned between the cracks and or through the remainder of the central thickness 226 within the blind holes if provided. As shown in FIG. 52, the cracks may be formed by a laser 4505 scanning in the direction 104 (e.g., of the fold axis 102, of the width 103) although the cracks 4507 may be formed by applying a bending moment or other technique in further embodiments. The holes 5001 can help direct the cracks 4507 to the minimum distance between the holes 5001 along the aligned paths to help divide the panes 950 with the desired dimensions from the central portion 225. The cracks 4507 and/or holes 5001 that can extend through the central thickness 226 of the central portion 225 from the first central surface area 233 to the second major surface 205 to divide the central portion 225 and thereby provide pairs of panes 950 that are separate from one another by the cracks 4507 and/or holes 5001 along the aligned path.

In any of the embodiments of the disclosure can including applying the backer layer 3101 (e.g., tape) to the central portion 225 prior to the step 4403 of dividing the central portion 225 into the plurality of panes 950 in any of the embodiments discussed above. The backer layer 3101 can act to help maintain the position of the first portion 221, the central portion 225 (including the plurality of panes 950) and the second portion 223 relative to one another despite the fact that the panes 950 may separate and independent from one another with the first portion 221 separated from a first outer pane 950, the second portion 223 separated from a second outer pane 950 opposite the first outer pane 950 and adjacent pairs of panes 950 separated from one another and positioned between and including the first and second outer panes 950.

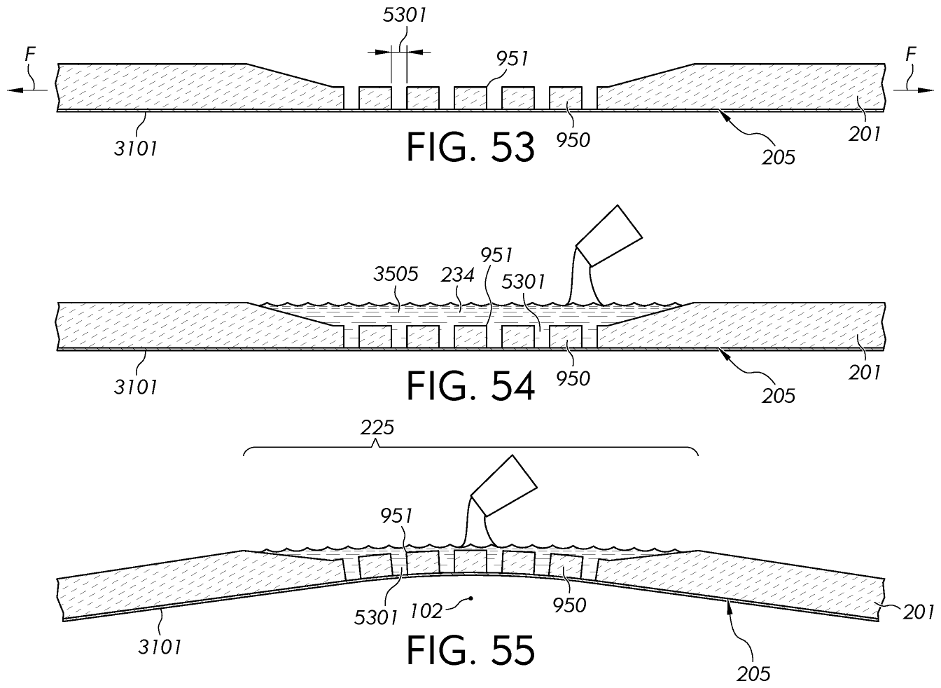

FIG. 44 further illustrates an optional step 4405 of stretching the backer layer 3101 to present spaces 5301 (see FIG. 53) on opposite sides of the panes 950. In the example embodiments of FIG. 53, a force “F” may be applied to the first portion 221 and the second portion 223 to stretch the backer layer 3101 to form the spaces 5301.

As further shown in FIG. 44, the method can include the step 4407 of flowing the first material 254 into the space 5301. For example, in the embodiments shown in FIG. 54, the method may include flowing the first material 254 into the spaces 5301 on opposite sides of the panes 950 and between pairs of panes 950. As further shown, in some embodiments, the second material 256 can flow into the recess 234. Without wishing to be bound by theory, the first material 254 and/or second material 256 may flow into the space between pair of panes due to capillary action and gravity. In some embodiments, as shown, the first material 254 and the second material 256 can comprise the same material and the step of filling the spaces 5301 be conducted while or during filling the recess 234 with the material. In some embodiments, the first material 254 and/or second material 256 can comprise any of the materials or precursors of the materials and can optionally comprise a solvent. Precursors can comprise, without limitation, one or more of a monomer, an accelerator, a curing agent, an epoxy, and/or inorganic particles. Example embodiments of solvents include polar solvents (e.g., water, an alcohol, an acetate, acetone, formic acid, dimethylformamide, acetonitrile, dimethyl sulfoxone, nitromethane, propylene carbonate, polyether ether ketone) and non-polar solvents (e.g., pentane, 1,4-dioxane, chloroform, dichloromethane, diethyl ether, hexane, heptane, benzene, toluene, xylene). The method can further include the step of curing the first material 254 to connect the pair of panes 950 together and curing the second material 256 within the recess 234. In some embodiments, curing the first material 254 and/or second material 256 can comprise heating, ultraviolet (UV) irradiation, and/or waiting for a predetermined period of time. In some embodiments, the first material 254 and/or second material 256 can comprise a negative coefficient of thermal expansion, as discussed above. In some embodiments, the precursor(s) can comprise a cyclic monomer (e.g., norbornene, cyclopentene), where curing the precursor(s) comprises ring-opening metathesis polymerization that can result in an increase in volume from the liquid (e.g., first liquid 3505, second liquid 4003) to the first material 254 and/or second material 256.

FIG. 55 shows embodiments of the step 4407 of flowing the first material 254 into the space 5301. As shown, the method can include bending the central portion 225 about the fold axis 102 to present the illustrated bent central portion. The method can then include flowing the first material 254 into the spaces 5301 while the central portion 225 is presented as the bent central portion. The method can then comprise curing the first material 254 to connect the pair of panes together while the central portion 225 is presented as the bent central portion. In some embodiments, after curing the first material 254, the foldable substrate 201 may then be flattened (e.g., as shown in FIG. 54) and the recess 234 can then be filled with the second material 256 that may be the same material as the first material 254 in some embodiments. Filling and curing the first material 254 in the spaces 5301 while the central portion 225 is bent can help reduce stress at the interface connection between the first material 254 and the panes 950 during bending. For example, the first material 254 at the outer edges 951 of the panes 950 in the bent orientation (see FIG. 15) can be in tension that may cause an undesired magnitude of stress at the outer edges 951 that may cause delamination of the first material 254 from the panes 950 originating at the outer edges 951. By curing the first material 254 while the central portion 225 is bent (see FIG. 55), tension is reduced since the central portion 225 is already partially bent with no stress in the first material 254 at the outer edges 951. Thus, deformation of the first material 254 is reduced to achieve the orientation shown in FIG. 15 that reduces the stress on the first material 254 at the outer edges 951.

As indicated by arrow 4402 in FIG. 44, in some embodiments, the method may proceed from step 4403 of dividing to step 4407 of flowing and curing the first material 254 into the spaces 5301 without the step 4405 of stretching the backer layer 3101 to present spaces 5301 first before beginning step 4407. For example, the weight of the material flowing into the recess 234 can force the panes 950 apart to generate the spaces 5301 that are filled with the first material 254 creating the spaces. In such a method, the backer layer 3101 may stretch but as a result of the step 4407 of flowing the first material 254 into the recess 234 that then creates the spaces 5301 that the first material 254 fills.

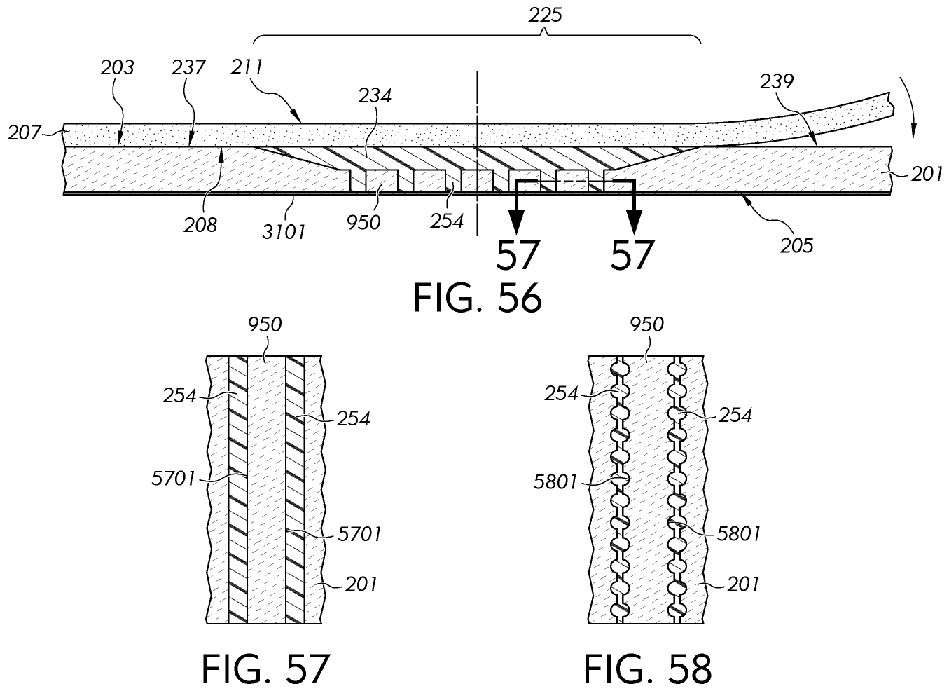

FIGS. 57-58 illustrate cross-sections of a portion of the central portion 225 along line 57-57 of FIG. 56. FIG. 57 illustrates example side walls 5701 of example panes 950 produced by the methods of FIGS. 45-49 where a strong interface attachment can be provided between the first material 254 and the substantially planar side walls 5701 of the panes 950. FIG. 58 illustrates example side walls 5801 of example panes 950 produced by the methods of FIGS. 50-52 that have non-planar shapes due to the formation of the holes 5001. The non-planar shapes increase the surface area of the side walls 5801 in contact with the first material 254 and can therefore provide a stronger interface attachment than can be achieved with planar side walls like shown in FIG. 57.

As shown by arrow 4406, the method may end at 4413 after the step 4407 of flowing and curing the first material 254. Alternatively, in some embodiments, the method may proceed to step 4415 of removing the backer layer 3101 from the foldable substrate 201. The backer layer 3101 can be removed in a wide range of ways, for example, by heating, exposing to UV light, peeling, or other techniques.

After step 4415, as shown in FIG. 44, methods of the disclosure can proceed to step 4417, which comprises applying an adhesive layer 207 to contact the first surface area 237 of the first major surface 203, the third surface area 239 of the first major surface 203, and the cured first material 254 or the cured second material 256. In alternative embodiments, the cured first material 254 or the second material 256 can comprise the adhesive that fills the recess 234. As shown by arrow 4404 in FIG. 44, in some embodiments, the method may comprise step 4417 of applying the adhesive layer 207 before removing the backer layer 3101. For example, in some embodiments, the backer layer 3101 may still be applied to the foldable substrate 201 at the end at 4413 to allow the backer layer 3101 to also act as a protective layer that can protect the second major surface 205 until a later time (e.g., after the foldable substrate 201 is applied to the display device 303).

As shown in FIG. 56, a sheet of the adhesive layer 207 can be deposited on the foldable substrate 201. The first contact surface 208 of the adhesive layer 207 can contact the first surface area 237 of the first major surface 203 and the third surface area 239 of the first major surface 203. Furthermore, the first contact surface 208 of the adhesive layer 207 can contact the outer surface of the cured first material 254 to provide an integral interface therebetween. Due to the integral interface between the cured first material 254 and the adhesive layer 207, optical diffraction can be avoided as light travels between the cured first material 254 and the adhesive layer 207 since the cured first material 254 and the adhesive layer 207 can, in some embodiments, include substantially the same index of refraction. Providing the cured first material 254 and the adhesive layer 207 with substantially the same index of refraction can avoid optical discontinuities that may otherwise exist at the vicinity of the interface between the cured first material 254 and the adhesive layer 207. In further embodiments, as shown in FIG. 56, the adhesive layer 207 can comprise the second contact surface 211 that can be planar and, in some embodiments, can be parallel with the first surface area 237 and/or the third surface area 239. In other embodiments, the entire layer of adhesive may be formed by application (by any suitable method known in the art) of a liquid material followed by optional curing.

In some embodiments, during step 4421 of FIG. 44, a release liner (e.g., see release liner 213 in FIG. 2) may be deposited on the second contact surface 211 of the adhesive layer 207. In some embodiments, when ready to apply the foldable substrate 201 to the display device 303, the release liner 213 may be removed and then the second contact surface 211 of the adhesive layer 207 may be deposited on the display device 303. In some embodiments, as indicated by step 4423, the second contact surface 211 of the adhesive layer 207 may be deposited on the display device 303 without involving a release liner 213.

In some embodiments, the foldable apparatus after step 4413 can comprise a neutral stress configuration when the foldable apparatus is in a bent configuration. In further embodiments, the foldable apparatus can comprise a maximum magnitude of the deviatoric strain of the polymer-based portion in one or more of the ranges discussed above (e.g., in a range from about 1% to about 8%, from about 2% to about 6%) in the neutral stress configuration. In further embodiments, the foldable apparatus can comprise an angle within one or more of the ranges discussed above in the neutral stress configuration. In some embodiments, the neutral stress configuration can correspond to a bent configuration as a result of curing the liquid (e.g., first liquid 3505, second liquid 4003) to form the first material 254 (or the second material 256) while the foldable substrate 201 was in a bent configuration. In some embodiments, the neutral stress configuration can correspond to a bent configuration as a result of an increase in volume in curing the liquid (e.g., first liquid 3505, second liquid 4003) to form the first material 254 (or the second material 256). In some embodiments, the neutral stress configuration can correspond to a bent configuration as a result of the first material 254 (or second material 256) comprising a negative coefficient of thermal expansion.

### EXAMPLES

Various embodiments will be further clarified by the following examples. Tables 4-7 present information about embodiments of polymer-based portions, which may be used as the first material 254 and/or the second material 256. Tables 8-10 present information about embodiments of adhesives. Tables 11-12 present calculated times to halve a maximum initial compressive stress for a glass-based substrate (having a Composition 1 of, nominally, in mol % of: 69.1 SiO₂; 10.2 Al₂O₃; 15.1 Na₂O; 0.01 K₂O; 5.5 MgO; 0.09 SnO₂) having a substrate thickness of 100 μm. Examples 1-10 demonstrate exemplary methods of making a glass-based substrate. As used herein, a liquid refractive index refers to the refractive index of the composition before it is cured while the cured refractive index refers to the refractive index of the composition after it is cured. Haze values were measured with a CIE D65 illuminant. Haze values were measured at an angle of 10° relative to an angle of incidence normal to the surface.

Compositions of Examples A-O are presented in Table 4. RX0057 (Allinex), Photomer 6320 (IGM Resins), and Miramer SC2565 (Miwon) are difunctional urethane-acrylate oligomers. Photomer 4184 (IGM Resins) is a difunctional cross-linking agent, Miramer M166 (Miwon), Miramer M170 (Miwon), Miramer M1084 (Miwon), Miramer M1539 (Miwon), Miramer M1192 (Miwon), and Miramer M1140 (Miwon) are reactive diluents. Kraton G1650 (Kraton) is an elastomer. These examples can be combined with a mercapto-silane and/or a photo-initiator. Examples A-N are embodiments of the polymer-based portion of the disclosure. Specifically, Examples C-N fall within one or more of the ranges R1-R4 in Table 1. Example O is a comparative example.

TABLE 4
Composition ranges (wt %) of embodiments of polymer-based portions

| Example | A | B | C | D | E | F | G | H | I | J | K | L | M | N | O |
|---|---|---|---|---|---|---|---|---|---|---|---|---|---|---|---|
| RX0057 | 20 | 0 | 0 | 0 | 0 | 0 | 0 | 0 | 0 | 0 | 0 | 0 | 0 | 0 | 0 |
| Photomer 6230 | 40 | 40 | 64 | 50 | 50 | 60 | 50 | 50 | 50 | 50 | 0 | 0 | 0 | 0 | 0 |
| Dymax BR-543 | 0 | 0 | 0 | 0 | 0 | 0 | 0 | 0 | 0 | 0 | 50 | 50 | 50 | 50 | 0 |
| Miramer SC2565 | 0 | 0 | 0 | 0 | 0 | 0 | 0 | 0 | 0 | 0 | 0 | 0 | 0 | 0 | 50 |
| Photomer 4184 | 20 | 24 | 32 | 30 | 30 | 40 | 0 | 0 | 0 | 0 | 0 | 0 | 0 | 0 | 0 |
| Miramer M166 | 0 | 0 | 0 | 0 | 0 | 0 | 40 | 0 | 0 | 0 | 40 | 0 | 0 | 25 | 0 |
| Miramer M170 | 0 | 0 | 0 | 0 | 0 | 0 | 0 | 40 | 0 | 0 | 0 | 0 | 0 | 0 | 0 |
| Miramer M1084 | 0 | 0 | 0 | 0 | 0 | 0 | 0 | 0 | 40 | 0 | 0 | 40 | 20 | 25 | 0 |
| Miramer M1539 | 0 | 0 | 0 | 0 | 0 | 0 | 0 | 0 | 0 | 40 | 0 | 0 | 0 | 0 | 0 |
| Miramer M1192 | 0 | 16 | 0 | 20 | 10 | 10 | 10 | 10 | 10 | 10 | 10 | 10 | 0 | 0 | 0 |
| Miramer M1140 | 0 | 0 | 0 | 0 | 0 | 0 | 0 | 0 | 0 | 0 | 0 | 0 | 0 | 0 | 50 |
| Miramer HR3700 | 0 | 0 | 0 | 0 | 0 | 0 | 0 | 0 | 0 | 0 | 0 | 0 | 30 | 0 | 0 |
| Kraton G1650 | 20 | 20 | 0 | 0 | 0 | 0 | 0 | 0 | 0 | 0 | 0 | 0 | 0 | 0 | 0 |

TABLE 5
Properties of embodiments of polymer-based portions

| Example | A | B | C | D | E | F |
|---|---|---|---|---|---|---|
| Tg (° C.) | n/a | n/a | 34 | 12 | 16 | 13 |
| Tensile Strength (MPa) | 2.30 | 0.75 | 12.3 | 1.32 | 1.74 | 2.15 |
| Ultimate Elongation (%) | 37 | 67 | 65 | 100 | 107 | 107 |
| Elastic Modulus (MPa) | 7.0 | 0.1 | 23.4 | 2.9 | 2.7 | 3.4 |
| Transmittance (%) | 87.2 | 87.4 | 91.4 | 91.8 | 87.6 | 87.4 |
| Haze (%) | 0.79 | 3.06 | 0.15 | 0.07 | 0.51 | 0.10 |
| Liquid Refractive Index | 1.466 | 1.503 | 1.495 | 1.481 | 1.482 | 1.494 |
| Cured Refractive Index | 1.465 | 1.498 | 1.500 | 1.513 | 1.499 | 1.499 |

| Example | G | H | I | J | K | L | N | O |
|---|---|---|---|---|---|---|---|---|
| Tg (° C.) | −29 | −24 | −13 | −17 | −32 | −39 | −35 | 45 |
| Tensile Strength | 0.55 | 0.66 | 0.62 | 0.47 | 0.71 | 0.51 | 0.53 | 24.4 |
| (MPa) | | | | | | | | |
| Ultimate | 59 | 42 | 76 | 44 | 172 | 181 | 150 | 297 |
| Elongation (%) | | | | | | | | |
| Elastic Modulus | 1.5 | 2.1 | 1.6 | 1.5 | 1.2 | 0.9 | 0.9 | 27.0 |
| (MPa) | | | | | | | | |
| Transmittance | 87.3 | 87.6 | 87.4 | 87.8 | 87.4 | 87.5 | 87.5 | 87.6 |
| (%) | | | | | | | | |
| Haze (%) | 0.92 | 0.33 | 0.81 | 0.49 | 0.58 | 0.14 | 0.03 | 0.10 |
| Liquid | 1.493 | 1.471 | 1.469 | 1.478 | 1.493 | 1.471 | 1.481 | 1.485 |
| Refractive Index | | | | | | | | |
| Cured Refractive | 1.503 | 1.491 | 1.491 | 1.492 | 1.500 | 1.489 | 1.493 | 1.499 |
| Index | | | | | | | | |

Table 5 presents properties of Examples A-N and Example 0. Examples C-F comprise glass transition temperatures from about 10° C. to about 35° C. while Examples G-N comprise glass transition temperatures less than −10° C., and Examples G-H and Examples K-N comprise glass transition temperatures less than −20° C. Example C comprises a tensile strength of 12.3 MPa. Example A and Examples D-F comprise tensile strengths from about 1 MPa to about 3 MPa while Example B, Examples G-L, and Example N comprise tensile strengths from about 0.3 MPa to about 0.7 MPa. Examples D-F, Examples K-L, and Example K comprise ultimate elongations of 100% or more while Examples B-C and Example I comprise ultimate elongations from about 60% to about 80%, and Examples G-H and Example J comprise ultimate elongations from about 40% to about 60%. Example C comprises an elastic modulus of 23.4 MPa while Example A comprises an elastic modulus of 7.0 MPa. Examples D-L and Example N comprise elastic moduli from about 0.9 MPa to about 3.4 MPa. Examples C-D comprise transmittances of more than 90% and hazes from about 0.05% to about 0.20%. Examples A-O comprise transmittances of more than 87%. Example A an Examples C-O comprise hazes less than 1%. Examples B-O comprise cured refractive indices from about 1.49 to about 1.52. The refractive index can be increased by increasing the content of Miramer M1192 with refractive indices between 1.49 and 1.53 observed when the content of Miramer M1192 in Example E was adjusted from 0% wt to about 30% wt. The liquid refractive index for Examples B-G, Example K, and Examples N-O are from 1.48 and 1.505 while the liquid refractive index for Example A, Examples H-J, and Example L is from 1.46 to 1.48. In Examples C-O, the cured refractive index is greater than the liquid refractive index. Examples C-N all withstood 2,000 bending cycles at a parallel plate distance of 3 millimeters. In contrast, Example O failed to withstand 2,000 cycles at a parallel plate distance of 4 millimeters. Example C 23° C. fully recovered after being extended to a strain of 40% at a strain rate of 10% strain per minute at 23° C. In contrast, Example N comprised a strain set of 3% after being extended to a strain of 40% at a strain rate of 10% strain per minute at 23° C.

TABLE 6
Composition ranges (wt %) of embodiments
of polymer-based portions

| Example | P | Q | R | S | T | U | V | W | X |
|---|---|---|---|---|---|---|---|---|---|
| Dymax BR-543 | 0 | 0 | 0 | 0 | 0 | 0 | 9 | 23 | 1 |
| Miramer M200 | 0.1 | 0.5 | 1 | 0.1 | 0.5 | 1 | 0 | 0 | 0 |
| 2-Propylheptyl | 0 | 0 | 0 | 60 | 59.8 | 59.5 | 55 | 46 | 59 |
| acrylate | | | | | | | | | |
| Butyl Acrylate | 55 | 54.8 | 54.5 | 0 | 0 | 0 | 0 | 0 | 0 |
| Miramer 1192 | 44.9 | 44.7 | 44.5 | 39.9 | 39.7 | 39.5 | 36 | 31 | 40 |

TABLE 7
Properties of embodiments of polymer-based portions

| Example | P | Q | R | S | T | U | V | W | X |
|---|---|---|---|---|---|---|---|---|---|
| Tg (° C.) | −5 | −4 | −3 | n/a | −19 | −19 | −27 | −28 | n/a |
| Transmittance (%) | 86.7 | 86.7 | 86.7 | 87.1 | 87.0 | 87.1 | 87.1 | n/a | 87.3 |
| Haze (%) | 0.07 | 0.03 | 0.04 | 0.11 | 0.08 | 0.06 | 0.12 | n/a | 0.06 |
| Liquid | 1.495 | 1.495 | 1.494 | 1.497 | 1.498 | 1.497 | 1.495 | 1.492 | 1.497 |
| Refractive | | | | | | | | | |
| Index | | | | | | | | | |
| Cured | 1.616 | 1.621 | 1.609 | 1.528 | 1.528 | 1.528 | 1.549 | n/a | 1.532 |
| Refractive | | | | | | | | | |
| Index | | | | | | | | | |

Table 6 presents the compositions of Examples P-X. Examples P-X are embodiments of the polymer-based portion of the disclosure. Specifically, Examples P-X fall within one or more of the ranges R1-R4 in Table 1. Properties of Examples P-X are presented in Table 7. Examples P-R and Examples T-W comprised a glass transition temperature less than 0° C. Further, Examples T-U comprised a glass transition temperature of -19° C. while Examples V-W comprised a glass transition temperature less than −20° C. The liquid refractive index for Examples P-X were between 1.49 and 1.50. The cured refractive indices for Examples S-U were 1.528, the cured refractive index for Example X was 1.532, and the cured refractive index for Example V was 1.549. Also, Example U comprised a tensile strength of 0.07 MPa, an ultimate elongation of 161%, and an elastic modulus of 0.13 MPa. Example V comprises a tensile strength of 0.12 MPa, an ultimate elongation of 205%, and an elastic modulus of 0.17 MPa. Additionally, Example W comprised a tensile strength of 0.4 MPa, an ultimate elongation of 99%, and an elastic modulus of 0.6 MPa.

TABLE 8
Composition ranges (wt %) of embodiments of adhesive materials

| Range | AA | BB | CC | DD | EE | FF | GG |
|---|---|---|---|---|---|---|---|
| SMS-992 | 98 | 19.5 | 16.2 | 25 | 20 | 11.3 | 0 |
| Miramer | 2 | 0.5 | 0.3 | 0 | 0 | 0 | 0 |
| M1192 | | | | | | | |
| PDV-2331 | 0 | 20 | 22 | 25 | 40 | 87.5 | 45.7 |
| MTV-112 | 0 | 0 | 8.8 | 0 | 0 | 1.2 | 0 |
| VPT-1323 | 0 | 60 | 52.7 | 50 | 40 | 0 | 22.8 |

TABLE 9
Properties of embodiments of adhesive materials

| Property | BB | DD | EE | FF |
|---|---|---|---|---|
| Tg (° C.) | −73 | −74 | −73 | −73 |
| Storage Modulus | 9.6 | 3.0 | 3.2 | 6.6 |
| (MPa), 23° C. | | | | |
| Loss Modulus | 1.20 | 0.50 | 0.31 | 0.82 |
| (MPa), 23° C. | | | | |

Compositions of Examples AA-GG are presented in Table 8. SMS-992 (Gelest) is a silane-hydride-terminated siloxane. PDV-2331 (Gelest), MTV-112 (Gelest), and VPT-1323 are vinyl-terminated siloxanes. SMS-992 (Gelest) is a thiol-containing siloxane. These examples can be combined with a silane coupling agent, catalyst, and/or photo-initiator. Examples AA-GG are embodiments of the polymer-based portion of the disclosure. Specifically, Examples AA-GG fall within one or more of the ranges R10-R12 in Table 2.

Table 9 presents properties of Examples BB and DD-FF. Examples BB and DD-FF comprise glass transition temperatures from about −75° C. to about −70° C. At 23° C., Example BB comprises a storage modulus of 9.6 MPa and a loss modulus of 1.20 MPa while Examples DD-FF comprise storage moduli from about 3 MPa to about 7 MPa and loss moduli from about 0.30 MPa to about 0.90 MPa.

TABLE 10
Properties of embodiments of adhesive materials

| Property | BB | Control |
|---|---|---|
| Transmittance (%) | 85.9 | 85.7 |
| (KrystalFlex) | | |
| Haze (%) | 20 | 20 |
| (KrystalFlex) | | |
| Transmittance (%) | 92.2 | 85.7 |
| (Sylgard 184) | | |
| Haze (%) | 15 | 30 |
| (Sylgard 184) | | |
| Steel Wool | Ripped after | Ripped after |
| Abrasion | 1,700 cycles | 5 cycles |
| (Sylgard 184) | | |

Haze and transmittance of the adhesives (e.g., Example BB) can be evaluated as included in a shattered pane. The shattered pane with the adhesive positioned between at least an adjacent pair of the plurality of shattered pieces comprising the shattered pane was prepared following Example 2 or Example 3 (see below). The shattered pane comprised a 1 mm thick glass-based substrate comprising Composition 1 (see below). The control example comprised a shattered pane without a first material positioned between the shattered pieces comprising the shattered pane. For the data presented in Table 10, the shattered pane was attached to a second material comprising a thickness of 75 μm comprising the material listed in parenthesis. KrystalFlex refers to KrystalFlex PE505 available from Huntsman. Sylgard 184 is available from Dow Chemical. The transmittance and/or haze are then measured for the combined apparatus as described above. Further, a steel wool abrasion test can be conducted using type #0000 steel wool rubbed at a rate of 40 cycles per minute until failure.

As shown in Table 10, Example BB comprises a higher transmittance than the control for both KrystalFlex (0.2% higher) and Sylgard 184 (6.5% higher). For KrystalFlex, both Example BB and the control comprise the same haze. For Sylgard 184, the control comprises a haze of 30% while Example BB comprises a haze of 15% (15% less). For the steel wool test, the control failed after 5 cycles while Example BB failed after 1,700 cycles.

Tables 11-12 were calculated based on the diffusion of alkali metal ions introduced in a prior chemically strengthening step and assumed an Arrhenius relationship for the time at different temperatures. Table 11 presents the time needed to halve a maximum initial compressive stress at temperatures from 250° C. to 400° C. Without wishing to be bound by theory, these temperatures correspond to temperatures easily achievable with commercial ovens. While the time at 250° C. is 505 hours, it drops as temperature is increased. For example at 300° C., the time is 68 hours, and at 400° C. it is less than 3 hours. While these times are for 100 μm thick glass-based substrates, the times are expected to be less for thinner glass-based substrates and greater for thicker glass-based substrates.

TABLE 11
Time to halve maximum initial compressive stress

| Temperature (° C.) | Time (hours) |
|---|---|
| 250 | 505 |
| 275 | 176 |
| 300 | 68 |
| 325 | 28 |
| 350 | 12.5 |
| 375 | 5.93 |
| 400 | 2.97 |

Example AAA having Composition 1, a substrate thickness of 100 μm, and an initial DOL of 43.5 μm (43.5% of the substrate thickness) was heated at 300° C. for 68 hours. Example AAA comprised a final DOL of 51.6 μm (51.6% of the substrate thickness). As suggested by Table 11, the final maximum compressive stress was half of the maximum initial compressive stress. A final difference between a first refractive index and a central refractive index was reduced by more than half of an initial difference between an initial first surface area refractive index and an initial central refractive index as a result of the heating.

Table 12 presents the time needed to halve a maximum initial compressive stress at temperatures from 575° C. to 1100° C. Without wishing to be bound by theory, these temperatures correspond to temperatures easily achievable with laser heating. While the time at 575° C. is 4.44 minutes, it drops as temperature is increased. For example at 600° C., the time is 2.96 minutes, and at 675° C. it is less than 1 minute. Further increasing the temperature, for example to 900° C., the time is 0.09 minutes (e.g., 5.5 seconds), and at 1100° C., the time is 0.02 minutes (e.g., 1.2 seconds). While these times are for 100 μm thick glass-based substrates, the times are expected to be less for thinner glass-based substrates and greater for thicker glass-based substrates.

TABLE 12
Time to halve maximum initial compressive stress

| Temperature (° C.) | Time (min) |
|---|---|
| 575 | 4.44 |
| 600 | 2.96 |
| 650 | 1.40 |
| 675 | 0.99 |
| 700 | 0.72 |
| 750 | 0.39 |
| 800 | 0.23 |
| 850 | 0.14 |
| 900 | 0.09 |
| 1000 | 0.04 |
| 1100 | 0.02 |

Examples 1-8 all comprise a foldable substrate comprising a glass-based substrate (having a Composition 1 of, nominally, in mol % of: 69.1 SiO₂; 10.2 Al₂O₃; 15.1 Na₂O; 0.01 K₂O; 5.5 MgO; 0.09 SnO₂) and a first thickness of 100 μm.

Example 1 comprised a glass-based substrate (Composition 1) with dimensions of 160 mm by 100 mm by 100 μm that was chemically strengthened in a bath comprising 100% molten KNO₃ at 420° C. for 7 hours. Example 1 comprised compressive stress regions extending for a depth of compression of 18 μm (18% of the first thickness) from the first major surface and the second major surface, a maximum central tension of about 380 MPa, and a stored strain energy of about 38.6 J/m².

Example 2 comprised chemically strengthened glass-based substrate of Example 1. A second material comprising a sheet of cured polyimide comprising a thickness of 50 μm was disposed over the second major surface of the substrate with a 25 μm OCA (3M 8146) positioned between the polyimide sheet and the substrate. Next, the substrate was shattered by cutting with scissors for a length of about 3 mm or less. The substrate curled, which increased the space between the shattered pieces at the first major surface. Then, a first liquid comprising a thermally curable sol-gel material comprising a viscosity of about 4,000 mPa-s infiltrated the spaces between the shattered pieces. The first liquid was cured at 150° C. for 1 hour to form the first material comprising a sol gel with an elastic modulus of about 15 GPa.

Example 3 comprised chemically strengthened glass-based substrate of Example 1 that was treated with gamma-aminopropyltrimethoxysilane on the second major surface. A 25 μm coating of a second liquid comprising a solution of polyimide precursors was slot die coated on to the second major surface and cured at 150° C. for 1 hour to form a polyimide layer as the second material. Next, the substrate was shattered using a silicon carbide scribe. Then, a first liquid comprising precursors of a thiol-ene-based UV curable silicone infiltrated the spaces between the shattered pieces. The first liquid was cured using a mercury lamp emitting UV light to form the first material. A 50 μm PET layer was disposed over the PI layer using an OCA (3M 8146) comprising a thickness of 25 μm.

Example 4 comprised chemically strengthened glass-based substrate of Example 1. A second liquid comprising a 150 μm coating of Eleglass W802-GL044 with only 2 wt % cross-linker was applied using a down-draw method. The second liquid was cured at 120° C. for 1 hour to form a 75 μm layer of the second material. Next, the substrate was shattered using a silicon carbide scribe. Then, a first liquid comprising precursors of a silicone elastomer (PP2-OE50 available from Gelest) infiltrated the spaces between the shattered pieces. The first liquid was cured at 100° C. for 1 hour to form the first material.

Example 5 was the same as Example 4 except that the second material comprising the Eleglass material was replaced with a polyurethane layer resulting from curing a 150 μm coating of an aqueous polyurethane dispersion (Dispurez 102) at 100° C. for 1 hour resulting in a 75 μm layer of the second material.

Example 6 was the same as Example 4 except that the second material comprising the Eleglass material was replaced with a silicone layer resulting from curing a 25 μm coating of Nu-Sil LS 8941 at 150° C. for 1 hour.

Example 7 was the same as Example 4 except that the second material comprising a 200 μm layer of mounting wax applied to the first major surface. After the first material was cured, a 50 μm PET layer was disposed over the second major surface using an OCA (3M 8146) comprising a thickness of 25 μm. Then, the mounting wax was removed by heating the substrate to 100° C. followed by using an acetone solution.

Example 8 comprised chemically strengthened glass-based substrate of Example 1. A first material comprising a 50 μm layer of thermoplastic polyurethane (TPU) (KrystalFlex PESOS) was disposed on the second major surface of the substrate. The TPU layer was adhered to the substrate using a vacuum-assisted autoclave process with a maximum temperature of 110° C. Next, the substrate was shattered using a silicon carbide scribe. Then, a substrate was placed in a Carver press that was heated to 150° C. and 300 pounds per square inch (psi) (e.g., about 2 GPa) of pressure was applied to force the TPU into the space between the shattered pieces.

Examples 9-10 relate to the foldable apparatus 1701, 1801, and 2401 shown in FIGS. 17-18 and 24. In Example 9, a sol-gel coating (e.g., as consistent with coating 2007) was made by mixing the following constituents: 9 g of diphenylsilanediol, 20 ml of methyltriethoxysilane, 2 ml of tetraethoxysilane, 2 ml of hydroxyl poly(dimethylsiloxane), 3 ml of water, 2 ml of boron n-butoxide, and 2 ml of tetrakistrimethylsilyltitanium. The materials were dispensed into a round bottom flask (“RBF”) and placed in a glycerol bath heated to 80° C. The RBF was fitted with an air condenser to prevent loss of starting materials during heating, and to retain as much ethanol as possible to hinder the formation of a high viscosity gel. The solution was then heated with stirring for 3 hours after which time the RBF was removed from the bath and any residual glycerol was cleaned from the outside of the RBF. The condenser was removed, and the sol-gel solution was dispensed into a Nalgene® bottle. The top of the bottle was secured and the material was allowed to cool to room temperature. Next, the sol-gel solution was mixed with n-propyl acetate at a 1:1 ratio to form the final sol-gel coating solution suitable for spin coating.

In Example 9, glass substrates comprising Composition 1 and dimensions of 53 mm×90 mm×0.2 mm were spin coated with the final sol-gel coating solution. All spin coating was conducted by ramping for 5 seconds to 1,000 revolutions per minute (rpm) and holding this speed for 30 seconds followed by an immediate stop. Samples were removed from the spin coater and placed on a 150° C. hotplate for 30 minutes to drive off residual solvents and to begin curing the sol gel. Various bendable glass article samples were prepared by applying a narrow strip of the sol-gel coating to the center of the part with widths of 20 mm, 10 mm and 20 mm for Samples 9B, 9C, and 9D, respectively. Sample 9A is a control and was not subjected to spin coating with the sol-gel coating solution. During the spin coating, an adhesive mask was applied to mask off the uncoated area. The masked substrate was placed on the spin coater chuck and a disposable pipette was used to apply the sol-gel solution. The masked and coated substrate was then spun at 1,000 rpm for 30 seconds after which time the mask material was removed and the now unmasked substrate was placed on a hotplate that was preheated to 150° C. It was left on the hotplate for 30 minutes to drive off residual solvent and to begin the condensation of the sol-gel material. Once removed from the hotplate, each sample was placed on an alumina setter in a room temperature furnace and heated at 5° C./min to 700° C. The furnace was held at this temperature for 20 minutes and then the furnace was allowed to cool naturally to room temperature.

Further, in Example 9, the parts were removed from the furnace and examined for bend properties. Samples 9B, 9C, and 9D naturally developed into as-bent configurations with bend angles of 90° (“hamburger” configuration), 45° (“taco” configuration), 90° (“hot dog” configuration), respectively. These bend angles refer to the amount of movement of each end of the sample relative to a flat configuration. That is, the left end moved about 45° in a clockwise direction and the right end moved about 45° in a counterclockwise direction. For example, in Sample 9C each end of the sample moved about 45° from a flat configuration, leading to the “taco” configuration. As for Samples 9A and 9C, each of the right end and the left end of the sample moved about 90° in a counter-clockwise and clockwise direction, respectively, from a flat configuration, leading to the “hamburger” and “hot dog” configurations, respectively. Also, the as-bent Samples 9B-9D can be characterized with the following diameters of curvature: 4.75 mm, 3 mm, and 4.75 mm, respectively. At this stage of the process, the samples could be etched to remove the oxide layer derived from the sol-gel coating and manually adjusted to a substantially non-bent configuration. Once in the non-bent configuration, the samples will retain residual compressive stress at the primary surface opposite the bends discussed above. In contrast, the samples are characterized by about zero residual stress as bent configurations (Samples 9B and 9C). That is, the as-bent configuration is the new neutral stress state of the glass and, therefore, it will return to the as-bent configuration when unconstrained after being flattened. The goal is to provide a glass article that contains minimal residual, tensile stress when flexed to either an open (flat) or closed (fully bent) state. As such, these samples are resistant to bend fatigue-related failures when being subjected to the as-bent configurations of Samples 9B-9C and back to a substantially non-bent configuration.

In Example 10, a secondary ion mass spectrometry (SIMS) of sodium ions (Na⁺) diffusing through a glass substrate with an oxide coating formed from a sol-gel coating, according to embodiments of the disclosure, was measured. In order to provide flat samples for SIMS analysis, a glass substrate (50 mm×50 mm×0.7 mm) was dip coated in a sol gel solution (so as to coat both sides of the substrate, whereby after drying the sol gel solution the effects of drying it on each side cause the substrate to maintain a flat configuration as opposed to the bent configurations described above) that was made according to the principles of this disclosure by diluting the sol-gel with n-propyl acetate. The sample was dried, to remove residual solvents in a 150° C. oven for 30 minutes. The sample was then placed in a furnace and heated per the previously described schedule set forth in Example 1 to consolidate the oxide layer. After the SIMS analysis was conducted: a 3 kV Cs⁺ primary ion beam was used to sputter and a quadrupole mass spectrometer was used to analyze positive and negative secondary ions. For reference, a depth of 0.0 μm refers to the surface of the oxide coating and the SIMS is conducted through the coating and to a depth within the substrate of about 0.9 μm (as measured through the coating). A mole fraction of Na⁺ ions of about 0.02 to about 0.07 Na was observed within the coating while a mole fraction of Na⁺ ions of about 0.09 was observed beyond the coating (within the glass sample). As is evident from the SIMS analysis, Na⁺ ions are able to travel through the oxide coating. As such, without being bound by theory, it is believed that the oxide coating has sufficient alkali ion diffusivity to allow for ion-exchange processes to impart an ion-exchange compressive stress region in an underlying glass substrate through an oxide coating, as formed in a manner consistent with the principles of the disclosure.

The above observations can be combined to provide polymer-based portions, adhesives, foldable apparatus comprising a polymer-based portion and/or an adhesive, foldable apparatus comprising a shattered pane, foldable apparatus comprising a plurality of planes, and methods of making the same. The polymer-based portions of embodiments of the disclosure can provide several technical benefits. For example, the polymer-based portion can comprise a urethane acrylate material that is elastomeric. By providing an elastomeric polymer-based portion, the polymer-based portion can recover (e.g., fully recover) from folding-induced strains and/or impact-induced strains, which can decrease fatigue of the polymer-based portion from repeated folding, enable a low force to achieve a given parallel plate distance, and enable good impact and/or good puncture resistance. Further, the polymer-based portion can be cross-linked, for example, using a difunctional cross-linking agent, which can further increase the elastomeric character of the polymer-based portion. Also, the polymer-based portion can further comprise a block copolymer or silicone-based rubber, which can further increase the elastomeric character of the polymer-based portion. In some embodiments, the polymer-based portion can be made using a reactive diluent, which can decrease the glass transition temperature of the polymer-based portion. Providing a low glass transition temperature (e.g., about 0° C. or less, about −20° C. or less) can enable consistent mechanical properties of the polymer-based portion across a temperature range in which it is used (e.g., from about 0° C. to about 60° C., from about 10° C. to about 30° C.). Also, the polymer-based portion can withstand high strains (e.g., about 50% or more, from about 65% to about 110%), which can improve folding performance and durability. Providing a silane-coupling agent can increase adhesion of the polymer-based portion to substrates (e.g., glass-based substrates, polymer-based substrates) and/or adhesives. Additionally, the polymer-based portion can comprise high transmittance (e.g., about 90% or more) and low haze (e.g., about 0.2% or less).

The adhesives of embodiments of the disclosures can provide several technical benefits. The adhesive can comprise a silicone-based polymer with a low glass-transition temperature (e.g., about −60° C. or less). Providing a low glass transition temperature (e.g., about −60° C. or less) can enable consistent mechanical properties of the polymer-based portion across a temperature range in which it is used (e.g., from about −20° C. to about 60° C., from about 10° C. to about 30° C.). The adhesive can withstand high strains (e.g., about 75% or more), comprise a low storage modulus (e.g., from about 0.2 kiloPascals to about 2 kiloPascals), and/or comprise a low Young's modulus (e.g., elastic modulus about 75 MegaPascals or less). Providing an adhesive with a low storage modulus and/or low Young's modulus can improve folding performance of a foldable apparatus, for example, by decoupling the stresses of different components in the foldable apparatus. Providing a low modulus (e.g., storage, Young's) and high strain adhesive can improve folding performance and durability. The adhesive can be formed by curing a substantially solvent-free composition. Providing a composition that is substantially solvent-free can increase its curing rate, which can decrease processing time. Providing a composition that is substantially solvent-free can reduce (e.g. decrease, eliminate) the use of rheology modifiers and increase composition homogeneity, which can increase the optical transparency (e.g., transmittance) of the resulting adhesive. Providing a silane-coupling agent can increase adhesion of the polymer-based portion to substrates (e.g., glass-based substrates, polymer-based substrates), polymer-based portions, and/or adhesives.

Foldable apparatus can exhibit good optical performance, for example, low optical distortions across the thickness of the foldable apparatus. Providing a foldable apparatus comprising a shattered pane and/or a plurality of panes with a low difference (e.g., about 0.008 or less) between a refractive index at a major surface of the foldable apparatus and a central location of the foldable apparatus can minimize optical distortions from the plurality of shattered pieces comprising the shattered pane and/or the plurality of panes. Also, providing a foldable apparatus comprising a shattered pane and/or a plurality of panes with a low difference (e.g., about 0.008 or less) between a refractive index at a major surface of the foldable apparatus and a central location of the foldable apparatus can minimize optical distortions between an adjacent pair of shattered pieces of the plurality of shattered pieces and/or the plurality of panes and a first material positioned therebetween, if provided.

Providing a smooth surface of the foldable apparatus can reduce optical distortions and provide a perceived continuous surface for a user touching the foldable apparatus. Likewise, providing a second material disposed over substantially an entire second major surface of a foldable substrate can reduce optical distortions. In some embodiments, the first material can substantially match (e.g., a magnitude of a difference of about 0.1 or less) a refractive index of a shattered piece and/or a pane, which can minimize the visibility of the shattered pane and/or plurality of panes to a user. In some embodiments, providing the first material between a pair of shattered pieces and/or a pair of panes can produce an anti-glare and/or anti-reflective property in the foldable apparatus that can improve visibility of an electronic device that the foldable apparatus may be disposed over. In some embodiments, providing a first material comprising a different (e.g., a magnitude of a difference of about 0.02 or more) refractive index than a refractive index of a shattered piece and/or a pane can produce an angle-dependent visibility (e.g., haze, color shift) through the foldable apparatus. For example, visibility may be at a maxima (e.g., maximum) when viewed at a direction normal to the surface (e.g., first major surface) of the foldable apparatus, and that visibility may decrease (e.g., increasing haze) as an angle relative to a direction normal to the surface is increased.

Providing a foldable apparatus comprising a central portion comprising a central thickness that is less than a first thickness of the first portion and/or second portion can enable small effective minimum bend radii (e.g., about 10 millimeters or less) based on the reduced thickness in the central portion. As indicated by surprising results of the Pen Drop Test presented in FIG. 7, foldable substrates comprising a thickness of about 50 μm or less can provide good pen drop performance while thicknesses in a range from about 50 μm to about 80 μm provide poor pen drop performance. Furthermore, providing the central portion with the central thickness that is less than the first thickness can reduce stress concentrations at the outer edges of the shattered pieces and/or the panes during folding that may otherwise occur with larger thicknesses at the first portion and the second portion. Furthermore, the thickness of the first portion and the second portion may be increased to enhance puncture resistance that may be more difficult to achieve with reduced thicknesses that are similar and/or the same thickness as the shattered pane, the plurality of panes, and/or the central portion. Additionally, the foldable substrate may comprise a glass-based substrate to enhance puncture resistance and/or impact resistance. Further, the foldable apparatus comprising the glass-based substrate may be chemically strengthened to further enhance impact resistance and/or puncture resistance of the foldable apparatus. Also, the plurality of panes and/or plurality of shattered pieces may comprise a plurality of glass-based panes that can optionally be chemically strengthened, which can enhance impact resistance and/or puncture resistance of the foldable apparatus.

A foldable apparatus according to embodiments of the disclosure can comprise the adhesive and/or the polymer-based portion. For example, the foldable apparatus can provide small effective minimum bend radii while simultaneously providing good impact and puncture resistance. By providing a shattered pane with a plurality of shattered pieces attached together by a first material having an elastic modulus that is less than an elastic modulus of a shattered piece of the plurality of shattered pieces, a foldable apparatus can enable good flexibility and folding performance (e.g., achieve an effective bend radius of about 10 millimeters or less). By providing a plurality of panes attached together by a first material having an elastic modulus that is less than an elastic modulus of a pane of the plurality of panes, a foldable apparatus can enable good flexibility and folding performance (e.g., achieve an effective bend radius of about 10 millimeters or less). The foldable apparatus can comprise glass-based and/or ceramic-based materials comprising one or more compressive stress regions, which can further provide increased impact resistance and/or increased puncture resistance while simultaneously facilitating good folding performance.

Also, by providing a shattered pane with a plurality of shattered pieces and/or a plurality of panes attached together by a first material, a smooth (e.g., regular, planar) surface (e.g., first major surface) can be enabled, for example, when the shattered pane and/or plurality of panes was generated from a substrate deposed on a backer when it was shattered. Providing a smooth surface of the foldable apparatus can reduce optical distortions and provide a perceived continuous surface for a user touching the foldable apparatus. Likewise, providing a second material disposed over substantially an entire second major surface of a foldable substrate can reduce optical distortions. In some embodiments, the first material can substantially match (e.g., a magnitude of a difference of about 0.1 or less) a refractive index of a shattered piece, which can minimize the visibility of the shattered pane to a user.

In some embodiments, providing the first material between a pair of shattered pieces and produce an anti-glare and/or anti-reflective property in the foldable apparatus that can improve visibility of an electronic device that the foldable apparatus may be disposed over. In some embodiments, providing a first material comprising a different (e.g., a magnitude of a difference of about 0.02 or more) refractive index than a refractive index of a shattered piece can produce an angle-dependent visibility (e.g., haze, color shift) through the foldable apparatus. In further embodiments, providing the different refractive indices can be useful as a privacy screen. For example, visibility may be at a maxima (e.g., maximum) when viewed at a direction normal to the surface (e.g., first major surface) of the foldable apparatus, and that visibility may decrease (e.g., increasing haze) as an angle relative to a direction normal to the surface is increased.

Providing a central portion with a shattered pane and/or a plurality of panes with the first material can help further reduce the effective minimum bend radius compared to a monolithic pane entirely fabricated from a glass-based material or a ceramic-based material. Also, providing the plurality of shattered pieces of the shattered pane and/or a plurality of panes can provide good scratch resistance, good impact resistance, and/or good puncture resistance to the foldable apparatus, which may be difficult to achieve if fabricating the foldable substrate entirely of the first material. The foldable apparatus can comprise glass-based and/or ceramic-based materials comprising one or more compressive stress regions, which can further provide increased impact resistance and/or puncture resistance while simultaneously facilitating good bending performance.

By providing a shattered pane with a plurality of shattered pieces and/or plurality of panes attached together by a first material having an elastic modulus that is less than an elastic modulus of a shattered piece of the plurality of shattered pieces and/or a pane of the plurality of panes, a foldable substrate can enable good folding performance (e.g., achieve an effective bend radius of about 10 millimeters or less) as well as limiting the extent of potential damages to the foldable apparatus. For example, the damage resistance of the foldable apparatus may increase because damage to the foldable apparatus may be limited to a shattered piece and/or pane impacted rather than the entire foldable substrate. Additionally, the first material between pairs of shattered pieces and/or pairs of panes can improve the ability of the foldable apparatus to absorb impacts without failure. Furthermore, providing a central portion with a shattered pane with the first material can help further reduce the effective minimum bend radius compared to an unshattered pane entirely fabricated from a glass-based or ceramic-based material. Also, providing the plurality of shattered pieces of the shattered pane can provide good scratch resistance, good impact resistance, and/or good puncture resistance to the foldable apparatus, which may be difficult to achieve if fabricating the shattered pane entirely of the first material.

Minimizing a total mass of first material (e.g., about 10% or less of a total weight of the plurality of shattered pieces) can further improve scratch resistance, impact resistance, and/or puncture resistance of the foldable apparatus. The foldable apparatus can comprise glass-based and/or ceramic-based materials comprising one or more compressive stress regions, which can further provide increased impact resistance and/or puncture resistance while simultaneously facilitating good bending performance.

Providing a second material comprising a higher modulus than the first material can reduce bend-induced stresses on the foldable substrate, for example, by shifting a neutral axis of the substrate closer to the second material than a mid-plane of the substrate. Further, providing a second material disposed over substantially an entire second major surface of a foldable substrate can present a contact surface with consistent properties across its length and/or width for coupling components to (e.g., substrates, coatings, release liners, display devices). In some embodiments, a first portion and a second portion can be positioned opposite a first major surface of the substrate. Providing a first portion and a second portion with the second material positioned therebetween can provide good bending performance as well as minimize a region of the foldable apparatus with a lower impact resistance (e.g., the portion including the second material compared to the portions comprising the first portion or the second portion).

Further, the net mechanical properties of the foldable apparatus can be adjusted by changing the relationship between the elastic modulus of the first material relative to the elastic modulus of a piece of the shattered pieces and/or a pane of the plurality of panes. Providing a first material and/or a second material with a glass transition temperature outside of an operating range (e.g., from about −20° C. to about 60°) of a foldable apparatus can enable the foldable apparatus to have consistent properties across the operating range. Similarly, by providing a first material and/or a second material comprising a storage modulus that changes by a multiple of 100 or less when changing a temperature of the corresponding material from 100° C. to about −20° C. there can be achieved consistent properties across a wide range of temperatures. As discussed above, the adhesives can comprise the first material.

Providing a foldable apparatus and/or a foldable substrate comprising a neutral stress configuration when the foldable apparatus and/or a foldable substrate is in a bent configuration, the force to bend the foldable apparatus to a predetermined parallel plate distance can be decreased. Further, providing a neutral stress configuration when the foldable apparatus is in a bent state can reduce the maximum stress and/or maximum strain experienced by a polymer-based portion and/or an adhesive, if provided, during normal use conditions, which can, for example, enable increased durability and/or reduced fatigue of the foldable apparatus. In some embodiments, the neutral stress configuration can be generated by heating the foldable substrate and a sol-gel coating disposed on the foldable substrate to form the foldable substrate into a bent configuration (e.g., neutral stress configuration). Providing a width of the sol-gel coating from about 5% to about 30% or a longest dimension of the foldable substrate can minimize the amount of material and/or cost associated with making the foldable substrate and/or foldable apparatus.

Providing a neutral stress configuration when the foldable apparatus is in a bent configuration can decrease the force to fold the foldable apparatus to a predetermined parallel plate distance. Further, providing a neutral stress configuration when the foldable apparatus is in a bent state can reduce the maximum stress and/or the maximum strain experienced by the polymer-based portion during normal use conditions, which can, for example, enable increased durability and/or reduced fatigue of the foldable apparatus. In some embodiments, the polymer-based portion can comprise a low (e.g., substantially zero and/or negative) coefficient of thermal expansion, which can mitigate warp caused by volume changes during curing of the polymer-based portion. In some embodiments, the neutral stress configuration can be generated by providing a polymer-based portion that expands as a result of curing. In some embodiments, the neutral stress configuration can be generated by curing the polymer-based portion in a bent configuration.

Methods are disclosed that shift the neutral stress configuration of a foldable apparatus that, as used in its intended application, may experience large compressive and tensile stresses when folded to tight bend radii. These methods can reduce the incidence of fatigue failure in the foldable apparatus. In some embodiments, the neutral stress configuration can correspond to a bent (e.g., as-bent) configuration through the deposition and annealing of a sol-gel oxide coating, leading to a neutral stress state in the as-bent configuration and a beneficial stress state in a substantially non-bent configuration. Foldable apparatus of embodiments of the disclosure, for example, can be shaped in a desired as-bent configuration (e.g., neutral stress configuration) without the use of a mold and at lower temperatures than employed in thermal sagging processes. The methods also have flexibility in terms of developing the two-dimensional and three-dimensional as-bent configurations of the intended bendable glass articles by virtue of the ease in which the sol-gel coatings can be patterned on the glass substrate.

Directional terms as used herein—for example, up, down, right, left, front, back, top, bottom—are made only with reference to the figures as drawn and are not intended to imply absolute orientation.

It will be appreciated that the various disclosed embodiments may involve features, elements, or steps that are described in connection with that embodiment. It will also be appreciated that a feature, element, or step, although described in relation to one embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises embodiments having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another embodiment. Whether or not a numerical value or endpoint of a range in the specification recites “about,” the numerical value or endpoint of a range is intended to include two embodiments: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C. As used herein, the terms “comprising” and “including”, and variations thereof shall be construed as synonymous and open-ended unless otherwise indicated.

The above embodiments, and the features of those embodiments, are exemplary and can be provided alone or in any combination with any one or more features of other embodiments provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the embodiments herein provided they come within the scope of the appended claims and their equivalents.

1-336. (canceled)

337. A polymer-based portion comprising an index of refraction in a range from about 1.49 to about 1.55, wherein the polymer-based portion comprises the product of curing a composition, the composition comprising the following in weight % (wt %):
0-25 wt % of a difunctional urethane-acrylate oligomer;
0-5 wt % of a difunctional cross-linking agent; and
75-100 wt % of a reactive diluent.

338. The polymer-based portion of claim 337, wherein the reactive diluent comprises one or more of biphenylmethyl acrylate, nonyl phenol acrylate, or isooctyl acrylate.

339. The polymer-based portion of claim 337, wherein the reactive diluent comprises a vinyl-terminated mono-acrylate monomer.

340. The polymer-based portion of claim 337, wherein the difunctional cross-linking agent comprises a urethane diacrylate monomer.

341. The polymer-based portion of claim 337, wherein the difunctional cross-linking agent comprises 2-[[(butylamino)carbonyl]oxy]ethyl acrylate.

342. The polymer-based portion of claim 337, wherein the polymer-based portion comprises a glass transition temperature of about 0° C. or less.

343. The polymer-based portion of claim 342, wherein the glass transition temperature is in a range from about −60° C. to about −20° C.

344. The polymer-based portion of claim 337, wherein the composition further comprises 0.1-3 wt % of a photo-initiator, and curing the composition comprises irradiating the composition with at least one wavelength of light that the photo-initiator is sensitive to.

345. The polymer-based portion of claim 337, wherein curing the composition comprises heating the composition at a temperature in a range from about 100° C. to about 200° C. for a time in a range from about 15 minutes to about 6 hours.

346. The polymer-based portion of claim 337, wherein the composition further comprises 1-4.9 wt % of a silane coupling agent.

347. The polymer-based portion of claim 346, wherein the silane coupling agent comprises a mercapto-silane.

348. The polymer-based portion of claim 337, further comprising a thermoplastic elastomer.

349. The polymer-based portion of claim 337, wherein the polymer-based portion comprises an average transmittance of about 90% or more measured over optical wavelengths in a range from 400 nanometers to 760 nanometers.

350. The polymer-based portion of claim 337, wherein the polymer-based portion comprises a haze of about 0.2% or less.

351. The polymer-based portion of claim 337, wherein the polymer-based portion comprises an ultimate elongation of about 50% or more.

352. The polymer-based portion of claim 337, wherein the polymer-based portion comprises a tensile strength of about 1 MegaPascal or more.

353. The polymer-based portion of claim 337, wherein the polymer-based portion comprises an elastic modulus in a range from about 1 MegaPascal to about 100 MegaPascals.

354. The polymer-based portion of claim 337, wherein a storage modulus of the polymer-based portion at 23° C. is in a range from about 0.3 MegaPascals to about 3 MegaPascals.

355. The polymer-based portion of claim 337, wherein the polymer-based portion at 23° C. can fully recover after being extended to a strain of 40% at a strain rate of 10% strain per minute.

356. The polymer-based portion of claim 337, wherein the polymer-based portion can withstand 2,000 bending cycles at a parallel plate distance of 3 millimeters.
